(19) United States
(12) Patent Application Publication
(10) Pub. No.: US 2014/0377385 A1
(43) Pub. Date: Dec. 25, 2014

(54) PEST CONTROL COMPOSITIONS AND METHODS

(71) Applicant: TyraTech, Inc., Morrisville, NC (US)

(72) Inventor: Essam ENAN, Davis, CA (US)

(21) Appl. No.: 14/290,892

(22) Filed: May 29, 2014

Related U.S. Application Data
(63) Continuation of application No. 12/009,220, filed on Jan. 16, 2008, now abandoned.
(60) Provisional application No. 60/885,214, filed on Jan. 16, 2007.
(60) Provisional application No. 60/885,403, filed on Jan. 17, 2007.
(60) Provisional application No. 60/889,259, filed on Feb. 9, 2007.

(51) Int. Cl. A01N 65/32; A01N 65/08; A01N 37/18; A01N 37/36; A01N 27/00; A01N 35/04; A01N 43/78; A01N 43/88; A01N 65/22; A01N 65/16; A01N 37/02; A01N 65/12; A01N 43/50

(52) U.S. Cl. CPC A01N 65/32; A01N 65/12; A01N 65/08; A01N 37/18; A01N 37/36; A01N 27/00; A01N 43/50; A01N 43/78; A01N 43/88; A01N 65/22; A01N 65/16; A01N 37/02; A01N 35/04
USPC 424/745; 424/764; 514/341

(57) ABSTRACT

Embodiments of the present invention provide compositions for controlling a target pest including a pest control product and at least one active agent, wherein: the active agent can be capable of interacting with a receptor in the target pest; the pest control product can have a first activity against the target pest when applied without the active agent and the compositions can have a second activity against the target pest; and the second activity can be greater than the first activity.

### CROSS-REFERENCE TO RELATED APPLICATIONS

This application is a continuation of U.S. patent application Ser. No. 12/009,220, filed Jan. 16, 2008, which claims priority from U.S. Provisional Application Ser. Nos. 60/885,214 filed Jan. 16, 2007, 60/885,403 filed Jan. 17, 2007, and 60/889,259 filed Feb. 9, 2007, each of which is hereby incorporated by reference in its entirety.

### FIELD OF THE INVENTION

The present invention relates to compositions and methods related to controlling insects.

### BACKGROUND OF THE INVENTION

While the first recorded use of chemicals to control pests dates back to 2500 BC, only in the last 60 years has chemical control has been widely used. Early pesticides included hellebore to control body lice, nicotine to control aphids, and pyrithrin to control a wide variety of insects. Lead arsenate was first used in 1892 as an orchard spray, while at the same time it was discovered that a mixture of lime and copper sulphate (Bordeaux mixture) controlled downy mildew, a fungal disease of grapes.

The modern era of chemical pest control commenced during World War II. For example, DDT played a major role in maintaining the health and welfare of soldiers who used it to control body lice and mosquitoes. Further developments of pesticides followed, and with their relatively low cost, ease of use, and effectiveness, they became the primary means of pest control. Protection of crops, produce, animals, and humans over extended periods became possible with corresponding increases in food production and improved standards of living.

Some modern pesticides are sophisticated compounds that are carefully researched to ensure they are effective against target organisms, generally safe to the environment, and can be used without undue hazard to users or consumers. Many of these have been developed to target specific biochemical reactions within the target organism, e.g. an enzyme necessary for photosynthesis within a plant or a hormone required for normal development in an insect. Thus, some modern chemicals are safer, more specific, and friendlier to the environment than the older products they have replaced.

### SUMMARY

Embodiments of the present invention provide compositions for controlling a target pest including a pest control product and at least one active agent, wherein: the active agent can be capable of interacting with a receptor in the target pest; the pest control product can have a first activity against the target pest when applied without the active agent and the compositions can have a second activity against the target pest; and the second activity can be greater than the first activity. The first and second activities can be quantified by measuring concentration of the pest control product effective to control the target pest, and a concentration corresponding to the first activity can be higher than a concentration corresponding to the second activity. The first and second activities can be quantified by measuring disablement effect of the target pest at a standard concentration of pest control product, and the compositions exhibit a greater disablement effect than the pest control product applied without the active agent. The first activity can persist for a first period, the second activity can persist for a second period, and the second period can be longer than the first period. The active agent can include a synergistic combination of at least two receptor ligands. The second activity can reflect a synergistic interaction of the active agent and the pest control product.

The target pest can be selected from the group consisting of a fungus, a plant, an animal, a moneran, and a protist. The target pest can be an arthropod species, such as, for example, an insect, an arachnid, or an arachnoid. The target pest can be a species belonging to an animal order selected from: Acari, Anoplura, Araneae, Blattodea, Coleoptera, Collembola, Diptera, Grylloptera, Heteroptera, Homoptera, Hymenoptera, Isopoda, Isoptera, Lepidoptera, Mantodea, Mallophaga, Neuroptera, Odonata, Orthoptera, Psocoptera, Siphonaptera, Symphyla, Thysanura, and Thysanoptera.

The pest control product can be a chlorphenoxy compound such as, for example, 2,4-D Amine and/or 2,4D IBE. Likewise, the pest control product can be a carbamate such as, for example, methomyl, carbofuran, carbaryl, BPMC, carbendazim, carbosulfan, captan hydrochloride, and/or cartap. The pest control product can be an organophosphate such as, for example, acephate, malathion, diazinon, chlorpyfiros, fenoxycab, edifenphos, febuconazole, chlorphenapyr, magnesium phosphide, metamidophos, and/or fenitrothion. The pest control product can be an organochlorine such as, for example, DDT, DDE, and/or heptachlorepoxide. The pest control product can be a pyrethroid such as, for example, cypermethrin, cynmethylin +2,4-D IBE, lambdacyhalothrin, dazomet, cyfluthrin, betacypermethrin, pendimethlin, permethrin, deltamethrin, bifenethrin, alphacypermethrin, fenvalerate, propanil, and/or esfenvalerate. The pest control product can be a neonicotinoid such as, for example, thiomethoxam, fipronil, clothianidin, and/or imidacloprid. The pest control product can include at least one of an avermectin, abamectin, spinosad, fluxastrobin, and/or indoxacarb. The pest control product can be a botanical product such as, for example, rotenone, nicotine, caffeine, a pyrethrum, an essential oil, and/or a fixed oil. The pest control product can be a fungicide, a nematicide, an insecticide, an acaricide, and/or a bactericide.

The receptor can be a G protein-coupled receptor (GPCR), such as a GPCR of the insect olfactory cascade, such as, for example, a tyramine receptor, an olfactory receptor Or43a, an olfactory receptor Or83b and/or an octopamine receptor. Binding of the receptor by an ingredient of the compositions can result in a change in intracellular level of cAMP and/or calcium, wherein the change can be sufficient to permit control of the target pest.

Control can include a condition such as, for example, killing, knockdown, repellency, interference with reproduction, interference with feeding, and interference with a stage of a life cycle of the target pest.

Embodiments of the invention also include a crop protected by the compositions disclosed herein.

In addition, embodiments of the invention can include compositions for controlling a target pest including a pest control product and at least one active agent, wherein: the active agent can include a ligand of a GPCR of a target pest, wherein binding of the ligand to the GPCR can cause a change in a level of cAMP or calcium that can permit control of the target pest; the pest control product can have a first activity against the target pest, the active agent can have a second activity against the target pest, and the compositions can have a third activity against the target pest; and the third activity can be greater than the first activity or the second activity. The active agent can include a synergistic combination of at least two GPCR ligands. The third activity can be indicative of synergy between the active agent and the pest control product. In some embodiments, compositions can include at least two active ingredients, wherein at least one active ingredient interacts with a G protein-coupled receptor (GPCR) of the pest and wherein at least one active ingredient does not interact with the GPCR, and wherein the at least two active ingredients in combination have a synergistic pest-control activity. The pest can be an insect and the GPCR can be associated with olfaction, and further the GPCR preferably can be absent from vertebrate animals. The synergistic pest-control activity can have a coefficient of synergy in excess of 1.5. The synergistic pest-control activity can exceed additive effects of the active ingredients, as measured by the Colby calculation of synergy. The GPCR can have a high affinity for the active ingredient in a target organism and the GPCR can be absent or can have a low affinity for the active ingredient in a non-target organism. The non-target organism can be a vertebrate animal. In some embodiments, the target organism can be a plant, an animal, a fungus, a protist, or a moneran, and the non-target organism can be selected from a crop plant, a vertebrate animal, and a non-pest invertebrate.

In some embodiments, the invention provides low-resistance pest-control compositions, including at least a first active ingredient and a second active ingredient, wherein the first active ingredient interacts with a first molecular target under genetic control within a selected pest, and wherein the second active ingredient interacts with a second molecular target under genetic control within the selected pest, and wherein the ingredients in the compositions act together in a complementary manner upon the target pest, and wherein resistance to the compositions in an individual target pest requires two separate genetic lesions divergent from a non-resistant population of the pest. The first and second molecular targets can include two separate molecules encoded or controlled by separate genetic elements. The complementary manner can include an additive effect of each agent acting separately, or the complementary manner can include a synergistic effect as compared with each agent acting separately. The first molecular target can be a GPCR, and the second molecular target is preferably not the same as the first molecular target.

Also provided in some embodiments are pest-control compositions exhibiting high potency against an invertebrate target pest and low toxicity against a vertebrate animal, the compositions including a synergistic combination of active agents, wherein each active agent interacts with a molecular target with high affinity in the target pest and that can be absent form, or present with low affinity, from the vertebrate. The at least one active agent can be a ligand of a selected GPCR, and the at least one active agent is preferably not a ligand of the selected GPCR. The high target potency and low vertebrate toxicity can be expressed as a ratio of LD50(target) versus LD50(vertebrate animal), and wherein the ratio can be less than 100:1.

In some embodiments, the invention provides methods of pest control including contacting a target pest with a composition as described herein, resulting in control of the pest. The methods can include applying a composition to a target pest or to a substrate associated with a target pest, wherein the compositions can include a pesticide and an active agent including at least one receptor ligand, and wherein the pest control can include affecting a physiological condition of the pest associated with a function of the pesticide while also affecting a function of the receptor associated with the receptor ligand. The binding of the receptor by an ingredient of the compositions can result in a change in intracellular level of cAMP and/or calcium, and wherein the change can be sufficient to permit control of the target pest. The pesticide can be selected from a chlorphenoxy compound, a carbamate, an organophosphate, an organochlorine, a pyrethroid, a neonicotinoid, a botanical product, a fungicide, a nematicide, and insecticide, and acaracide, a bactericide. and an avermectin. The substrate can be, for example, a crop plant and/or a soil. The target pest can be, for example, a fungus, a plant, an animal, a moneran, or a protist. The use of the compositions can permit an improvement of control of the pest as compared with use of the pesticide alone or the active agent alone. The improvement can include a synergistic interaction of the pest control product with the active agent. The improvement can include an improved result with use of a substantially similar amount of the pest control product. The improved result can be at least one of: increased killing of the target pest; increased interference with reproduction by the target pest; and prolonged effectiveness of the pest control product. The improvement can include a substantially similar result with use of a substantially lower amount of the pest control product and/or the active agent. Use of the compositions permits an agricultural improvement such as, for example, increased crop yield; reduced frequency of application of pest control product; reduced phytotoxicity associated with the pesticide; and reduced cost or increased value associated with at least one environmental factor. The environmental factor can include, for example, air quality, water quality, soil quality, detectable pesticide residue, safety or comfort of workers; and a collateral effect on a non-target organism.

Also provided are methods of developing a compositions for pest control, including: providing a cell line expressing at least one of: a tyramine receptor, an olfactory receptor Or43a, or an olfactory receptor Or83b, wherein binding of a ligand to any of the receptors causes a change in a level of intracellular cAMP or calcium, and the change can be indicative of a potential for invertebrate pest control; contacting the cell with a candidate ligand; detecting a change in the level of cAMP and/or calcium in the cell; identifying the candidate ligand as an active compound for control of an invertebrate pest; and combining the active compound with a pesticide to form a composition for pest control, wherein the pesticide does not bind to a receptor bound by the active compound, and wherein a combined effect of the active compound and the pesticide can include an effect against a target pest that can be greater than the effect of either the active compound alone or the pesticide alone. The compositions further can include a second active compound capable of binding at least one of the receptors. The active compounds can cooperate to cause a synergistic change in the level of cAMP and/or calcium in the cell line and/or in a target pest. The combined effect of the active compound and the pesticide can be synergistic. The combined effect can be determined by at least one condition selected from the group consisting of: killing, knockdown, repellency, interference with reproduction, interference with feeding, and interference with a stage of a life cycle of the target pest.

Also provided are further methods of pest control, including, providing a composition including at a first and a second active ingredient, wherein the first active ingredient interacts with a receptor of a target pest, and wherein the second active ingredient can be a pesticide that does not interact with the receptor of the first active ingredient; and contacting the pest with the compositions, wherein the contacting results in synergistic pest control. The compositions further can include a third active ingredient, wherein the third active ingredient interacts with a receptor of the target pest, and wherein at least the first and third active ingredients in combination synergistically interact to permit control of the target pest. The first and third active ingredients can optionally bind the same receptor; in other embodiments, the first and third active ingredients do not bind the same receptor. The first, second, and third active ingredients in combination can have a synergistic effect that can be greater than the effect of any single ingredient and can be also greater than the synergistic effect of the first and third ingredients in combination. The receptor can be a GPCR such as, for example, a tyramine receptor, an olfactory receptor Or43a, and an olfactory receptor Or83b. The pest control can be associated with a receptor-activated alteration in a level of cAMP and/or calcium within the pest. The alteration can persist for at least about 60 seconds.

Also provided are other methods of pest control, including: providing a composition including at least two active ingredients, wherein at least one active ingredient interacts with a GPCR of a target pest, the composition produces a first level of at least one of intracellular calcium and cyclic AMP in a cell expressing the GPCR on exposure to the cell, and the first level can be higher than a second level produced when the cell can be contacted with any single active ingredient; and contacting the pest with the compositions, wherein the contacting results in synergistic pest control. Other embodiments provide methods for controlling a target pest including use of a pest control compositions, the compositions including a pest control product and at least one active agent, wherein: the active agent can include a ligand of a GPCR of a target pest, wherein binding of the ligand to the GPCR causes a change in a level of cAMP or calcium that permits control of the target pest; the pest control product can have a first activity against the target pest, the active agent can have a second activity against the target pest, and the compositions can have a third activity against the target pest; and the third activity can be greater than the first activity or the second activity. A further method of pest control can include use of a pest control composition, wherein the composition can include at least two active ingredients, wherein at least one active ingredient interacts with a G protein-coupled receptor (GPCR) of the pest and wherein at least one active ingredient does not interact with the GPCR, and wherein the at least two active ingredients in combination have a synergistic pest-control activity. Other methods of pest control can permit low-resistance in a target pest, including administering a pest-control composition, the composition including at least a first active ingredient and a second active ingredient, wherein the first active ingredient interacts with a first molecular target under genetic control within a selected pest, and wherein the second active ingredient interacts with a second molecular target under genetic control within the selected pest, and wherein the ingredients in the composition act together in a complementary manner upon the target pest, and wherein resistance to the composition in an individual target pest requires two separate genetic lesions divergent from a non-resistant population of the pest.

Still other embodiments provide pest control compositions exemplified by the following: in combination, a blend of lilac flower oil (LFO), d-limonene, thyme oil, and further including a pesticide. The pesticide can be, for example, clothianidin. The blend can include 10-80% LFO, 5-60% d-limonene, and 10-80% thyme oil. In other embodiments, the blend can include 20-60% LFO, 10-45% d-limonene, and 20-60% thyme oil. In other embodiments, blend can include 42.6% w/w LFO, 27.35% w/w d-limonene, and 30.08% w/w thyme oil white.

### BRIEF DESCRIPTION OF THE DRAWINGS

FIG. 1 shows a screening method using a transfected cell lines expressing a receptor of interest, for example, a biogenic amine receptor, such as, a TyR or an octopamine receptor;

FIG. 2 shows the binding of a ligand to a biogenic amine receptor, resulting in downstream signaling affecting certain physiological responses;

FIG. 3 shows an insect control chemical, deltamethrin (DM), affecting downstream signaling;

FIG. 4A shows a pesticidal effect against Aedes aegypti caused by 1) a test composition; 2) clothianidin; and 3) a combination of a test composition and clothianidin;

FIG. 4B shows a pesticidal effect against Aedes aegypti caused by 1) a test composition; 2) clothianidin; and 3) a combination of a test composition and clothianidin;

FIG. 4C shows a pesticidal effect against Aedes aegypti caused by 1) a test composition; 2) imidacloprid; and 3) a combination of a test composition and imidacloprid;

FIG. 4D shows a pesticidal effect against Drosophila sp. caused by 1) a test composition; 2) imidacloprid; and 3) a combination of a test composition and imidacloprid;

FIG. 5 shows a pesticidal effect against Aedes aegypti caused by 1) a test composition; 2) imidacloprid; and 3) a combination of a test composition and imidacloprid;

FIG. 6A shows a pesticidal effect against Periplaneta americana caused by 1) a test composition; 2) clothianidin; and 3) a combination of a test composition and clothianidin;

FIG. 6B shows a pesticidal effect against Periplaneta americana caused by 1) a test composition; 2) imidacloprid; and 3) a combination of a test composition and imidacloprid;

FIG. 7 shows a pesticidal effect against bed bugs caused by 1) a test composition; 2) pyrethrum; and 3) a combination of a test composition and pyrethrum;

FIG. 8A shows the nucleic acid sequence and the peptide sequence of a Tyramine receptor;

FIG. 8B shows the nucleic acid sequence and the peptide sequence of a Tyramine receptor;

FIG. 9 shows fluorescence intensity curves corresponding to intracellular calcium ion concentrations, with the curve corresponding to the composition containing the mixture of imidacloprid and thyme oil indicated by triangles, the curve corresponding to the composition containing the thyme oil alone indicated by circles, and the curve corresponding to the composition containing imidacloprid alone indicated by squares;

FIG. 10 shows fluorescence intensity curves corresponding to intracellular calcium ion concentrations, with the curve corresponding to the composition containing the mixture of fluoxastrobin and thyme oil indicated by triangles, the curve corresponding to the composition containing the thyme oil alone indicated by squares, and the curve corresponding to the composition containing fluoxastrobin alone indicated by circles.

### DESCRIPTION OF EXEMPLARY EMBODIMENTS

Many previously known and commercialized products having sufficient pesticidal activity to be useful also have toxic or deleterious effects on mammals, fish, fowl, or other non-target species. For example, common insecticides such as organophosphorus compounds and carbamates inhibit the activity of acetylcholinesterase in all classes of animals. Chlordimeform and related formamidines are known to act on insect octopamine receptors, but have been removed from the market because of cardiotoxic potential in vertebrates and carcinogenicity in animals and a varied effect on different insects.

However, the deleterious effects of many pesticides can be mitigated by reducing the amount of pesticide that can be applied to a given area to achieve the desired result. This reduction can be achieved by combining the pesticidal compound or product with selected active ingredients. These active ingredients can comprise, for example, plant essential oils, and the like. Combinations of selected active ingredients with selected pesticidal compounds or products can reduce the concentration of pesticide needed to achieve a net efficiency, and extend the useful life of existing synthetic pesticides.

The details of one or more embodiments of the invention are provided. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom.

Embodiments of the invention are directed to methods of screening compositions for pest-control potential, compositions for controlling pests, and methods for using these compositions.

As used herein, “pests” can mean any organism whose existence it can be desirable to control. Pests can include, for example, bacteria, cestodes, fungi, insects, nematodes, parasites, plants, and the like.

As used herein, “pesticidal” can mean, for example, antibacterial, antifungal, antiparasitic, herbicidal, insecticidal, and the like.

Screening of Compositions

In some embodiments of the invention, the screening method for pest control potential can target a molecule of an insect olfactory receptor protein. In some embodiments of the invention, the screening method for pest control potential can target an insect olfactory receptor protein. The insect olfactory system includes more than 60 identified olfactory receptors. These receptors are generally members of a large family of G protein coupled receptors (GPCRs).

As used herein, a “receptor” is an entity on the cell membrane or within the cell, cytoplasm, or cell nucleus that can bind to a specific molecule (a ligand), such as, for example, a neurotransmitter, hormone, or the like, and initiates the cellular response to the ligand. Ligand-induced changes in the behavior of receptor proteins can result in physiological changes that constitute the biological actions of the ligands.

In accordance with the present disclosure, receptors such as G protein-coupled receptors may be classified on the basis of binding affinity of the receptor to an active ingredient. This may also be expressed as the binding affinity of the active ingredient for the receptor. The binding affiity of an active ingredient for a receptor, or the binding affinity of a receptor for an active ingredient, may be measured in accordance with methods disclosed herein or methods known to those of skill in the art. As used in the present disclosure, a “low” affinity indicates that a high concentration of the active ingredient relative to the receptor is required to maximally occupy the binding site of the receptor and trigger a physiological response, while a “high” affinity indicates that that a low concentration of the active ingredient relative to the receptor is adequate to maximally occupy the binding site of the receptor and trigger a physiological response. A “high” affinity may correspond to, for example, an active ingredient concentration of two or more orders of magnitude less than the concentration of the receptor that is effective to trigger the physiological response, while a “low” affinity may correspond to an active ingredient concentration of one or more orders of magnitude greater than the concentration of the receptor that is effective to trigger the physiological response.

In Drosophila melanogaster, the olfactory receptors are located in two pairs of appendages located on the head of the fly. The family of Drosophila chemoreceptors includes approximately 62 odorant receptor (Or) and 68 gustatory receptor (Gr) proteins, encoded by families of approximately 60 Or and 60 Gr genes through alternative splicing. Some of these receptor proteins have been functionally characterized, while others have been identified by sequence homology to other sequences but have not been fully characterized. Other insects have similar olfactory receptor proteins.

In certain embodiments, the insect olfactory receptor protein targeted by the screening or insect control method of the invention is the tyramine receptor (TyR). In additional embodiments, the insect olfactory receptor protein is the insect olfactory receptor protein Or83b or Or43a. In additional embodiments, the targeted protein can be any of the insect olfactory protein receptors.

Additionally, other components of the insect olfactory receptor cascade can be targeted using the method of the invention in order to identify useful insect control compounds. Exemplary insect olfactory cascade components that can be targeted by methods of the invention include but are not limited to serotonin receptor, Or22a, Or22b, Gr5a, Gr21a, Gr61a, β-arrestin receptor, GRK2 receptor, and tyramine β-hydroxylase receptor, and the like.

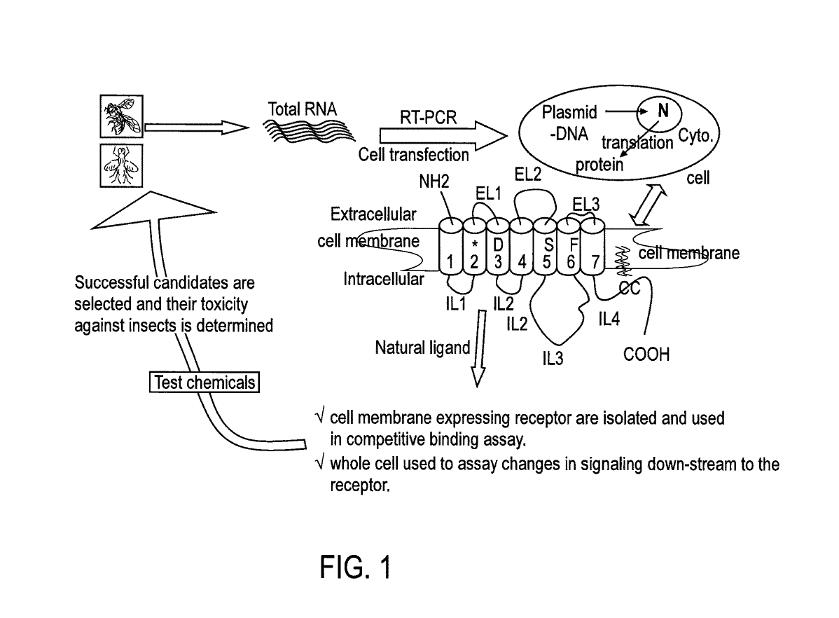

With reference to FIG. 1, an exemplary screening method for identifying effective pestcontrol compositions can make use of one or more transfected cell lines expressing a receptor of interest, for example, a biogenic amine receptor, such as, a TyR or an octopamine receptor.

In some embodiments of the invention, isolated cell membranes expressing the receptor of interest can be used in competitive binding assays. Whole cells can be used to study changes in signaling down-stream to the receptor, in response to treatment with a test composition.

Embodiments of the invention can utilize prokaryotic and eukaryotic cells including, for example, bacterial cells, yeast cells, fungal cells, insect cells, nematode cells, plant cells, animal cells, and the like. Suitable animal cells can include, for example, HEK cells, HeLa cells, COS cells, U20S cells, CHO-K1 cells, various primary mammalian cells, and the like. An animal model expressing one or more conjugates of an arrestin and a marker molecule, for example, throughout its tissues, within a particular organ or tissue type, or the like, can be used.

The potential for insect control activity can be identified by measuring the affinity of the test compositions for the receptor in the cell lines expressing a TyrR, Or83b, and/or Or43a. The potential for insect control activity can also be identified by measuring the change in intracellular cAMP and/or Ca²⁺ in the cell lines expressing TyrR, Or83b, and/or Or43a following treatment with the test compositions. The gene sequences of the TyrR, the Or 83b receptor and the Or 43a receptor have substantial similarity between various insect species. As such, the Drosophila Schneider cell lines expressing these receptors can be used to screen for compositions having insect control activity in various insect species.

In some embodiments, a method of selecting a composition for pesticidal use can include the following. A cell expressing a TyR is provided and is contacted with test compounds. The receptor binding affinity of the compounds is measured. At least one parameter selected from the following parameters is measured: intracellular cAMP level, and intracellular Ca²⁺ level. A first compound for the composition is identified, that is capable of altering at least one of the parameters, and that has a high receptor binding affinity for the TyR; and a second compound for the composition is identified, that is capable of altering at least one of the parameters, and that has a low receptor binding affinity for the TyR. A composition is selected that includes the first and second compounds. In some embodiments, a composition is selected that includes the first and second compounds and demonstrates an anti-parasitic effect that exceeds the anti-parasitic effect of any of the compounds when used alone.

In some embodiments of the invention, the cell used can be any cell capable of being transfected with and express a TyR. Examples of cells include, but are not limited to: insect cells, such as Drosophila Schneider cells, Drosophila Schneider 2 cells (S2 cells), and Spodoptera frugiperda cells (e.g., Sf9 or Sf21); or mammalian cells, such as Human Embryonic Kidney cells (HEK-293 cells), African green monkey kidney fibroblast cells (COS-7 cells), HeLa Cells, and Human Keratinocyte cells (HaCaT cells).

The TyrR can be a full-length TyrR, a functional fragment of a TyrR, or a functional variant of a TyrR. A functional fragment of a TyrR is a TyrR in which amino acid residues are deleted as compared to the reference polypeptide, i.e., full-length TyrR, but where the remaining amino acid sequence retains the binding affinity of the reference polypeptide for tyramine. A functional variant of a TyrR is a TyrR with amino acid insertions, amino acid deletions, or conservative amino acid substitutions, that retains the binding affinity of the reference polypeptide for tyramine. A “conservative amino acid substitution” is a substitution of an amino acid residue with a functionally similar residue. Examples of conservative substitutions can include, for example, the substitution of one non-polar (hydrophobic) residue such as isoleucine, valine, leucine or methionine for another; the substitution of one polar (hydrophilic) residue for another such as between arginine and lysine, between glutamine and asparagine, between glycine and serine; the substitution of one basic residue such as lysine, arginine or histidine for another; the substitution of one acidic residue, such as aspartic acid or glutamic acid for another, and the like. A conservative amino acid substitution can also include replacing a residue with a chemically derivatized residue, provided that the resulting polypeptide retains the binding affinity of the reference polypeptide for tyramine. Examples of TyrRs can include, for example: TyrRs, such as, Drosophila melanogaster TyrR (GENBANK® accession number (GAN) CAA38565), Locusta migratoria TyrR (GAN: Q25321), TyrRs of other invertebrates, TyrRs of nematodes, and the like.

Exemplary screening methods can include “positive” screening, where, for example, compositions that bind a receptor of interest are selected. Exemplary screening methods can include “negative” screening, where, for example, compositions that bind a receptor of interest are rejected. An exemplary method can include: selecting a composition that binds a TyR. Another exemplary method can include: selecting a composition that binds a TyR and does not bind an octopamine receptor.

In some embodiments of the invention, the efficacy of a test composition can be determined by conducting studies with insects. For example, the efficacy of a test composition for repelling an insect can be studied using controlled experiments wherein insects are exposed to the test composition. In some embodiments, the toxicity of a test composition against an insect can be studied using controlled experiments wherein insects are exposed to the test composition.

Methods of screening compositions for insect control activity are set forth in the following applications, each of which is incorporated in its entirety herein by reference: U.S. application Ser. No. 10/832,022, entitled COMPOSITIONS AND METHODS FOR CONTROLLING INSECTS; U.S. application Ser. No. 11/086,615, entitled COMPOSITIONS AND METHODS FOR CONTROLLING INSECTS RELATED TO THE OCTOPAMINE RECEPTOR; U.S. application Ser. No. 11/365,426, entitled COMPOSITIONS AND METHODS FOR CONTROLLING INSECTS INVOLVING THE TYRAMINE RECEPTOR; and U.S. application Ser. No. 11/870,385, entitled COMPOSITIONS AND METHODS FOR CONTROLLING INSECTS.

Compositions for Pest Control

Embodiments of the invention can include a composition for controlling pests. Embodiments of the invention that include a composition for controlling pests can include an pest control chemical or product. Embodiments of the invention that include a composition for controlling pests can include an active agent.

In embodiments of the invention that include an active agent, the active agent can be, for example, an agent that can have a biogocal impact on an insect, such as, for example, a chemical, a compound, or the like. In embodiments of the invention that include an active agent, the active agent can be, for example, one or more plant essential oils, or the like. The plant essential oils, when combined, can have a synergistic effect. Embodiments can also can include a fixed oil, which is typically a non-volatile, non-scented plant oil. Additionally, in some embodiments, these compositions can be made up of generally regarded as safe (GRAS) compounds.

In embodiments of the invention that include at least one pest control chemical, the at least one pest control chemical can be selected from, for example, the pest control chemicals set forth in Table 1, or the like.

TABLE 1
PEST CONTROL CHEMICALS

| Pest Control Chemical | CAS Registry Number |
|---|---|
| ABAMECTIN | 71751-41-2 |
| ACEPHATE | 30560-19-1 |
| ACETAMIPRID | 135410-20-7 |
| ACETOCHLOR | 34256-82-1 |
| ACEQUINOCYL | 57960-19-7 |
| ACIBENZOLAR-S-METHYL | |
| ALACHLOR | 15972-60-8 |
| ALDICARB | 116-06-3 |
| ALDIMORPH | |
| ALLETHRIN | 584-79-2 |
| AMISULBROM | |
| AMITRAZ | 33089-61-1 |
| ANILAZINE | |
| AZACONAZOLE | |
| AZOXYSTROBIN | |
| BIFENTHRIN | 82657-04-3 |
| BENALAXYL | |
| BENDIOCARB | 22781-23-3 |
| BENTHIAVALICARB | |
| BENODANIL | |
| BENOMYL | |
| BIFENTHRIN | 82657-04-3 |
| BINAPACRYL | |
| BIORESMETHRIN | 28434-01-7 |
| BIPHENYL | |
| BITERTANOL | |
| BLASTICIDIN-S | |
| BOSCALID | |
| BROMUCONAZOLE | |
| BUPIRIMATE | |
| CAPTAFOL | |
| CAPTAN | |
| CARBENDAZIM | 1563-66-2 |
| CARBOFURAN | |
| CARBARYL | 63-25-2 |
| CARBENDAZIM | |
| CARBOXIN | |
| CARPROPAMID | |
| CHLORDIMEFORM | 6164-98-3 |
| CHLORFENVINFOS | 470-90-6 |
| CHLORONEB | |
| CHLOROTHALONIL | 1897-45-6 |
| CHLOROXURON | 1982-47-4 |
| CHLORPYRIFOS | 2921-88-2 |
| CHLOZOLINATE | |
| CLOTHIANIDIN | |
| COPPER (DIFFERENT SALTS) | |
| COPPER FUNGICIDES | |
| CYAZOFAMID | |
| CYCLOPROPANECARBOXYLIC ACID, 2,2- | 39515-40-7 |
| DIMETHYL-3-(2-METHYL-1-PROPENYL)-, | |
| CYANO(3-PHENOXYPHENYL)METHYL | |
| ESTER | |
| CYFLUFENAMID | |
| CYFLUTHRIN | 68359-37-5 |
| CYHALOFOP BUTYL | 122008-85-9 |
| CYHALOTHRIN K | 91465-08-6 |
| CYHALOTHRIN (lambda) | |
| CYMOXANIL | |
| CYPERMETHRIN | 52315-07-8 |
| CYPROCONAZOLE | |
| CYPRODINIL | |
| CYROMAZINE | 66215-27-8 |
| D-TRANS-ALLETHRIN | 28057-48-9 |
| DELTAMETHRIN (DECA-) | 52918-63-5 |
| DIAFENTHIURON | 80060-09-0 |
| DIAZINON | 333-41-5 |
| DICHLOFENTHION | 97-17-6 |
| DICHLOFLUANID | |
| DICLOCYMET | |
| DICLOMEZINE | |
| DICLORAN | |
| DIFENOCONAZOLE | |
| DIETHOFENCARB | |
| DIFLUBENZURON | 35367-38-5 |
| DIFLUMETORIM | |
| DIFENOCONAZOLE | |
| DIMETHIRIMOL | |
| DIMETHOATE | 60-51-5 |
| DIMETHOMORPH | |
| DIMOXYSTROBIN | |
| DINICONAZOLE | |
| DINOCAP | |
| DISULFOTON | 298-04-4 |
| DITHIANON | |
| DODEMORPH | |
| DODINE | |
| EDFINPHOS | |
| ENDOSULFAN | 115-29-7 |
| ENESTROBIN | |
| EPOXICONAZOLE | |
| ESFENVALERATE | 66230-04-4 |
| ETHABOXAM | |
| ETHIRIMOL | |
| ETRIDIAZOLE | |
| FAMOXADONE | |
| FENBUCONAZOLE | |
| FENFURAM | |
| FENITROTHION | 122-14-5 |
| FENOXYCARB | 72490-01-8 |
| ENPROPATHRIN | 39515-41-8 |
| FENAMIDONE | |
| FENARIMOL | |
| FENHEXAMID | |
| FENOXANIL | |
| FENPICLONIL | |
| FENPROPIDIN | |
| FENPROPIMORPH. | |
| FENTIN ACETATE | |
| FENTIN CHLORIDE | |
| FENTIN HYDROXIDE | |
| FENVALERATE | 51630-58-1 |
| FERBAM | |
| FERIMZONE | |
| FIPRONIL | 120068-37-3 |
| FLUAZINAM | |
| FLUDIOXONIL | |
| FLUMORPH | |
| FLUSILAZOLE | |
| FLUSULFAMIDE | |
| FLUTRIAFOL | |
| FLUOPICOLIDE | |
| FLUOXASTROBIN | |
| FLUQUINCONAZOLE | |
| FLUTOLANIL | |
| FOSETYL-AL | |
| FOLPET | |
| FTHALIDE | |
| FUBERIDAZOLE | |
| FURAMETPYR | |
| FURALAXYL | |
| GUAZATINE | |
| HEXACONAZOLE | |
| HYDRAMETHYLNON | 67485-29-4 |
| HYMEXAZOLE | |
| IMAZALIL | |
| IMIBENCONAZOLE | |
| IMIDACLOPRID | 105827-78-9 |
| IMINOCTADINE | |
| INDOXACARB | |
| IODOCARB | |
| IPCONAZOLE | |
| IPROBENFOS (IBP) | |
| IPRODINE | |
| ISOPROTHIOLANE | |
| ISOTIANIL | |
| KASUGAMYCIN | |
| KRESOXIM-METHYL | |
| LAMBDA-CYHALOTHRIN | 91465-08-6 |
| LUFENURON | 103055-07-8 |
| MALATHION | 121-75-5 |
| MANCOZEB | |
| MANDIPROPAMID | |
| MANEB | |
| MEPANIPYRIM | |
| MEPRONIL | |
| METALAXYL | |
| METALAXYL-M (=MEFENOXAM) | |
| METCONAZOLE | |
| METHIDATHION | 950-37-8 |
| METHAMIDAPHOS (O,S- | 10265-92-6 |
| Dimethylphosphoramidothiolate) | |
| METHASULFOCARB | |
| METHOMYL | 16752-77-5 |
| METHYL PARATHION | 298-00-0 |
| METIRAM | |
| METOMINOSTROBIN | |
| METRAFENONE | |
| MINERAL OILS, ORGANIC OILS, | |
| POTASSIUM BICARBONATE, MATERIAL OF | |
| BIOLOGICAL ORIGIN | |
| MYCLOBUTANIL | |
| NAFTIFINE | |
| NALED | 300-76-5 |
| NUARIMOL | |
| OCTHILINONE | |
| OFURACE | |
| ORYSASTROBIN | |
| OXADIXYL | |
| OXAMYL | 23135-22-0 |
| OXOLINIC ACID | |
| OXPOCONAZOLE | |
| OXYCARBOXIN | |
| OXYDEMETON METHYL | 301-12-2 |
| OXYTETRACYCLINE | |
| PEFURAZOATE | |
| PENCONAZOLE | |
| PENCYCURON | |
| PENTHIOPYRAD | |
| PERMETHRIN | 52645-53-1 |
| PHENOTHRIN | 26002-80-2 |
| PHOPHOROUS ACID AND SALTS | |
| PHORATE | 52645-53-1 |
| PHOSMET | 298-02-2 |
| PICOXYSTROBIN | |
| PIPERALIN | |
| POLYOXIN | |
| PRALLETHRIN (ETOC) | 23031-36-9 |
| PROBENAZOLE (ALSO ANTIBACTERIAL | |
| AND ANTIFUNGAL ACTIVITY) | |
| PROCHLORAZ | |
| PROCYMIDONE | |
| PROFENOFOS | 41198-08-7 |
| PROPAMOCARB | |
| PROPICONAZOLE | |
| PROPINEB | |
| PROQUINAZID | |
| PROTHIOCARB | |
| PROTHIOCONAZOLE | |
| PYRACLOSTROBIN | |
| PYRAZOPHOS | |
| PYRETHRUM | 8003-34-7 |
| PYRIBUTICARB | |
| PYRIFENOX | |
| PYRIMETHANIL | |
| PYRIBENCARB | |
| PYROQUILON | |
| QUINTOZENE (PCNB) | |
| QUINOXYFEN | |
| RESMETHRIN | 10453-86-8 |
| SILITHIOFAM | |
| SIMECONAZOLE | |
| SPINOSAD | 131929-60-7 |
| SPIROXAMINE | |
| STREPTOMYCIN | |
| SULPHUR | |
| TEBUCONAZOLE | |
| TEBUFENOZIDE | 112410-23-8 |
| TECLOFTHALAM (BACTERICIDE) | |
| TECNAZENE (TCNB) | |
| TEFLUTHRIN | 79538-32-2 |
| TERBINAFINE | |
| TETRACONAZOLE | |
| THIABENDAZOLE | |
| TIADINIL | |
| THIFLUZAMIDE | |
| THIOCYCLAM | 31895-21-3 |
| THIODICARB | 59669-26-0 |
| THIOPHANATE | |
| THIOPHANATE-METHYL | |
| THIAMETHOXAM | 153719-23-4 |
| THIRAM | |
| TOLCLOFOS-METHYL | |
| TOLYFLUANID | |
| TRALOMETHRIN | 66841-25-6 |
| TRIADIMEFON | |
| TRIADIMENOL | |
| TRIAZOXIDE | |
| TRICYCLAZOLE | |
| TRIDEMORPH | |
| TRIFLOXYSTROBIN | |
| TRIFLUMIZOLE | |
| TRIFORINE | |
| TRITICONAZOLE | |
| VALIDAMYCIN | |
| VALIPHENAL | |
| VINCLOZOLIN | |
| N,N-DIETHYL-3-METHYLBENZAMIDE | 134-62-3 |
| (DEET) | |
| ZINEB | |
| ZIRAM | |
| ZOXAMIDE | |

Embodiments of the invention can include compounds such as, for example, abamectin, allethrin, citronella oil, IR3535® (3-[N-butyl-N-acetyl]-aminopropionic acid ethyl ester), methyl nonyl ketone, metofluthrin, neem oil, nepetalactone, oil of lemon eucalyptus, permethrin, picaridin, p-menthane 3, 8 diol, and the like.

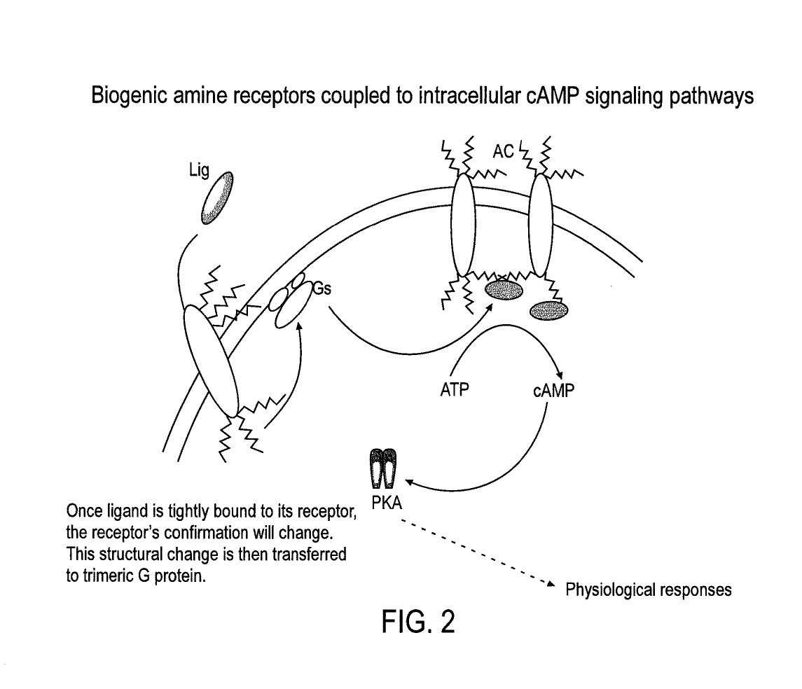

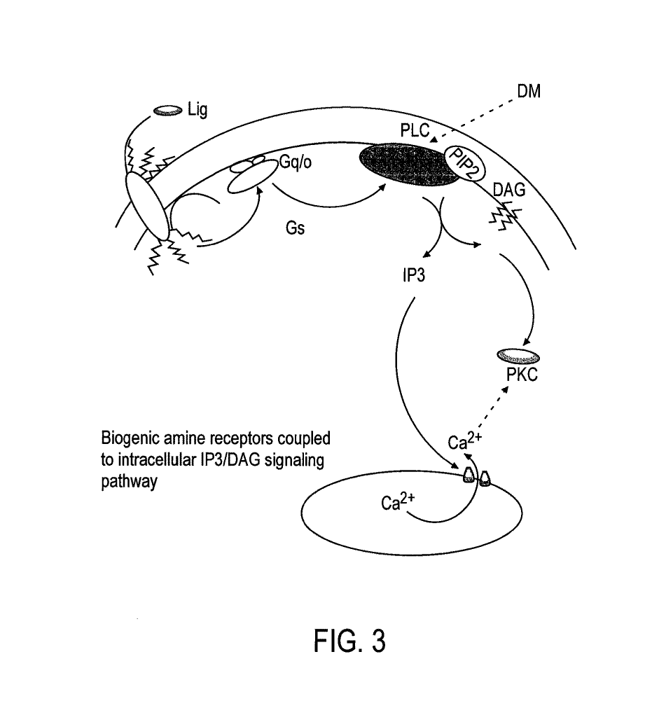

Embodiments of the present invention can include at least one insect control chemical, and at least one compound of a plant origin, or at least one blend of compounds of a plant origin. With reference to FIG. 2, compounds of plant origin, such as plant essential oils, can bind certain biogenic amine receptors, resulting in downstream signaling affecting certain physiological responses. With reference to FIG. 3, insect control chemicals, such as deltamethrin (DM), can also affect downstream signaling. As depicted in FIGS. 2 and 3, the compounds or blends of plant origin and the insect control chemicals activate signaling in different manners.

In embodiments that include an insect control chemical, the insect control chemical can include, for example, any insect control chemical from the classes listed in the following table:

TABLE 2
CLASSIFICATION OF INSECT CONTROL COMPOSITIONS

| | | | Chemical subgroup | |
|---|---|---|---|---|
| | | | or exemplifying active | |
| Group | Subgroup | Primary target site of action | ingredient | Active ingredients |
| 1* | 1A | Acetylcholine esterase | Carbamates | Aldicarb |
| | | inhibitors | | Bendiocarb |
| | | | | Carbaryl |
| | | | | Carbofuran |
| | | | | Methiocarb |
| | | | | Methomyl |
| | | | | Oxamyl |
| | | | | Propoxur |
| | | | | Thiodicarb |
| | 1B | | Organophosphates | Acephate |
| | | | | Azinphos-methyl |
| | | | | Chlorpyrifos |
| | | | | Chlorpyrifos- |
| | | | | methyl |
| | | | | Coumaphos |
| | | | | Diazinon |
| | | | | Dichlorvos |
| | | | | Dicrotophos |
| | | | | Dimethoate |
| | | | | Disulfoton |
| | | | | Ethoprop |
| | | | | Fenamiphos |
| | | | | Fenthion |
| | | | | Isofenphos |
| | | | | Malathion |
| | | | | Methamidophos |
| | | | | Methidathion |
| | | | | Methyl parathion |
| | | | | Naled |
| | | | | Oxydemeton- |
| | | | | methyl |
| | | | | Phorate |
| | | | | Profenofos |
| | | | | Propetamphos |
| | | | | Temephos |
| | | | | Terbufos |
| | | | | Tetrachlorvinphos |
| | | | | Trichlorfon |
| 2* | 2A | GABA-gated chloride | Cyclodiene | Endosulfan |
| | | channel antagonists | organochlorines | Lindane |
| | 2B | | Fipronil | Fipronil |
| | | | (phenylpyrazoles) | |
| 3 | | Sodium channel modulators | Pyrethroids | Allethrin |
| | | | | d-cis-trans Allethrin |
| | | | | d-trans Allethrin |
| | | | | Bifenthrin |
| | | | | Bioallethrin S- |
| | | | | cyclopentenyl |
| | | | | Cyfluthrin |
| | | | | Beta-Cyfluthrin |
| | | | | Cypermethrin |
| | | | | zeta-Cypermethrin |
| | | | | Cyphenothrin |
| | | | | [(1R)-trans- |
| | | | | isomers] |
| | | | | Deltamethrin |
| | | | | Esfenvalerate |
| | | | | Fenpropathrin |
| | | | | Fenvalerate |
| | | | | Imiprothrin |
| | | | | Permethrin |
| | | | | Phenothrin [(1R)- |
| | | | | trans-isomer] |
| | | | | Prallethrin |
| | | | | Resmethrin |
| | | | | Tefluthrin |
| | | | | Tetramethrin |
| | | | | Tralomethrin |
| | | | Pyrethrins | Pyrethrins |
| | | | | (pyrethrum) |
| | | | Methoxychlor | Methoxychlor |
| 4* | 4A | Nicotinic acetylcholine | Neonicotinoids | Acetamiprid |
| | | receptor agonists/antagonists | | Imidacloprid |
| | | | | Thiamethoxam |
| | 4B | | Nicotine | Nicotine |
| 6 | | Chloride channel activators | Avermectins, | Abamectin |
| | | | Milbemycins | |
| 7* | 7A | Juvenile hormone mimics | Juvenile hormone | Hydroprene |
| | | | analogues | Kinoprene |
| | | | | Methoprene |
| | 7B | | Fenoxycarb | Fenoxycarb |
| 8* | 8A | Compounds of unknown or | Methyl bromide | Methyl bromide |
| | | non-specific mode of action | | and other alkyl |
| | | (fumigants) | | halides |
| | 8B | | Chloropicrin | Chloropicrin |
| | 8C | | Sulfuryl fluoride | Sulfuryl fluoride |
| 9* | 9A | Compounds of unknown or | Cryolite | Cryolite |
| | | non-specific mode of action | | |
| | | (selective feeding blockers) | | |
| 10* | 10A | Compounds of unknown or | Clofentezine | Clofentezine |
| | | non-specific mode of action | Hexythiazox | Hexythiazox |
| | 10B | (mite growth inhibitors) | Etoxazole | Etoxazole |
| 11* | 11A1 | Microbial disruptors of insect | B.t. var. israelensis | B.t. var. israelinsis |
| | 11B1 | midgut membranes (includes | B.t. var. aizawai | B.t. var. aizawai |
| | 11B2 | transgenic crops expressing | B.t. var. kurstaki | B.t. var. kurstaki |
| | | B.t. toxins) | | |
| 12* | 12B | Inhibitors of oxidative | Organotin miticides | Fentutatin oxide |
| | | phosphorylation, disruptors of | | |
| | | ATP formation (inhibitors of | | |
| | 12C | ATP synthase) | Propargite | Propargite |
| 15 | | Inhibitors of chitin | Benzoylureas | Diflubenzuron |
| | | biosynthesis, type 0, | | Hexaflumuron |
| | | Leptdopteran | | Novaluron |
| 17 | | Moulting disruptor, Dipteran | Cyromazine | Cyromazine |
| 18* | 18A | Ecdysone agonists/moulting | Diacylhydrazines | Halofenozide |
| | | disruptors | | Methoxyfenozide |
| | | | | Tebufenozide |
| | 18B | | Azadirachtin | Azadirachtin |
| 19 | | Octopaminergic agonists | Amitraz | Amitraz |
| 20* | 20A | Mitochondrial complex III | Hydramethylnon | Hydramethylnon |
| | | electron transport inhibitors | | |
| | | (Coupling site II) | | |
| 21 | | Mitochondrial complex I | METI acaricides, | Rotenone |
| | | electron transport inhibitors | Rotenone | |
| 22 | | Voltage-dependent sodium | Indoxacarb | Indoxacarb |
| | | channel blockers | | |
| 24* | 24A | Mitochondrial complex IV | Aluminum phosphide | Aluminum |
| | | electron transport inhibitors | | phosphide |
| | 24C | | Phosphine | Phosphine |
| 25 | | Neuronal inhibitors (unknown | Bifenazate | Bifenazate |
| | | mode of action) | | |
| 27* | 27A | Synergists | P450 monooxygenase | Piperonyl butoxide |
| | | | inhibitors | |
| UN | UNC | Compounds with unknown | Dicofol | Dicofol |
| | UND | mode of action** | Pyridalyl | Pyridalyl |
| NS | NSA | Miscellaneous non-specific | Borax | Borax |
| | | (multi-site) inhibitors^{†} | | |

In some embodiments of the invention, the insect control chemical can include at least one of, for example, an organophosphate compound, a carbamate compound, a carbazate compound, a neonicotinoid compound, an organochlorine compound, an organotin compound, an oxadiazine compound, a pyridazinone compound, a pyrethroid, a tetrazine compound, or the like.

In embodiments of the invention that include at least one organophosphate compound, the organophosphate compound can be, for example, azinphos-methyl, chlorpyrifos, diazinon, dimethoate, methidathion, phosmet, or the like.

In embodiments of the invention that include at least one carbamate compound, the carbamate compound can be, for example, methomyl, oxamyl, carbaryl, formetanate, hexythiazox, or the like.

In embodiments of the invention that include at least one carbazate compound, the carbazate compound can be, for example, bifenazate, or the like.

In embodiments of the invention that include at least one neonicotinoid compound, the neonicotinoid compound can be acetamiprid, imidacloprid, thiacloprid, thiomethoxam, or the like.

In embodiments of the invention that include at least one organochlorine compound, the organochlorine compound can be, for example, endosulfan, dicofil, or the like.

In embodiments of the invention that include at least one organotin compound, the organotin compound can be, for example, hexakis, or the like.

In embodiments of the invention that include at least one oxadiazine compound, the oxadiazine compound can be, for example, indoxacarb, or the like.

In embodiments of the invention that include at least one pyridazinone compound, the pyridazinone compound can be, for example, pyridaben, or the like.

In embodiments of the invention that include at least one pyrethroid, the pyrethroid can be, for example, esfenvalerate, fenpropathrin, permethrin, or the like.

In embodiments of the invention that include at least one tetrazine compound, the tetrazine compound can be, for example, clofentezine, or the like.

Embodiments of the invention can include at least one insect control product; and at least one compound of a plant origin, or at least one blend of compounds of a plant origin. The at least one insect control product can be selected from, for example, the insect control products set forth in Table 4, or the like.

TABLE 3
INSECT CONTROL PRODUCTS

| Brand Name | Generic name | Classification |
|---|---|---|
| ARCHER 50 WP | NICLOSAMIDE | |
| 2,4-D AMINE 6 | 2,4-D AMINE | CHLOROPHENOXY COMPOUND |
| LBS/USG | | |
| 2,4-D AMINE 3.34 | 2,4-D AMINE | CHLOROPHENOXY COMPOUND |
| LBS/USG | | |
| 2,4-D AMINE EC | 2,4-D AMINE | CHLOROPHENOXY COMPOUND |
| 2,4-D ESTER | 2,4-D IBE | CHLOROPHENOXY COMPOUND |
| 2,4-D ESTER | 2,4-D IBE | CHLOROPHENOXY COMPOUND |
| 2,4-D ESTER | 2,4-D IBE | CHLOROPHENOXY COMPOUND |
| 2,4-D ESTER | 2,4-D IBE | CHLOROPHENOXY COMPOUND |
| 2,4-D ESTER | 2,4-D IBE | CHLOROPHENOXY COMPOUND |
| 2,4-D GRANULES | 2,4-D IBE | CHLOROPHENOXY COMPOUND |
| 2,4-D GRANULES | 2,4-D IBE | CHLOROPHENOXY COMPOUND |
| 5 Star GENERAL | ISOPROTHIOLANE | |
| ABATE 500 E | TEBUFENOZIDE | |
| ABATE SG | TEMEPHOS | |
| Access 2,4-d ESTER | 2,4-D IBE | CHLOROPHENOXY COMPOUND |
| ACETAM 75 SP | ACEPHATE | ORGANOPHOSPHATE |
| ACROBAT 50 WP | DIMETHOMORPH | |
| ACROBAT MZ | DIMETHOMORPH + | |
| | MANCOZEB | |
| ACTARA 25 WG | THIABENDAZOLE + 0- | |
| | PHENOL | |
| ACTELLIC 25 EC | PIPEROPHOS + 2,4-D | |
| | IBE | |
| ACTIVO 22 SC | ANILOFOS + ETHOYSULFRON | |
| ADER 5 EC | CYPERMETHRIN | PYRETHROID |
| ADMIRE 5 WP | IMAZAQUIN | |
| ADVANCE EC | BUTACHLOR + | MISCELLANEOUS |
| | PROPANIL | |
| ADVANTAGE 5 G | CARBOFURAN | CARBAMATE |
| ADVANTAGE 5 G | CARBOFURAN | CARBAMATE |
| AFALON 50 WP | LINDANE | |
| AGRI MEK 1.8 EC | AVERMECTIN | CHLORIDE CHANNEL ACTIVATOR |
| AGRICOTE MZ 80 WP | MANCOZEB | DITHIOCARBAMATE |
| AGRISOL A-150 K | POLYOXYETHYLENE | |
| | DODECYL ETHER | |
| AGRISOL A-150K | POLYOXYETHYLENE | |
| | SORBITAN FATTY | |
| | ACIDS | |
| AGRO | CYPERMETHRIN | PYRETHROID |
| CYPERMETHRIN 5 EC | | |
| AGROPOINT CARTAP | CARTAP | |
| 50 SP | HYDROCHLORIDE | |
| AGROZEB 80 WP | MANCOZEB | DITHIOCARBAMATE |
| AL-100 TS | SETHOXYDIM | |
| ALAKDAN 300 | BPMC + CHLOPYRIFOS | |
| ALIETTE 80 WP | FOSETHYL-AL | |
| ALIETTE 800 WG | FOSETHYL-AL | |
| ALMIX 20 WP | METRIBUZIN | |
| AMBUSH 5 EC | CYPERMETHRIN | PYRETHROID |
| AMDRO ANT BAIT | HEXYTHIAZOX | |
| AMETREX 80 WP | AMETRYNE | MISCELLANEOUS |
| AMETREX 80 WP | AMETRYNE | MISCELLANEOUS |
| AMETRYNE 80 WP | AMETRYNE | MISCELLANEOUS |
| AMISTAR 25 SC | AZOXYSTROBIN | |
| AMMO 5 EC | CYPERMETHRIN | PYRETHROID |
| AMWAY APSA 80 | ALKYL ARYL | |
| | ALKOXYLATE + TALL | |
| | OIL FATTY AC | |
| ANCOM BUTACHLOR | BUTACHLOR | MISCELLANEOUS |
| 60 EC | | |
| ANCOM | CYPERMETHRIN | PYRETHROID |
| CYPERMETHRIN 5 EC | | |
| ANTRACOL 70 WG | PROPICONAZOLE | |
| ANTRACOL 70 WP | PROPINEB | |
| ANVIL 5 SC | HALOXYFOP-R- | |
| | METHYL ESTER | |
| APACHE 10 G | CADUSAFOS | |
| APACHE 100 ME | CADUSAFOS | |
| APACHE 100 ME | CADUSAFOS | |
| APPLAUD 10 WP | BUPROFESIN | |
| APRON 35 SD | MCPA | |
| AQUADIN 25 EC | NICLOSAMIDE | |
| AQUADIN 70 WP | NICLOSAMIDE | |
| ARGOLD 10 EC | CINMETHYLIN | |
| ARGOLD PLUS | CYNMETHYLIN + 2,4-DIBE | PYRETHROID |
| ARIES SUPER | CYPERMETHRIN | PYRETHROID |
| METHRIN 5 EC | | |
| ARMOR | THIOPHANATE | |
| | METHYL | |
| ARMURE 300 EC | DIFECONAZOLE + | |
| | PROPICONAZOLE | |
| ARNIS 2.5 EC | LAMBDACYHALOTHRIN | PYRETHROID |
| ARRIVO 5 EC | CYPERMETHRIN | PYRETHROID |
| ARROW 5 EC | CYPERMETHRIN | PYRETHROID |
| ASCEND 50 SC | FIPRONIL | |
| ASSET 48 SL | GLYPHOSATE | |
| | MONOETHALONAMINE | |
| | SALT | |
| ASSURE II EC | PYRIMETHANIL | |
| ATABRON 5 E | CHLORFLUAZURON | |
| ATRAMET COMBI 80 | AMETRYNE + | MISCELLANEOUS |
| WP | ATRAZINE | |
| ATRAZINE 80 WP | ATRAZINE | MISCELLANEOUS |
| ATTACK 5R | CYPERMETHRIN | PYRETHROID |
| ATTAIN M-80 | MALATHION | ORGANOPHOSPHATE |
| AVANTEC EC | BUTACHLOR + | MISCELLANEOUS |
| | PROPANIL | |
| AVID | AVERMECTIN | CHLORIDE CHANNEL ACTIVATOR |
| AX 5 EC | CYPERMETHRIN | PYRETHROID |
| BALEAR 500 SC | CHLOROTHALONIL | CHLORONITRILE |
| BANKIT | AZOXYSTROBIN | |
| BANKO 720 SC | CHLOROTHALONIL | MISCELLANEOUS |
| BANKO 720 SC | CHLOROTHALONIL | MISCELLANEOUS |
| BANKO 75 WP | CHLOROTHALONIL | MISCELLANEOUS |
| BANNER 60 EC | BUTACHLOR | MISCELLANEOUS |
| BANOLE OIL | PARAFFIN OIL | |
| BANOLE OIL 60 | PARAFFINIC MINERAL | |
| | OIL | |
| BASAGRAN 48 EC | BENTAZONE | |
| BASAMID G | DAZOMET | PYRETHROID |
| BASTA 15 SL | GIBBERRELIC ACID | |
| BASUDIN 40 WP | DIAZINON | ORGANOPHOSPHATE |
| BASUDIN 400 EC | DIAZINON | ORGANOPHOSPHATE |
| BASUDIN 600 EC | DIAZINON | ORGANOPHOSPHATE |
| BAVISTIN 50 DF | CARBARYL | CARBAMATE |
| BAYCOR 300 EC | BITERTANOL | |
| BAYLETON 25 WP | THIOPHANATE | |
| | METHYL | |
| BAYLUSCIDE 250 EC | NICLOSAMIDE | |
| BAYLUSCIDE 50 WP | NICLOSAMIDE | |
| | ETHANOLAMINE SALT | |
| BAYLUSCIDE 70 WP | NICLOSAMIDE | |
| | ETHANOLAMINE SALT | |
| BAYONET 6% | METALDEHYDE | |
| PELLETS | | |
| BAYTHROID 0125 EC | CYFLUTHRIN | Pyrethroid |
| BAYTHROID 050 EC | CYFLUTHRIN | Pyrethroid |
| BAZZOKA | CHLORPYFIROS + | Organophosphate + Carbamate |
| | BPMC | |
| BELEREX TABLET | GIBBERRELIC ACID | |
| BELORAN 400 SL | BENZOXONIUM | |
| | CHLORIDE | |
| BENLATE 50 WP/OD | BENOMYL | |
| BENSUL 10 WP | BENSULFURON | |
| | METHYL | |
| BERDUGO 50 WP | NICLOSAMIDE | |
| | ETHANOLAMINE SALT | |
| BERELEX TABLET | GENERIC NAME | |
| BIDA 2.5 EC | LAMBACYHALOTHRIN | PYRETHROID |
| BIFLEX 10 TC | BIFENTHRIN | |
| BIFLEX 10 TC | BIFENTHRIN | |
| BIFLEX 2.5 TC | BIFENTHRIN | |
| BIFLEX TC | BIFENTHRIN | |
| BIOACT WG | PACLOBUTRAZOL | |
| BIODAN 3 G | CARBUFORAN | CARBAMATE |
| BIOZEB | MANCOZEB | DITHIOCARBAMATE |
| BIOZEB 80 WP | MANCOZEB | DITHIOCARBAMATE |
| BLADE 60 EC | BUTACHLOR | MISCELLANEOUS |
| BLINK 275 EC | CHLORPYFIROS + | ORGANOPHOSPHATE |
| | CYPERMETHRIN | |
| BLOCKADE 480 SL | BENTAZONE | |
| BLUE COP 770 WP | COPPER HYDROXIDE | MISCELLANEOUS |
| BOLT 50 SP | CARTAP | CARBAMATE |
| BOOST 500 SC | ACIBENZOLAR-S- | |
| | METHYL | |
| BOXER 5 EC | CYPERMETHRIN | PYRETHROID |
| BRAVO 720 FLO | CHLOROTHALONIL | MISCELLANEOUS |
| BREAK-THRU | POLYCARBOXYLIC | |
| | ACID | |
| BRODAN 31.5 EC | CHLORPYFIROS + | Organophosphate + Carbamate |
| | BPMC | |
| BROMO GAS | METHOMYL | |
| BRONCHO | GLYPHOSATE | |
| | AMMONIUM SALT | |
| BUGBUSTER 5 EC | CYPERMETHRIN | PYRETHROID |
| BULLDOZER 50 WP | NICLOSAMIDE | |
| BULLET 5 EC | CYPERMETHRIN | PYRETHROID |
| BULL'S EYE | CYPERMETHRIN | PYRETHROID |
| INSECTICIDE | | |
| BUMPER 25 EC | PROPICONAZOLE | |
| BURNDOWN 160 AS | GLYPHOSATE DI- | |
| | AMMONIUM SALT | |
| BURNDOWN 160 AS | GLYPHOSATE IPA | |
| BUSHWHACK 5 EC | CYPERMETHRIN | PYRETHROID |
| BUTACHLOR 600 EC | BUTACHLOR | MISCELLANEOUS |
| BUTATAF 60 E | BUTACHLOR | MISCELLANEOUS |
| CALIBER 70 WP | NICLOSAMIDE | |
| CALIBER 70 WP | NICLOSAMIDE | |
| CALIXIN 75 EC | TRICLOPYR | |
| CAPTAN 50 WP | CAPTAN | MISCELLANEOUS |
| CAPTAN 50 WP | CAPTAN | MISCELLANEOUS |
| CAPTURE 5 EC | CYPERMETHRIN | PYRETHROID |
| CARANCHO 2.5 EC | ETHOFENPROX | |
| CARBARYL 85 S | CARBARYL | CARBAMATE |
| CARVIL 50 EC | BPMC | CARBAMATE |
| CASCADE 10 WDC | FLUFENOXURON | |
| CELCURE A(P) WOOD | COPPER, CHROME, ARSENIC | |
| PRESERVE | (CCA) | |
| CHAKU 2.5 EC | LAMBDACYHALOTHRIN | |
| CHAMP DP | COPPER HYDROXIDE | COPPER |
| CHAMPION WP | CUPRIC HYDROXIDE | COPPER |
| CHESS 25 WP | PROPINEB | |
| CHESS 50 WG | PYMETROZINE | |
| CHIX 2.5 EC | BETACYPERMETHRIN | PYRETHROID |
| CHLORMITE TC | CHLOROPYFIROS | ORGANOPHOSPHATE |
| CHOPPER 85 S | CARBARYL | CARBAMATE |
| CITRUS LUSTER 213 | THIABENDAZOLE | |
| CIVIL 75 WP | CHLOROTHALONIL | MISCELLANEOUS |
| CLEANFIELD EC | BUTACHLOR + PROPANIL | MISCELLANEOUS |
| CLEAR OUT 41 | GLYPHOSPATE IPA | |
| CLEAR OUT 41 PLUS | GLYPHOSPHATE IPA | |
| CLINCHER.100 EC | CYHALOFOP BUTYL | |
| COBRA 20 EC | CHLORPYFIROS | ORGANOPHOSPHATE |
| COMBAT 5 EC | CYPERMETHRIN | PYRETHROID |
| COMMAND 3 ME | CLOMAZONE | |
| COMMAND 3 ME | CLOMAZONE | |
| COMMAND PLUS 600 | CLOMAZONE + | |
| EC | PROPANIL | |
| COMPETE 75 SP | ACEPHATE | ORGANOPHOSPHATE |
| COMPRO 600 EC | CLOMAZONE + PROPANIL | |
| CONFIDOR 100 SL | IMIDACLOPRID | |
| CONFIDOR 200 SL | IMIDACLOPRID | |
| CONTRAZINE 80 WP | ATRAZINE | MISCELLANEOUS |
| CONTRAZINE 80 WP | ATRAZINE | MISCELLANEOUS |
| CONTROL 250 EC | NICLOSAMIDE | |
| CONTROL 70 WP | NICLOSAMIDE | |
| | ETHANOLAMINE SALT | |
| CORSAIR 5 EC | PENDIMETHLIN | PYRETHROID |
| CORSAIR 5 EC | PERMETHRIN | PYRETHROID |
| COSAVET DF | SULFUR | |
| COTRIN 5 EC | CYPERMETHRIN | PYRETHROID |
| COTRIN 5 EC | CYPERMETHRIN | PYRETHROID |
| COUNTER 10 G | TEMEPHOS | |
| COZEB 80 WP | MANCOZEB | DITHIOCARBAMATE |
| CRUSHER 250 EC | NICLOSAMIDE | |
| CRUSHER 50 WP | NICLOSAMIDE | |
| | ETHANOLAMINE SALT | |
| CRUSHER 70 WP | NICLOSAMIDE | |
| CULTAR 25 SC | OXYFLUORFEN | |
| CUPRAVIT OB 21 | COPPER | COPPER |
| | OXYCHLORIDE | |
| CURZATE M | MANCOZEB | DITHIOCARBAMATE |
| FUNGICIDE | | |
| CYBEST 5 EC | CYPERMETHRIN | PYRETHROID |
| CYCLONE 5 EC | CYPERMETHRIN | PYRETHROID |
| CYMBUSH 5 EC | CYPERMETHRIN | PYRETHROID |
| CYPER-5 | CYPERMETHRIN | PYRETHROID |
| CYPERMETHRIN 5 EC | CYPERMETHRIN | PYRETHROID |
| CYPERTHRIN 5 EC | CYPERMETHRIN | PYRETHROID |
| CYPEX 50 EC | CYPERMETHRIN | PYRETHROID |
| CYPRO 5 EC | CYPERMETHRIN | PYRETHROID |
| CYREN 300 EC | CHLORPYFIROS | ORGANOPHOSPHATE |
| DACINOL 2787 50 WP | CHLOROTHALONIL | MISCELLANEOUS |
| DACINOL 2787 75 WP | CHLOROTHALONIL | MISCELLANEOUS |
| DACONIL 720 SC | CHLOROTHALONIL | MISCELLANEOUS |
| DEADBOL | NICLOSAMIDE | |
| DECIDE 2.5 EC | DELTAMETHRIN | PYRETHROID |
| DECIS 1% SC | DELTAMETHRIN | PYRETHROID |
| DECIS 2.5 EC | DELTAMETHRIN | PYRETHROID |
| DECIS M 2.5 EC | DELTAMETHRIN | PYRETHROID |
| DECIS R | DELTAMETHRIN | PYRETHROID |
| DECIS TAB | DELTAMETHRIN | PYRETHROID |
| DEFENSA 5 EC | CYPERMETHRIN | PYRETHROID |
| DEGESCH MAGTOXIN | LUFENURON | |
| DEGESCH | MAGNESSIUM | |
| PLATES/STRIPS | PHOSPHIDE | |
| DEGESH PHOSTOXIN | ALUMINUM | RODENTICIDE |
| | PHOSPHIDE | |
| DELMARK 2.5 EC | DELTAMETHRIN | PYRETHROID |
| DETIA GAS EX-B | ALUMINUM | RODENTICIDE |
| | PHOSPHIDE | |
| DETIA GAS EX-T | ALUMINUM | RODENTICIDE |
| | PHOSPHIDE | |
| DETIA PHOSPHINE | ALUMINUM | RODENTICIDE |
| PELLETS | PHOSPHIDE | |
| DIACARB 50 EC | BPMC | CARBAMATE |
| DIAFURAN 10 G | CARBOFURAN | CARBAMATE |
| DIAFURAN 3 G | CARBOFURAN | CARBAMATE |
| DIAFURAN 5 G | CARBOFURAN | CARBAMATE |
| DIAGRAN 5 G | DIAZINON | ORGANOPHOSPHATE |
| DIAGRAN 5 G | DIAZINON | ORGANOPHOSPHATE |
| DIAZINON 40 EC | DIAZINON | ORGANOPHOSPHATE |
| DIAZINON 60 EC | DIAZINON | ORGANOPHOSPHATE |
| DIAZINON 60 EC | DIAZINON | ORGANOPHOSPHATE |
| DIAZINON 60 EC | DIAZINON | ORGANOPHOSPHATE |
| DIAZINON 600 EC | DIAZINON | ORGANOPHOSPHATE |
| DIAZOL 40 EC | DIAZINON | ORGANOPHOSPHATE |
| DIAZOL 40 EC | DIAZINON | ORGANOPHOSPHATE |
| DIAZOL 60 EC | DIAZINON | ORGANOPHOSPHATE |
| DIAZOL 60 EC | DIAZINON | ORGANOPHOSPHATE |
| DICARE 37.5 WG | DIAFENTHIURON + | ORGANOPHOSPHATE |
| | FENOXYCAB | |
| DICARZOL 20 SP | FORMETHANATE HCL | |
| DIMO 50 SP | CARTAP | |
| | HYDROCHLORIDE | |
| DIPEL WP | BACILLUS | PLANT ORIGIN |
| | THURINGIENSIS | |
| DIPTEREX 95 SP | TRIBUTYLPOLYGLYCO | |
| | ETHER | |
| DIREK 800 | BUTACHLOR + | |
| | SAFENER | |
| DITHANE F-448 | MANCOZEB | DITHIOCARBAMATE |
| DITHANE F-448 | MANCOZEB | DITHIOCARBAMATE |
| DITHANE M-45 | MANCOZEB | DITHIOCARBAMATE |
| DITHANE M-45 | MANCOZEB | DITHIOCARBAMATE |
| DITHANE M-45 WP | MANCOZEB | DITHIOCARBAMATE |
| DITHANE OS 600 | MANCOZEB | DITHIOCARBAMATE |
| DITHANE OS-600 | MANCOZEB | DITHIOCARBAMATE |
| DIUREX 80 WP | DIURON | UREA |
| DIUREX 80 WP | DIURON | UREA |
| DIURON 80 WP | DIURON | UREA |
| DIURON 80 WP | DIURON | UREA |
| DIURON 80 WP | DIURON | UREA |
| DMA 3.34 LBS/USG | 2,4-D AMINE | CHLOROPHENOXY COMPOUND |
| DRAGO 60 WP | FLUFENACET | |
| DREXEL DIURON 80 | DIURON | UREA |
| DF | | |
| DREXEL MALATHION | MALATHION | ORGANOPHOSPHATE |
| 57 EC | | |
| DREXEL SULFA 80 W | SULFUR | |
| DURSBAN | CHLORPYRIFOS | ORGANOPHOSPHATE |
| DYNAMEC | AVERMECTIN | CHLORIDE CHANNEL ACTIVATOR |
| EASY 5 EC | CYPERMETHRIN | PYRETHROID |
| ELTRA 200 SC | CARBOFURAN | CARBAMATE |
| EQUATION PRO 52.5 | CYMOXANIL + | |
| DF | FAMOXADONE | |
| ERASER 70 EC | BUTACHLOR + | MISCELLANEOUS |
| | PROPANIL | |
| ETHREL 10 SL | ETHEPHON | |
| ETHREL PGR 48% | ETHEPHON | |
| ETROFOLAN 50 WP | ISAZOFOS | |
| EXPERT 20 EC | CHLORPYFIROS | ORGANOPHOSPHATE |
| EXTREME 50 SP | CARTAP | |
| | HYDROCHLORIDE | |
| FASTAC 15 WDG | ALPHACYPERMETHRIN | PYRETHROID |
| FASTAC 250 SC | ALPHACYPERMETHRIN | PYRETHROID |
| FASTAC R | ALPHACYPERMETHRIN + | PYRETHROID + CARBAMATE |
| | BPMC | |
| FENOM D 225 EC | DIAZINON + | Organophosphate + Pyrethroid |
| | CYPERMETHRIN | |
| FLASH 5 EC | CYPERMETHRIN | PYRETHROID |
| FLIP 500 WP | NICLOSAMIDE | |
| FLIP 700 WP | NICLOSAMIDE | |
| | ETHANOLAMINE SALT | |
| FOLICUR 250 EC | SULPHUR | |
| FOLICUR 430 SC | TEBUCONAZOLE | |
| FORWARD 700 EC | BUTACHLOR + | MISCELLANEOUS |
| | PROPANIL | |
| FROWNCIDE 50 SC | FLUAZINAM | |
| FRUITONE CPA | CHLOROPHENOXY | |
| | PROPIONIC ACID | |
| FUJI-ONE 40 EC | ISOPROCARB | |
| FUMITOXIN | ALUMINUM | RODENTICIDE |
| | PHOSPHIDE | |
| FUNGAFLOR 50 L | HYDRAMETHYLNON | |
| FUNGAFLOR 75 SP | IMAZALIL | |
| FUNGITOX 70 WP | THIOPHANATE | |
| | METHYL | |
| FUNGURAN-OH | COPPER HYDROXIDE | MISCELLANEOUS |
| FURADAN 10G | CARBARYL | CARBAMATE |
| FURADAN 3 G | CARBENDAZIM | CARBAMATE |
| FURADAN 3G | CARBOFURAN | CARBAMATE |
| FURADAN 5 G | CARBARYL | CARBAMATE |
| FURADAN 5 G | CARBOFURAN | CARBAMATE |
| FURUDAN 10 G | CARBOSULFAN | CARBAMATE |
| FURUDAN 3 G | CARBOSULFAN | CARBAMATE |
| FURUDAN 5 G | CARBUFORAN | CARBAMATE |
| GALLANT SUPER | HALOSULFURON | |
| | METHYL | |
| GARLON 4 | TRICHLOROFON | |
| GAROTE EC | CHLORPYRIFOS + BPMC | Organophosphate + Carbamate |
| GAS 250 EC | NICLOSAMIDE | |
| GAUCHO 70 WS | IMIDACLOPRID | |
| GEM 2,4-D AMINE | 2,4-D AMINE | CHLOROPHENOXY COMPOUND |
| GEM 2,4-D ESTER | 2,4-D IBE | CHLOROPHENOXY COMPOUND |
| GEM ATRAZINE | ATRAZINE | MISCELLANEOUS |
| GEM MALATHION 57 | MALATHION | ORGANOPHOSPHATE |
| EC | | |
| GEMTRAK 50 SP | CARTAP | |
| | HYDROCHLORIDE | |
| GESAPAX 500 FW | AMETRYNE | MISCELLANEOUS |
| GESAPAX 80 WP | AMETRYNE | MISCELLANEOUS |
| GESAPAX COMBI 80 | AMETRYNE + | MISCELLANEOUS |
| WP | ATRAZINE | |
| GESAPRIM 80 WP | ATRAZINE | MISCELLANEOUS |
| GLADIATOR 75 WDG | CHLORPYRIFOS | ORGANOPHOSPHATE |
| GLYPHOMAX | GLYPHOSATE IPA | |
| GOAL 24 EC | OXADIAZON | |
| GOAL 24 EC | OXYFLOURFEN | |
| GRAMOXONE 20 AS | PARAFINIC MINERAL | |
| | OIL | |
| GRASSEDGE | THIOBENCARB | |
| GRASSEDGE 800 EC | THIOBENCARB + 2,4-D | |
| GUARDIAN 5 EC | CYPERMETHRIN | PYRETHROID |
| HALT | BACILLUS | PLANT ORIGIN |
| | THURINGIENSIS | |
| HEDONAL LIQ. SL | 2,4-D AMINE | CHLOROPHENOXY COMPOUND |
| 4OO | | |
| HERBADOX 33 EC | PENDIMETHALIN | |
| HERBIMAX | PIRIMIPHOS METHYL | |
| HERCULES 20 EC | TRIADIMEFON | |
| HI-CONFIL F 75 WP | CHLOROTHALONIL | MISCELLANEOUS |
| HIDROCOB 77 WP | COPPER HYDROXIDE | MISCELLANEOUS |
| HINOSAN 300 EC | EDIFENPHOS | Organophosphate |
| HINOSAN 50 EC | EDIFENPHOS | Organophosphate |
| HI-PER 5 EC | CYPERMETHRIN | PYRETHROID |
| HIT 250 EC | NICLOSAMIDE | |
| HIT WP | NICLOSAMIDE | |
| HOESTICK | TRIAZOPHOS | |
| HOPCIDE 50 EC | BPMC | CARBAMATE |
| HOPCIN 50 EC | BPMC | CARBAMATE |
| HOPKILL 50 EC | BPMC | CARBAMATE |
| HOSTATHION 20 EC | TRIAZOPHOS | |
| HYDROX 77 WP | COPPER HYDROXIDE | COPPER |
| HYDROXIDE SUPER | COPER HYDROXIDE | COPPER |
| 77 WP | | |
| HYDROXIDE SUPER | COPPER HYDROXIDE | COPPER |
| 77 WP | | |
| HYTOX 50 WP | MICP | |
| HYVAR X | BROMACIL | |
| WEEDKILLER | | |
| IMAGE 1.5 LC | IMAZALIL | |
| IMPACT 2.5 EC | DELTAMETHRIN | PYRETHROID |
| INDAR 2F | FENBUCONAZOLE | ORGANOPHOSPHATE |
| INDAR 2F | FENBUCONAZOLE | ORGANOPHOSPHATE |
| INSECT PRO 50 SP | CARTAP | |
| | HYDOCLORIDE | |
| INSECT PRO 50 SP | CARTAP | |
| | HYDOCLORIDE | |
| INSTAR | CARTAP | |
| | HYDROCHLORIDE | |
| INVEST 10 WP | CYCLOSULFAMURON | |
| IVA DIURON 80 WP | DIURON | MISCELLANEOUS |
| IVA PYRITILINE 20 PE | CHLORPYFIROS | ORGANOPHOSPHATE |
| M/B | | |
| IVAZEB 80 WP | MANCOZEB | DITHIOCARBAMATE |
| KARATE 2.5 EC | LAMBDACYHALOTHRIN | PYRETHROID |
| KARATE w/ ZEON | LAMBDACYHALOTHRIN | PYRETHROID |
| TECHNOLOGY | | |
| KARET 40 | MANEB W/ ZINC | |
| KARMEX | DIURON | MISCELLANEOUS |
| WEEDKILLER | | |
| KHOLUSCIDE 70 WP | NICLOSAMIDE | |
| | ETHANOLAMINE SALT | |
| KICK 25 EC | NICLOSAMIDE | |
| KICK 70 WP | NICLOSAMIDE | |
| KILLER 5 EC | CYPERMETHRIN | PYRETHROID |
| KILPES 3 EC | FENVALERATE | PYRETHROID |
| KING 5 EC | CYPERMETHRIN | PYRETHROID |
| KITAL ATRAZINE | ATRAZINE | MISCELLANEOUS |
| KITAL MANCOZEB | MANCOZEB | DITHIOCARBAMATE |
| KITAL STRYKER 5 EC | CYPERMETHRIN | PYRETHROID |
| KLEEN UP 480 AS | GLYPHOSATE IPA | |
| KLEN UP 480 AS | GLYPHOSATE IPA | |
| KLERAT WITH | BRODIFACOUM | COUMARIN |
| BITREX | | |
| KLIK 700 EC | BUTACHLOR + | MISCELLANEOUS |
| | PROPANIL | |
| KNOCK OUT 5 EC | CYPERMETHRIN | PYRETHROID |
| KOCIDE 101 | CUPRIC HYDROXIDE | MISCELLANEOUS |
| KOCIDE DF | CUPRIC HYDROXIDE | MISCELLANEOUS |
| KOCIDE DF 2000 | COPPER HYDROXIDE | MISCELLANEOUS |
| KOP-HYDROXIDE 50 | COPPER HYDROXIDE | MISCELLANEOUS |
| WP | | |
| KOTETSU 10 SC | CHLORPHENAPYR | ORGANOPHOSPHATE |
| KRISS EC | LAMBDACYHALOTHRIN | PYRETHROID |
| KUHZAK 25 EC | NICLOSAMIDE | |
| KUHZAK 70 WP | NICLOSAMIDE | |
| KUMULUS DF | ELEMENTAL SULFUR | |
| LANNATE 40 SP | METHIOCARB | |
| LARVIN 350 FS | THIOBENCARB + 2,4-D | |
| | IBE | |
| LATRON B-1956 | PHENTHOATE + BPMC | |
| LEAD CORP. 2,4-D | 2,4-D AMINE | CHLOROPHENOXY COMPOUND |
| AMINE | | |
| LEADCORP CARTAP | CARTAP | |
| | HYDROCHLORIDE | |
| LEADCORP | MALATHION | ORGANOPHOSPHATE |
| MALATHION 57 EC | | |
| LEADMARK 3 EC | FENVALERATE | PYRETHROID |
| LEADONIL 500 SC | CHLOROTHALONIL | MISCELLANEOUS |
| LEADREX TC | CHLORPYFIROS | ORGANOPHOSPHATE |
| LEADTHREL 480 SL | ETHEPON | |
| LEBAYCID 50 EC | FENTHION | |
| LECSPRO 44 WP | FENTRAZAMIDE + | PYRETHROID |
| | PROPANIL | |
| LENTREK TC | CHLORPYRIFOS | ORGANOPHOSPHATE |
| LENTREK TC | CHLORPYRIFOS | ORGANOPHOSPHATE |
| LINDAFOR 75 F | LAMBDACYHALOTHRIN | ORGANOCHLORINE |
| LONDAX WP | BENSULFURON | |
| | METHYL | |
| LORSBAN 3E | CHLORPYRIFOS | ORGANOPHOSPHATE |
| LORSBAN 40 EC | CHLORPYRIFOS | ORGANOPHOSPHATE |
| LUTENSOL A8 | ALKYL | |
| | POLYETHELENE | |
| | GLYSOL ETHER | |
| LUV 2,4-D ESTER | 2,4-D IBE | CHLOROPHENOXY COMPOUND |
| LUV MALATHION 57 | MALATHION | ORGANOPHOSPHATE |
| EC | | |
| MACHETE 5 G | BUTACHLOR | MISCELLANEOUS |
| MACHETE EC | BUTACHLOR | MISCELLANEOUS |
| MACHETE EXPRESS | BUTACHLOR | MISCELLANEOUS |
| MACHO | BUTACHLOR | MISCELLANEOUS |
| MAGIK 5% EC | CYPERMETHRIN | PYRETHROID |
| MAGNUM 5 EC | CYPERMETHRIN | PYRETHROID |
| MAITHREL 10 PGR | ETHEPON | |
| MAITHREL 48 PGR | ETHEPON | |
| MALATHION 57 E | MAGNESSIUM | ORGANOPHOSPHATE |
| PREMIUM | PHOSPHIDE | |
| MALATHION 57 EC | MALATHION | ORGANOPHOSPHATE |
| MALATHION 57 EC | MALATHION | ORGANOPHOSPHATE |
| MANAGER 80 WP | MANCOZEB | DITHIOCARBAMATE |
| MANZATE 200 | MANCOZEB | DITHIOCARBAMATE |
| FUNGICIDE | | |
| MANZATE 75 DF | MANCOZEB | DITHIOCARBAMATE |
| MANZEB 80 WP | MIPC | |
| MARSBYL 85 WP | CARBARYL | CARBAMATE |
| MARVEL 5 EC | CYPERMETHRIN | PYRETHROID |
| MASO 70 WP | NICLOSAMIDE | |
| MASTER 2.5 EC | LAMBDACYHALOTHRIN | PYRETHROID |
| MASTRA DIURON 80 | DIURON | MISCELLANEOUS |
| WP | | |
| MATADOR 60 SC | METAMIDOPHOS | ORGANOPHOSPHATE |
| MATCH 050 EC | LINURON | UREA |
| MATON 5 EC | CYPERMETHRIN | PYRETHROID |
| MEBROM | METHYL BROMIDE + | |
| | CHLOROPICRIN | |
| MEGARIFOS 20 EC | CHLORPYFIROS | ORGANOPHOSPHATE |
| MEGATHRIN 5 EC | CYPERMETHRIN | PYRETHROID |
| MELODY DUO | IPRODIONE | |
| MESUROL 50 WP | METHAMIDOPHOS | |
| META BAIT | METALDEHYDE | |
| META BAIT 6% | METALAXYL-m + | |
| PELLETS | MANCOZEB | |
| METABROM | METHYL BROMIDE + | |
| | CHLOROPICRIN | |
| MICROTHIOL DF | SPINOSAD | |
| MIMIC 20 F | TEBUCONAZOLE | |
| MIMIC 20 F | TEBUFENOZIDE | |
| MINER 50 SP | CARTAP | |
| | HYDROCHLORIDE | |
| MIPCIN 50 WP | METSULFURON | |
| | METHYL + | |
| | CHLORIMURON ETH | |
| MIRACLE AMINE | 2,4-D AMINE | CHLOROPHENOXY COMPOUND |
| MIRAL 3 G | IPROVALICARB + | |
| | PROPINEB | |
| MOCAP 10 G | ETHOPROP | |
| MODEL 5 EC | CYPERMETHRIN | PYRETHROID |
| MOLUXIDE 250 EC | NICLOSAMIDE | |
| MOSPHILAN 3 EC | ACETAMIPRID | |
| NABU-S | QUIZALOFOP-P-ETHYL | |
| NEMACUR 10 G | PERMETHRIN + Zn | |
| NEMACUR 400 EC | PHENAMIPHOS | |
| NEMATHORIN 10 G | FOZTHIAZATE | |
| NET 50 WP | NICLOSAMIDE | |
| | ETHANOLAMINE SALT | |
| NICLOS M | NICLOSAMIDE | |
| NISSORUN 5 EC | HEXAFLUMURON | |
| NOBLITE 60 WG | FENAMIDONE + MANCOZEB | |
| NOMINEE 100 SC | BISPYRIBAC SODIUM | |
| NOMINEE 100 SC | BISPYRIBAC SODIUM | |
| NORDOX 50 WP | COPPER OXIDE | COPPER |
| NURELLE D | CHLORPYFIROS + | ORGANOPHOSPHATE |
| | CYPERMETHRIN | |
| NUVACRON 300 SCW | Mn—Zn ETHYLENE | |
| | BISDITHIOCARBAMATE | |
| NYDREL 100 | ETHEPHON | |
| NYDREL 480 | ETHEPHON | |
| OCHO 5 WP | CARBARYL | CARBAMATE |
| OMEGA 45 EC | PRETILACHLOR + | |
| | FENCLORIM | |
| ONECIDE 15 EC | FLUAZIFOP-P-BUTYL | |
| ORTHENE/ACETAM | ACEPHATE | ORGANOPHOSPHATE |
| 75 SP | | |
| ORTHENE 75 SP | ACEPHATE | ORGANOPHOSPHATE |
| OXYCHLOR 85 WP | COPPER | |
| | OXYCHLORIDE | |
| PADAN 50 SP | CAPTAN | CARBAMATE |
| | HYDROCHLORIDE | |
| PADAN 50 SP | CARTAP | |
| | HYDROCHLORIDE | |
| PARAFUNGUS 80 WP | MANCOZEB | DITHIOCARBAMATE |
| PARAKUHOL 250 EC | NICLOSAMIDE | |
| PARAPEST D 400 EC | DIAZINON | ORGANOPHOSPHATE |
| PARAULOD 300 EC | CHLORPYFIROS | ORGANOPHOSPHATE |
| PARTNER 40 DF | CARFENTRAZONE- | |
| | ETHYL | |
| PARTNER 40 DF | CARFENTRAZONE- | |
| | ETHYL | |
| PASSPORT 500 SC | CHLOROTHALONIL | MISCELLANEOUS |
| PENNANT | PHENAMIPHOS | |
| PERFEK 31.5 EC | CHLORPYRIFOS + | Organophosphate + Carbamate |
| | BPMC | |
| PERFEKTHION 40 EC | DIMETHOATE | |
| PERMIT 10 WP | GLYSOPHATE IPA | |
| PESTMASTER | CYPERMETHRIN | PYRETHROID |
| PILARICH 500 G/L FP | CHLOROTHALONIL | MISCELLANEOUS |
| PILARZEB 80 WP | MANCOZEB | DITHIOCARBAMATE |
| PIPSET 35 WP | CINOSULFURON + | |
| | PIPEROPHOS | |
| PISTOL 50 WP | NICLOSAMIDE | |
| | ETHANOLAMINE | |
| PISTOL 50 WP | NICLOSAMIDE | |
| | ETHANOLAMINE SALT | |
| PLANTERS | MALATHION | ORGANOPHOSPHATE |
| MALATHION 57 EC | | |
| POLIDO 2.5 EC | ETHOFENPROX | |
| PORSANAIL | METALDEHYDE | |
| POSSE 200 SC | CARBOSULFAN | CARBAMATE |
| POWER | GLYPHOSATE IPA | |
| POWER SUPRATECH | GLYPHOSATE DI- | |
| | AMMONIUM SALT | |
| PREDATOR EC | CHLORPYFIROS | ORGANOPHOSPHATE |
| PREDATOR PLUS | CHLORPYFIROS + | ORGANOPHOSPHATE |
| | CYPERMETHRIN | |
| PREKILL 330 | PARAQUAT | |
| | DICHLORIDE | |
| PREMISE 200 SC | IMIDACLOPRID | |
| PREMIUM 5 EC | CYPERMETHRIN | PYRETHROID |
| PREVENT 77 WP | COPPER HYDROXIDE | COPPER |
| PREVICUR-N | PROFENOFOS | |
| PROCIN 25 WP | BUFROFESIN | |
| PROCURE 50 WP | BENOMYL | |
| PROPLANT | PROPAMOCARB | |
| PROVADO SUPRA 050 | IMIDACLOPRID | |
| EC | | |
| PROVIN 85 WP | CARBARYL | CARBAMATE |
| PUNISH 5.5 EC | CYPERMETHRIN | PYRETHROID |
| PYRITILENE 20 PE | CHLOPYFIROS | ORGANOPHOSPHATE |
| M/B | | |
| PYTOX 10 EC | PERMETHRIN | PYRETHROID |
| QUICKPHOS (ROUND | ALUMINUM | RODENTICIDE |
| TAB) | PHOSPHIDE | |
| RACUMIN DUST | COUMATETRALYL | |
| RADISSON | MANCOZEB | DITHIOCARBAMATE |
| MANCOZEB 80 WP | | |
| RADOR 262.5 EC | CHLORPYFIROS + | Organophosphate + Pyrethroid |
| | BETACYFLUTHRIN | |
| RAFT 800 WG | NICLOSAMIDE | |
| | ETHANOLAMINE SALT | |
| RAPIDO 5 EC | CYPERMETHRIN | PYRETHROID |
| RATKIL ZINC | WARFARIN | |
| PHOSPHIDE80% BAIT | | |
| RATOXIN P | TRISILOXANE | |
| | ALKOXYLATE + ALLYL | |
| | ETHOXYLA | |
| RECRUIT II | HEXACONAZOLE | |
| REDEEM 80 WP | MANCOZEB | DITHIOCARBAMATE |
| RED-OUT 80 WP | MANCOZEB | DITHIOCARBAMATE |
| REGENT 0.3 GR | FIPRONIL | |
| REV 800 WP | MANCOZEB | DITHIOCARBAMATE |
| RICESTAR EC | FENOXAPROP P-ETHYL | |
| RIDOMIL GOLD MZ 68 | METALAXYL + | |
| WP | MANCOZEB | |
| RIDOMIL MZ 58 WP | METALAXYL | |
| RILOF 500 EC | PICLORAM + 2,4-D | |
| RIPCORD 2.5 EC | CYPERMETHRIN | PYRETHROID |
| ROBODAX 25 EC | NICLOSAMIDE | |
| ROGUE EC | BUTACHLOR + 2,4-D | |
| RONSTAR 25 EC | OXADIARGYL | |
| RONSTAR 2G | OXADIAZON | |
| ROUND-UP BIOSORB | GLYPHOSATE | |
| | ISOPROPYLAMINE | |
| | SALT | |
| ROUNDUP EW | GLYPHOSATE IPA | |
| ROUND-UP MAX | GLUFOSINATE | |
| | AMMONIUM | |
| ROVER | CHLOROTHALONIL | MISCELLANEOUS |
| ROVRAL 50 WP | INDOXACARB | |
| ROVRAL AQUAFLO | IPRODIONE | |
| 50 SC | | |
| ROYAL CARTAP | CARTAP | CARBAMATE |
| ROYANIL 75 WP | CHLOROTHALONIL | MISCELLANEOUS |
| SABEDONG 5 EC | CYPERMETHRIN | PYRETHROID |
| SAMURAI 60EC | BUTACHLOR | MISCELLANEOUS |
| SANAFURAN 3 G | CARBOSULFAN | CARBAMATE |
| SANAZOLE 250 EC | PROPICONAZOLE | |
| SAPROL EC | TRIFLUMIZOLE | |
| SATURN 60 EC | THIAMETOXAM | |
| SATURN D | THIOBENCARB + 2,4-D | |
| SATURN S | THIOBENCARB | THIOCARBAMATE |
| SAVIOR 80 WP | MANCOZEB | DITHIOCARBAMATE |
| SCOPE 70 WP | THIOPHANATE | |
| | METHYL | |
| SCORE 250 EC | DIFENOCONAZOLE | |
| SELECRON 500 EC | PROCHLORAZ MN | |
| SELECT 120 EC | CLETHODIM | |
| SELECT 120 EC | CLETHODIM | |
| SENCOR 70 WP | METHYL BROMIDE + | |
| | CHLOROPICRIN | |
| SENTINEL 75 WP | CHLOROTHALONIL | MISCELLANEOUS |
| SERVWEL 2,4-D | 2,4-D AMINE | CHLOROPHENOXY COMPOUND |
| AMINE | | |
| SERVWEL | MALATHION | ORGANOPHOSPHATE |
| MALATHION 57 EC | | |
| SERVWEL | MANCOZEB | DITHIOCARBAMATE |
| MANCOZEB 80 WP | | |
| SERVWEL TKO 50 EC | CYPERMETHRIN | PYRETHROID |
| SERVWEL2,4-D | 2,4-D IBE | CHLOROPHENOXY COMPOUND |
| GRANULES | | |
| SEVIN 50 WP | CARBUFORAN | CARBAMATE |
| SEVIN 85 WP | CARBUFORAN | CARBAMATE |
| SHERPA 5 EC | CYPERMETHRIN | PYRETHROID |
| SHIELD | CHLOROTHALONIL | MISCELLANEOUS |
| SHOTGUN M | MANCOZEB | DITHIOCARBAMATE |
| SICO 250 EC | DIFENOCONAZOLE | |
| SIGA 300 EC | CHLORPYRIFOS | ORGANOPHOSPHATE |
| SIGANEX 600 SC | PYMETROZINE | |
| SIGMA | GLYPHOSPHATE IPA | |
| SILWET 408 | TRISILOXANE | |
| | ALKOXYLATE + ALLYL | |
| | ETHOXYLA | |
| SILWET 408 | TRIFORINE | |
| SLASH | GLYPHOSATE IPA | |
| SMART 480 | GLYPHOSATE IPA | |
| SMART 480 | GLYPHOSATE IPA | |
| SMASH 5 EC | CYPERMETHRIN | PYRETHROID |
| SNAIL CHAMP 25 EC | NICLOSAMIDE | |
| SNAIL OUT 50 WP | NICLOSAMIDE | |
| SNAILKIL 6% P | METALDEHYDE | |
| SNIPER 5 EC | CYPERMETHRIN | PYRETHROID |
| SOFIT 300 EC | POLYOXYETHYLENE | |
| | SORBITANT FATTY | |
| | ACIDS + | |
| SOLIGNUM BROWN | PERMETHRIN | PYRETHROID |
| SOLIGNUM | PERMETHRIN | PYRETHROID |
| COLORLESS | | |
| SOLNET 500 EC | PRETILACHLOR | |
| SONIC 60 EC | BUTACHLOR | MISCELLANEOUS |
| SPECTRA 5 EC | CYPERMETHRIN | PYRETHROID |
| SPEED 25 EC | MONOCROTOPHOS | |
| SPEED 50 WP | NICLOSAMIDE | |
| SPEEDEX | POLYETHER:POLYMETHYLSILOXANE | |
| | COPOLYME | |
| STAM LV-10 | PROPAMOCARB HCL | |
| STAR 5 EC | CYPERMETHRIN | PYRETHROID |
| STEADFAST TC | ALPHACYPERMETHRIN | PYRETHROID |
| STEWARD WDG | IMIDACLOPRID + | |
| | CYFLUTHRIN | |
| STIMUKIL FLY BAIT | METHOMYL | |
| STINGRAY 5.625 | DELTAMETHRIN + BUPROFEZIN | |
| STIX 480 EC | CARBUFORAN | CARBAMATE |
| STOP 6% PELLETS | METALDEHYDE | |
| STORM WAX W/ | FLOCOUMAFEN | |
| BITREX | | |
| SUCCESS | SORBITAN | |
| NATURALYTE 25 SC | MONOOLATE(SB), POLYOXYETHYL | |
| SUMI-ALPHA 2.5 EC | ESFENVALERATE | PYRETHROID |
| SUMI-ALPHA 2.5 EC | ESFENVALERATE | PYRETHROID |
| SUMI-ALPHA 2.5 EC | ESFENVALERATE | PYRETHROID |
| SUMICIDIN | FENVALERATE | PYRETHROID |
| SUMICIDIN 3 EC | FENVALERATE | PYRETHROID |
| SUMICIDIN 3 EC | FENVALERATE | PYRETHROID |
| SUMI-EIGHT | DINICONAZOLE | |
| SUMITHION 40 WDP | FENITROTHION | ORGANOPHOSPHATE |
| SUMITHION 50 EC | FENITROTHION | ORGANOPHOSPHATE |
| SUMITHION 50 EC | FENITHROTHION | ORGANOPHOSPHATE |
| SUMITHION 50 EC | FENITROTHION | ORGANOPHOSPHATE |
| SUNRICE 15 WDG | ETHOXYSULFURON | |
| SUNSPRAY 8N | PAECILOMYCES | |
| | LILACINUS STRAIN 251 | |
| SUPER BLUE 85 WP | COPPER | COPPER |
| | OXYCHLORIDE | |
| SUPREME 5 EC | CYPERMETHRIN | PYRETHROID |
| SUPREMO EC | BPMC + CHLORPYFIROS | |
| SURE 250 EC | NICLOSAMIDE | |
| SUREKILL 70 WP | NICLOSAMIDE | |
| SURFACTANT A-100 | POLYETHER- | |
| | POLYMETHYLSILOXANE | |
| | COPOLYM | |
| SURFACTANT A-100 | POLYOXYETHYLENE | |
| | DODECYL ETHER | |
| SURFIX | BETA PINENE | |
| | POLYMER | |
| SWEEP | THIOPHANATE | |
| | METHYL | |
| SWIPE 25 EC | NICLOSAMIDE | |
| SWIPE 50 WP | NICLOSAMIDE | |
| TAMARON 600 SL | METALDEHYDE | |
| TAMEX 360 EC | BUTRALIN | |
| TARGET 2.5 EC | NICLOSAMIDE | |
| TARGET 25 EC | NICLOSAMIDE | |
| TECTO 45 FW | TETRAMETHYLTHIURAM | |
| | DISULPHIDE | |
| TEGA 075 EC | TRIDEMORPH | |
| TELONE II | DICHCHLOROPROPENE | |
| TERMEX 48 EC | CHLORPYFIROS | ORGANOPHOSPHATE |
| TERMIDOR 2.5 EC | FIPRONIL | |
| TERMINATOR 2.5 EC | LAMBDACYHALOTHRIN | PYRETHROID |
| TERMITE-X | CHLORPYFIROS | ORGANOPHOSPHATE |
| TERRAGUARD 48 EC | CHLORPYFIROS | ORGANOPHOSPHATE |
| THESIS 2.5 EC | DELTAMETHRIN | PYRETHROID |
| THIRAM 80 WG | TETRAMETHYLTHIURAM | |
| | DISULPHIDE | |
| THYLATE 80 WG | TERBUFOS | |
| TIGER 25 SC | NICLOSAMIDE | |
| TILT 250 EC | PROPANIL | |
| TIMBER GUARD | PERMETHRIN + Zn | |
| CLEAR | | |
| TIMBER GUARD | PERMETHRIN | PYRETHROID |
| MEDIUM BROWN | | |
| TOP 70 WP | THIOPHANATE | |
| | METHYL | |
| TOPNOTCH | THIODICARB | |
| TOPSIN-M 70 WP | THIOPHANATE | |
| | METHYL | |
| TOPSTAR 60 EC | OXADIARGYL | |
| TORDON 101 | PHTHALIC GLYCEROL | |
| MIXTURE | ALKYL | |
| TORNADO 60 EC | BUTACHLOR + PROPANIL | MISCELLANEOUS |
| TORNADO 60 EC | BUTACHLOR + | MISCELLANEOUS |
| | PROPANIL | |
| TORO | BUTACHLOR + | MISCELLANEOUS |
| | PROPANIL | |
| TORPEDO 5 EC | CYPERMETHRIN | PYRETHROID |
| TRAMEX COMBI 80 | AMETRYNE + | MISCELLANEOUS |
| WP | ATRAZINE | |
| TRANZEB 455 FC | MANCOZEB | DITHIOCARBAMATE |
| TRANZEB 80 WP | MANCOZEB | DITHIOCARBAMATE |
| TRAP 70 WP | NICLOSAMIDE | |
| TREBON 10 EC | ETHOFENPROX | |
| TREBON 10 EC | ETHOFENPROX | |
| TREBON 10 EW | ETHOFENPROX | |
| TREFIC 20 WP | ETHOFENPROX | |
| TRIFMINE 30 WP | TRIFLOXYSTROBIN | |
| TRIGARD 75 WP | CYROMAZINE | |
| TRIM 50 WP | LINURON | |
| TRINEB 80 WP | MANCOZEB + | |
| | CYMOXANIL | |
| TRIO 50 WP | PROCHLORAZ | |
| TRIPLEX 50 EC | CYPERMETHRIN | PYRETHROID |
| TROJAN 31.5 EC | CHLORPYFIROS + BPMC | |
| TWISTER 70 EC | BUTACHLOR + | MISCELLANEOUS |
| | PROPANIL | |
| TWISTER EC | BUTACHLOR + PROPANIL | MISCELLANEOUS |
| ULTIMO EC 200 | NICLOSAMIDE | |
| ULTIMO EC 225 | NICLOSAMIDE | |
| UPROOT 60 EC | BUTACHLOR | MISCELLANEOUS |
| VECTRON 10 EW | ETHOFENPROX | |
| VECTRON 20 WP | ETHOFENPROX | |
| VEGETOX 50 SP | CARTAP | CARBAMATE |
| VERTIMEC | AVERMECTIN | CHLORIDE CHANNEL ACTIVATOR |
| VEXTER 300 EC | CHLORPYFIROS | ORGANOPHOSPHATE |
| VINDEX PLUS | PHENTHOATE | |
| VISOCOL 50 WP | NICLOSAMIDE | |
| VITAL BLUE 85 WP | COPPER | COPPER |
| | OXYCHLORIDE | |
| VITIGRAN BLUE 58 | COPPER | COPPER |
| WP | OXYCHLORIDE | |
| VITIGRAN BLUE 58 | COPPER | COPPER |
| WP | OXYCHLORIDE | |
| VONDOZEB 42 SC | MANCOZEB | DITHIOCARBAMATE |
| VONDOZEB 75 DF | MANCOZEB | DITHIOCARBAMATE |
| VONDOZEB L | MANEB | |
| VONDOZEB PLUS | MANCOZEB | DITHIOCARBAMATE |
| WALLOP 70 WP | NICLOSAMIDE | |
| WARRIOR 31.5 | CHLORPYRIFOS + | ORGANOPHOSPHATE + CARBAMATE |
| | BPMC | |
| WAZARY 10 FL | FENVALERATE | PYRETHROID |
| WAZARY 10 FL | FENVALERATE | PYRETHROID |
| WEAPON 5 EC | CYPERMETHRIN | PYRETHROID |
| WEDKILL 2,4-D | 2,4-D IBE | CHLOROPHENOXY COMPOUND |
| WEEDER 60 EC | BUTACHLOR | MISCELLANEOUS |
| WEEDTROL 40 EC | 2,4-D IBE | CHLOROPHENOXY COMPOUND |
| WEISER ATRAZINE 80 | ATRAZINE | 1,3,5-TRIAZINE |
| WP | | |
| WEISSER ATRAZINE | ATRAZINE | 1,3,5-TRIAZINE |
| 80 WP | | |
| WEISSER | CYPERMETHRIN | PYRETHROID |
| CYPERMETHRIN 5 EC | | |
| WHIP-S 120 EW | FENOXAPROP P-ETHYL | |
| WHIP-S 75 EW | FENOXAPROP P-ETHYL | |
| WINNER 5 EC | CYPERMETHRIN | PYRETHROID |
| WIPER5 EC | CYPERMETHRIN | PYRETHROID |
| WOLMAN CCA-C | COPPER, CHROME, ARSENIC | |
| | (CCA) | |
| XENTARI WDG | BACILLUS | PLANT ORIGIN |
| | THURINGIENSIS | |
| X-PHOS 20 EC | CHLORPYFIROS | ORGANOPHOSPHATE |
| X-PHOS 40 EC | CHLORPYFIROS | ORGANOPHOSPHATE |
| X-RAT 1% P | WARFARIN | |
| XTRAGRO 10 LS | ETHEPHON | |
| XTRAGRO 240 PGR | ETHEPHON | |
| XTRAGRO 480 PGR | ETHEPHON | |
| ZACARB 85 WP | CARBARYL | CARBAMATE |
| ZACK 50 WP | MIPC | |
| ZECTRIC 6% PELLETS | METALDEHYDE | |
| ZEPHYR | AVERMECTIN | CHLORIDE CHANNEL ACTIVATOR |
| ZINC PHOSPHIDE 80 | ZINC PHOSPHIDE | |
| DP | | |
| ZOOM 5 EC | CYPERMETHRIN | PYRETHROID |

Embodiments of the invention can include at least one biologically-based insecticide, such as, for example, abamectin, proteins and/or spores derived from Bacillus thuriniensis, spinosad, or the like.

Embodiments of the invention can include at least one insect growth regulator, such as, for example, etoxazol, methoxyfenozide, pyriproxyfen, or the like.

Embodiments of the invention can include at least one oil, such as, for example, “Superior oil,” highly-refined oils, and the like.

Embodiments of the invention can include at least one pheromone, such as, for example, Codling moth pheromone, Oriental fruit moth pheromone, and the like.

Embodiments of the invention can include a herbicidal chemical or product. In some embodiments, these herbicidal chemicals can include, for example, amide herbicides, anilide herbicides, arylalanine herbicides, chloroacetanilide herbicides, sulfonanilide herbicides, sulfonamide herbicides, thioamide herbicides, antibiotic herbicides, aromatic acid herbicides, benzoic acid herbicides, pyrimidinyloxybenzoic acid herbicides, pyrimidinylthiobenzoic acid herbicides, phthalic acid herbicides, picolinic acid herbicides, quinolinecarboxylic acid herbicides, arsenical herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisoxazole herbicides, dicarboximide herbicides, dinitroaniline herbicides, dinitrophenol herbicides, diphenyl ether herbicides, nitrophenyl ether herbicides, dithiocarbamate herbicides, halogenated aliphatic herbicides, imidazolinone herbicides, inorganic herbicides, nitrile herbicides, organophosphorus herbicides, oxadiazolone herbicides, phenoxy herbicides, phenoxyacetic herbicides, phenoxybutyric herbicides, phenoxypropionic herbicides, aryloxyphenoxypropionic herbicides, phenylenediamine herbicides, pyrazole herbicides, benzoylpyrazole herbicides, phenylpyrazole herbicides, pyridazine herbicides, pyridazinone herbicides, pyridine herbicides, pyrimidinediamine herbicides, quaternary ammonium herbicides, thiocarbamate herbicides, thiocarbonate herbicides, thiourea herbicides, triazine herbicides, chlorotriazine herbicides, methoxytriazine herbicides, methylthiotriazine herbicides, triazinone herbicides, triazole herbicides, triazolopyrimidine herbicides, uracil herbicides, urea herbicides, phenylurea herbicides, sulfonylurea herbicides, pyrimidinylsulfonylurea herbicides, triazinylsulfonylurea herbicides, thiadiazolylurea herbicides, unclassified herbicides, and the like.

Embodiments of the invention can include a fungicidal chemical or product. In some embodiments, these fungicidal chemicals can include, for example, aliphatic nitrogen fungicides, amide fungicides, acylamino acid fungicides, anilide fungicides, benzanilide fungicides, furanilide fungicides sulfonanilide fungicides, benzamide fungicides, furamide fungicides, phenylsulfamide fungicides, sulfonamide fungicides, valinamide fungicides, antibiotic fungicides, strobilurin fungicides, aromatic fungicides, benzimidazole fungicides, benzimidazole precursor fungicides, benzothiazole fungicides, bridged diphenyl fungicides, carbamate fungicides, benzimidazolylcarbamate fungicides, carbanilate fungicides, conazole fungicides, copper fungicides, dicarboximide fungicides, dichlorophenyl dicarboximide fungicides, phthalimide fungicides, dinitrophenol fungicides, dithiocarbamate fungicides, imidazole fungicides, inorganic fungicides, mercury fungicides, morpholine fungicides, organophosphorus fungicides, organotin fungicides, oxathin fungicides, oxazole fungicides, polysulfide fungicides, pyrazole fungicides, pyridine fungicides, pyrimidine fungicides, pyrrole fungicides, quinoline fungicides, quinone fungicides, quinoxaline fungicides, thiazole fungicides, thiazolidine fungicides, thiocarbamate fungicides, thiophene fungicides, triazine fungicides, triazole fungicides, urea fungicides, unclassified fungicides, and the like.

In embodiments of the invention that include at least one compound or chemical of a plant origin, the at least one compound or chemical of a plant origin can include, for example, any of the compounds or chemicals listed in table 4, or the like:

TABLE 4
COMPOUNDS OF PLANT ORIGIN

| | | | |
|---|---|---|---|
| T-ANETHOLE | CORN OIL | LILAC FLOWER | PIPERONAL |
| ALLYL SULFIDE | B-COSTOL | OIL (LFO) | PIPERONYL |
| ALLYL TRISULFIDE | CRYPTONE | LIME OIL | PIPERONYL |
| ALLYL-DISULFIDE | CUMIN OIL | D-LIMONENE | ACETATE |
| ARTEMISIA | CURZERENONE | LINALOOL | PIPERONYL |
| ALCOHOL ACETATE | P-CYMENE | LINALYL | ALCOHOL |
| BENZALDEHYDE | DAVANONE | ACETATE | PIPERONYL |
| BENZOIC ACID | DIALLYL | LINALYL | AMINE |
| BENZYL ACETATE | TETRASULFIDE | ANTHRANILATE | PRENAL |
| BENZYL ALCOHOL | DIETHYL | LINDESTRENE | PULEGONE |
| BERGAMOTENE | PHTHALATE | LINDENOL | QUININE |
| B-BISABOLENE | DIHYDROPYROCURZERENONE | LINSEED OIL | ROSEMARY OIL |
| BISABOLENE OXIDE | DIHYDROTAGENTONE | METHYL-ALLYL- | SABINENE |
| A-BISABOLOL | BETA-ELEMENE | TRISULFIDE | SABINYL |
| BISABOLOL OXIDE | GAMMA- | MENTHOL | ACETATE |
| BISOBOLOL OXIDE B | ELEMENE | MENTHONE | SAFFLOWER OIL |
| BORNYL ACETATE | ELMOL | 2-METHOXY | A-SANTALENE |
| B-BOURBONENE | ESTRAGOLE | FURANODIENE | SANTALOL |
| BLACK SEED OIL | 2-ETHYL-2- | MENTHYL | SATIVEN |
| (BSO) | HEXEN-1-OL | ACETATE | Δ-SELINENE |
| A-CADINOL | EUGENOL | METHYL | SESAME OIL |
| CAMPHENE | EUGENOL | CINNAMATE | B- |
| A-CAMPHOLENE | ACETATE | METHYL CITRATE | SESQUPHELANDRENE |
| A-CAMPHOLENE | A-FARNESENE | METHYL DI- | SILICONE FLUID |
| ALDEHYDE | (Z,E)-A- | HYDROJASMONATE | SODIUM LAURYL |
| CAMPHOR | FARNESENE | MENTHYL | SULFATE |
| CARVACROL | E-B-FARNESENE | SALICYLATE | SOYBEAN OIL |
| D-CARVONE | FENCHONE | MINERAL OIL | SPATHULENOL |
| L-CARVONE | FURANODIENE | MUSK AMBRETTE | TAGETONE |
| CARYOPHYLLENE | FURANOEUDESM | MYRCENE | TANGERINE OIL |
| OXIDE | A-1,3-DIENE | MYRTENAL | A-TERPINENE |
| TRANS- | FURANOEUDESM | NERALDIMETHYL | TERPINENE 900 |
| CARYOPHYLLENE | A-1,4-DIENE | ACETATE | A-TERPINEOL |
| CASTOR OIL | FURANO | NEROLIDOL | A-TERPINOLENE |
| CEDAR OIL | GERMACRA | NONANONE | GAMMA- |
| CHAMAZULENE | 1,10(15)-DIENE-6- | GAMMA- | TERPINEOL |
| 1,8-CINEOLE | ONE | NONALACTONE | A-TERPINYL |
| CINNAMALDEHYDE | FURANOSESQUITERPENE | OIL OF | ACETATE |
| CINNAMYL | GARLIC OIL | PENNYROYAL | 2-TERT-BUTYL-P- |
| ALCOHOL | GERANIOL | OLIVE OIL | QUINONE |
| CINNAMON OIL | GERANIOL | ORANGE SWEET | A-THUJONE |
| CITRAL A | ACETATE | OIL | THYME OIL |
| CITRAL B | GERMACRENE D | 1-OCTANOL | THYMOL |
| ISOPROPYL | GERMACRENE B | E OCIMENONE | THYMYL METHYL |
| CITRATE | GRAPEFRUIT OIL | Z OCIMENONE | ETHER |
| CITRONELLAL | A-GURJUNENE | 3-OCTANONE | GAMMA- |
| CITRONELLA OIL | A-HUMULENE | OCIMENE | UNDECALACTONE |
| CITRONELLOL | A-IONONE | OCTYL ACETATE | VALERIC |
| CITRONELLYL | B-IONONE | PEANUT OIL | ANHYDRIDE |
| ACETATE | ISOBORNEOL | PERILLYL | VANILLIN |
| CITRONELLYL | ISOFURANOGERMACRENE | ALCOHOL | TRANS- |
| FORMATE | ISO-MENTHONE | PEPPERMINT OIL | VERBENOL |
| CLOVE OIL | ISO-PULEGONE | A- | CIS-VERBENOL |
| A-COPAENE | JASMONE | PHELLANDRENE | VERBENONE |
| CORNMINT OIL | LECITHIN | B- | WHITE MINERAL |
| | LEMON OIL | PHELLANDRENE | OIL |
| | LEMON GRASS | PHENETHYL | YOMOGI |
| | OIL | PROPRIONATE | ALCOHOL |
| | | PHENYL | ZINGIBERENE |
| | | ACETALDEHYDE | |
| | | A-PINENE | |
| | | B-PINENE | |
| | | PINE OIL | |
| | | TRANS- | |
| | | PINOCARVEOL | |

Additional compounds and chemicals of a plant origin that can be used in accordance with embodiments of the present invention are set forth in the following applications, each of which is incorporated in its entirety herein by reference: U.S. application Ser. No. 10/832,022, entitled COMPOSITIONS AND METHODS FOR CONTROLLING INSECTS; U.S. application Ser. No. 11/086,615, entitled COMPOSITIONS AND METHODS FOR CONTROLLING INSECTS RELATED TO THE OCTOPAMINE RECEPTOR; U.S. application Ser. No. 11/365,426, entitled COMPOSITIONS AND METHODS FOR CONTROLLING INSECTS INVOLVING THE TYRAMINE RECEPTOR; and U.S. application Ser. No. 11/870,385, entitled COMPOSITIONS AND METHODS FOR CONTROLLING INSECTS.

In certain embodiments, it can be desirable to include a naturally-occurring version or a synthetic version of a compound. For example, in certain embodiments it can be desirable to include Lime Oil 410, a synthetic lime oil that can be obtained, for example, from Millennium Chemicals, Inc. In certain exemplary compositions, it can be desirable to include a compound that is designated as meeting Food Chemical Codex (FCC), for example, Geraniol Fine FCC or Tetrahydrolinalool FCC, which compounds can be obtained, for example, from Millennium Chemicals, Inc.

In embodiments of the invention that include at least one blend of compounds of a plant origin, the compounds of plant origin can be tested for their precise chemical composition using, for example, High-Pressure Liquid Chromatography (HPLC), Mass Spectrometry (MS), gas chromatography, or the like.

The term “about” or “approximately” means within an acceptable error range for the particular value as determined by one of ordinary skill in the art, which will depend in part on how the value is measured or determined, i.e., the limitations of the measurement system, i.e., the degree of precision required for a particular purpose, such as a pharmaceutical formulation. For example, “about” can mean within 1 or more than 1 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

The term “substantially,” as used herein, means at least about 80%, preferably at least about 90%, more preferably at least about 99%, for example at least about 99.9%. In some embodiments, the term “substantially” can mean completely, or about 100%.

In embodiments of the invention that include at least one blend of compounds of a plant origin, the at least one blend of compounds can include at least two compounds. For example, in an exemplary embodiment, the at least one blend of compounds can include LFO and Black Seed Oil (BSO).

In another exemplary embodiments, the at least one blend of compounds can include LFO, D-limonene, Thyme Oil White, and Lime Oil.

In another exemplary embodiment, the at least one blend of compounds can include Tetrahydrolinalool, Isopropyl Myristate, Piperonal (aldehyde), Triethyl Citrate, Linalool, Geraniol, Vanillin, D-limonene, Lime Oil, and Thyme Oil White.

In another exemplary embodiment, the at least one blend of compounds can include Isopropyl myristate, Tetrahydrolinalool, Linalool, Geraniol, Piperonal (aldehyde), Vanillin, and BSO.

In another exemplary embodiment, the at least one blend of compounds can include Isopropyl myristate, Tetrahydrolinalool, Linalool Synthetic, Geraniol Fine, Piperonal (aldehyde), Vanillin, BSO, Methyl Salicylate, and D-limonene.

In another exemplary embodiment, the at least one blend of compounds can include Thyme Oil White, Wintergreen Oil, Isopropyl Myristate, and Vanillin.

In another exemplary embodiment, the at least one blend of compounds can include D-limonene, Thyme Oil White, and Wintergreen Oil.

In another exemplary embodiment, the at least one blend of compounds can include Thyme Oil White, Wintergreen Oil, and Isopropyl Myristate.

In another exemplary embodiment, the at least one blend of compounds can include D-limonene, Linalool, Geraniol, Tetrahydrolinalool, Isopropyl Myristate, Piperonal, and Vanillin.

In another exemplary embodiment, the at least one blend of compounds can include Methyl Salicylate, Linalool, Geraniol, Tetrahydrolinalool, Isopropyl Myristate, Piperonal (aldehyde), Vanillin, BSO, and D-limonene.

In another exemplary embodiment, the at least one blend of compounds can include Isopropyl myristate, Tetrahydrolinalool, Linalool, Geraniol, Piperonal (aldehyde), Vanillin, Mineral Oil, BSO, and D-limonene.

In another exemplary embodiment, the at least one blend of compounds can include Linalool, Thymol (crystal), Alpha-Pinene, Para-Cymene, and trans-Anethole.

In another exemplary embodiment, the at least one blend of compounds can include Isopropyl Myristate, Tetrahydrolinalool, Linalool, Geraniol, Piperonal (aldehyde), Vanillin, and BSO.

In another exemplary embodiment, the at least one blend of compounds can include Thyme Oil White, Methyl Salicylate, Isopropyl Myristate, and Vanillin.

In another exemplary embodiment, the at least one blend of compounds can include D-limonene, Thyme Oil White, and Methyl Salicylate.

In another exemplary embodiment, the at least one blend of compounds can include Methyl Salicylate, Thymol, Geraniol, Isopropyl Myristate, and Vanillin.

In some embodiments, the blend of compounds can include between 4 and 5% Lilace Flower Oil (LFO), between 75 and 90% D-Limonene, between 3 and 4% Thyme Oil White, and between 8 and 12% Lime Oil 410.

In some embodiments, the blend of compounds can include 4.40% LFO, 82.3% D-Limonene, 3.3% Thyme Oil White, and 10.0% Lime Oil 410.

In some embodiments, the blend of compounds can include between 75 and 90% D-Limonene, between 2.5 and 4% Thyme Oil White, between 0.5 and 0.65% Linalool Coeur, between 0.7 and 0.9% Tetrahydrolinalool, between 0.04 and 0.06% Vanillin, between 0.7 and 0.9% Isopropyl myristate, between 0.7 and 0.9% Piperonal (aldehyde), between 9 and 11% Lime Oil Minus, between 0.35 and 0.5% Geraniol 60, and between 0.7 and 0.9% Triethyl Citrate.

In some embodiments, the blend of compounds can include 82.52% D-Limonene, 3.28% Thyme Oil White, 0.57% Linalool Coeur, 0.78% Tetrahydrolinalool, 0.05% Vanillin, 0.80% Isopropyl myristate, 0.80% Piperonal (aldehyde), 9.99% Lime Oil Minus, 0.41% Geraniol 60, and 0.80% Triethyl Citrate.

In some embodiments, the blend of compounds can include between 18 and 24% BSO, between 14 and 17% Linalool Coeur, between 17 and 21% Tetrahydrolinalool, between 1.6 and 2% Vanillin, between 21 and 26% Isopropyl myristate, between 7 and 9% Piperonal (aldehyde), and between 9 and 12% Geraniol Fine FCC.

In some embodiments, the blend of compounds can include 21.50% BSO, 15.90% Linalool Coeur, 19.00% Tetrahydrolinalool, 1.80% Vanillin, 23.50% Isopropyl myristate, 7.80% Piperonal (aldehyde), and 10.50% Geraniol Fine FCC.

In some embodiments, the blend of compounds can include between 8 and 10% D-Limonene, 24 and 28.5% BSO, 5.5 and 7.0% Linalool Coeur, between 7 and 9% Tetrahydrolinalool, between 0.7 and 0.9% Vanillin, between 8.5 and 10.5% Isopropyl myristate, between 2.8 and 3.6% Piperonal (aldehyde), between 3.8 and 5% Geraniol Fine FCC, and between 29 and 37% Methyl Salicylate 98% Nat.

In some embodiments, the blend of compounds can include 8.80% D-Limonene, 26.20% BSO, 6.40% Linalool Coeur, 7.80% Tetrahydrolinalool, 0.80% Vanillin, 9.50% Isopropyl myristate, 3.20% Piperonal (aldehyde), 4.30% Geraniol Fine FCC, and 33.00% Methyl Salicylate 98% Nat.

In some embodiments, the blend of compounds can include between 18 and 23% Thyme Oil White, between 40 and 50% Wintergreen Oil, between 1 and 1.2% Vanillin, and between 30 and 37% Isopropyl myristate.

In some embodiments, the blend of compounds can include 20.50% Thyme Oil White, 45.00% Wintergreen Oil, 1.10% Vanillin, and 33.40% Isopropyl myristate.

In some embodiments, the blend of compounds can include between 50 and 62% D-Limonene, between 10.5 and 13.5% Thyme Oil White, and between 28 and 35% Wintergreen Oil.

In some embodiments, the blend of compounds can include 56.30% D-Limonene, 12.38% Thyme Oil White, and 31.32% Wintergreen Oil.

In some embodiments, the blend of compounds can include between 50 and 62% D-Limonene, between 10.5 and 13.5% Thyme Oil White, and between 28 and 35% Wintergreen Oil Technical.

In some embodiments, the blend of compounds can include 56.30% D-Limonene, 12.38% Thyme Oil White, and 31.32% Wintergreen Oil Technical.

In some embodiments, the blend of compounds can include between 11.5 and 14.5% LFO, between 7.9 and 9.5% D-Limonene, between 8.5 and 10.6% Thyme Oil White, and between 61 and 76% Lime Oil 410.

In some embodiments, the blend of compounds can include 12.94% LFO, 8.72% D-Limonene, 9.58% Thyme Oil White, and 68.76% Lime Oil 410.

In some embodiments, the blend of compounds can include between 11.5 and 14.5% LFO, between 38 and 46.5% D-Limonene, between 8.5 and 10.6% Thyme Oil White, between 0.76 and 0.92% Linalool Coeur, between 6 and 8% Citral, between 6.5 and 8% gamma-terpinene, between 1.1 and 1.5% Alpha-Pinene (98%), between 4.1 and 5.2% Alpha-Terpineol, between 3.8 and 5% Terpinolene, between 1 and 1.25% Para-Cymene, between 1.6 and 2% Linalyl Acetate, between 1.7 and 2.1% Beta Pinene, between 0.08 and 0.1% Camphor Dextro, between 0.07 and 0.09% Terpinene 4 OL, between 1.7 and 2.1% Alpha Terpinene, between 0.8 and 1.0% Borneol L, between 0.3 and 0.45% Camphene, between 0.10 and 0.14% Decanal, between 0.09 and 0.11% Dodecanal, between 0.005 and 0.015% Fenchol Alpha, between 0.1 and 0.14% Geranyl Acetate, between 0.2 and 0.35% Isoborneol, between 0.24 and 0.28% 2-Methyl 1,3-cyclohexadiene, between 0.7 and 0.85% Myrcene, between 0.015 and 0.025% Nonanal, between 0.03 and 0.05% Octanal, and between 0.015 and 0.025% Tocopherol Gamma Tenox.

In some embodiments, the blend of compounds can include 12.94% LFO, 42.2% D-Limonene, 9.58% Thyme Oil White, 0.84% Linalool Coeur, 7.02% Citral, 7.23% gamma-terpinene, 1.33% Alpha-Pinene (98%), 4.68% Alpha-Terpineol, 4.33% Terpinolene, 1.11% Para-Cymene, 1.79% Linalyl Acetate, 1.93% Beta Pinene, 0.09% Camphor Dextro, 0.08% Terpinene 4 OL, 1.93% Alpha Terpinene, 0.89% Borneol L, 0.37% Camphene, 0.12% Decanal, 0.10% Dodecanal, 0.01% Fenchol Alpha, 0.12% Geranyl Acetate, 0.28% Isoborneol, 0.26% 2-Methyl 1,3-cyclohexadiene, 0.78% Myrcene, 0.02% Nonanal, 0.04% Octanal, and 0.02% Tocopherol Gamma Tenox.

In some embodiments, the blend of compounds can include between 8.7 and 10.8% D-Limonene, between 7.7 and 9.4% Thyme Oil White, between 62 and 76% Lime Oil 410, between 1.4 and 1.9% Linalool Coeur, between 2 and 2.5% Tetrahydrolinalool, between 0.13 and 0.17% Vanillin, between 2.1 and 2.55% Isopropyl myristate, between 2.1 and 2.55% Piperonal (aldehyde), between 1.08 and 1.35% Geraniol 60, and between 2.1 and 2.55% Triethyl Citrate.

In some embodiments, the blend of compounds can include 9.70% D-Limonene, 8.54% Thyme Oil White, 69.41% Lime Oil 410, 1.66% Linalool Coeur, 2.29% Tetrahydrolinalool, 0.15% Vanillin, 2.35% Isopropyl myristate, 2.35% Piperonal (aldehyde), 1.21% Geraniol 60, and 2.35% Triethyl Citrate.

In some embodiments, the blend of compounds can include between 72 and 89% LFO and between 18 and 22% Black Seed Oil (BSO).

In some embodiments, the blend of compounds can include 80.09% LFO and 19.91% BSO.

In some embodiments, the blend of compounds can include between 45 and 56% LFO and between 45 and 55% BSO.

In some embodiments, the blend of compounds can include 50.13% LFO and 49.87% BSO.

In some embodiments, the blend of compounds can include between 4.1 and 5.2% Thyme Oil White, between 52 and 64% Wintergreen Oil, and between 33 and 42% Isopropyl myristate.

In some embodiments, the blend of compounds can include 4.60% Thyme Oil White, 57.80% Wintergreen Oil, and 37.60% Isopropyl myristate.

In some embodiments, the blend of compounds can include between 25 and 31% D-Limonene, between 4 and 5% Thyme Oil White, and between 60 and 72% Wintergreen Oil.

In some embodiments, the blend of compounds can include 28.24% D-Limonene, 4.44% Thyme Oil White, and 67.32% Wintergreen Oil.

In some embodiments, the blend of compounds can include between 8.9 and 11% D-Limonene, between 12.5 and 16% Linalool Coeur, between 21.5 and 27% Tetrehydrolinalool, between 2.2 and 2.7% Vanillin, between 25 and 32% Isopropyl myristate, between 9 and 11% Piperonal (aldehyde), and between 9 and 11.4% Geraniol 60.

In some embodiments, the blend of compounds can include 9.90% D-Limonene, 14.14% Linalool Coeur, 24.29% Tetrehydrolinalool, 2.48% Vanillin, 28.92% Isopropyl myristate, 9.97% Piperonal (aldehyde), and 10.30% Geraniol 60.

In some embodiments, the blend of compounds can include between 8.4 and 10.2% D-Limonene, between 29 and 35% Black Seed Oil, between 8.5 and 10.6% Linalool Coeur, between 10 and 12.8% Tetrahydrolinalool, between 1 and 1.35% Vanillin, between 12.5 and 15.5% Isopropyl myristate, between 4.2 and 5.3% Piperonal (aldehyde), between 5.7 and 6.9% Geraniol Fine FCC, and between 10.5 and 13% Methyl Salicylate 98% Nat.

In some embodiments, the blend of compounds can include 9.30% D-Limonene, 31.92% Black Seed Oil, 9.48% Linalool Coeur, 11.40% Tetrahydrolinalool, 1.16% Vanillin, 14.04% Isopropyl myristate, 4.68% Piperonal (aldehyde), 6.29% Geraniol Fine FCC, and 11.72% Methyl Salicylate 98% Nat.

In some embodiments, the blend of compounds can include between 8.7 and 10.4% D-Limonene, between 23 and 30% Black Seed Oil, between 8.9 and 10.8% Linalool Coeur, between 10.7 and 12.9% Tetrahydrolinalool, between 1.05 and 1.35% Vanillin, between 13.4 and 16.5% Mineral Oil White (USP), between 13 and 16% Isopropyl myristate, between 4.4 and 5.4% Piperonal (aldehyde), and between 5.9 and 7.2% Geraniol Fine FCC.

In some embodiments, the blend of compounds can include 9.63% D-Limonene, 26.66% BSO, 9.82% Linalool Coeur, 11.81% Tetrahydrolinalool, 1.20% Vanillin, 14.97% Mineral Oil White (USP), 14.54% Isopropyl myristate, 4.85% Piperonal (aldehyde), and 6.51% Geraniol Fine FCC.

In some embodiments, the blend of compounds can include between 47 and 58% BSO, between 8.7 and 10.5% Linalool Coeur, between 10 and 13% Tetrahydrolinalool, between 1.0 and 1.25% Vanillin, between 12.8 and 15.3% Isopropyl myristate, between 4.3 and 5.2% Piperonal (aldehyde), and between 5.7 and 7% Geraniol Fine FCC.

In some embodiments, the blend of compounds can include 52.28% BSO, 9.63% Linalool Coeur, 11.57% Tetrahydrolinalool, 1.12% Vanillin, 14.26% Isopropyl myristate, 4.75% Piperonal (aldehyde), and 6.38% Geraniol Fine FCC.

In some embodiments, the blend of compounds can include between 34 and 42.5% Thyme Oil White, between 22 and 27.5% Wintergreen Oil, between 1.0 and 1.22% Vanillin, and between 32 and 40% Isopropyl myristate.

In some embodiments, the blend of compounds can include 38.21% Thyme Oil White, 24.79% Wintergreen Oil, 1.11% Vanillin, and 35.89% Isopropyl myristate.

In some embodiments, the blend of compounds can include between 35 and 44% Thyme Oil White, between 22 and 27.2% Wintergreen Oil, and between 32 and 40% Isopropyl myristate.

In some embodiments, the blend of compounds can include 39.24% Thyme Oil White, 24.82% Wintergreen Oil, and 35.94% Isopropyl myristate.

In some embodiments, the blend of compounds can include between 35 and 44% Thyme Oil White, between 32 and 40% Isopropyl myristate, and between 22 and 27.2% Wintergreen Oil Technical.

In some embodiments, the blend of compounds can include 39.24% Thyme Oil White, 35.94% Isopropyl myristate, and 24.82% Wintergreen Oil Technical.

In some embodiments, the blend of compounds can include between 13.3 and 16.3% D-Limonene, between 2.6 and 3.2% Linalool Coeur, between 3.15 and 3.85% Tetrahydrolinalool, between 0.18 and 0.22% Vanillin, between 3.05 and 3.75% Isopropyl myristate, between 3.2 and 4.0% Piperonal (aldehyde), between 1.25 and 1.55% Piperonyl Alcohol, and between 63 and 78% Lime Oil Minus.

In some embodiments, the blend of compounds can include 14.8% D-Limonene, 2.9% Linalool Coeur, 3.5% Tetrahydrolinalool, 0.2% Vanillin, 3.4% Isopropyl myristate, 3.6% Piperonal (aldehyde), 1.4% Piperonyl Alcohol, and 70.2% Lime Oil Minus.

In some embodiments, the blend of compounds can include between 62 and 77% D-Limonene, between 2.6 and 3.2% Linalool Coeur, between 3.15 and 3.85% Tetrahydrolinalool, between 0.18 and 0.22% Vanillin, between 3.05 and 3.75% Isopropyl myristate, between 3.25 and 3.95% Piperonal (aldehyde), between 1.25 and 1.55% Piperonyl Alcohol, and between 13.5 and 16.7% Lime Oil Minus.

In some embodiments, the blend of compounds can include 69.8% D-Limonene, 2.9% Linalool Coeur, 3.5% Tetrahydrolinalool, 0.2% Vanillin, 3.4% Isopropyl myristate, 3.6% Piperonal (aldehyde), 1.4% Piperonyl Alcohol, and 15.2% Lime Oil Minus.

In some embodiments, the blend of compounds can include between 5.1 and 6.3% Linalool Coeur, between 6.2 and 7.6% Tetrahydrolinalool, between 0.36 and 0.44% Vanillin, between 6.1 and 7.5% Isopropyl myristate, between 6.4 and 7.9% Piperonal (aldehyde), between 2.6 and 3.2% Piperonyl Alcohol, and between 63 and 78% Lime Oil Minus.

In some embodiments, the blend of compounds can include 5.7% Linalool Coeur, 6.9% Tetrahydrolinalool, 0.4% Vanillin, 6.8% Isopropyl myristate, 7.1% Piperonal (aldehyde), 2.9% Piperonyl Alcohol, and 70.2% Lime Oil Minus.

In some embodiments, the blend of compounds can include between 37 and 45.5% LFO, between 25 and 31% D-Limonene, and between 27.5 and 34% Thyme Oil White.

In some embodiments, the blend of compounds can include 41.4% LFO, 27.9% D-Limonene, and 30.7% Thyme Oil White.

In some embodiments, the blend of compounds can include between 24 and 30% D-Limonene, between 27 and 33% Thyme Oil White, and between 38 and 47% Blend C-4003 (13.5% Linalool Coeur, 18.5% Tetradyrdolinalool, 1.2% Vanillin, 19.0% Isopropyl myristate, 19.0% Piperonal [aldehyde], 9.8% Geraniol 60, 19.1% Triethyl Citrate).

In some embodiments, the blend of compounds can include 27.35% D-Limonene, 30.08% Thyme Oil White, and 42.57% Blend C-4003 (13.5% Linalool Coeur, 18.5% Tetradyrdolinalool, 1.2% Vanillin, 19.0% Isopropyl myristate, 19.0% Piperonal [aldehyde], 9.8% Geraniol 60, 19.1% Triethyl Citrate).

In some embodiments, the blend of compounds can include between 24 and 31% D-Limonene, between 27 and 33% Thyme Oil White, between 5.1 and 6.3% Linalool Coeur, between 7.1 and 8.8% Tetrahydrolinalool, between 0.45 and 0.55% Vanillin, between 7.3 and 8.9% Isopropyl myristate, between 7.3 and 8.9% Piperonal (aldehyde), between 3.8 and 4.6% Geraniol 60, and between 7.3 and 8.9% Triethyl Citrate.

In some embodiments, the blend of compounds can include 27.4% D-Limonene, 30.1% Thyme Oil White, 5.7% Linalool Coeur, 7.9% Tetrahydrolinalool, 0.5% Vanillin, 8.1% Isopropyl myristate, 8.1% Piperonal (aldehyde), 4.2% Geraniol 60, and 8.1% Triethyl Citrate.

In some embodiments, the blend of compounds can include between 38 and 47% LFO, between 24 and 31% D-Limonene, between 27 and 33% Thyme Oil White.

In some embodiments, the blend of compounds can include 42.6% LFO, 27.35% D-Limonene, 30.08% Thyme Oil White.

In some embodiments, the blend of compounds can include between 3.6 and 4.45% D-Limonene, between 4 and 4.9% Thyme Oil White, between 15 and 18.4% Benzyl Alcohol, between 18 and 23.5% Isopar M, between 41 and 49% Water, between 5.7 and 7% C-4003 (13.5% Linalool Coeur, 18.5% Tetradyrdolinalool, 1.2% Vanillin, 19.0% Isopropyl myristate, 19.0% Piperonal [aldehyde], 9.8% Geraniol 60, and 19.1% Triethyl Citrate), and between 2.8.5 and 3.5% Solution S-3002 (Stock 10% SLS Solution; 10% Sodium Lauryl Sulfate, 90.00% Water).

In some embodiments, the blend of compounds can include 4.03% D-Limonene, 4.43% Thyme Oil White, 16.61% Benzyl Alcohol, 20.95% Isopar M, 44.53% Water, 6.27% C-4003 (13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate), and 3.18% Solution S-3002 (Stock 10% SLS Solution; 10% Sodium Lauryl Sulfate, 90.00% Water).

In some embodiments, the blend of compounds can include between 3.6 and 4.45% D-Limonene, 4.0 and 4.75% Thyme Oil White, between 0.76 and 0.92% Linalool Coeur, between 1.05 and 1.27% Tetrahydrolinalool, between 0.063 and 0.077% Vanillin, between 1.05 and 1.33% Isopropyl myristate, between 1.05 and 1.33% Piperonal (aldehyde), between 0.56 and 0.68% Geraniol 60, between 1.05 and 1.33% Triethyl Citrate, between 15 and 18% Benzyl Alcohol, between 18 and 24.2% Isopar M, between 40 and 49% Water, and between 2.85 and 3.5% Solution S-3002 (Stock 10% SLS Solution; 10% Sodium Lauryl Sulfate, 90.00% Water).

In some embodiments, the blend of compounds can include 4.03% D-Limonene, 4.43% Thyme Oil White, 0.84% Linalool Coeur, 1.16% Tetrahydrolinalool, 0.07% Vanillin, 1.19% Isopropyl myristate, 1.19% Piperonal (aldehyde), 0.62% Geraniol 60, 1.19% Triethyl Citrate, 16.61% Benzyl Alcohol, 20.95% Isopar M, 44.53% Water, and 3.18% Solution S-3002 (Stock 10% SLS Solution; 10% Sodium Lauryl Sulfate, 90.00% Water).

In some embodiments, the blend of compounds can include between 24 and 31% D-Limonene, between 27 and 33% Thyme Oil White, and between 38 and 47% Blend C-4003 (13.5% Linalool Coeur, 18.5% Tetradyrdolinalool, 1.2% Vanillin, 19.0% Isopropyl myristate, 19.0% Piperonal [aldehyde], 9.8% Geraniol 60, and 19.1% Triethyl Citrate).

In some embodiments, the blend of compounds can include 27.35% D-Limonene, 30.08% Thyme Oil White, and 42.57% Blend C-4003 (13.5% Linalool Coeur, 18.5% Tetradyrdolinalool, 1.2% Vanillin, 19.0% Isopropyl myristate, 19.0% Piperonal [aldehyde], 9.8% Geraniol 60, and 19.1% Triethyl Citrate).

In some embodiments, the blend of compounds can include between 24 and 31% D-Limonene, between 27 and 33% Thyme Oil White, between 5.2 and 6.4% Linalool Coeur, between 7 and 8.8% Tetrahydrolinalool, between 0.45 and 0.55% Vanillin, between 7.2 and 8.9% Isopropyl myristate, between 7.2 and 8.9% Piperonal (aldehyde), between 3.7 and 4.6% Geraniol 60, and between 7.3 and 9.0% Triethyl Citrate.

In some embodiments, the blend of compounds can include 27.35% D-Limonene, 30.08% Thyme Oil White, 5.73% Linalool Coeur, 7.88% Tetrahydrolinalool, 0.50% Vanillin, 8.08% Isopropyl myristate, 8.09% Piperonal (aldehyde), 4.18% Geraniol 60, and 8.11% Triethyl Citrate.

In some embodiments, the blend of compounds can include between 4 and 4.9% Lilac Flower Oil, between 7.6 and 9.1% D-Limonene, 2.9 and 3.65% Thyme Oil White, and between 9 and 11% Lime Oil Minus.

In some embodiments, the blend of compounds can include 4.4% Lilac Flower Oil, 82.3% D-Limonene, 3.3% Thyme Oil White, and 10.0% Lime Oil Minus.

In some embodiments, the blend of compounds can include between 11.7 and 14.2% Lilac Flower Oil, between 7.9 and 9.6% D-Limonene, between 8.7 and 10.6% Thyme Oil White, and between 61 and 76% Lime Oil Minus.

In some embodiments, the blend of compounds can include 12.94% Lilac Flower Oil, 8.72% D-Limonene, 9.58% Thyme Oil White, and 68.76% Lime Oil Minus.

In some embodiments, the blend of compounds can include between 8.8 and 10.8% D-Limonene, between 7.7 and 9.5% Thyme Oil White, between 1.53 and 1.87% Linalool Coeur, between 2.1 and 2.5% Tetrahydrolinalool, between 0.09 and 0.11% Vanillin, between 2.15 and 2.65% Piperonal (aldehyde), between 62 and 77% Lime Oil Minus, between 1.05 and 1.35% Geraniol 60, and between 2.15 and 2.55% Triethyl Citrate.

In some embodiments, the blend of compounds can include 9.8% D-Limonene, 8.6% Thyme Oil White, 1.7% Linalool Coeur, 2.3% Tetrahydrolinalool, 0.1% Vanillin, 2.4% Piperonal (aldehyde), 69.3% Lime Oil Minus, 1.2% Geraniol 60, and 2.4% Triethyl Citrate.

In some embodiments, the blend of compounds can include between 18 and 23% Thyme Oil White, between 40 and 50% Wintergreen Oil, and between 31 and 38% Isopropyl myristate.

In some embodiments, the blend of compounds can include 20.6% Thyme Oil White, 45.1% Wintergreen Oil, and 34.3% Isopropyl myristate.

In some embodiments, the blend of compounds can include between 19 and 24% Black Seed Oil, between 14 and 17.5% Linalool Coeur, between 17 and 21% Tetrahydrolinalool, between 1.7 and 2.1% Vanillin, between 21 and 26% Isopropyl myristate, between 7 and 8.6% Piperonal (aldehyde), and between 9.5 and 11.6% Geraniol Fine FCC.

In some embodiments, the blend of compounds can include 21.5% Black Seed Oil, 15.8% Linalool Coeur, 19.0% Tetrahydrolinalool, 1.9% Vanillin, 23.4% Isopropyl myristate, 7.8% Piperonal (aldehyde), and 10.5% Geraniol Fine FCC.

In some embodiments, the blend of compounds can include between 6 and 7.4% Linalool Coeur, between 22 and 26% Soy Bean Oil, between 33 and 41% Thymol (crystal), and between 3.3 and 4.2% Alpha-Pinene (98%).

In some embodiments, the blend of compounds can include 6.63% Linalool Coeur, 24.03% Soy Bean Oil, 37.17% Thymol (crystal), and 3.78% Alpha-Pinene (98%).

In some embodiments, the blend of compounds can include between 7.9 and 9.6% Linalool Coeur, between 43 and 53% Thymol (crystal), between 4.5 and 5.5% Alpha-Pinene (98%), and between 33 and 42% Para-Cymene.

In some embodiments, the blend of compounds can include 8.73% Linalool Coeur, 48.93% Thymol (crystal), 4.97% Alpha-Pinene (98%), and 37.37% Para-Cymene.

In some embodiments, the blend of compounds can include between 7.9 and 9.5% D-Limonene, between 8.6 and 10.5% Thyme Oil White, between 61 and 76% Lime Oil 410, between 2.3 and 2.9% Linalool Coeur, between 2.8 and 3.4% Tetrahydrolinalool, between 0.29 and 0.35% Vanillin, between 3.4 and 4.3% Isopropyl myristate, between 1.16 and 1.42% Piperonal (aldehyde), and between 1.5 and 1.9% Geraniol Fine FCC.

In some embodiments, the blend of compounds can include 8.72% D-Limonene, 9.58% Thyme Oil White, 68.76% Lime Oil 410, 2.61% Linalool Coeur, 3.13% Tetrahydrolinalool, 0.32% Vanillin, 3.86% Isopropyl myristate, 1.29% Piperonal (aldehyde), and 1.73% Geraniol Fine FCC.

In some embodiments, the blend of compounds can include between 25 and 31% D-Limonene, between 4 and 4.9% Thyme Oil White, and between 60 and 74% Methyl Salicylate (Synth.).

In some embodiments, the blend of compounds can include 28.24% D-Limonene, 4.44% Thyme Oil White, and 67.32% Methyl Salicylate (Synth.).

In some embodiments, the blend of compounds can include between 18 and 23% Thyme Oil White, between 31 and 37.8% Isopropyl Myristate, and between 40 and 50% Wintergreen Oil (Technical).

In some embodiments, the blend of compounds can include 20.6% Thyme Oil White, 34.3% Isopropyl Myristate, and 45.1% Wintergreen Oil (Technical).

In some embodiments, the blend of compounds can include between 49 and 60% Castor Oil hydrogenated (PEO40), between 20.7 and 25% Lemon Grass Oil (India), and between 20 and 24.6% Blend B-5006 (12.94% Lilac Flower Oil, 8.72% D-Limonene, 9.58% Thyme Oil White, 68.76% Lime Oil 410).

In some embodiments, the blend of compounds can include 54.63% Castor Oil hydrogenated—PEO40, 22.93% Lemon Grass Oil—India, and 22.44% Blend B-5006 (12.94% Lilac Flower Oil, 8.72% D-Limonene, 9.58% Thyme Oil White, 68.76% Lime Oil 410).

In some embodiments, the blend of compounds can include between 14.5 and 17.8% Lilac Flower Oil, between 60 and 75% D-Limonene, between 10 and 12.4% Thyme Oil White, and between 4.4 and 5.4% Black Seed Oil.

In some embodiments, the blend of compounds can include 16.18% Lilac Flower Oil, 67.81% D-Limonene, 11.18% Thyme Oil White, and 4.83% Black Seed Oil.

In some embodiments, the blend of compounds can include between 14.4 and 17.6% Lilac Flower Oil (LFO), between 60 and 75% D-Limonene, between 10.4 and 12.7% Thyme Oil White, and between 4.8 and 5.8% Black Seed Oil (BSO).

In some embodiments, the blend of compounds can include 16.01% LFO, 67.09% D-Limonene, 11.59% Thyme Oil White, 5.31% BSO.

In some embodiments, the blend of compounds can include between 8 and 9.6% D-Limonene, between 8.8 and 10.6% Thyme Oil White, between 50 and 60% Lime Oil 410, between 1.5 and 1.85% Linalool Coeur, between 2.1 and 2.5% Tetrahydrolinalool, between 0.135 and 0.165% Vanillin, between 2.1 and 2.5% Isopropyl myristate, between 2.1 and 2.6% Piperonal (aldehyde), between 1.1 and 1.35% Geraniol 60, between 2.1 and 2.6% Triethyl Citrate, and between 12.5 and 15.3% Isopar M.

In some embodiments, the blend of compounds can include 8.83% D-Limonene, 9.71% Thyme Oil White, 55.17% Lime Oil 410, 1.68% Linalool Coeur, 2.31% Tetrahydrolinalool, 0.15% Vanillin, 2.37% Isopropyl myristate, 2.37% Piperonal (aldehyde), 1.23% Geraniol 60, 2.38% Triethyl Citrate, and 13.80% Isopar M.

In some embodiments, the blend of compounds can include between 7.9 and 9.5% D-Limonene, between 8.6 and 10.5% Thyme Oil White, between 62 and 76% Lime Oil 410, between 1.5 and 1.82% Linalool Coeur, between 2 and 2.5% Tetrahydrolinalool, between 0.14 and 0.16% Vanillin, between 2.1 and 2.6% Isopropyl myristate, between 2.1 and 2.6% Piperonal (aldehyde), between 1.1 and 1.32% Geraniol 60, and between 2.1 and 2.6% Triethyl Citrate.

In some embodiments, the blend of compounds can include 8.72% D-Limonene, 9.59% Thyme Oil White, 69.35% Lime Oil 410, 1.66% Linalool Coeur, 2.28% Tetrahydrolinalool, 0.15% Vanillin, 2.34% Isopropyl myristate, 2.34% Piperonal (aldehyde), 1.21% Geraniol 60, and 2.35% Triethyl Citrate.

In some embodiments, the blend of compounds can include between 14.7 and 18% LFO, between 61 and 76% D-Limonene, between 4.8 and 5.9% Thyme Oil White, and between 9 and 11% Lime Oil 410.

In some embodiments, the blend of compounds can include 16.31% LFO, 68.34% D-Limonene, 5.37% Thyme Oil White, and 9.98% Lime Oil 410.

In some embodiments, the blend of compounds can include between 4.2 and 5.2% Linalool Coeur, between 36 and 45% Thymol (crystal), between 1.7 and 2.1% Alpha-Pinene (98%), between 31 and 38% Para-Cymene, and between 16 and 20% Trans-anethole.

In some embodiments, the blend of compounds can include 4.7% Linalool Coeur, 40.8% Thymol (crystal), 1.9% Alpha-Pinene (98%), 34.49% Para-Cymene, and 18.2% Trans-anethole.

In some embodiments, the blend of compounds can include between 6 and 7.4% Linalool Coeur, between 21.5 and 26.5% Soy Bean Oil, between 33 and 41% Thymol (crystal), between 3.4 and 4.2% Alpha-Pinene (98%), and between 25 and 31% Para-Cymene.

In some embodiments, the blend of compounds can include 6.6% Linalool Coeur, 24.0% Soy Bean Oil, 37.2% Thymol (crystal), 3.8% Alpha-Pinene (98%), and 28.39% Para-Cymene.

In some embodiments, the blend of compounds can include between 36 and 45% Linalool Coeur, between 31 and 37.5% Thymol (crystal), between 4.2 and 5.2% Alpha-Pinene (98%), between 1.7 and 2.1% Para-Cymene, and between 16.5 and 20% Trans-anethole.

In some embodiments, the blend of compounds can include 40.8% Linalool Coeur, 34.4% Thymol (crystal), 4.7% Alpha-Pinene (98%), 1.9% Para-Cymene, and 18.20% Trans-anethole.

In some embodiments, the blend of compounds can include between 8.5 and 10.5% Linalool Coeur, between 42 and 53% Thymol (crystal), between 8.5 and 10.4% Alpha-Pinene (98%), and between 30 and 36.5% Para-Cymene.

In some embodiments, the blend of compounds can include 9.49% Linalool Coeur, 47.87% Thymol (crystal), 9.46% Alpha-Pinene (98%), and 33.18% Para-Cymene.

In some embodiments, the blend of compounds can include between 18 and 22.3% Linalool Coeur, between 22 and 27% Tetrahydrolinalool, between 2.2 and 2.7% Vanillin, between 26 and 33% Isopropyl myristate, between 9 and 11% Piperonal (aldehyde), and between 12 and 14.6% Geraniol Fine FCC.

In some embodiments, the blend of compounds can include 20.15% Linalool Coeur, 24.23% Tetrahydrolinalool, 2.47% Vanillin, 29.84% Isopropyl myristate, 9.95% Piperonal (aldehyde), and 13.36% Geraniol Fine FCC.

In some embodiments, the blend of compounds can include between 20 and 26% Tetrahydrolinalool, between 1.0 and 1.4% Vanillin, between 4 and 4.9% Hercolyn D, between 13.5 and 16.6% Isopropyl myristate, between 6.8 and 8.3% Piperonal (aldehyde), between 20 and 25.2% Ethyl Linalool, between 6 and 7.3% Hedione, between 9 and 11.2% Triethyl Citrate, and between 8.1 and 10% Dipropylene glycol (DPG).

In some embodiments, the blend of compounds can include 22.98% Tetrahydrolinalool, 1.17% Vanillin, 4.44% Hercolyn D, 15.10% Isopropyl myristate, 7.55% Piperonal (aldehyde), 22.91% Ethyl Linalool, 6.67% Hedione, 10.10% Triethyl Citrate, and 9.09% Dipropylene glycol (DPG).

In some embodiments, the blend of compounds can include between 12.2 and 14.8% Linalool Coeur, between 16.9 and 20.1% Tetradyrdolinalool, 1.08 and 1.32% Vanillin, between 17 and 21% Isopropyl myristate, between 17 and 21% Piperonal (aldehyde), between 8.8 and 10.8% Geraniol 60, and between 17 and 21% Triethyl Citrate.

In some embodiments, the blend of compounds can include 13.5% Linalool Coeur, 18.5% Tetradyrdolinalool, 1.2% Vanillin, 19.0% Isopropyl myristate, 19.0% Piperonal (aldehyde), 9.8% Geraniol 60, and 19.1% Triethyl Citrate.

In some embodiments, the blend of compounds can include between 17 and 21% Linalool Coeur, between 21 and 25.5% Tetrahydrolinalool, between 1.08 and 1.32% Vanillin, between 20.6 and 25.2% Isopropyl myristate, between 21 and 26% Piperonal (aldehyde), and between 8.6 and 10.5% Piperonyl Alcohol.

In some embodiments, the blend of compounds can include 19.2% Linalool Coeur, 23.2% Tetrahydrolinalool, 1.2% Vanillin, 22.9% Isopropyl myristate, 23.8% Piperonal (aldehyde), and 9.6% Piperonyl Alcohol.

In some embodiments, the blend of compounds can include between 43 and 54% D-Limonene, between 1.1 and 1.34% Linalool Coeur, between 9.2 and 11.3% Citral, between 9.4 and 11.6% gamma-terpinene, between 1.7 and 2.13% Alpha-Pinene (98%), between 6.1 and 7.5% Alpha-Terpineol, between 5.6 and 7.0% Terpinolene, between 1.45 and 1.76% Para-Cymene, between 2.34 and 2.86% Linalyl Acetate, between 2.5 and 3.1% Beta Pinene, between 0.12 and 0.14% Camphor Dextro, between 0.1 and 0.12% Terpinene 4 OL, between 2.5 and 3.1% Alpha Terpinene, between 1.17 and 1.43% Borneol L, between 0.49 and 0.61% Camphene, between 0.155 and 0.185% Decanal, between 0.13 and 0.15% Dodecanal, between 0.009 and 0.011% Fenchol Alpha, between 0.16 and 0.20% Geranyl Acetate, between 0.37 and 0.45% Isoborneol, between 0.34 and 0.42% 2-Methyl 1,3-cyclohexadiene, between 1.03 and 1.25% Myrcene, between 0.027 and 0.033% Nonanal, between 0.054 and 0.066% Octanal, and between 0.027 and 0.033% Tocopherol Gamma Tenox.

In some embodiments, the blend of compounds can include 48.58% D-Limonene, 1.22% Linalool Coeur, 10.21% Citral, 10.51% gamma-terpinene, 1.94% Alpha-Pinene (98%), 6.80% Alpha-Terpineol, 6.30% Terpinolene, 1.61% Para-Cymene, 2.60% Linalyl Acetate, 2.80% Beta Pinene, 0.13% Camphor Dextro, 0.11% Terpinene 4 OL, 2.80% Alpha Terpinene, 1.30% Borneol L, 0.54% Camphene, 0.17% Decanal, 0.14% Dodecanal, 0.01% Fenchol Alpha, 0.18% Geranyl Acetate, 0.41% Isoborneol, 0.38% 2-Methyl 1,3-cyclohexadiene, 1.14% Myrcene, 0.03% Nonanal, 0.06% Octanal, and 0.03% Tocopherol Gamma Tenox.

In some embodiments, the blend of compounds can include between 52 and 65% D-Limonene, between 1.3 and 1.61% Linalool Coeur, between 11.4 and 13.9% gamma-terpinene, between 2.1 and 2.6% Alpha-Pinene (98%), between 6.8 and 8.5% Terpinolene, between 1.7 and 2.2% Para-Cymene, between 2.8 and 2.45% Linalyl Acetate, between 3 and 3.7% Beta Pinene, between 0.145 and 0.176% Camphor Dextro, between 0.12 and 0.14% Terpinene 4 OL, between 3 and 3.7% Alpha Terpinene, between 1.42 and 1.72% Borneol L, between 0.59 and 0.71% Camphene, between 0.18 and 0.22% Decanal, between 0.155 and 0.185% Dodecanal, between 0.009 and 0.011% Fenchol Alpha, 0.2 and 0.24% Geranyl Acetate, between 0.44 and 0.54% Isoborneol, between 0.42 and 0.5% 2-Methyl 1,3-cyclohexadiene, between 1.24 and 1.5% Myrcene, between 0.036 and 0.044% Nonanal, between 0.06 and 0.08% Octanal, and between 0.036 and 0.044% Tocopherol Gamma Tenox.

In some embodiments, the blend of compounds can include 58.54% D-Limonene, 1.47% Linalool Coeur, 12.66% gamma-terpinene, 2.34% Alpha-Pinene (98%), 7.59% Terpinolene, 1.94% Para-Cymene, 3.13% Linalyl Acetate, 3.37% Beta Pinene, 0.16% Camphor Dextro, 0.13% Terpinene 4 OL, 3.37% Alpha Terpinene, 1.57% Borneol L, 0.65% Camphene, 0.20% Decanal, 0.17% Dodecanal, 0.01% Fenchol Alpha, 0.22% Geranyl Acetate, 0.49% Isoborneol, 0.46% 2-Methyl 1,3-cyclohexadiene, 1.37% Myrcene, 0.04% Nonanal, 0.07% Octanal, and 0.04% Tocopherol Gamma Tenox.

In some embodiments, the blend of compounds can include between 31 and 38% D-Limonene, between 9 and 11.1% Linalool Coeur, between 4.5 and 5.5% Alpha-Pinene (98%), between 9 and 11.2% Terpinolene, between 9 and 11.1% Para-Cymene, between 2.8 and 5.9% Linalyl Acetate, between 4.5 and 5.8% Beta Pinene, between 4.3 and 5.4% Alpha Terpinene, between 5.2 and 6.4% Camphene, and between 8.3 and 10.2% Myrcene.

In some embodiments, the blend of compounds can include 34.50% D-Limonene, 10.05% Linalool Coeur, 5.01% Alpha-Pinene (98%), 10.10% Terpinolene, 10.04% Para-Cymene, 5.30% Linalyl Acetate, 5.02% Beta Pinene, 4.88% Alpha Terpinene, 5.84% Camphene, and 9.26% Myrcene.

In some embodiments, the blend of compounds can include between 81 and 99% B-5028 (20.6% Thyme Oil White, 45.1% Wintergreen Oil, and 34.3% Isopropyl myristate) and between 9 and 11% Solution S-3002 (Stock 10% SLS Solution; 10% Sodium Lauryl Sulfate, 90.00% Water).

In some embodiments, the blend of compounds can include 90% B-5028 (20.6% Thyme Oil White, 45.1% Wintergreen Oil, and 34.3% Isopropyl myristate) and 10% Solution S-3002 (Stock 10% SLS Solution; 10% Sodium Lauryl Sulfate, 90.00% Water).

In some embodiments, the blend of compounds can include between 0.8 and 1.0% Polyglycerol-4-oleate, between 0.18 and 0.22% Lecithin, between 8.8 and 10.8% Water, and between 80 and 98% Blend B-5028 (20.6% Thyme Oil White, 45.1% Wintergreen Oil, 34.3% Isopropyl myristate).

In some embodiments, the blend of compounds can include 0.90% Polyglycerol-4-oleate, 0.20% Lecithin, 9.8% Water, and 89.1% Blend B-5028 (20.6% Thyme Oil White, 45.1% Wintergreen Oil, 34.3% Isopropyl myristate).

In some embodiments, the blend of compounds can include between 0.9 and 1.1% Potassium sorbate, between 0.25 and 0.31% Xanthan Gum, between 73 and 89% Water, and between 15.3 and 18.4% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]).

In some embodiments, the blend of compounds can include 1.00% Potassium sorbate, 0.28% Xanthan Gum, 81.82% Water, and 16.90% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]).

In some embodiments, the blend of compounds can include between 0.10 and 0.12% Potassium sorbate, between 0.135 and 0.165% Polyglycerol-4-oleate, between 0.25 and 0.31% Xanthan Gum, between 0.030 and 0.038% Lecithin, between 76 and 92% Water, and between 13.5 and 16.5% Blend B-5028 (20.6% Thyme Oil White, 45.1% Wintergreen Oil, 34.3% Isopropyl myristate).

In some embodiments, the blend of compounds can include 0.11% Potassium sorbate, 0.15% Polyglycerol-4-oleate, 0.28% Xanthan Gum, 0.034% Lecithin, 84.4% Water, and 15% Blend B-5028 (20.6% Thyme Oil White, 45.1% Wintergreen Oil, 34.3% Isopropyl myristate).

In some embodiments, the blend of compounds can include between 2.7 and 3.4% Thyme Oil White, between 6 and 7.5% Wintergreen Oil, between 4.5 and 5.7% Isopropyl myristate, between 0.1 and 0.12% Potassium sorbate, between 0.135 and 0.165% Polyglycerol-4-oleate, between 0.25 and 0.31% Xanthan Gum, between 0.027 and 0.033% Lecithin, and between 76 and 91% Water.

In some embodiments, the blend of compounds can include 3.09% Thyme Oil White, 6.77% Wintergreen Oil, 5.15% Isopropyl myristate, 0.11% Potassium sorbate, 0.15% Polyglycerol-4-oleate, 0.28% Xanthan Gum, 0.03% Lecithin, and 84.41% Water.

In some embodiments, the blend of compounds can include between 0.8 and 1.0% Polyglycerol-4-oleate, between 0.18 and 0.22% Lecithin, between 9 and 11% Water, and between 80 and 98% Blend B-5016 (39.24% Thyme Oil White, 24.82% Wintergreen Oil, 35.94% Isopropyl myristate).

In some embodiments, the blend of compounds can include 0.90% Polyglycerol-4-oleate, 0.20% Lecithin, 9.8% Water, and 89.10% Blend B-5016 (39.24% Thyme Oil White, 24.82% Wintergreen Oil, 35.94% Isopropyl myristate).

In some embodiments, the blend of compounds can include between 2.7 and 3.4% Water, between 76 and 92% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]), and between 11.5 and 14% Solution S-3001 (Stock 2.5% Xanthan-1% K sorbate; 1% Potassium Sorbate, 2.50% Xanthan Gum, 96.50% Water).

In some embodiments, the blend of compounds can include 3.1% Water, 84.2% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]), and 12.7% Solution S-3001 (Stock 2.5% Xanthan-1% K sorbate; 1% Potassium Sorbate, 2.50% Xanthan Gum, 96.50% Water).

In some embodiments, the blend of compounds can include between 14 and 17% Thyme Oil White, between 30 and 37% Wintergreen Oil, between 23 and 27.5% Isopropyl myristate, between 0.115 and 0.145% Potassium sorbate, between 0.7 and 0.83% Polyglycerol-4-oleate, between 0.29 and 0.36% Xanthan Gum, between 0.15 and 0.19% Lecithin, and between 21 and 26% Water.

In some embodiments, the blend of compounds can include 15.5% Thyme Oil White, 33.8% Wintergreen Oil, 25.7% Isopropyl myristate, 0.13% Potassium sorbate, 0.76% Polyglycerol-4-oleate, 0.32% Xanthan Gum, 0.17% Lecithin, and 23.6% Water.

In some embodiments, the blend of compounds can include between 9.2% Water, between 70 and 88% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]), and between 10.5 and 13.2% Solution S-3001 (Stock 2.5% Xanthan-1% K sorbate; 1% Potassium Sorbate, 2.50% Xanthan Gum, 96.50% Water).

In some embodiments, the blend of compounds can include 9.2% Water, 78.87% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]), and 11.90% Solution S-3001 (Stock 2.5% Xanthan-1% K sorbate; 1% Potassium Sorbate, 2.50% Xanthan Gum, 96.50% Water).

In some embodiments, the blend of compounds can include between 0.11 and 0.15% Potassium sorbate, between 0.7 and 0.84% Polyglycerol-4-oleate, between 0.29 and 0.36% Xanthan gum, between 0.15 and 0.19% Lecithin, between 25 and 32% Water, and between 63 and 77% Blend B-5028 (20.6% Thyme Oil White, 45.1% Wintergreen Oil, 34.3% Isopropyl myristate).

In some embodiments, the blend of compounds can include 0.13% Potassium sorbate, 0.76% Polyglycerol-4-oleate, 0.32% Xanthan gum, 0.17% Lecithin, 28.6% Water, and 70% Blend B-5028 (20.6% Thyme Oil White, 45.1% Wintergreen Oil, 34.3% Isopropyl myristate).

In some embodiments, the blend of compounds can include between 2.8 and 3.4% Water, between 76 and 92% Blend F-4003 (0.90% Polyglycerol-4-oleate, 0.20% Lecithin, 9.8% Water, 89.10% Blend B-5016 [39.24% Thyme Oil White, 24.82% Wintergreen Oil, 35.94% Isopropyl Myristate]), and between 11.5 and 14% Solution S-3001 (Stock 2.5% Xanthan-1% K sorbate; 1% Potassium Sorbate, 2.50% Xanthan Gum, 96.50% Water).

In some embodiments, the blend of compounds can include 3.1% Water, 84.2% Cationic formulation-Hi residual (F-4003; 0.90% Polyglycerol-4-oleate, 0.20% Lecithin, 9.8% Water, 89.10% Blend B-5016 [39.24% Thyme Oil White, 24.82% Wintergreen Oil, 35.94% Isopropyl Myristate]), and 12.7% Solution S-3001 (Stock 2.5% Xanthan-1% K sorbate; 1% Potassium Sorbate, 2.50% Xanthan Gum, 96.50% Water).

In some embodiments, the blend of compounds can include between 0.9 and 1.1% Potassium sorbate, between 0.25 and 0.31% Xanthan gum, between 73 and 90% Water, and between 15.3 and 18.5% Blend F-4003 (0.90% Polyglycerol-4-oleate, 0.20% Lecithin, 9.8% Water, 89.10% Blend B-5016 [39.24% Thyme Oil White, 24.82% Wintergreen Oil, 35.94% Isopropyl Myristate]).

In some embodiments, the blend of compounds can include 1% Potassium sorbate, 0.28% Xanthan gum, 81.8% Water, and 16.9% Blend F-4003 (0.90% Polyglycerol-4-oleate, 0.20% Lecithin, 9.8% Water, 89.10% Blend B-5016 [39.24% Thyme Oil White, 24.82% Wintergreen Oil, 35.94% Isopropyl Myristate]).

In some embodiments, the blend of compounds can include between 0.8 and 1.0% Polyglycerol-4-oleate, between 0.18 and 0.22% Lecithin, between 8.9 and 11% Water, and between 80 and 98% Blend B-5034 (20.6% Thyme Oil White, 34.3% Isopropyl Myristate, 45.1% Wintergreen Oil Technical).

In some embodiments, the blend of compounds can include 0.90% Polyglycerol-4-oleate, 0.20% Lecithin, 9.8% Water, and 89.10% Blend B-5034 (20.6% Thyme Oil White, 34.3% Isopropyl Myristate, 45.1% Wintergreen Oil Technical).

In some embodiments, the blend of compounds can include between 0.9 and 1.1% Potassium sorbate, between 0.25 and 0.31% Xanthan gum, between 73 and 90% Water, and between 15.3 and 17.5% Formulation F-4009 (0.90% Polyglycerol-4-oleate, 0.20% Lecithin, 9.8% Water, 89.10% Blend B-5034 [24B-4-a for Institutions with Methyl Sal; 20.6% Thyme Oil White, 34.3% Isopropyl Myristate, 45.1% Wintergreen Oil Technical]).

In some embodiments, the blend of compounds can include 1.00% Potassium sorbate, 0.28% Xanthan gum, 81.82% Water, and 16.9% Formulation F-4009 (0.90% Polyglycerol-4-oleate, 0.20% Lecithin, 9.8% Water, 89.10% Blend B-5034 [24B-4-a for Institutions with Methyl Sal; 20.6% Thyme Oil White, 34.3% Isopropyl Myristate, 45.1% Wintergreen Oil Technical]).

In some embodiments, the blend of compounds can include between 0.18 and 0.22% Citronella Oil, between 0.18 and 0.22% Carbopol 940, between 0.9 and 0.11% BHT, between 54 and 66% Water, between 12.5 and 16% Emulsifying Wax, between 3.6 and 4.4% Light liquid paraffin, between 8.1 and 9.9% White Soft Paraffin, between 0.22 and 0.28% Sodium metabisulfate, between 1.8 and 2.2% Propylene glycol, between 0.13 and 0.17% Methyl parabin, between 0.045 and 0.055% Propyl parabin, between 4.5 and 5.5% Cresmer RH40 hydrogenated, between 0.13 and 0.17% Triethanolamine, between 0.018 and 0.022% Vitamin E acetate, between 0.045 and 0.055% Disodium EDTA, and between 4.5 and 5.5% Blend B-5006 (12.94% Lilac Flower Oil, 8.72% D-Limonene, 9.58% Thyme Oil White, 68.76% Lime Oil 410).

In some embodiments, the blend of compounds can include 0.20% Citronella Oil, 0.20% Carbopol 940, 0.10% BHT, 59.83% Water, 14.00% Emulsifying Wax, 4.00% Light liquid paraffin, 9.00% White Soft Paraffin, 0.25% Sodium metabisulfate, 2.00% Propylene glycol, 0.15% Methyl parabin, 0.05% Propyl parabin, 5.00% Cresmer RH40 hydrogenated, 0.15% Triethanolamine, 0.02% Vitamin E acetate, 0.05% Disodium EDTA, and 5.00% Blend B-5006 (12.94% Lilac Flower Oil, 8.72% D-Limonene, 9.58% Thyme Oil White, 68.76% Lime Oil 410).

In some embodiments, the blend of compounds can include between 0.045 and 0.055% Span 80, between 0.18 and 0.22% Sodium benzoate, between 26 and 32% Isopar M, between 13 and 16% A46 Propellant, between 38 and 46% Water, between 1.3 and 1.7% Isopropyl alcohol, and between 11.2 and 13.7% Blend B-5005 (56.30% D-Limonene, 12.38% Thyme Oil White, 31.32% Wintergreen Oil).

In some embodiments, the blend of compounds can include 0.05% Span 80, 0.20% Sodium benzoate, 29% Isopar M, 14.5% A46 Propellant, 42.25% Water, 1.50% Isopropyl alcohol, and 12.5% Blend B-5005 (56.30% D-Limonene, 12.38% Thyme Oil White, 31.32% Wintergreen Oil).

In some embodiments, the blend of compounds can include between 46 and 56% Isopar M, between 36 and 44% A46 propellant, between 2.7 and 3.3% Isopropyl alcohol, and between 5.4 and 6.6% B-5024 (TT-7; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include 51.0% Isopar M, 40.0% A46 propellant, 3.0% Isopropyl alcohol, and 6.0% B-5024 (TT-7; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include between 46 and 56% Isopar M, between 36 and 44% A46 propellant, between 0.045 and 0.055% Bifenthrin, between 2.7 and 3.3% Isopropyl alcohol, and between 5.4 and 6.6% Blend B-5024 (TT-7; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include 51.0% Isopar M, 40.0% A46 propellant, 0.05% Bifenthrin, 3.0% Isopropyl alcohol, and 6.0% Blend B-5024 (TT-7; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include between 49 and 60% Isopar M, between 36 and 44% A46 propellant, and between 5.4 and 6.6% Blend B-5021 (HL1; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include 54.0% Isopar M, 40.0% A46 propellant, and 6.0% Blend B-5021 (HL1; 27.35% D-Limonene, 30.08% Thyme Oil White, 42.57% Blend C-4003 [13.5% Linalool Coeur, 18.5% Tetradyrdolinalool, 1.2% Vanillin, 19.0% Isopropyl myristate, 19.0% Piperonal (aldehyde), 9.8% Geraniol 60, 19.1% Triethyl Citrate]).

In some embodiments, the blend of compounds can include between 1.8 and 2.3% Thyme Oil White, between 4 and 5% Wintergreen Oil, between 3.1 and 3.75% Isopropyl myristate, between 0.10 and 0.12% Potassium Sorbate, between 0.135 and 0.165% Polyclycerol-4-oleate, between 0.25 and 0.31% Xanthan Gum, between 0.027 and 0.033% Lecithin, and between 80 and 98% Water.

In some embodiments, the blend of compounds can include 2.06% Thyme Oil White, 4.51% Wintergreen Oil, 3.43% Isopropyl myristate, 0.11% Potassium Sorbate, 0.15% Polyclycerol-4-oleate, 0.28% Xanthan Gum, 0.03% Lecithin, and 89.42% Water.

In some embodiments, the blend of compounds can include between 0.9 and 1.15% Thyme Oil White, between 2 and 2.5% Wintergreen Oil, between 1.55 and 1.89% Isopropyl myristate, between 0.1 and 0.12% Potassium Sorbate, between 0.13 and 0.17% Polyglycerol-4-oleate, between 0.25 and 0.31% Xanthan Gum, between 0.027 and 0.033% Lecithin, and between 85 and 100% Water.

In some embodiments, the blend of compounds can include 1.03% Thyme Oil White, 2.26% Wintergreen Oil, 1.72% Isopropyl myristate, 0.11% Potassium Sorbate, 0.15% Polyglycerol-4-oleate, 0.28% Xanthan Gum, 0.03% Lecithin, and 94.43% Water.

In some embodiments, the blend of compounds can include between 0.18 and 0.22% Soya Lecithin, between 0.8 and 1.0% Polyglycerol-4-oleate, between 8.8 and 10.8% Water, and between 80 and 98% Blend B-5016 (39.24% Thyme Oil White, 24.82% Wintergreen Oil, 35.94% Isopropyl Myristate).

In some embodiments, the blend of compounds can include 0.20% Soya Lecithin, 0.90% Polyglycerol-4-oleate, 9.80% Water, and 89.10% Blend B-5016 (39.24% Thyme Oil White, 24.82% Wintergreen Oil, 35.94% Isopropyl Myristate).

In some embodiments, the blend of compounds can include between 32 and 38% Thyme Oil White, between 29 and 35% Isopropyl myristate, between 0.18 and 0.22% Soya Lecithin, between 0.8 and 1.0% Polyglycerol-4-oleate, between 8.8 and 10.8% Water, and between 20 and 24% Wintergreen Oil Technical.

In some embodiments, the blend of compounds can include 35.0% Thyme Oil White, 32.0% Isopropyl myristate, 0.20% Soya Lecithin, 0.90% Polyglycerol-4-oleate, 9.80% Water, and 22.1% Wintergreen Oil Technical.

In some embodiments, the blend of compounds can include between 0.09 and 0.11% Soya Lecithin, between 0.8 and 1.0% Polyglycerol-4-oleate, between 8.9 and 10.9% Water, and between 80 and 98% Blend B-5004 (20.50% Thyme Oil White, 45.00% Wintergreen Oil, 1.10% Vanillin, 33.40% Isopropyl myristate).

In some embodiments, the blend of compounds can include 0.10% Soya Lecithin, 0.90% Polyglycerol-4-oleate, 9.90% Water, and 89.1% Blend B-5004 (20.50% Thyme Oil White, 45.00% Wintergreen Oil, 1.10% Vanillin, 33.40% Isopropyl myristate).

In some embodiments, the blend of compounds can include between 16 and 20.5% Thyme Oil White, between 36 and 44% Wintergreen Oil, between 0.89 and 1.08% Vanillin, between 26.5 and 33% Isopropyl myristate, between 0.09 and 0.11% Soya Lecithin, between 0.8 and 1.0% Polyglycerol-4-oleate, and between 8.9 and 10.9% Water.

In some embodiments, the blend of compounds can include 18.27% Thyme Oil White, 40.10% Wintergreen Oil, 0.98% Vanillin, 29.76% Isopropyl myristate, 0.10% Soya Lecithin, 0.90% Polyglycerol-4-oleate, and 9.90% Water.

In some embodiments, the blend of compounds can include between 1.7 and 2.1% Polyglycerol-4-oleate, between 8 and 10% Water, and between 80 and 98% Blend B-5016 (39.24% Thyme Oil White, 24.82% Wintergreen Oil, 35.94% Isopropyl Myristate).

In some embodiments, the blend of compounds can include 1.90% Polyglycerol-4-oleate, 9.00% Water, and 89.10% Blend B-5016 (39.24% Thyme Oil White, 24.82% Wintergreen Oil, 35.94% Isopropyl Myristate).

In some embodiments, the blend of compounds can include between 31.5 and 38.5% Thyme Oil White, between 29 and 35% Isopropyl myristate, between 1.7 and 2.1% Polyglycerol-4-oleate, between 8 and 10% Water, and between 20 and 24% Wintergreen Oil (Technical).

In some embodiments, the blend of compounds can include 35.0% Thyme Oil White, 32.0% Isopropyl myristate, 1.90% Polyglycerol-4-oleate, 9.00% Water, and 22.1% Wintergreen Oil (Technical).

In some embodiments, the blend of compounds can include between 0.10 and 0.12% Potassium Sorbate, between 1.7 and 2.1% Polyglycerol-4-oleate, between 0.24 and 0.31% Xanthan Gum, between 78 and 94% Water, and between 10 and 12.5% Blend P-1010 (0.10% Soya Lecithin, 0.90% Polyglycerol-4-oleate, 9.90% Water, 89.1% Blend B-5004 [20.50% Thyme Oil White, 45.00% Wintergreen Oil, 1.10% Vanillin, 33.40% Isopropyl myristate]).

In some embodiments, the blend of compounds can include 0.11% Potassium Sorbate, 1.90% Polyglycerol-4-oleate, 0.275% Xanthan Gum, 86.410% Water, and 11.30% Blend P-1010 (0.10% Soya Lecithin, 0.90% Polyglycerol-4-oleate, 9.90% Water, 89.1% Blend B-5004 [20.50% Thyme Oil White, 45.00% Wintergreen Oil, 1.10% Vanillin, 33.40% Isopropyl myristate]).

In some embodiments, the blend of compounds can include between 5.0 and 6.3% D-Limonene, between 1.1 and 1.4% Thyme Oil White, between 0.010 and 0.012% Soya Lecithin, between 0.1 and 0.12% Potassium Sorbate, between 1.8 and 2.2% Polyglycerol-4-oleate, between 0.24 and 0.31% Xanthan Gum, between 79 and 96.5% Water, and between 2.8 and 3.45% Wintergreen Oil (Technical).

In some embodiments, the blend of compounds can include 5.67% D-Limonene, 1.25% Thyme Oil White, 0.011% Soya Lecithin, 0.11% Potassium Sorbate, 2.002% Polyglycerol-4-oleate, 0.275% Xanthan Gum, 87.529% Water, and 3.15% Wintergreen Oil (Technical).

In some embodiments, the blend of compounds can include between 0.1 and 0.12% Potassium Sorbate, between 0.24 and 0.31% Xanthan Gum, between 80 and 97% Water, and between 10 and 12.6% Blend P-1000 (0.20% Soya Lecithin, 0.90% Polyglycerol-4-oleate, 9.80% Water, 89.10% Blend B-5016 [39.24% Thyme Oil White, 24.82% Wintergreen Oil, 35.94% Isopropyl Myristate]).

In some embodiments, the blend of compounds can include 0.11% Potassium Sorbate, 0.275% Xanthan Gum, 88.315% Water, and 11.30% Blend P-1000 (0.20% Soya Lecithin, 0.90% Polyglycerol-4-oleate, 9.80% Water, 89.10% Blend B-5016 [39.24% Thyme Oil White, 24.82% Wintergreen Oil, 35.94% Isopropyl Myristate]).

In some embodiments, the blend of compounds can include between 3.5 and 4.4% Thyme Oil White, between 3.2 and 4% Isopropyl myristate, between 0.02 and 0.025% Soya Lecithin, between 0.1 and 0.12% Potassium Sorbate, between 0.9 and 0.115% Polyglycerol-4-oleate, between 0.25 and 0.30% Xanthan Gum, between 80 and 98% Water, and between 2.2 and 2.8% Wintergreen Oil (Technical).

In some embodiments, the blend of compounds can include 3.95% Thyme Oil White, 3.62% Isopropyl myristate, 0.023% Soya Lecithin, 0.11% Potassium Sorbate, 0.102% Polyglycerol-4-oleate, 0.275% Xanthan Gum, 89.422% Water, 2.50% Wintergreen Oil (Technical).

In some embodiments, the blend of compounds can include between 0.1 and 0.12% Potassium Sorbate, between 0.25 and 0.30% Xanthan Gum, between 80 and 98% Water, and between 10 and 12.6% Blend P-1020 (1.90% Polyglycerol-4-oleate, 9.00% Water, 89.10% Blend B-5016 [39.24% Thyme Oil White, 24.82% Wintergreen Oil, 35.94% Isopropyl Myristate]).

In some embodiments, the blend of compounds can include 0.11% Potassium Sorbate, 0.275% Xanthan Gum, 88.315% Water, and 11.30% Blend P-1020 (1.90% Polyglycerol-4-oleate, 9.00% Water, 89.10% Blend B-5016 [39.24% Thyme Oil White, 24.82% Wintergreen Oil, 35.94% Isopropyl Myristate]).

In some embodiments, the blend of compounds can include between 3.5 and 4.4% Thyme Oil White, between 2.2 and 2.8% Wintergreen Oil, between 3.3 and 40% Isopropyl myristate, between 0.1 and 0.12% Potassium Sorbate, between 0.18 and 0.23% Polyglycerol-4-oleate, between 0.25 and 0.30% Xanthan Gum, and between 80 and 98% Water.

In some embodiments, the blend of compounds can include 3.95% Thyme Oil White, 2.50% Wintergreen Oil, 3.62% Isopropyl myristate, 0.11% Potassium Sorbate, 0.21% Polyglycerol-4-oleate, 0.275% Xanthan Gum, and 89.332% Water.

In some embodiments, the blend of compounds can include between 0.9 and 1.1% Potassium Sorbate, between 2.2 and 2.8% Xanthan Gum, and between 87 and 100% Water.

In some embodiments, the blend of compounds can include 1.00% Potassium Sorbate, 2.500% Xanthan Gum, and 96.500% Water.

In some embodiments, the blend of compounds can include between 1.8 and 2.2% Sodium Benzoate and between 89 and 100% Water.

In some embodiments, the blend of compounds can include 2% Sodium Benzoate and 98% Water.

In some embodiments, the blend of compounds can include between 1.05 and 1.32% Span 80, between 1.5 and 1.8% Tween 80, between 13 and 15.4% Isopar M, between 60 and 76% Water, between 2.5 and 3.2% Blend B-5005 (25B-4-b blend; 56.30% D-Limonene, 12.38% Thyme Oil White, 31.32% Wintergreen Oil), and between 10 and 12.5% Solution P-1100 (2% Sodium Benzoate; 2% Sodium Benzoate, 98% Water).

In some embodiments, the blend of compounds can include 1.20% Span 80, 1.65% Tween 80, 14.20% Isopar M, 68.75% Water, 2.84% Blend B-5005 (25B-4-b blend; 56.30% D-Limonene, 12.38% Thyme Oil White, 31.32% Wintergreen Oil), and 11.36% Solution P-1100 (2% Sodium Benzoate; 2% Sodium Benzoate, 98% Water).

In some embodiments, the blend of compounds can include between 1.4 and 1.8% D-Limonene, between 0.32 and 0.38% Thyme Oil White, between 0.8 and 0.98% Wintergreen Oil, between 1.1 and 1.3% Span 80, between 1.5 and 1.8% Tween 80, between 0.2 and 0.26% Sodium Benzoate, between 13 and 15.4% Isopar M, and between 71 and 88% Water.

In some embodiments, the blend of compounds can include 1.60% D-Limonene, 0.35% Thyme Oil White, 0.89% Wintergreen Oil, 1.20% Span 80, 1.65% Tween 80, 0.23% Sodium Benzoate, 14.20% Isopar M, and 79.88% Water.

In some embodiments, the blend of compounds can include between 20 and 24% Propellent A70 and between 70 and 86% Blend P-1110 (1.20% Span 80, 1.65% Tween 80, 14.20% Isopar M, 68.75% Water, 2.84% Blend B-5005 [56.30% D-Limonene, 12.38% Thyme Oil White, 31.32% Wintergreen Oil], 11.36% Solution P-1100 [2% Sodium Benzoate; 2% Sodium Benzoate, 98% Water]).

In some embodiments, the blend of compounds can include 22% Propellent A70 and 78% Blend P-1110 (1.20% Span 80, 1.65% Tween 80, 14.20% Isopar M, 68.75% Water, 2.84% Blend B-5005 [56.30% D-Limonene, 12.38% Thyme Oil White, 31.32% Wintergreen Oil], 11.36% Solution P-1100 [2% Sodium Benzoate; 2% Sodium Benzoate, 98% Water]).

In some embodiments, the blend of compounds can include between 1.1 and 1.4% D-Limonene, between 0.24 and 0.3% Thyme Oil White, between 0.62 and 0.76% Wintergreen Oil, between 0.85 and 1.04% Span 80, between 1.1 and 1.48% Tween 80, between 0.16 and 0.20% Sodium Benzoate, between 10 and 12.2% Isopar M, between 56 and 69% Water, and between 20 and 24% Propellent A70.

In some embodiments, the blend of compounds can include 1.25% D-Limonene, 0.27% Thyme Oil White, 0.69% Wintergreen Oil, 0.94% Span 80, 1.29% Tween 80, 0.18% Sodium Benzoate, 11.08% Isopar M, 62.31% Water, and 22.0% Propellent A70.

In some embodiments, the blend of compounds can include between 0.9 and 1.1% Potassium Sorbate, between 0.13 and 0.17% Polyglycerol-4-oleate, between 0.25 and 0.31% Xanthan Gum, between 0.030 and 0.037% Lecithin, between 75 and 91% Water, and between 13.5 and 16.6% Blend B-5028 (20.6% Thyme Oil White, 45.1% Wintergreen Oil, 34.3% Isopropyl myristate).

In some embodiments, the blend of compounds can include 1.0% Potassium Sorbate, 0.15% Polyglycerol-4-oleate, 0.28% Xanthan Gum, 0.034% Lecithin, 83.5% Water, and 15.1% Blend B-5028 (20.6% Thyme Oil White, 45.1% Wintergreen Oil, 34.3% Isopropyl myristate).

In some embodiments, the blend of compounds can include between 30 and 37% Water and between 59 and 74% Formulation F-4002 (1.00% Potassium sorbate, 0.28% Xanthan Gum, 81.82% Water, 16.90% Formulation F-4001 [0.90% Polyglycerol-4-oleate, 0.20% Lecithin, 9.8% Water, 89.1% Blend B-5028 (20.6% Thyme Oil White, 45.1% Wintergreen Oil, 34.3% Isopropyl myristate)]).

In some embodiments, the blend of compounds can include 33.40% Water and 66.60% Formulation F-4002 (1.00% Potassium sorbate, 0.28% Xanthan Gum, 81.82% Water, 16.90% Formulation F-4001 [0.90% Polyglycerol-4-oleate, 0.20% Lecithin, 9.8% Water, 89.1% Blend B-5028 (20.6% Thyme Oil White, 45.1% Wintergreen Oil, 34.3% Isopropyl myristate)]).

In some embodiments, the blend of compounds can include between 3.6 and 4.5% D-Limonene, between 4 and 4.9% Thyme Oil White, between 15 and 18.2% Benzyl Alcohol, between 18 and 23.5% Isopar M, between 44 and 49% Water, between 5.6 and 7.0% Blend C-4003 (3.18% Solution S-3002 (Stock 10% SLS Solution; 10% Sodium Laurly Sulfate, 90% Water).

In some embodiments, the blend of compounds can include 4.03% D-Limonene, 4.43% Thyme Oil White, 16.61% Benzyl Alcohol, 20.95% Isopar M, 44.53% Water, 6.27% Blend C-4003 (3.18% Solution S-3002 (Stock 10% SLS Solution; 10% Sodium Laurly Sulfate, 90% Water).

In some embodiments, the blend of compounds can include between 3.6 and 4.45% D-Limonene, between 4.0 and 4.9% Thyme Oil White, between 15 and 18.4% Benzyl Alcohol, between 18 and 23.4% Isopar M, between 40 and 49% Water, between 0.045 and 0.055% Bifenthrin, between 5.6 and 7.0% Blend C-4003 (3.178% Solution S-3002 (Stock 10% SLS Solution; 10% Sodium Laurly Sulfate, 90% Water).

In some embodiments, the blend of compounds can include 4.028% D-Limonene, 4.428% Thyme Oil White, 16.60% Benzyl Alcohol, 20.94% Isopar M, 44.51% Water, 0.05% Bifenthrin, 6.267% Blend C-4003 (3.178% Solution S-3002 (Stock 10% SLS Solution; 10% Sodium Laurly Sulfate, 90% Water).

In some embodiments, the blend of compounds can include between 1.8 and 2.3% Thyme Oil White, between 4.0 and 5.0% Wintergreen Oil, between 3.1 and 3.8% Isopropyl myristate, between 0.45 and 0.55% Span 80, between 13.5 and 16.5% Isopar M, between 67 and 82% Water, and between 0.045 and 0.055% Bifenthrin.

In some embodiments, the blend of compounds can include 2.06% Thyme Oil White, 4.51% Wintergreen Oil, 3.43% Isopropyl myristate, 0.50% Span 80, 15% Isopar M, 74.45% Water, 0.05% Bifenthrin.

In some embodiments, the blend of compounds can include between 0.36 and 0.45% Thyme Oil White, between 0.8 and 1.0% Wintergreen Oil, between 0.6 and 0.76% Isopropyl myristate, between 0.018 and 0.022% Sodium Lauryl Sulfate, and between 88 and 100% Water.

In some embodiments, the blend of compounds can include 0.41% Thyme Oil White, 0.90% Wintergreen Oil, 0.69% Isopropyl myristate, 0.02% Sodium LaurylSulfate, and 97.98% Water.

In some embodiments, the blend of compounds can include between 0.9 and 1.15% Thyme Oil White, between 2.0 and 2.5% Wintergreen Oil, between 1.5 and 1.9% Isopropyl myristate, and between 85 and 100% AgSorb.

In some embodiments, the blend of compounds can include 1.03% Thyme Oil White, 2.26% Wintergreen Oil, 1.71% Isopropyl myristate, 95.00% AgSorb.

In some embodiments, the blend of compounds can include between 0.9 and 1.16% Thyme Oil White, between 2.0 and 2.5% Wintergreen Oil, between 1.5 and 1.9% Isopropyl myristate, and between 85 and 100% DG Light.

In some embodiments, the blend of compounds can include 1.03% Thyme Oil White, 2.26% Wintergreen Oil, 1.71% Isopropyl myristate, 95.0% DG Light.

In some embodiments, the blend of compounds can include between 0.36 and 0.45% Thyme Oil White, between 0.8 and 1.0% Wintergreen Oil, between 0.6 and 0.78% Isopropyl myristate, between 0.018 and 0.022% Sodium Lauryl Sulfate, and between 87 and 100% Water.

In some embodiments, the blend of compounds can include 0.41% Thyme Oil White, 0.90% Wintergreen Oil, 0.69% Isopropyl myristate, 0.02% Sodium Lauryl Sulfate, 97.98% Water.

In some embodiments, the blend of compounds can include between 22 and 27% D-Limonene, between 0.89 and 1.1% Thyme Oil White, between 0.15 and 0.19% Linalool Coeur, between 0.2 and 0.26% Tetrahydrolinalool, between 0.018 and 0.022% Vanillin, between 0.22 and 0.26% Isopropyl myristate, between 0.215 and 0.265% Piperonal (aldehyde), between 2.7 and 3.3% Lime Oil Minus, between 0.11 and 0.13% Geraniol 60, between 0.22 and 0.26% Triethyl Citrate, between 60 and 74% Water, and between 2.7 and 3.3% Solution S-3002 (Stock 10% SLS Solution; 10% Sodium Lauryl Sulfate; 90% Water).

In some embodiments, the blend of compounds can include 24.76% D-Limonene, 0.98% Thyme Oil White, 0.17% Linalool Coeur, 0.23% Tetrahydrolinalool, 0.02% Vanillin, 0.24% Isopropyl myristate, 0.24% Piperonal (aldehyde), 3.00% Lime Oil Minus, 0.12% Geraniol 60, 0.24% Triethyl Citrate, 67% Water, 3% Solution S-3002 (Stock 10% SLS Solution; 10% Sodium Lauryl Sulfate; 90% Water).

In some embodiments, the blend of compounds can include between 18 and 23% Thyme Oil White, between 40 and 50% Wintergreen Oil, between 31 and 38% Isopropyl myristate, between 0.9 and 1.1% Potassium Sorbate, between 0.25 and 0.31% Xanthan Gum, between 72 and 89% Water, between 15 and 17.6% Blend F-4001 (0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]).

In some embodiments, the blend of compounds can include 20.6% Thyme Oil White, 45.1% Wintergreen Oil, 34.3% Isopropyl myristate, 1% Potassium Sorbate, 0.28% Xanthan Gum, 81.82% Water, 16.90% Blend F-4001 ({Cationic Formulation;}0.90% Polyglycerol-4-oleate, 0.20% Lecithin, 9.8% Water, 89.1% Blend B-5028 [20.6% Thyme Oil White, 45.1% Wintergreen Oil, 34.3% Isopropyl myristate]).

In some embodiments, the blend of compounds can include between 85 and 100% Miracle Gro (Sterile), and between 4.5 and 5.5% Blend B-5028 (20.6% Thyme Oil White, 45.1% Wintergreen Oil, 34.3% Isopropyl myristate).

In some embodiments, the blend of compounds can include 95% Miracle Gro (Sterile), 5% Blend B-5028 ({25B-4A for Institutions;}20.6% Thyme Oil White, 45.1% Wintergreen Oil, 34.3% Isopropyl myristate).

In some embodiments, the blend of compounds can include between 0.45 and 0.56% Thyme Oil White, between 1.0 and 1.3% Wintergreen Oil, between 0.78 and 0.95% Isopropyl myristate, between 0.45 and 0.55% Span 80, between 13.5 and 16.5% Isopar M, between 73 and 90% Water, and between 0.045 and 0.55% Bifenthrin.

In some embodiments, the blend of compounds can include 0.51% Thyme Oil White, 1.13% Wintergreen Oil, 0.86% Isopropyl myristate, 0.50% Span 80, 15% Isopar M, 81.95% Water, and 0.05% Bifenthrin.

In certain embodiments wherein the composition includes LFO, one or more of the following compounds can be substituted for the LFO: Tetrahydrolinalool, Ethyl Linalool, Heliotropine, Hedion, Hercolyn D, and Triethyl Citrate. In certain embodiments wherein the composition includes LFO, a blend of the following compounds can be substituted for the LFO: Isopropyl myristate, Tetrahydrolinalool FCC, Linalool, Geraniol Fine FCC, Piperonal (aldehyde), and Vanillin.

In certain embodiments wherein the composition includes LFO, a blend of the following compounds can be substituted for the LFO: Isopropyl myristate, Tetrahydrolinalool, Linalool, Geraniol, Piperonal (aldehyde), Vanillin, Methyl Salicylate, and D-limonene.

In certain embodiments wherein the composition includes BSO, one or more of the following compounds can be substituted for the BSO: alpha-thujene: alpha-pinene; beta-pinene; p-cymene; limonene; and tert-butyl-p-benzoquinone.

In certain exemplary embodiments wherein the composition includes Thyme Oil, one or more of the following compounds can be substituted for the Thyme Oil: thymol, α-thujone; α-pinene, camphene, β-pinene, p-cymene, α-terpinene, linalool, borneol, β-caryophyllene, and carvacrol.

Compounds used to prepare the exemplary compositions of the present invention can be obtained, for example, from the following sources: Millennium Chemicals, Inc. (Jacksonville, Fla.), Ungerer Company (Lincoln Park, N.J.), SAFC (Milwaukee, Wis.), and IFF Inc. (Hazlet, N.J.).

In some embodiments of the compositions, it can be desirable to include compounds each having a purity of about 60%, 65%, 70%, 75%, 80%, 85%, 90%, or 95%. For example, in some embodiments of the compositions that include geraniol, it can be desirable to include a geraniol that is at least about 60%, 85% or 95% pure. In some embodiments, it can be desirable to include a specific type of geraniol. For example, in some embodiments, the compositions can include: geraniol 60, geraniol 85, or geraniol 95. When geraniol is obtained as geraniol 60, geraniol 85, or geraniol 95, then forty percent, fifteen percent, or five percent of the oil can be Nerol. Nerol is a monoterpene (C₁₀H₁₈O), that can be extracted from attar of roses, oil of orange blossoms and oil of lavender.

Embodiments of the present invention can include art-recognised ingredients normally used in such formulations. These ingredients can include, for example, antifoaming agents, anti-microbial agents, anti-oxidants, anti-redeposition agents, bleaches, colorants, emulsifiers, enzymes, fats, fluorescent materials, fungicides, hydrotropes, moisturisers, optical brighteners, perfume carriers, perfume, preservatives, proteins, silicones, soil release agents, solubilisers, sugar derivatives, sun screens, surfactants, vitamins waxes, and the like.

In certain embodiments, embodiments of the present invention can also contain other adjuvants or modifiers such as one or more therapeutically or cosmetically active ingredients. Exemplary therapeutic or cosmetically active ingredients useful in the compositions of the invention can include, for example, fungicides, sunscreening agents, sunblocking agents, vitamins, tanning agents, plant extracts, anti-inflammatory agents, anti-oxidants, radical scavenging agents, retinoids, alpha-hydroxy acids, emollients, antiseptics, antibiotics, antibacterial agents, antihistamines, and the like, and can be present in an amount effective for achieving the therapeutic or cosmetic result desired.

In some embodiments, compositions of this invention can include one or more materials that can function as an antioxidant, such as reducing agents and free radical scavengers. Suitable materials that can function as an antioxidant can include, for example: acetyl cysteine, ascorbic acid, t-butyl hydroquinone, cysteine, diamylhydroquinone, erythorbic acid, ferulic acid, hydroquinone, p-hydroxyanisole, hydroxylamine sulfate, magnesium ascorbate, magnesium ascorbyl phosphate, octocrylene, phloroglucinol, potassium ascorbyl tocopheryl phosphate, potassium sulfite, rutin, sodium ascorbate, sodium sulfite, sodium thloglycolate, thiodiglycol, thiodiglycolamide, thioglycolic acid, thiosalicylic acid, tocopherol, tocopheryl acetate, tocopheryl linoleate, tris(nonylphenyl)phosphite, and the like.

Embodiments of the invention can also include one or more materials that can function as a chelating agent to complex with metallic ions. This action can help to inactivate the metallic ions for the purpose of preventing their adverse effects on the stability or appearance of a formulated composition. Chelating agents suitable for use in an embodiment of this invention can include, for example, aminotrimethylene phosphonic acid, beta-alanine diacetic acid, calcium disodium EDTA, citric acid, cyclodextrin, cyclohexanediamine tetraacetic acid, diammonium citrate, diammonium EDTA, dipotassium EDTA, disodium azacycloheptane diphosphonate, disodium EDTA, disodium pyrophosphate, EDTA (ethylene diamine tetra acetic acid), gluconic acid, HEDTA (hydroxyethyl ethylene diamine triacetic acid), methyl cyclodextrin, pentapotassium triphosphate, pentasodium aminotrimethylene phosphonate, pentasodium triphosphate, pentetic acid, phytic acid, potassium citrate, potassium gluconate, sodium citrate, sodium diethylenetriamine pentamethylene phosphonate, sodium dihydroxyethylglycinate, sodium gluconate, sodium metaphosphate, sodium metasilicate, sodium phytate, triethanolamine (“TEA”)-EDTA, TEA-polyphosphate, tetrahydroxypropyl ethylenediamine, tetrapotassium pyrophosphate, tetrasodium EDTA, tetrasodium pyrophosphate, tripotassium EDTA, trisodium EDTA, trisodium HEDTA, trisodium phosphate, and the like.

Embodiments of the invention can also include one or more materials that can function as a humectant. A humectant is added to a composition to retard moisture loss during use, which effect is accomplished, in general, by the presence therein of hygroscopic materials.

In some embodiments, each compound can make up between about 1% to about 99%, by weight (wt/wt %) or by volume (vol/vol %), of the composition. For example, one composition of the present invention comprises about 2% alpha-Pinene and about 98% D-limonene. As used herein, percent amounts, by weight or by volume, of compounds are to be understood as referring to relative amounts of the compounds. As such, for example, a composition including 7% linalool, 35% thymol, 4% alpha-pinene, 30% para-cymene, and 24% soy bean oil (vol/vol %) can be said to include a ratio of 7 to 35 to 4 to 30 to 24 linalool, thymol, alpha-pinene, para-cymene, and soy bean oil, respectively (by volume). As such, if one compound is removed from the composition, or additional compounds or other ingredients are added to the composition, it is contemplated that the remaining compounds can be provided in the same relative amounts. For example, if soy bean oil were removed from the exemplary composition, the resulting composition would include 7 to 35 to 4 to 40 linalool, thymol, alpha-pinene, and para-cymene, respectively (by volume). This resulting composition would include 9.21% linalool, 46.05% thymol, 5.26% alpha-pinene, and 39.48% para-cymene (vol/vol %). For another example, if safflower oil were added to the original composition to yield a final composition containing 40% (vol/vol) safflower oil, then the resulting composition would include 4.2% linalool, 21% thymol, 2.4% alpha-pinene, 18% para-cymene, 14.4% soy bean oil, and 40% safflower oil (vol/vol %). One having ordinary skill in the art would understand that volume percentages are easily converted to weight percentages based the known or measured specific gravity of the substance.

Surprisingly, by combining certain insect control chemicals, and compounds or blends of the present invention, insect control activity of the resulting compositions can be enhanced, i.e., a synergistic effect on insect control activity is achieved when a certain chemical or chemicals, and a certain compound or compounds are combined. In other words, the compositions including certain combinations of at least one chemical, and at least one compound or at least one blend of compounds can have an enhanced ability to control insects, as compared to each of the chemicals or compounds taken alone.

In embodiments of the present invention, “synergy” can refer to any substantial enhancement, in a combination of at least two ingredients, of a measurable effect, when compared with the effect of one active ingredient alone, or when compared with the effect of the complete combination minus at least one ingredient. Synergy is a specific feature of a combination of ingredients, and is above any background level of enhancement that would be due solely to, e.g., additive effects of any random combination of ingredients. Effects include but are not limited to: repellant effect of the composition; pesticidal effect of the composition; perturbation of a cell message or cell signal such as, e.g., calcium, cyclic-AMP, and the like; and diminution of activity or downstream effects of a molecular target.

In various embodiments, a substantial enhancement can be expressed as a coefficient of synergy, wherein the coefficient is a ratio of the measured effect of the complete blend, divided by the effect of a comparison composition, typically a single ingredient or a subset of ingredients found in the complete blend. In some embodiments, the synergy coefficient can be adjusted for differences in concentration of the complete blend and the comparison composition.

In some embodiments of the invention, a coefficient of synergy of 1.1, 1.2, 1.3, 1.4, or 1.5 can be substantial and commercially desirable. In other embodiments, the coefficient of synergy can be from about 1.6 to about 5, including but not limited to 1.8, 2.0, 2.5, 3.0, 3.5, 4.0, and 4.5. In other embodiments, the coefficient of synergy can be from about 5 to 50, including but not limited to 10, 15, 20, 25, 30, 35, 40, and 45. In other embodiments, the coefficient of synergy can be from about 50 to about 500, or more, including but not limited to 50, 75, 100, 125, 150, 200, 250, 300, 350, 400, and 450. Any coefficient of synergy above 500 is also contemplated within embodiments of the present invention.

Given that a broad range of synergies can be found in various embodiments of the invention, it is expressly noted that a coefficient of synergy can be described as being “greater than” a given number and therefore not necessarily limited to being within the bounds of a range having a lower and an upper numerical limit. Likewise, in some embodiments of the invention, certain low synergy coefficients, or lower ends of ranges, are expressly excluded. Accordingly, in some embodiments, synergy can be expressed as being “greater than” a given number that constitutes a lower limit of synergy for such an embodiment. For example, in some embodiments, the synergy coefficient is equal to or greater than 25; in such an embodiment, all synergy coefficients below 25, even though substantial, are expressly excluded.

Compositions containing combinations of certain chemicals and compounds can be tested for synergistic effect on insect control activity by comparing the effect of a particular combination of at least one chemical, and at least one compound or at least one blend of compounds, to the effect of the individual chemical(s) and compound(s). Additional information related to making a synergy determination can be found in the Examples set forth in this document.

Exemplary methods that can be used to determine the synergistic effect of a particular composition are set forth in the following applications, each of which is incorporated in its entirety herein by reference: U.S. application Ser. No. 10/832,022, entitled COMPOSITIONS AND METHODS FOR CONTROLLING INSECTS; U.S. application Ser. No. 11/086,615, entitled COMPOSITIONS AND METHODS FOR CONTROLLING INSECTS RELATED TO THE OCTOPAMINE RECEPTOR; U.S. application Ser. No. 11/365,426, entitled COMPOSITIONS AND METHODS FOR CONTROLLING INSECTS INVOLVING THE TYRAMINE RECEPTOR; and U.S. application Ser. No. 11/870,385, entitled COMPOSITIONS AND METHODS FOR CONTROLLING INSECTS.

Controlling Pests

Embodiments of the invention can be used to control insect species belonging to orders Acari, Anoplura, Araneae, Blattodea, Coleoptera, Collembola, Diptera, Grylloptera, Heteroptera, Homoptera, Hymenoptera, Isopoda, Isoptera, Lepidoptera, Mantodea, Mallophaga, Neuroptera, Odonata, Orthoptera, Psocoptera, Siphonaptera, Symphyla, Thysanura, and Thysanoptera.

Embodiments of the present invention can be used to control, for example, the insects set forth in Table 5, or the like.

TABLE 5
INSECTS SUBJECT TO CONTROL BY EMBODIMENTS OF THE INVENTION

| | English Common | | |
|---|---|---|---|
| Scientific Name | Name | Order | Family |
| Abgrallaspis ithacae (Ferris) | hemlock scale | Homoptera | Diaspididae |
| Acalitus essigi (Hassan) | redberry mite | Acari | Eriophyidae |
| Acalitus rudis (Can.) | birch budgall mite | Acari | Eriophyidae |
| Acalitus vaccinii (Keif.) | blueberry bud mite | Acari | Eriophyidae |
| Acalymma vittatum (F.) | striped cucumber | Coleoptera | Chrysomelidae |
| | beetle | | |
| Acantholyda erythrocephala (L.) | pine false webworm | Hymenoptera | Pamphiliidae |
| Acantholyda zappei (Roh.) | nesting pine sawfly | Hymenoptera | Pamphiliidae |
| Acanthomyops interjectus (Mayr) | larger yellow ant | Hymenoptera | Formicidae |
| Acanthoscelides obtectus (Say) | bean weevil | Coleoptera | Bruchidae |
| Acarus siro L. | grain mite | Acari | Acaridae |
| Aceria campestricola (Frauen.) | elm leafgall mite | Acari | Eriophyidae |
| Aceria dispar (Nal.) | aspen leaf mite | Acari | Eriophyidae |
| Aceria elongatus (Hodg.) | crimson erineum mite | Acari | Eriophyidae |
| Aceria fraxiniflora (Felt) | ash flower gall mite | Acari | Eriophyidae |
| Aceria parapopuli (Keif.) | poplar budgall mite | Acari | Eriophyidae |
| Aceria tosichella Keif. | wheat curl mite | Acari | Eriophyidae |
| Acericecis ocellaris (O.S.) | ocellate gall midge | Diptera | Cecidomyiidae |
| Achaearanea tepidariorum (Koch) | European house | Araneae | Theridiidae |
| | spider | | |
| Acheta domesticus (L.) | house cricket | Grylloptera | Gryllidae |
| Achyra rantalis (Gn.) | garden webworm | Lepidoptera | Pyralidae |
| Acleris chalybeana (Fern.) | lesser maple leafroller | Lepidoptera | Tortricidae |
| Acleris comariana (Zell.) | strawberry tortrix | Lepidoptera | Tortricidae |
| Acleris fuscana (B. & Bsk.) | small aspen leaftier | Lepidoptera | Tortricidae |
| Acleris gloverana (Wlsm.) | western blackheaded | Lepidoptera | Tortricidae |
| | budworm | | |
| Acleris logiana (Cl.) | blackheaded birch | Lepidoptera | Tortricidae |
| | leaffolder | | |
| Acleris minuta (Rob.) | yellowheaded | Lepidoptera | Tortricidae |
| | fireworm | | |
| Acleris variana (Fern.) | eastern blackheaded | Lepidoptera | Tortricidae |
| | budworm | | |
| Acossus centerensis (Lint.) | poplar carpenterworm | Lepidoptera | Cossidae |
| Acossus populi (Wlk.) | aspen carpenterworm | Lepidoptera | Cossidae |
| Acrobasis betulella Hulst | birch tubemaker | Lepidoptera | Pyralidae |
| Acrobasis caryae Grt. | hickory shoot borer | Lepidoptera | Pyralidae |
| Acrobasis comptoniella Hulst | sweetfern leaf | Lepidoptera | Pyralidae |
| | casebearer | | |
| Acrobasis juglandis (LeB.) | pecan leaf casebearer | Lepidoptera | Pyralidae |
| Acrobasis rubrifasciella Pack. | alder tubemaker | Lepidoptera | Pyralidae |
| Acrobasis sylviella Ely | ironwood tubemaker | Lepidoptera | Pyralidae |
| Acrobasis vaccinii Riley | cranberry fruitworm | Lepidoptera | Pyralidae |
| Acronicta americana (Harr.) | American dagger | Lepidoptera | Noctuidae |
| | moth | | |
| Acronicta dactylina Grt. | alder dagger moth | Lepidoptera | Noctuidae |
| Acronicta fragilis (Gn.) | fragile dagger moth | Lepidoptera | Noctuidae |
| Acronicta funeralis G. & R. | paddle caterpillar | Lepidoptera | Noctuidae |
| Acronicta furcifera Gn. | forked dagger moth | Lepidoptera | Noctuidae |
| Acronicta grisea Wlk. | gray dagger moth | Lepidoptera | Noctuidae |
| Acronicta hasta Gn. | cherry dagger moth | Lepidoptera | Noctuidae |
| Acronicta impressa Wlk. | willow dagger moth | Lepidoptera | Noctuidae |
| Acronicta innotata Gn. | birch dagger moth | Lepidoptera | Noctuidae |
| Acronicta leporina (L.) | poplar dagger moth | Lepidoptera | Noctuidae |
| Acronicta lepusculina Gn. | cottonwood dagger | Lepidoptera | Noctuidae |
| | moth | | |
| Acronicta oblinita (J. E. Smith) | smeared dagger moth | Lepidoptera | Noctuidae |
| Acronicta tristis Sm. | sad dagger moth | Lepidoptera | Noctuidae |
| Acronicta vinnula (Grt.) | elm dagger moth | Lepidoptera | Noctuidae |
| Actebia fennica (Tausch.) | black army cutworm | Lepidoptera | Noctuidae |
| Actias luna (L.) | luna moth | Lepidoptera | Saturniidae |
| Aculops lycopersici (Tryon) | tomato russet mite | Acari | Eriophyidae |
| Aculus fockeui (Nal. & Tr.) | plum rust mite | Acari | Eriophyidae |
| Aculus schlechtendali (Nal.) | apple rust mite | Acari | Eriophyidae |
| Acyrthosiphon caraganae | caragana aphid | Homoptera | Aphididae |
| (Cholodk.) | | | |
| Acyrthosiphon pisum (Harr.) | pea aphid | Homoptera | Aphididae |
| Adalia bipunctata (L.) | twospotted lady | Coleoptera | Coccinellidae |
| | beetle | | |
| Adelges abietis (L.) | eastern spruce gall | Homoptera | Adelgidae |
| | adelgid | | |
| Adelges cooleyi (Gill.) | Cooley spruce gall | Homoptera | Adelgidae |
| | adelgid | | |
| Adelges lariciatus (Patch) | spruce gall adelgid | Homoptera | Adelgidae |
| Adelges laricis Vallot | pale spruce gall | Homoptera | Adelgidae |
| | adelgid | | |
| Adelges piceae (Ratz.) | balsam woolly | Homoptera | Adelgidae |
| | adelgid | | |
| Adelges tsugae Ann. | hemlock woolly | Homoptera | Adelgidae |
| | adelgid | | |
| Adelphocoris lineolatus (Goeze) | alfalfa plant bug | Heteroptera | Miridae |
| Adelphocoris rapidus (Say) | rapid plant bug | Heteroptera | Miridae |
| Adelphocoris superbus (Uhl.) | superb plant bug | Heteroptera | Miridae |
| Aedes aegypti (L.) | yellowfever mosquito | Diptera | Culicidae |
| Aellopos titan (Cram.) | whitebanded day | Lepidoptera | Sphingidae |
| | sphinx | | |
| Aeshna canadensis Wlk. | Canada darner | Odonata | Aeshnidae |
| Aeshna umbrosa Wlk. | shadow darner | Odonata | Aeshnidae |
| Aglais milberti (Godt.) | Milbert tortoiseshell | Lepidoptera | Nymphalidae |
| Agrilus anxius Gory | bronze birch borer | Coleoptera | Buprestidae |
| Agrilus aurichalceus Redt. | rose stem girdler | Coleoptera | Buprestidae |
| Agrilus bilineatus (Weber) | twolined chestnut | Coleoptera | Buprestidae |
| | borer | | |
| Agrilus liragus B. & B. | bronze poplar borer | Coleoptera | Buprestidae |
| Agrilus politus (Say) | willow gall limb | Coleoptera | Buprestidae |
| | borer | | |
| Agrilus ruficollis (F.) | rednecked cane borer | Coleoptera | Buprestidae |
| Agriopodes fallax (H.-S.) | green marvel | Lepidoptera | Noctuidae |
| Agriotes limosus (LeC.) | little brown click | Coleoptera | Elateridae |
| | beetle | | |
| Agriotes lineatus (L.) | lined click beetle | Coleoptera | Elateridae |
| Agriotes mancus (Say) | wheat wireworm | Coleoptera | Elateridae |
| Agriotes obscurus (L.) | dusky wireworm | Coleoptera | Elateridae |
| Agriotes sparsus LeC. | western wireworm | Coleoptera | Elateridae |
| Agriphila vulgivagella (Clem.) | vagabond crambus | Lepidoptera | Pyralidae |
| Agrius cingulata (F.) | pinkspotted | Lepidoptera | Sphingidae |
| | hawkmoth | | |
| Agromyza aristata Malloch | elm agromyzid | Diptera | Agromyzidae |
| | leafminer | | |
| Agromyza frontella (Rond.) | alfalfa blotch | Diptera | Agromyzidae |
| | leafminer | | |
| Agromyza melampyga (Loew) | mockorange | Diptera | Agromyzidae |
| | leafminer | | |
| Agrotis gladiaria Morr. | claybacked cutworm | Lepidoptera | Noctuidae |
| Agrotis ipsilon (Hufn.) | black cutworm | Lepidoptera | Noctuidae |
| Agrotis orthogonia Morr. | pale western cutworm | Lepidoptera | Noctuidae |
| Ahasverus advena (Waltl) | foreign grain beetle | Coleoptera | Cucujidae |
| Alabama argillacea (Hbn.) | cotton leafworm | Lepidoptera | Noctuidae |
| Alaus myops (F.) | smalleyed click beetle | Coleoptera | Elateridae |
| Alaus oculatus (L.) | eyed click beetle | Coleoptera | Elateridae |
| Aleuroglyphus ovatus (Troup.) | brownlegged grain | Acari | Acaridae |
| | mite | | |
| Allantus cinctus (L.) | curled rose sawfly | Hymenoptera | Tenthredinidae |
| Alniphagus aspericollis (LeC.) | alder bark beetle | Coleoptera | Scolytidae |
| Alphitobius diaperinus (Panz.) | lesser mealworm | Coleoptera | Tenebrionidae |
| Alphitobius laevigatus (F.) | black fungus beetle | Coleoptera | Tenebrionidae |
| Alphitophagus bifasciatus (Say) | twobanded fungus | Coleoptera | Tenebrionidae |
| | beetle | | |
| Alsophila pometaria (Harr.) | fall cankerworm | Lepidoptera | Geometridae |
| Altica ambiens LeC. | alder flea beetle | Coleoptera | Chrysomelidae |
| Altica canadensis Gent. | prairie flea beetle | Coleoptera | Chrysomelidae |
| Altica chalybaea Ill. | grape flea beetle | Coleoptera | Chrysomelidae |
| Altica prasina LeC. | poplar flea beetle | Coleoptera | Chrysomelidae |
| Altica rosae Woods | rose flea beetle | Coleoptera | Chrysomelidae |
| Altica sylvia Malloch | blueberry flea beetle | Coleoptera | Chrysomelidae |
| Altica ulmi Woods | elm flea beetle | Coleoptera | Chrysomelidae |
| Alypia langtoni Couper | fireweed caterpillar | Lepidoptera | Noctuidae |
| Alypia octomaculata (F.) | eightspotted forester | Lepidoptera | Noctuidae |
| Amblyscirtes vialis (Edw.) | roadside skipper | Lepidoptera | Hesperiidae |
| Amphibolips confluenta (Harr.) | spongy oakapple gall | Hymenoptera | Cynipidae |
| Amphibolips quercusinanis (O.S.) | large oakapple gall | Hymenoptera | Cynipidae |
| Amphicerus bicaudatus (Say) | apple twig borer | Coleoptera | Bostrichidae |
| Amphimallon majalis (Raz.) | European chafer | Coleoptera | Scarabaeidae |
| Amphion floridensis B. P. Clark | nessus sphinx | Lepidoptera | Sphingidae |
| Amphipoea interoceanica (Sm.) | strawberry cutworm | Lepidoptera | Noctuidae |
| Amphipyra pyramidoides Gn. | copper underwing | Lepidoptera | Noctuidae |
| Amphipyra pyramidoides Gn. | rearhumped | Lepidoptera | Noctuidae |
| | caterpillar | | |
| Amplicephalus inimicus (Say) | painted leafhopper | Homoptera | Cicadellidae |
| Anabrus simplex Hald. | Mormon cricket | Orthoptera | Tettigoniidae |
| Anacampsis innocuella (Zell.) | darkheaded aspen | Lepidoptera | Gelechiidae |
| | leafroller | | |
| Anacampsis niveopulvella (Cham.) | paleheaded aspen | Lepidoptera | Gelechiidae |
| | leafroller | | |
| Anagrapha falcifera (Kby.) | celery looper | Lepidoptera | Noctuidae |
| Anaphothrips obscurus (Mull.) | grass thrips | Tysanoptera | Thripidae |
| Anarsia lineatella Zell. | peach twig borer | Lepidoptera | Gelechiidae |
| Anasa tristis (DeG.) | squash bug | Heteroptera | Coreidae |
| Anathix puta (G. & R.) | poplar catkin moth | Lepidoptera | Noctuidae |
| Anatis labiculata (Say) | fifteenspotted lady | Coleoptera | Coccinellidae |
| | beetle | | |
| Anatis mali (Say) | eyespotted lady beetle | Coleoptera | Coccinellidae |
| Ancistronycha bilineata (Say) | twolined cantharid | Coleoptera | Cantharidae |
| Ancylis burgessiana (Zell.) | oak leaffolder | Lepidoptera | Tortricidae |
| Ancylis comptana (Fro.) | strawberry leafroller | Lepidoptera | Tortricidae |
| Ancylis discigerana (Wlk.) | yellow birch | Lepidoptera | Tortricidae |
| | leaffolder | | |
| Anelaphus parallelus (Newm.) | hickory twig pruner | Coleoptera | Cerambycidae |
| Anelaphus villosus (F.) | twig pruner | Coleoptera | Cerambycidae |
| Anisota finlaysoni Riotte | shorthorned oakworm | Lepidoptera | Saturniidae |
| Anisota senatoria (J. E. Smith) | orangestriped | Lepidoptera | Saturniidae |
| | oakworm | | |
| Anisota stigma (F.) | spiny oakworm | Lepidoptera | Saturniidae |
| Anisota virginiensis (Drury) | pinkstriped oakworm | Lepidoptera | Saturniidae |
| Anobium punctatum (DeG.) | furniture beetle | Coleoptera | Anobiidae |
| Anomoea laticlavia (Forst.) | claycoloured leaf | Coleoptera | Chrysomelidae |
| | beetle | | |
| Anoplonyx canadensis Hgtn. | onelined larch sawfly | Hymenoptera | Tenthredinidae |
| Anoplonyx luteipes (Cress.) | threelined larch | Hymenoptera | Tenthredinidae |
| | sawfly | | |
| Antheraea polyphemus (Cram.) | polyphemus moth | Lepidoptera | Saturniidae |
| Anthonomus musculus Say | cranberry weevil | Coleoptera | Curculionidae |
| Anthonomus quadrigibbus (Say) | apple curculio | Coleoptera | Curculionidae |
| Anthonomus signatus Say | strawberry bud weevil | Coleoptera | Curculionidae |
| Anthonomus signatus Say | strawberry clipper | Coleoptera | Curculionidae |
| | weevil | | |
| Anthophylax attenuatus (Hald.) | mottled longhorned | Coleoptera | Cerambycidae |
| | beetle | | |
| Anthrenus flavipes LeC. | furniture carpet | Coleoptera | Dermestidae |
| | beetle* | | |
| Anthrenus museorum (L.) | museum beetle | Coleoptera | Dermestidae |
| Anthrenus scrophulariae (L.) | carpet beetle | Coleoptera | Dermestidae |
| Anthrenus verbasci (L.) | varied carpet beetle | Coleoptera | Dermestidae |
| Antispila nysaefoliella Clem. | tupelo leafminer | Lepidoptera | Heliozelidae |
| Apamea amputatrix (Fitch) | yellowheaded | Lepidoptera | Noctuidae |
| | cutworm | | |
| Apamea devastator (Brace) | glassy cutworm | Lepidoptera | Noctuidae |
| Aphis craccivora Koch | cowpea aphid | Homoptera | Aphididae |
| Aphis fabae Scop. | black bean aphid | Homoptera | Aphididae |
| Aphis fabae Scop. | bean aphid | Homoptera | Aphididae |
| Aphis gossypii Glov. | melon aphid | Homoptera | Aphididae |
| Aphis maculatae Oestl. | spotted poplar aphid | Homoptera | Aphididae |
| Aphis nasturtii Kltb. | buckthorn aphid | Homoptera | Aphididae |
| Aphis pomi DeG. | apple aphid | Homoptera | Aphididae |
| Aphis rubicola Oest. | raspberry aphid | Homoptera | Aphididae |
| Aphomia gularis (Zell.) | stored nut moth | Lepidoptera | Pyralidae |
| Aphrophora cribrata (Wlk.) | pine spittlebug | Homoptera | Cercopidae |
| Aphrophora fulva Doering | western pine | Homoptera | Cercopidae |
| | spittlebug | | |
| Aphrophora parallela (Say) | spruce spittlebug | Homoptera | Cercopidae |
| Aphrophora permutata Uhl. | Douglas-fir spittlebug | Homoptera | Cercopidae |
| Aphrophora saratogensis (Fitch) | Saratoga spittlebug | Homoptera | Cercopidae |
| Apion longirostre Oliv. | hollyhock weevil | Coleoptera | Apionidae |
| Apion nigrum Hbst. | black locust seed | Coleoptera | Apionidae |
| | weevil* | | |
| Apion simile Kby. | birch catkin weevil | Coleoptera | Apionidae |
| Apis mellifera L. | honey bee | Hymenoptera | Apidae |
| Apotomis dextrana (McD.) | green aspen leafroller | Lepidoptera | Tortricidae |
| Aradus kormileri Heiss | pine flat bug | Heteroptera | Aradidae |
| Araecerus fasciculatus (DeG.) | coffee bean weevil | Coleoptera | Anthribidae |
| Araneus trifolium (Hentz) | shamrock spider | Araneae | Araneidae |
| Archips argyrospila (Wlk.) | fruittree leafroller | Lepidoptera | Tortricidae |
| Archips cerasivorana (Fitch) | uglynest caterpillar | Lepidoptera | Tortricidae |
| Archips fervidana (Clem.) | oak webworm | Lepidoptera | Tortricidae |
| Archips mortuana Kft. | duskyback leafroller | Lepidoptera | Tortricidae |
| Archips negundana (Dyar) | larger boxelder | Lepidoptera | Tortricidae |
| | leafroller | | |
| Archips packardiana (Fern.) | spring spruce needle | Lepidoptera | Tortricidae |
| | moth | | |
| Archips purpurana (Clem.) | omnivorous leafroller | Lepidoptera | Tortricidae |
| Archips rosana (L.) | European leafroller | Lepidoptera | Tortricidae |
| Archips semiferana (Wlk.) | oak leafroller | Lepidoptera | Tortricidae |
| Arctia caja (L.) | great tiger moth | Lepidoptera | Arctiidae |
| Argas persicus (Oken) | fowl tick | Acari | Argasidae |
| Argyresthia conjugella Zell. | apple fruit moth | Lepidoptera | Argyresthiidae |
| Argyresthia laricella Kft. | larch shoot moth | Lepidoptera | Argyresthiidae |
| Argyresthia oreasella Clem. | cherry shoot borer | Lepidoptera | Argyresthiidae |
| Argyresthia thuiella (Pack.) | arborvitae leafminer | Lepidoptera | Argyresthiidae |
| Argyrotaenia citrana (Fern.) | orange tortrix | Lepidoptera | Tortricidae |
| Argyrotaenia mariana (Fern.) | graybanded leafroller | Lepidoptera | Tortricidae |
| Argyrotaenia occultana Free. | fall spruce needle | Lepidoptera | Tortricidae |
| | moth | | |
| Argyrotaenia pinatubana (Kft.) | pine tube moth | Lepidoptera | Tortricidae |
| Argyrotaenia quadrifasciana | fourlined leafroller | Lepidoptera | Tortricidae |
| (Fern.) | | | |
| Argyrotaenia quercifoliana (Fitch) | tortricid oakworm | Lepidoptera | Tortricidae |
| Argyrotaenia tabulana Free. | jack pine tube moth | Lepidoptera | Tortricidae |
| Argyrotaenia velutinana (Wlk.) | redbanded leafroller | Lepidoptera | Tortricidae |
| Arhopalus foveicollis (Hald.) | pitted longhorned | Coleoptera | Cerambycidae |
| | beetle | | |
| Arhopalus productus (LeC.) | new house borer | Coleoptera | Cerambycidae |
| Armadillidium vulgare (Latr.) | pillbug | Isopoda | Armadillidae |
| Aroga trialbamaculella (Cham.) | redstriped fireworm | Lepidoptera | Gelechiidae |
| Arrhenodes minutus (Drury) | oak timberworm | Coleoptera | Brentidae |
| Asemum striatum (L.) | opaque sawyer | Coleoptera | Cerambycidae |
| Aspidiotus nerii Bouch, | oleander scale | Homoptera | Diaspididae |
| Asterodiapsis variolosa (Ratz.) | golden oak scale | Homoptera | Asterolecaniida |
| Asynapta hopkinsi Felt | cone resin midge | Diptera | Cecidomyiidae |
| Asynonychus cervinus (Boh.) | Fuller rose beetle | Coleoptera | Curculionidae |
| Attagenus pellio (L.) | fur beetle | Coleoptera | Dermestidae |
| Attagenus unicolor (Brahm) | black carpet beetle | Coleoptera | Dermestidae |
| Aulacaspis rosae (Bouch,) | rose scale | Homoptera | Diaspididae |
| Aulacorthum solani (Kltb.) | foxglove aphid | Homoptera | Aphididae |
| Aulocara elliotti (Thos.) | bigheaded | Orthoptera | Acrididae |
| | grasshopper | | |
| Autographa biloba (Steph.) | bilobed looper | Lepidoptera | Noctuidae |
| Autographa californica (Speyer) | alfalfa looper | Lepidoptera | Noctuidae |
| Automeris io (F.) | io moth | Lepidoptera | Saturniidae |
| Bactrocera oleae (Gmel.) | olive fruit fly | Diptera | Tephritidae |
| Baliosus nervosus (Panz.) | basswood leafminer | Coleoptera | Chrysomelidae |
| Banasa dimiata (Say) | banasa stink bug | Heteroptera | Pentatomidae |
| Barbara colfaxiana (Kft.) | Douglas-fir cone | Lepidoptera | Tortricidae |
| | moth | | |
| Battus philenor (L.) | pipevine swallowtail | Lepidoptera | Papilionidae |
| Bemisia tabaci (Genn.) | sweetpotato whitefly | Homoptera | Aleyrodidae |
| Biston betularia cognataria (Gn.) | pepper-and-salt moth | Lepidoptera | Geometridae |
| Blastobasis glandulella (Riley) | acorn moth | Lepidoptera | Blastobasidae |
| Blatta orientalis L. | oriental cockroach | Blattodea | Blattellidae |
| Blattella germanica (L.) | German cockroach | Blattodea | Blattellidae |
| Blissus l. leucopterus (Say) | chinch bug | Heteroptera | Lygaeidae |
| Blissus leucopterus hirtus Montd. | hairy chinch bug | Heteroptera | Lygaeidae |
| Blissus occiduus Barber | western chinch bug | Heteroptera | Lygaeidae |
| Boisea rubrolineata (Barber) | western boxelder bug | Heteroptera | Rhopalidae |
| Boisea trivittata (Say) | boxelder bug | Heteroptera | Rhopalidae |
| Boloria bellona (F.) | meadow fritillary | Lepidoptera | Nymphalidae |
| Boloria eunomia (Esp.) | bog fritillary | Lepidoptera | Nymphalidae |
| Boloria selene (D. & S.) | silverbordered | Lepidoptera | Nymphalidae |
| | fritillary | | |
| Bombyx mori (L.) | silkworm | Lepidoptera | Bombycidae |
| Bomolocha deceptalis (Wlk.) | basswood owlet moth | Lepidoptera | Noctuidae |
| Bourletiella hortensis (Fitch) | garden springtail | Collembola | Sminthuridae |
| Bovicola bovis (L.) | cattle biting louse | Mallophaga | Trichodectidae |
| Bovicola caprae (Gurlt) | goat biting louse | Mallophaga | Trichodectidae |
| Bovicola equi (Denny) | horse biting louse | Mallophaga | Trichodectidae |
| Bovicola ovis (Schr.) | sheep biting louse | Mallophaga | Trichodectidae |
| Brachycaudus persicae (Pass.) | black peach aphid | Homoptera | Aphididae |
| Brachycoynella asparagi (Mord.) | asparagus aphid | Homoptera | Aphididae |
| Brevicoryne brassicae (L.) | cabbage aphid | Homoptera | Aphididae |
| Brochymena quadripustulata (F.) | fourhumped stink bug | Heteroptera | Pentatomidae |
| Bromius obscurus (L.) | western grape | Coleoptera | Chrysomelidae |
| | rootworm | | |
| Bruchophagus platypterus (Wlk.) | clover seed chalcid | Hymenoptera | Eurytomidae |
| Bruchophagus roddi (Guss.) | alfalfa seed chalcid | Hymenoptera | Eurytomidae |
| Bruchus brachialis Fahr. | vetch bruchid | Coleoptera | Bruchidae |
| Bruchus pisorum (L.) | pea weevil | Coleoptera | Bruchidae |
| Bruchus rufimanus Boh. | broadbean weevil | Coleoptera | Bruchidae |
| Bryobia praetiosa Koch | clover mite | Acari | Tetranychidae |
| Bryobia rubrioculus (Scheut.) | brown mite | Acari | Tetranychidae |
| Bucculatrix ainsliella Murt. | oak skeletonizer | Lepidoptera | Lyonetiidae |
| Bucculatrix canadensisella Cham. | birch skeletonizer | Lepidoptera | Lyonetiidae |
| Buprestis aurulenta L. | golden buprestid | Coleoptera | Buprestidae |
| Buprestis maculativentris Say | ventrally-spotted | Coleoptera | Buprestidae |
| | buprestid | | |
| Byturus unicolor Say | raspberry fruitworm | Coleoptera | Byturidae |
| Cacopsylla buxi (L.) | boxwood psyllid | Homoptera | Psyllidae |
| Cacopsylla mali (Schmdb.) | apple sucker | Homoptera | Psyllidae |
| Cacopsylla negundinis Mally | boxelder psyllid | Homoptera | Psyllidae |
| Cacopsylla pyricola Forst. | pear psylla | Homoptera | Psyllidae |
| Cadra cautella (Wlk.) | almond moth | Lepidoptera | Pyralidae |
| Cadra figulilella (Greg.) | raisin moth | Lepidoptera | Pyralidae |
| Caenurgina crassiuscula (Haw.) | clover looper | Lepidoptera | Noctuidae |
| Caliroa cerasi (L.) | pear sawfly | Hymenoptera | Tenthredinidae |
| Caliroa cerasi (L.) | pearslug | Hymenoptera | Tenthredinidae |
| Caliroa fasciata (Nort.) | oakslug | Hymenoptera | Tenthredinidae |
| Caliroa fasciata (Nort.) | oak sawfly | Hymenoptera | Tenthredinidae |
| Callidium antennatum hesperum | blackhorned pine | Coleoptera | Cerambycidae |
| Casey | borer | | |
| Calligrapha alni Schaeff. | russet alder leaf | Coleoptera | Chrysomelidae |
| | beetle | | |
| Calligrapha philadelphica (L.) | dogwood leaf beetle | Coleoptera | Chrysomelidae |
| Calligrapha scalaris (LeC.) | elm calligrapha | Coleoptera | Chrysomelidae |
| Callirhytis cornigera (O.S.) | horned oak gall wasp | Hymenoptera | Cynipidae |
| Callirhytis quercuspunctata | gouty oak gall wasp | Hymenoptera | Cynipidae |
| (Bass.) | | | |
| Callosamia promethea (Drury) | promethea moth | Lepidoptera | Saturniidae |
| Calocoris norvegicus Gmel. | strawberry bug | Heteroptera | Miridae |
| Calopteryx maculata (Beauv.) | ebony jeweling | Odonata | Calopterygidae |
| Caloptilia alnivorella (Cham.) | alder leafminer | Lepidoptera | Gracillariidae |
| Caloptilia invariabilis (Braun) | cherry leafcone | Lepidoptera | Gracillariidae |
| | caterpillar | | |
| Caloptilia negundella (Cham.) | boxelder leafroller | Lepidoptera | Gracillariidae |
| Caloptilia syringella (F.) | lilac leafminer | Lepidoptera | Gracillariidae |
| Calosoma calidum (F.) | fiery hunter | Coleoptera | Carabidae |
| Calvia quatuordecimguttata (L.) | fourteenspotted lady | Coleoptera | Coccinellidae |
| | beetle | | |
| Cameraria aceriella (Clem.) | maple leafblotch | Lepidoptera | Gracillariidae |
| | miner | | |
| Cameraria betulivora (Wlsm.) | birch leafblotch miner | Lepidoptera | Gracillariidae |
| Cameraria cincinnatiella (Cham.) | gregarious oak | Lepidoptera | Gracillariidae |
| | leafminer | | |
| Cameraria hamadryadella (Clem.) | solitary oak leafminer | Lepidoptera | Gracillariidae |
| Camnula pellucida (Scudd.) | clearwinged | Orthoptera | Acrididae |
| | grasshopper | | |
| Campaea perlata (Gn.) | fringed looper | Lepidoptera | Geometridae |
| Camponotus ferrugineus (F.) | red carpenter ant | Hymenoptera | Formicidae |
| Camponotus herculeanus (L.) | boreal carpenter ant | Hymenoptera | Formicidae |
| Camponotus pennsylvanicus | black carpenter ant | Hymenoptera | Formicidae |
| (DeG.) | | | |
| Campylomma verbasci (Meyer) | mullein bug | Heteroptera | Miridae |
| Canarsia ulmiarrosorella (Clem.) | elm leaftier | Lepidoptera | Pyralidae |
| Caripeta angustiorata Wlk. | brown pine looper | Lepidoptera | Geometridae |
| Caripeta divisata Wlk. | gray spruce looper | Lepidoptera | Geometridae |
| Carpoglyphus lactis (L.) | driedfruit mite | Acari | Carpoglyphidae |
| Carpophilus hemipterus (L.) | driedfruit beetle | Coleoptera | Nitidulidae |
| Carterocephalus palaemon | Arctic skipper | Lepidoptera | Hesperiidae |
| (Pallas) | | | |
| Cartodere constricta (Gyll.) | plaster beetle | Coleoptera | Lathridiidae |
| Carulaspis juniperi (Bouch,) | juniper scale | Homoptera | Diaspididae |
| Catastega aceriella Clem. | maple trumpet | Lepidoptera | Tortricidae |
| | skeletonizer | | |
| Catocala blandula Hulst | gray-blue underwing | Lepidoptera | Noctuidae |
| Catocala briseis Edw. | briseis underwing | Lepidoptera | Noctuidae |
| Catocala cerogama Gn. | yellowbanded | Lepidoptera | Noctuidae |
| | underwing | | |
| Catocala concumbens Wlk. | pink underwing | Lepidoptera | Noctuidae |
| Catocala gracilis Edw. | graceful underwing | Lepidoptera | Noctuidae |
| Catocala habilis Grt. | hickory underwing | Lepidoptera | Noctuidae |
| Catocala ilia (Cram.) | ilia underwing | Lepidoptera | Noctuidae |
| Catocala relicta Wlk. | white underwing | Lepidoptera | Noctuidae |
| Catocala sordida Grt. | blueberry underwing | Lepidoptera | Noctuidae |
| Catocala ultronia (Hbn.) | plum tree underwing | Lepidoptera | Noctuidae |
| Catocala unijuga Wlk. | oncemarried | Lepidoptera | Noctuidae |
| | underwing | | |
| Caulocampus acericaulis (MacG.) | maple petiole borer | Hymenoptera | Tenthredinidae |
| Cavariella aegopodii (Scop.) | carrot-willow aphid | Homoptera | Aphididae |
| Cecidomyia pellex O.S. | ash bulletgall midge | Diptera | Cecidomyiidae |
| Cecidomyia piniinopis O.S. | jack pine midge | Diptera | Cecidomyiidae |
| Cecidomyia resinicola (O.S.) | jack pine resin midge | Diptera | Cecidomyiidae |
| Cecidomyia verrucicola O.S. | linden wart gall | Diptera | Cecidomyiidae |
| | midge | | |
| Cecidophyopsis ribis (Westw.) | currant bud mite | Acari | Eriophyidae |
| Cecidophyopsis ribis (Westw.) | blackcurrant big bud | Acari | Eriophyidae |
| | mite | | |
| Celastrina argiolus (Cram.) | spring azure | Lepidoptera | Lycaenidae |
| Cephalcia fascipennis (Cress.) | spruce webspinning | Hymenoptera | Pamphiliidae |
| | sawfly | | |
| Cephalcia marginata Middk. | red pine webspinning | Hymenoptera | Pamphiliidae |
| | sawfly | | |
| Cephaloon lepturoides Newm. | false leptura beetle | Coleoptera | Cephaloidae |
| Cephus cinctus Nort. | wheat stem sawfly | Hymenoptera | Cephidae |
| Cephus pygmaeus (L.) | European wheat stem | Hymenoptera | Cephidae |
| | sawfly | | |
| Cerapteryx graminis L. | antler moth | Lepidoptera | Noctuidae |
| Ceratomia amyntor (Gey.) | elm sphinx | Lepidoptera | Sphingidae |
| Ceratomia undulosa (Wlk.) | waved sphinx | Lepidoptera | Sphingidae |
| Ceratophyllus gallinae (Schr.) | European chicken flea | Siphonaptera | Ceratophyllidae |
| Ceratophyllus niger Fox | western chicken flea | Siphonaptera | Ceratophyllidae |
| Cercyonis pegala (F.) | common wood | Lepidoptera | Satyridae |
| | nymph | | |
| Cerotoma trifurcata (Forst.) | bean leaf beetle | Coleoptera | Chrysomelidae |
| Ceutorhynchus assimilis (Payk.) | cabbage seedpod | Coleoptera | Curculionidae |
| | weevil | | |
| Ceutorhynchus rapae Gyll. | cabbage curculio | Coleoptera | Curculionidae |
| Chaetocnema pulicaria Melsh. | corn flea beetle | Coleoptera | Chrysomelidae |
| Chaetophloeus heterodoxus | mountain mahogany | Coleoptera | Scolytidae |
| (Casey) | bark beetle | | |
| Chaetosiphon fragaefolii (Ckll.) | strawberry aphid | Homoptera | Aphididae |
| Chaitophorus populicola Thos. | smokywinged poplar | Homoptera | Aphididae |
| | aphid | | |
| Chalcophora virginiensis (Drury) | sculptured pine borer | Coleoptera | Buprestidae |
| Charidotella sexpunctata bicolor | golden tortoise beetle | Coleoptera | Chrysomelidae |
| (F.) | | | |
| Charidryas harrisii (Scudd.) | Harris checkerspot | Lepidoptera | Nymphalidae |
| Charidryas nycteis (Dbly.) | silvery checkerspot | Lepidoptera | Nymphalidae |
| Cheimophila salicella (Hbn.) | blueberry flagleaf | Lepidoptera | Oecophoridae |
| | webworm | | |
| Chelopistes meleagridis (L.) | large turkey louse | Mallophaga | Philopteridae |
| Chelymorpha cassidea (F.) | argus tortoise beetle | Coleoptera | Chrysomelidae |
| Chilocorus stigma (Say) | twicestabbed lady | Coleoptera | Coccinellidae |
| | beetle | | |
| Chionaspis americana Johns. | elm scurfy scale | Homoptera | Diaspididae |
| Chionaspis corni Cooley | dogwood scale | Homoptera | Diaspididae |
| Chionaspis furfura (Fitch) | scurfy scale | Homoptera | Diaspididae |
| Chionaspis lintneri Comst. | Lintner scale | Homoptera | Diaspididae |
| Chionaspis pinifoliae (Fitch) | pine needle scale | Homoptera | Diaspididae |
| Chionaspis salicisnigrae (Walsh) | willow scurfy scale | Homoptera | Diaspididae |
| Chionodes formosella (Murt.) | spring oak leafroller | Lepidoptera | Gelechiidae |
| Chionodes obscurusella (Cham.) | boxelder leafworm | Lepidoptera | Gelechiidae |
| Chlorochlamys chloroleucaria | blackberry looper | Lepidoptera | Geometridae |
| (Gn.) | | | |
| Chlorochroa sayi (Stal) | Say stink bug | Heteroptera | Pentatomidae |
| Choreutis pariana (Cl.) | apple-and-thorn | Lepidoptera | Choreutidae |
| | skeletonizer | | |
| Chorioptes bovis (Gerl.) | chorioptic mange | Acari | Psoroptidae |
| | mite | | |
| Choristoneura biennis Free. | two-year-cycle | Lepidoptera | Tortricidae |
| | budworm | | |
| Choristoneura conflictana (Wlk.) | large aspen tortrix | Lepidoptera | Tortricidae |
| Choristoneura fractvittana (Clem.) | brokenbanded | Lepidoptera | Tortricidae |
| | leafroller | | |
| Choristoneura fumiferana (Clem.) | spruce budworm | Lepidoptera | Tortricidae |
| Choristoneura occidentalis Free. | western spruce | Lepidoptera | Tortricidae |
| | budworm | | |
| Choristoneura p. pinus Free. | jack pine budworm | Lepidoptera | Tortricidae |
| Choristoneura parallela (Rob.) | spotted fireworm | Lepidoptera | Tortricidae |
| Choristoneura rosaceana (Harr.) | obliquebanded | Lepidoptera | Tortricidae |
| | leafroller | | |
| Chortippus c. curtipennis (Harr.) | marsh meadow | Orthoptera | Acrididae |
| | grasshopper | | |
| Chromatomyia syngenesiae Hdy. | chrysanthemum | Diptera | Agromyzidae |
| | leafminer | | |
| Chrysobothris femorata (Oliv.) | flatheaded appletree | Coleoptera | Buprestidae |
| | borer | | |
| Chrysochus auratus (F.) | dogbane beetle | Coleoptera | Chrysomelidae |
| Chrysomela crotchi Brown | aspen leaf beetle | Coleoptera | Chrysomelidae |
| Chrysomela scripta F. | cottonwood leaf | Coleoptera | Chrysomelidae |
| | beetle | | |
| Chrysomela walshi Brown | balsam poplar leaf | Coleoptera | Chrysomelidae |
| | beetle | | |
| Chrysopa oculata Say | goldeneyed lacewing | Neuroptera | Chrysopidae |
| Chrysoperla carnea (Steph.) | common green | Neuroptera | Chrysopidae |
| | lacewing | | |
| Chrysoteuchia topiaria (Zell.) | cranberry girdler | Lepidoptera | Pyralidae |
| Cimbex americana Leach | elm sawfly | Hymenoptera | Cimbicidae |
| Cimex lectularius L. | bed bug | Heteroptera | Cimicidae |
| Cimex pilosellus (Horv.) | bat bug | Heteroptera | Cimicidae |
| Cinara banksiana P. & T. | jack pine aphid | Homoptera | Aphididae |
| Cinara curvipes (Patch) | balsam fir aphid | Homoptera | Aphididae |
| Cinara fornacula Hottes | green spruce aphid | Homoptera | Aphididae |
| Cinara laricifex (Fitch) | black larch aphid | Homoptera | Aphididae |
| Cinara laricis (Htg.) | larch aphid | Homoptera | Aphididae |
| Cinara pinea (Mord.) | pine aphid | Homoptera | Aphididae |
| Cinara strobi (Fitch) | white pine aphid | Homoptera | Aphididae |
| Cingilia catenaria (Drury) | chainspotted | Lepidoptera | Geometridae |
| | geometer | | |
| Circulifer tenellus (Baker) | beet leafhopper | Homoptera | Cicadellidae |
| Citheronia regalis (F.) | hickory horned devil | Lepidoptera | Saturniidae |
| Citheronia regalis (F.) | regal moth | Lepidoptera | Saturniidae |
| Clastoptera obtusa (Say) | alder spittlebug | Homoptera | Cercopidae |
| Clastoptera proteus Fitch | dogwood spittlebug | Homoptera | Cercopidae |
| Clepsis persicana (Fitch) | whitetriangle | Lepidoptera | Tortricidae |
| | leafroller | | |
| Clossiana titania grandis (B. & | purple lesser fritillary | Lepidoptera | Nymphalidae |
| McD.) | | | |
| Clostera albosigma Fitch | rustylined leaftier | Lepidoptera | Notodontidae |
| Clostera apicalis (Wlk.) | redmarked tentmaker | Lepidoptera | Notodontidae |
| Clostera inclusa (Hbn.) | poplar tentmaker | Lepidoptera | Notodontidae |
| Cnephasia longana (Haw.) | omnivorous leaftier | Lepidoptera | Tortricidae |
| Coccinella novemnotata Hbst. | ninespotted lady | Coleoptera | Coccinellidae |
| | beetle | | |
| Coccinella septempunctata L. | sevenspotted lady | Coleoptera | Coccinellidae |
| | beetle | | |
| Coccinella transversoguttata | transverse lady beetle | Coleoptera | Coccinellidae |
| richardsoni Brown | | | |
| Coccinella undecimpunctata L. | elevenspotted lady | Coleoptera | Coccinellidae |
| | beetle | | |
| Cochliomyia macellaria (F.) | secondary | Diptera | Calliphoridae |
| | screwworm | | |
| Coenonympha inornata Edw. | inornate ringlet | Lepidoptera | Satyridae |
| Coleophora laricella (Hbn.) | larch casebearer | Lepidoptera | Coleophoridae |
| Coleophora laticornella Clem. | pecan cigar | Lepidoptera | Coleophoridae |
| | casebearer | | |
| Coleophora limosipennella (Dup.) | elm casebearer | Lepidoptera | Coleophoridae |
| Coleophora malivorella Riley | pistol casebearer | Lepidoptera | Coleophoridae |
| Coleophora pruniella Clem. | cherry casebearer | Lepidoptera | Coleophoridae |
| Coleophora serratella (L.) | cigar casebearer | Lepidoptera | Coleophoridae |
| Coleophora serratella (L.) | birch casebearer | Lepidoptera | Coleophoridae |
| Coleotechnites apicitripunctella | green hemlock | Lepidoptera | Gelechiidae |
| (Clem.) | needleminer | | |
| Coleotechnites canusella (Free.) | banded jack pine | Lepidoptera | Gelechiidae |
| | needleminer | | |
| Coleotechnites laricis (Free.) | orange larch | Lepidoptera | Gelechiidae |
| | tubemaker | | |
| Coleotechnites macleodi (Free.) | brown hemlock | Lepidoptera | Gelechiidae |
| | needleminer | | |
| Coleotechnites milleri (Bsk.) | lodgepole | Lepidoptera | Gelechiidae |
| | needleminer | | |
| Coleotechnites piceaella (Kft.) | orange spruce | Lepidoptera | Gelechiidae |
| | needleminer | | |
| Coleotechnites resinosae (Free.) | red pine needleminer | Lepidoptera | Gelechiidae |
| Coleotechnites thujaella (Kft.) | brown cedar | Lepidoptera | Gelechiidae |
| | leafminer | | |
| Colias eurytheme Bdv. | alfalfa caterpillar | Lepidoptera | Pieridae |
| Colias interior Scudd. | pinkedged sulphur | Lepidoptera | Pieridae |
| Colias philodice Godt. | clouded sulphur | Lepidoptera | Pieridae |
| Colomerus vitis (Pgst.) | grape erineum mite | Acari | Eriophyidae |
| Colopha ulmicola (Fitch) | elm cockscombgall | Homoptera | Aphididae |
| | aphid | | |
| Coloradia pandora Blake | pandora moth | Lepidoptera | Saturniidae |
| Conophthorus coniperda (Schw.) | white pine cone | Coleoptera | Scolytidae |
| | beetle | | |
| Conophthorus ponderosae Hopk. | ponderosa pine cone | Coleoptera | Scolytidae |
| | beetle | | |
| Conophthorus ponderosae Hopk. | lodgepole cone beetle | Coleoptera | Scolytidae |
| Conophthorus resinosae Hopk. | red pine cone beetle | Coleoptera | Scolytidae |
| Conotrachelus juglandis LeC. | butternut curculio | Coleoptera | Curculionidae |
| Conotrachelus nenuphar (Hbst.) | plum curculio | Coleoptera | Curculionidae |
| Contarinia baeri (Prell) | European pineneedle | Diptera | Cecidomyiidae |
| | midge | | |
| Contarinia bromicola (M. & A.) | bromegrass seed | Diptera | Cecidomyiidae |
| | midge | | |
| Contarinia canadensis Felt | ash midribgall midge | Diptera | Cecidomyiidae |
| Contarinia johnsoni Felt | grape blossom midge | Diptera | Cecidomyiidae |
| Contarinia negundifolia Felt | boxelder leaf gall | Diptera | Cecidomyiidae |
| | midge | | |
| Contarinia negundinis (Gill.) | boxelder budgall | Diptera | Cecidomyiidae |
| | midge | | |
| Contarinia oregonensis Foote | Douglas-fir cone gall | Diptera | Cecidomyiidae |
| | midge | | |
| Contarinia pyrivora (Riley) | pear midge | Diptera | Cecidomyiidae |
| Contarinia schulzi Gagn, | sunflower midge | Diptera | Cecidomyiidae |
| Contarinia virginianae (Felt) | chokecherry midge | Diptera | Cecidomyiidae |
| Contarinia washingtonensis Johns. | Douglas-fir cone | Diptera | Cecidomyiidae |
| | scale midge | | |
| Corcyra cephalonica (Staint.) | rice moth | Lepidoptera | Pyralidae |
| Corthylus punctatissimus (Zimm.) | pitted ambrosia beetle | Coleoptera | Scolytidae |
| Corydalus cornutus (L.) | dobsonfly | Neuroptera | Corydalidae |
| Corydalus cornutus (L.) | hellgrammite | Neuroptera | Corydalidae |
| Corythucha arcuata (Say) | oak lace bug | Heteroptera | Tingidae |
| Corythucha ciliata (Say) | sycamore lace bug | Heteroptera | Tingidae |
| Corythucha elegans Drake | willow lace bug | Heteroptera | Tingidae |
| Corythucha heidemanni Drake | alder lace bug | Heteroptera | Tingidae |
| Corythucha juglandis (Fitch) | walnut lace bug | Heteroptera | Tingidae |
| Corythucha pallipes Parsh. | birch lace bug | Heteroptera | Tingidae |
| Corythucha ulmi O. & D. | elm lace bug | Heteroptera | Tingidae |
| Cotalpa lanigera (L.) | goldsmith beetle | Coleoptera | Scarabaeidae |
| Craponius inaequalis (Say) | grape curculio | Coleoptera | Curculionidae |
| Creophilus maxillosus (L.) | hairy rove beetle | Coleoptera | Staphylinidac |
| Crepidodera nana (Say) | tiny aspen flea beetle | Coleoptera | Chrysomelidae |
| Crioceris asparagi (L.) | asparagus beetle | Coleoptera | Chrysomelidae |
| Crioceris duodecimpunctata (L.) | spotted asparagus | Coleoptera | Chrysomelidae |
| | beetle | | |
| Crocigrapha normani (Grt.) | climbing cherry | Lepidoptera | Noctuidae |
| | cutworm | | |
| Croesia curvalana (Kft.) | blueberry leafier | Lepidoptera | Tortricidae |
| Croesia semipurpurana (Kft.) | oak leafshredder | Lepidoptera | Tortricidae |
| Croesus latitarsus Nort. | dusky birch sawfly | Hymenoptera | Tenthredinidae |
| Cryptocala acadiensis (Bethune) | catocaline dart | Lepidoptera | Noctuidae |
| Cryptococcus fagisuga Lind. | beech scale | Homoptera | Eriococcidae |
| Cryptolestes ferrugineus (Steph.) | rusty grain beetle | Coleoptera | Cucujidae |
| Cryptolestes pusillus (Schonh.) | flat grain beetle | Coleoptera | Cucujidae |
| Cryptolestes turcicus (Grouv.) | flourmill beetle | Coleoptera | Cucujidae |
| Cryptomyzus ribis (L.) | currant aphid | Homoptera | Aphididae |
| Cryptophagus varus W. & C. | sigmoid fungus beetle | Coleoptera | Cryptophagidae |
| Cryptorhynchus lapathi (L.) | poplar-and-willow | Coleoptera | Curculionidae |
| | borer | | |
| Ctenicera aeripennis (Kby.) | Puget Sound | Coleoptera | Elateridae |
| | wireworm | | |
| Ctenicera destructor (Brown) | prairie grain | Coleoptera | Elateridae |
| | wireworm | | |
| Ctenicera propola propola LeC. | twospotted click | Coleoptera | Elateridae |
| | beetle | | |
| Ctenicera pruinina (Horn) | Great Basin | Coleoptera | Elateridae |
| | wireworm | | |
| Ctenicera r. resplendens (Esch.) | green click beetle | Coleoptera | Elateridae |
| Ctenicera triundulata (Rand.) | threespotted click | Coleoptera | Elateridae |
| | beetle | | |
| Ctenocephalides canis (Curt.) | dog flea | Siphonaptera | Pulicidae |
| Ctenocephalides felis (Bouch,) | cat flea | Siphonaptera | Pulicidae |
| Cucullia intermedia Speyer | goldenrod cutworm | Lepidoptera | Noctuidae |
| Culex pipiens L. | northern house | Diptera | Culicidae |
| | mosquito | | |
| Curculio uniformis (LeC.) | filbert weevil | Coleoptera | Curculionidae |
| Cuterebra tenebrosa Coq. | rodent bot fly | Diptera | Oestridae |
| Cydia caryana (Fitch) | hickory shuckworm | Lepidoptera | Tortricidae |
| Cydia latiferreana (Wlsm.) | filbertworm | Lepidoptera | Tortricidae |
| Cydia nigricana (F.) | pea moth | Lepidoptera | Tortricidae |
| Cydia piperana Kft. | ponderosa pine | Lepidoptera | Tortricidae |
| | seedworm | | |
| Cydia pomonella (L.) | codling moth | Lepidoptera | Tortricidae |
| Cydia strobilella (L.) | spruce seed moth | Lepidoptera | Tortricidae |
| Cydia toreuta (Grt.) | eastern pine | Lepidoptera | Tortricidae |
| | seedworm | | |
| Cynaeus angustus (LeC.) | larger black flour | Coleoptera | Tenebrionidae |
| | beetle | | |
| Cytodites nudus (Vizioli) | airsac mite | Acari | Cytoditidae |
| Daktulosphaira vitifoliae (Fitch) | grape phylloxera | Homoptera | Phylloxeridae |
| Danaus plexippus (L.) | monarch butterfly | Lepidoptera | Danaidae |
| Darapsa myron (Cram.) | Virginiacreeper | Lepidoptera | Sphingidae |
| | sphinx | | |
| Darapsa versicolor (Harr.) | hydrangea sphinx | Lepidoptera | Sphingidae |
| Dasineura balsamicola (Lint.) | introduced false | Diptera | Cecidomyiidae |
| | balsam gall midge | | |
| Dasineura communis Felt | gouty vein midge | Diptera | Cecidomyiidae |
| Dasineura gleditchiae O.S. | honeylocust podgall | Diptera | Cecidomyiidae |
| | midge | | |
| Dasineura leguminicola (Lint.) | clover seed midge | Diptera | Cecidomyiidae |
| Dasineura mali (Keif.) | apple leaf midge | Diptera | Cecidomyiidae |
| Dasineura rhodophaga (Coq.) | rose midge | Diptera | Cecidomyiidae |
| Dasineura swainei (Felt) | spruce bud midge | Diptera | Cecidomyiidae |
| Dasychira dorsipennata (B. & | hardwood tussock | Lepidoptera | Lymantriidae |
| McD.) | moth | | |
| Dasychira pinicola (Dyar) | pine tussock moth | Lepidoptera | Lymantriidae |
| Dasychira plagiata (Wlk.) | northern pine tussock | Lepidoptera | Lymantriidae |
| | moth | | |
| Dasylophia thyatiroides (Wlk.) | beech caterpillar | Lepidoptera | Notodontidae |
| Datana integerrima G. & R. | walnut caterpillar | Lepidoptera | Notodontidae |
| Datana ministra (Drury) | yellownecked | Lepidoptera | Notodontidae |
| | caterpillar | | |
| Deidamia inscripta (Harr.) | lettered sphinx | Lepidoptera | Sphingidae |
| Delia antiqua (Meig.) | onion maggot | Diptera | Anthomyiidae |
| Delia floralis (Fall.) | turnip maggot | Diptera | Anthomyiidae |
| Delia platura (Meig.) | seedcorn maggot | Diptera | Anthomyiidae |
| Delia radicum (L.) | cabbage maggot | Diptera | Anthomyiidae |
| Demodex bovis Stiles | cattle follicle mite | Acari | Demodicidae |
| Demodex cati M, gn. | cat follicle mite | Acari | Demodicidae |
| Demodex equi Raill. | horse follicle mite | Acari | Demodicidae |
| Demodex ovis Raill. | sheep follicle mite | Acari | Demodicidae |
| Demodex phylloides Csokor | hog follicle mite | Acari | Demodicidae |
| Dendroctonus brevicomis LeC. | western pine beetle | Coleoptera | Scolytidae |
| Dendroctonus frontalis Zimm. | southern pine beetle* | Coleoptera | Scolytidae |
| Dendroctonus murrayanae Hopk. | lodgepole pine beetle | Coleoptera | Scolytidae |
| Dendroctonus ponderosae Hopk. | mountain pine beetle | Coleoptera | Scolytidae |
| Dendroctonus pseudotsugae Hopk. | Douglas-fir beetle | Coleoptera | Scolytidae |
| Dendroctonus punctatus LeC. | boreal spruce beetle | Coleoptera | Scolytidae |
| Dendroctonus rufipennis (Kby.) | spruce beetle | Coleoptera | Scolytidae |
| Dendroctonus simplex LeC. | eastern larch beetle | Coleoptera | Scolytidae |
| Dendroctonus valens LeC. | red turpentine beetle | Coleoptera | Scolytidae |
| Depressaria pastinacella (Dup.) | parsnip webworm | Lepidoptera | Oecophoridae |
| Dermacentor albipictus (Pack.) | winter tick | Acari | Ixodidae |
| Dermacentor andersoni Stiles | Rocky Mountain | Acari | Ixodidae |
| | wood tick | | |
| Dermacentor variabilis (Say) | American dog tick | Acari | Ixodidae |
| Dermanyssus gallinae (DeG.) | chicken mite | Acari | Dermanyssidae |
| Dermatophagoides farinae Hughes | American house dust | Acari | Epidermoptidae |
| | mite | | |
| Dermatophagoides pteronyssinus | European house dust | Acari | Epidermoptidae |
| (Troues.) | mite | | |
| Dermestes ater DeG. | black larder beetle | Coleoptera | Dermestidae |
| Dermestes lardarius L. | larder beetle | Coleoptera | Dermestidae |
| Dermestes maculatus DeG. | hide beetle | Coleoptera | Dermestidae |
| Desmia funeralis (Hbn.) | grape leaffolder | Lepidoptera | Pyralidae |
| Desmocerus palliatus (Forst.) | elder borer | Coleoptera | Cerambycidae |
| Diabrotica barberi S. & L. | northern corn | Coleoptera | Chrysomelidae |
| | rootworm | | |
| Diabrotica undecimpunctata | spotted cucumber | Coleoptera | Chrysomelidae |
| howardi Barber | beetle | | |
| Diabrotica v. virgifera LeC. | western corn | Coleoptera | Chrysomelidae |
| | rootworm | | |
| Diapheromera femorata (Say) | walkingstick | Phasmatodea | Heteronemiidae |
| Diaspidiotus ancylus (Putn.) | Putnam scale | Homoptera | Diaspididae |
| Dicerca divaricata (Say) | flatheaded hardwood | Coleoptera | Buprestidae |
| | borer | | |
| Dicerca tenebrica (Kby.) | flatheaded poplar | Coleoptera | Buprestidae |
| | borer | | |
| Dicerca tenebrosa (Kby.) | flatheaded conifer | Coleoptera | Buprestidae |
| | borer | | |
| Dichelonyx backii (Kby.) | green rose chafer | Coleoptera | Scarabaeidae |
| Dichomeris ligulella Hbn. | palmerworm | Lepidoptera | Gelechiidae |
| Dichomeris marginella (F.) | juniper webworm | Lepidoptera | Gelechiidae |
| Dimorphopteryx melanognathus | fringed birch sawfly | Hymenoptera | Tenthredinidae |
| Roh. | | | |
| Dioryctria abietivorella (Grt.) | fir coneworm | Lepidoptera | Pyralidae |
| Dioryctria auranticella (Grt.) | ponderosa pine | Lepidoptera | Pyralidae |
| | coneworm | | |
| Dioryctria disclusa Heinr. | webbing coneworm | Lepidoptera | Pyralidae |
| Dioryctria reniculelloides Mut. & | spruce coneworm | Lepidoptera | Pyralidae |
| Mun. | | | |
| Dioryctria resinosella Mut. | red pine shoot moth | Lepidoptera | Pyralidae |
| Dioryctria zimmermani (Grt.) | Zimmerman pine | Lepidoptera | Pyralidae |
| | moth | | |
| Diplolepis radicum (O.S.) | rose root gall wasp | Hymenoptera | Cynipidae |
| Diplolepis rosae (L.) | mossyrose gall wasp | Hymenoptera | Cynipidae |
| Diprion similis (Htg.) | introduced pine | Hymenoptera | Diprionidae |
| | sawfly | | |
| Diptacus gigantorhynchus (Nal.) | bigbeaked plum mite | Acari | Diptilomiopidae |
| Discestra trifolii (Hufn.) | clover cutworm | Lepidoptera | Noctuidae |
| Disonycha alternata (Ill.) | striped willow leaf | Coleoptera | Chrysomelidae |
| | beetle | | |
| Disonycha triangularis (Say) | threespotted flea | Coleoptera | Chrysomelidae |
| | beetle | | |
| Disonycha xanthomelas (Dalm.) | spinach flea beetle | Coleoptera | Chrysomelidae |
| Dissosteira carolina (L.) | Carolina grasshopper | Orthoptera | Acrididae |
| Diuraphis noxia (Mordv.) | Russian wheat aphid | Homoptera | Aphididae |
| Diuraphis tritici (Gill.) | western wheat aphid | Homoptera | Aphididae |
| Dolichovespula arenaria (F.) | aerial yellowjacket | Hymenoptera | Vespidae |
| Dolichovespula maculata (L.) | baldfaced hornet | Hymenoptera | Vespidae |
| Drepana arcuata Wlk. | masked birch | Lepidoptera | Drepanidae |
| | caterpillar | | |
| Drepana bilineata (Pack.) | warty birch caterpillar | Lepidoptera | Drepanidae |
| Drepanaphis acerifoliae (Thos.) | painted maple aphid | Homoptera | Aphididae |
| Dryocampa rubicunda (F.) | greenstriped | Lepidoptera | Saturniidae |
| | mapleworm | | |
| Dryocoetes betulae Hopk. | birch bark beetle | Coleoptera | Scolytidae |
| Dryocoetes confusus Swaine | western balsam bark | Coleoptera | Scolytidae |
| | beetle | | |
| Dysaphis plantaginea (Pass.) | rosy apple aphid | Homoptera | Aphididae |
| Dysstroma citrata (L.) | dark marbled carpet | Lepidoptera | Geometridae |
| Eacles imperialis pini Mich. | pine imperial moth | Lepidoptera | Saturniidae |
| Earomyia abietum McAlp. | fir seed maggot | Diptera | Lonchaeidae |
| Ecdytolopha insiticiana Zell. | locust twig borer | Lepidoptera | Tortricidae |
| Ectoedemia lindquisti (Free.) | small birch leafminer | Lepidoptera | Nepticulidae |
| Ectropis crepuscularia (D. & S.) | saddleback looper | Lepidoptera | Geometridae |
| Eilema bicolor (Grt.) | smoky moth | Lepidoptera | Arctiidae |
| Elaphria versicolor (Grt.) | fir harlequin | Lepidoptera | Noctuidae |
| Elasmostethus cruciatus Say | redcrossed stink bug | Heteroptera | Acanthosomatida |
| Elatobium abietinum (Wlk.) | spruce aphid | Homoptera | Aphididae |
| Empoasca fabae (Harr.) | potato leafhopper | Homoptera | Cicadellidae |
| Empoasca maligna (Walsh) | apple leafhopper | Homoptera | Cicadellidae |
| Enargia decolor (Wlk.) | aspen twoleaf tier | Lepidoptera | Noctuidae |
| Enchenopa binotata (Say) | twomarked | Homoptera | Membracidae |
| | treehopper | | |
| Endelomyia aethiops (F.) | roseslug | Hymenoptera | Tenthredinidae |
| Endopiza viteana Clem. | grape berry moth | Lepidoptera | Tortricidae |
| Endothenia albolineana (Kft.) | spruce needleminer | Lepidoptera | Tortricidae |
| Endrosis sarcitrella (L.) | whiteshouldered | Lepidoptera | Oecophoridae |
| | house moth | | |
| Ennomos magnaria Gn. | maple spanworm | Lepidoptera | Geometridae |
| Ennomos subsignaria (Hbn.) | elm spanworm | Lepidoptera | Geometridae |
| Enodia anthedon Clark | northern pearly eye | Lepidoptera | Satyridae |
| Entomoscelis americana Brown | red turnip beetle | Coleoptera | Chrysomelidae |
| Epargyreus clarus (Cram.) | silverspotted skipper | Lepidoptera | Hesperiidae |
| Ephestia elutella (Hbn.) | tobacco moth | Lepidoptera | Pyralidae |
| Ephestia kuehniella Zell. | Mediterranean flour | Lepidoptera | Pyralidae |
| | moth | | |
| Epicauta fabricii (LeC.) | ashgray blister beetle | Coleoptera | Meloidae |
| Epicauta maculata (Say) | spotted blister beetle | Coleoptera | Meloidae |
| Epicauta murina (LeC.) | dark blister beetle | Coleoptera | Meloidae |
| Epicauta pennsylvanica (DeG.) | black blister beetle | Coleoptera | Meloidae |
| Epicauta pestifera Werner | margined blister | Coleoptera | Meloidae |
| | beetle* | | |
| Epicauta subglabra (Fall) | caragana blister beetle | Coleoptera | Meloidae |
| Epicauta vittata (F.) | striped blister beetle | Coleoptera | Meloidae |
| Epilachna varivestis Muls. | Mexican bean beetle | Coleoptera | Coccinellidae |
| Epinotia meritana Heinr. | white fir needleminer | Lepidoptera | Tortricidae |
| Epinotia nanana (Treit.) | European spruce | Lepidoptera | Tortricidae |
| | needleminer | | |
| Epinotia nisella (Cl.) | yellowheaded aspen | Lepidoptera | Tortricidae |
| | leaftier | | |
| Epinotia radicana (Heinr.) | redstriped | Lepidoptera | Tortricidae |
| | needleworm | | |
| Epinotia solandriana (L.) | birch-aspen leafroller | Lepidoptera | Tortricidae |
| Epinotia solicitana (Wlk.) | birch shootworm | Lepidoptera | Tortricidae |
| Epinotia timidella (Clem.) | oak trumpet | Lepidoptera | Tortricidae |
| | skeletonizer | | |
| Epinotia tsugana Free. | hemlock needleminer | Lepidoptera | Tortricidae |
| Epirrita autumnata henshawi | November moth | Lepidoptera | Geometridae |
| (Swett) | | | |
| Epitrimerus pyri (Nal.) | pear rust mite | Acari | Eriophyidae |
| Epitrix cucumeris (Harr.) | potato flea beetle | Coleoptera | Chrysomelidae |
| Epitrix hirtipennis (Melsh.) | tobacco flea beetle | Coleoptera | Chrysomelidae |
| Epitrix subcrinita (LeC.) | western potato flea | Coleoptera | Chrysomelidae |
| | beetle | | |
| Epitrix tuberis Gent. | tuber flea beetle | Coleoptera | Chrysomelidae |
| Erannis tiliaria (Harr.) | linden looper | Lepidoptera | Geometridae |
| Erannis tiliaria vancouverensis | western winter moth | Lepidoptera | Geometridae |
| Hulst | | | |
| Ergates spiculatus (LeC.) | ponderous borer | Coleoptera | Cerambycidae |
| Eriocampa juglandis (Fitch) | woolly butternut | Hymenoptera | Tenthredinidae |
| | sawfly | | |
| Eriocampa ovata (L.) | woolly alder sawfly | Hymenoptera | Tenthredinidae |
| Eriophyes betulae (Nal.) | birch witches broom | Acari | Eriophyidae |
| | mite | | |
| Eriophyes pyri (Pgst.) | pearleaf blister mite | Acari | Eriophyidae |
| Eriosoma americanum (Riley) | woolly elm aphid | Homoptera | Aphididae |
| Eriosoma crataegi (Oestl.) | woolly hawthorn | Homoptera | Aphididae |
| | aphid | | |
| Eriosoma lanigerum (Hausm.) | woolly apple aphid | Homoptera | Aphididae |
| Eristalis tenax (L.) | drone fly | Diptera | Syrphidae |
| Eristalis tenax (L.) | rattailed maggot | Diptera | Syrphidae |
| Erynnis icelus (Scudd. & Burg.) | dreamy dusky wing | Lepidoptera | Hesperiidae |
| Erynnis juvenalis (F.) | Juvenal dusky wing | Lepidoptera | Hesperiidae |
| Erythroneura comes (Say) | grape leafhopper | Homoptera | Cicadellidae |
| Erythroneura tricincta Fitch | threebanded | Homoptera | Cicadellidae |
| | leafhopper | | |
| Erythroneura vitis (Harr.) | grapevine leafhopper | Homoptera | Cicadellidae |
| Erythroneura ziczac Walsh | Virginiacreeper | Homoptera | Cicadellidae |
| | leafhopper | | |
| Estigmene acrea (Drury) | saltmarsh caterpillar | Lepidoptera | Arctiidae |
| Euceraphis punctipennis (Zett.) | European birch aphid | Homoptera | Aphididae |
| Euchaetes egle (Drury) | milkweed tussock | Lepidoptera | Arctiidae |
| | moth | | |
| Euclea delphinii (Bdv.) | spiny slug caterpillar | Lepidoptera | Limacodidae |
| Eucosma gloriola Heinr. | eastern pine shoot | Lepidoptera | Tortricidae |
| | borer | | |
| Eucosma monitorana Heinr. | red pine cone borer | Lepidoptera | Tortricidae |
| Eucosma recissoriana Heinr. | lodgepole pine cone | Lepidoptera | Tortricidae |
| | borer | | |
| Eucosma siskiyouana (Kft.) | fir cone borer | Lepidoptera | Tortricidae |
| Eucosma sonomana Kft. | western pine shoot | Lepidoptera | Tortricidae |
| | borer | | |
| Eucosma tocullionana Heinr. | white pine cone borer | Lepidoptera | Tortricidae |
| Eudryas grata (F.) | beautiful wood | Lepidoptera | Noctuidae |
| | nymph | | |
| Eudryas unio (Hbn.) | pearly wood nymph | Lepidoptera | Noctuidae |
| Eulachnus agilis (Kltb.) | spotted pineneedle | Homoptera | Aphididae |
| | aphid | | |
| Eulithis diversilineata (Hbn.) | grapevine looper | Lepidoptera | Geometridae |
| Eumerus strigatus (Fall.) | onion bulb fly | Diptera | Syrphidae |
| Eumerus tuberculatus Rond. | lesser bulb fly | Diptera | Syrphidae |
| Eumorpha achemon (Drury) | achemon sphinx | Lepidoptera | Sphingidae |
| Eumorpha pandorus (Hbn.) | pandora sphinx | Lepidoptera | Sphingidae |
| Eupareophora parca (Cress.) | spiny ash sawfly | Hymenoptera | Tenthredinidae |
| Euparthenos nubilis (Hbn.) | locust underwing | Lepidoptera | Noctuidae |
| Euphoria inda (L.) | bumble flower beetle | Coleoptera | Scarabaeidae |
| Euphranta canadensis (Loew) | currant fruit fly | Diptera | Tephritidae |
| Euphydryas phaeton (Drury) | Baltimore | Lepidoptera | Nymphalidae |
| Euphyes vestris (Bdv.) | dun skipper | Lepidoptera | Hesperiidae |
| Eupithecia filmata Pears. | early brown looper | Lepidoptera | Geometridae |
| Eupithecia luteata Pack. | fir needle inchworm | Lepidoptera | Geometridae |
| Eupithecia mutata Pears. | spruce cone looper | Lepidoptera | Geometridae |
| Eupithecia palpata Pack. | small pine looper | Lepidoptera | Geometridae |
| Eupithecia spermaphaga (Dyar) | fir cone looper | Lepidoptera | Geometridae |
| Eupithecia transcanadata MacK. | small conifer looper | Lepidoptera | Geometridae |
| Euproctis chrysorrhoea (L.) | browntail moth | Lepidoptera | Lymantriidae |
| Eupsilia tristigmata (Grt.) | brown fruitworm | Lepidoptera | Noctuidae |
| Euptoieta claudia (Cram.) | variegated fritillary | Lepidoptera | Nymphalidae |
| Eurema lisa Bdv. & LeC. | little sulphur | Lepidoptera | Pieridae |
| Eurema nicippe (Cram.) | sleepy orange | Lepidoptera | Pieridae |
| Euschistus tristigmus (Say) | dusky stink bug | Heteroptera | Pentatomidae |
| Euschistus variolarius (P. de B.) | onespotted stink bug | Heteroptera | Pentatomidae |
| Eutrapela clemataria (J. E. Smith) | purplishbrown looper | Lepidoptera | Geometridae |
| Eutrombidium trigonum (Herm.) | red grasshopper mite | Acari | Trombidiidae |
| Euura atra (Jur.) | smaller willow shoot | Hymenoptera | Tenthredinidae |
| | sawfly | | |
| Euxoa auxiliaris (Grt.) | army cutworm | Lepidoptera | Noctuidae |
| Euxoa detersa (Wlk.) | sand cutworm | Lepidoptera | Noctuidae |
| Euxoa messoria (Harr.) | darksided cutworm | Lepidoptera | Noctuidae |
| Euxoa ochrogaster (Gn.) | redbacked cutworm | Lepidoptera | Noctuidae |
| Euxoa scandens (Riley) | white cutworm | Lepidoptera | Noctuidae |
| Euxoa tessellata (Harr.) | striped cutworm | Lepidoptera | Noctuidae |
| Euxoa tristicula (Morr.) | early cutworm | Lepidoptera | Noctuidae |
| Euzophera semifuneralis (Wlk.) | American plum borer | Lepidoptera | Pyralidae |
| Everes amyntula (Bdv.) | western tailed blue | Lepidoptera | Lycaenidae |
| Everes comyntas (Godt.) | eastern tailed blue | Lepidoptera | Lycaenidae |
| Evergestis pallidata (Hufn.) | purplebacked | Lepidoptera | Pyralidae |
| | cabbageworm | | |
| Evergestis rimosalis (Gn.) | cross-striped | Lepidoptera | Pyralidae |
| | cabbageworm | | |
| Evora hemidesma (Zell.) | spirea leaftier | Lepidoptera | Tortricidae |
| Exoteleia dodecella (L.) | pine bud moth | Lepidoptera | Gelechiidae |
| Exoteleia nepheos Free. | pine candle moth | Lepidoptera | Gelechiidae |
| Fannia canicularis (L.) | little house fly | Diptera | Muscidae |
| Fannia scalaris (F.) | latrine fly | Diptera | Muscidae |
| Faronta diffusa (Wlk.) | wheat head | Lepidoptera | Noctuidae |
| | armyworm | | |
| Felicola subrostratus (Burm.) | cat louse | Mallophaga | Trichodectidae |
| Feltia jaculifera (Gn.) | dingy cutworm | Lepidoptera | Noctuidae |
| Feniseca tarquinius (F.) | harvester | Lepidoptera | Lycaenidae |
| Fenusa dohrnii (Tisch.) | European alder | Hymenoptera | Tenthredinidae |
| | leafminer | | |
| Fenusa pusilla (Lep.) | birch leafminer | Hymenoptera | Tenthredinidae |
| Fidia viticida Walsh | grape rootworm | Coleoptera | Chrysomelidae |
| Fishia discors (Grt.) | garden cutworm | Lepidoptera | Noctuidae |
| Forficula auricularia L. | European earwig | Dermaptera | Forficulidae |
| Formica exsectoides Forel | Allegheny mound ant | Hymenoptera | Formicidae |
| Formica fusca L. | silky ant | Hymenoptera | Formicidae |
| Formica obscuripes Forel | western thatching ant | Hymenoptera | Formicidae |
| Frankliniella occidentalis (Perg.) | western flower thrips | Thysanoptera | Thripidae |
| Frankliniella tritici (Fitch) | flower thrips | Thysanoptera | Thripidae |
| Frankliniella vaccinii Morg. | blueberry thrips | Thysanoptera | Thripidae |
| Galeruca browni Blake | peppergrass beetle | Coleoptera | Chrysomelidae |
| Galerucella nymphaeae (L.) | waterlily leaf beetle | Coleoptera | Chrysomelidae |
| Galleria mellonella (L.) | greater wax moth | Lepidoptera | Pyralidae |
| Galleria mellonella (L.) | waxworm | Lepidoptera | Pyralidae |
| Gargaphia tiliae (Walsh) | basswood lace bug | Heteroptera | Tingidae |
| Gasterophilus haemorrhoidalis | nose bot fly | Diptera | Oestridae |
| (L.) | | | |
| Gasterophilus intestinalis (DeG.) | horse bot fly | Diptera | Oestridae |
| Gasterophilus nasalis (L.) | throat bot fly | Diptera | Oestridae |
| Gilpinia frutetorum (F.) | nursery pine sawfly | Hymenoptera | Diprionidae |
| Gilpinia hercyniae (Htg.) | European spruce | Hymenoptera | Diprionidae |
| | sawfly | | |
| Givira lotta B.& McD. | pine carpenterworm | Lepidoptera | Cossidae |
| Glaucopsyche lygdamus (Dbly.) | silvery blue | Lepidoptera | Lycaenidae |
| Glischrochilus quadrisignatus | fourspotted sap beetle | Coleoptera | Nitidulidae |
| (Say) | | | |
| Glycobius speciosus (Say) | sugar maple borer | Coleoptera | Cerambycidae |
| Glyphipteryx linneella (Cl.) | linden bark borer | Lepidoptera | Glyphipterigidae |
| Glyptoscelis pubescens (F.) | hairy leaf beetle | Coleoptera | Chrysomelidae |
| Gnatocerus cornutus (F.) | broadhorned flour | Coleoptera | Tenebrionidae |
| | beetle | | |
| Goes tesselatus (Hald.) | oak sapling borer* | Coleoptera | Cerambycidae |
| Gonioctena americana (Schaeff.) | American aspen | Coleoptera | Chrysomelidae |
| | beetle | | |
| Goniodes gigas (Tasch.) | large chicken louse | Mallophaga | Philopteridae |
| Gossyparia spuria (Mod.) | European elm scale | Homoptera | Eriococcidae |
| Grammia virguncula (Kby.) | little virgin tiger moth | Lepidoptera | Arctiidae |
| Grapholita interstinctana (Clem.) | clover head caterpillar | Lepidoptera | Tortricidae |
| Grapholita molesta (Bsk.) | oriental fruit moth | Lepidoptera | Tortricidae |
| Grapholita packardi Zell. | cherry fruitworm | Lepidoptera | Tortricidae |
| Grapholita prunivora (Walsh) | lesser appleworm | Lepidoptera | Tortricidae |
| Gretchena delicatana Heinr. | ironwood fruitworm | Lepidoptera | Tortricidae |
| Grylloprociphilus imbricator | beech blight aphid | Homoptera | Aphididae |
| (Fitch) | | | |
| Gryllus pennsylvanicus Burm. | fall field cricket | Grylloptera | Gryllidae |
| Gryllus veletis (Alex. & Big.) | spring field cricket | Grylloptera | Gryllidae |
| Gypsonoma haimbachiana (Kft.) | cottonwood twig | Lepidoptera | Tortricidae |
| | borer | | |
| Haemaphysalis chordeilis (Pack.) | bird tick | Acari | Ixodidae |
| Haemaphysalis leporispalustris | rabbit tick | Acari | Ixodidae |
| (Pack.) | | | |
| Haematobia irritans (L.) | horn fly | Diptera | Muscidae |
| Haematopinus asini (L.) | horse sucking louse | Anoplura | Haematopinidae |
| Haematopinus eurysternus (Nitz.) | shortnosed cattle | Anoplura | Haematopinidae |
| | louse | | |
| Haematopinus suis (L.) | hog louse | Anoplura | Haematopinidae |
| Haemodipsus ventricosus (Denny) | rabbit louse | Anoplura | Hoplopleuridae |
| Halysidota harrisii Walsh | sycamore tussock | Lepidoptera | Arctiidae |
| | moth | | |
| Halysidota tessellaris (J. E. Smith) | pale tussock moth | Lepidoptera | Arctiidae |
| Hamamelistes spinosus Shimer | witch hazel gall aphid | Homoptera | Aphididae |
| Haploa confusa (Lyman) | Lyman haploa | Lepidoptera | Arctiidae |
| Haploa lecontei (G.-M.) | Leconte haploa | Lepidoptera | Arctiidae |
| Haplothrips leucanthemi Schr. | clover thrips | Thysanoptera | Phlaeothripidae |
| Harkenclenus titus (F.) | coral hairstreak | Lepidoptera | Lycaenidae |
| Harrisimemna trisignata (Wlk.) | Harris threespot | Lepidoptera | Zygaenidae |
| Hedya nubiferana (Haw.) | green budworm | Lepidoptera | Tortricidae |
| Helicoverpa zea (Boddie) | tomato fruitworm | Lepidoptera | Noctuidae |
| Helicoverpa zea (Boddie) | corn earworn | Lepidoptera | Noctuidae |
| Heliothis ononis (D. & S.) | flax bollworm | Lepidoptera | Noctuidae |
| Heliothis virescens (F.) | tobacco budworm | Lepidoptera | Noctuidae |
| Heliothrips haemorrhoidalis | greenhouse thrips | Thysanoptera | Thripidae |
| (Bouch,) | | | |
| Hemaris diffinis (Bdv.) | snowberry clearwing | Lepidoptera | Sphingidae |
| Hemaris thysbe (F.) | hummingbird moth | Lepidoptera | Sphingidae |
| Hemichroa crocea (Geoff.) | striped alder sawfly | Hymenoptera | Tenthredinidae |
| Henricus fuscodorsanus (Kft.) | cone cochylid | Lepidoptera | Cochylidae |
| Hepialus gracilis Grt. | graceful ghost moth | Lepidoptera | Hepialidae |
| Hercinothrips femoralis (Reut.) | banded greenhouse | Thysanoptera | Thripidae |
| | thrips | | |
| Herculia thymetusalis (Wlk.) | spruce needleworm | Lepidoptera | Pyralidae |
| Hesperia comma borealis Linds. | Labrador skipper | Lepidoptera | Hesperiidae |
| Hesperia comma laurentina | Laurentian skipper | Lepidoptera | Hesperiidae |
| (Lyman) | | | |
| Heterarthrus nemoratus (Fall.) | late birch leaf | Hymenoptera | Tenthredinidae |
| | edgeminer | | |
| Heterocampa guttivitta (Wlk.) | saddled prominent | Lepidoptera | Notodontidae |
| Hippodamia convergens G.-M. | convergent lady | Coleoptera | Coccinellidae |
| | beetle | | |
| Hippodamia tredecimpunctata | thirteenspotted lady | Coleoptera | Coccinellidae |
| tibialis (Say) | beetle | | |
| Hofmannophila pseudospretella | brown house moth | Lepidoptera | Oecophoridae |
| (Staint.) | | | |
| Homadaula anisocentra Meyr. | mimosa webworm | Lepidoptera | Plutellidae |
| Homoeosoma electellum (Hulst) | sunflower moth | Lepidoptera | Pyralidae |
| Homoglaea hircina Morr. | goat sallow | Lepidoptera | Noctuidae |
| Homohadena badistriga (Grt.) | honeysuckle | Lepidoptera | Noctuidae |
| | budworm | | |
| Hoplocampa halcyon (Nort.) | shadbush sawfly | Hymenoptera | Tenthredinidae |
| Hoplocampa testudinea (Klug) | European apple | Hymenoptera | Tenthredinidae |
| | sawfly | | |
| Hyalophora cecropia (L.) | cecropia moth | Lepidoptera | Saturniidae |
| Hyalophora columbia (S. I. Smith) | Columbian silk moth | Lepidoptera | Saturniidae |
| Hyalophora columbia (S. I. Smith) | larch silkworm | Lepidoptera | Saturniidae |
| Hyalopterus pruni (Geoff.) | mealy plum aphid | Homoptera | Aphididae |
| Hydraecia immanis Gn. | hop vine borer | Lepidoptera | Noctuidae |
| Hydraecia micacea (Esp.) | potato stem borer | Lepidoptera | Noctuidae |
| Hydria prunivorata (Fgn.) | cherry scallopshell | Lepidoptera | Geometridae |
| | moth | | |
| Hydriomena divisaria (Wlk.) | transversebanded | Lepidoptera | Geometridae |
| | looper | | |
| Hylastinus obscurus (Marsh.) | clover root borer | Coleoptera | Scolytidae |
| Hyles gallii (Rott.) | bedstraw hawkmoth | Lepidoptera | Sphingidae |
| Hyles lineata (F.) | whitelined sphinx | Lepidoptera | Sphingidae |
| Hylesinus aculeatus Say | eastern ash bark | Coleoptera | Scolytidae |
| | beetle | | |
| Hylesinus californicus (Swaine) | western ash bark | Coleoptera | Scolytidae |
| | beetle | | |
| Hyllolycaena hyllus (Cram.) | bronze copper | Lepidoptera | Lycaenidae |
| Hylobius congener D.T., S. & M. | seedling debarking | Coleoptera | Curculionidae |
| | weevil | | |
| Hylobius pales (Hbst.) | pales weevil | Coleoptera | Curculionidae |
| Hylobius piceus (DeG.) | large spruce weevil* | Coleoptera | Curculionidae |
| Hylobius pinicola (Couper) | Couper collar weevil | Coleoptera | Curculionidae |
| Hylobius radicis Buch. | pine root collar | Coleoptera | Curculionidae |
| | weevil | | |
| Hylobius warreni Wood | Warren root collar | Coleoptera | Curculionidae |
| | weevil | | |
| Hylotrupes bajulus (L.) | old house borer | Coleoptera | Cerambycidae |
| Hylurgopinus rufipes (Eichh.) | native elm bark beetle | Coleoptera | Scolytidae |
| Hypagyrtis unipunctata (Haw.) | onespotted variant | Lepidoptera | Geometridae |
| Hypena scabra (F.) | green cloverworm | Lepidoptera | Noctuidae |
| Hypera meles (F.) | clover head weevil | Coleoptera | Curculionidae |
| Hypera nigrirostris (F.) | lesser clover leaf | Coleoptera | Curculionidae |
| | weevil | | |
| Hypera postica (Gyll.) | alfalfa weevil | Coleoptera | Curculionidae |
| Hypera punctata (F.) | clover leaf weevil | Coleoptera | Curculionidae |
| Hyphantria cunea (Drury) | fall webworm | Lepidoptera | Arctiidae |
| Hypnoidus abbreviatus (Say) | abbreviated | Coleoptera | Elateridae |
| | wireworm | | |
| Hypoderma bovis (L.) | northern cattle grub | Diptera | Oestridae |
| Hypoderma lineatum (DeVill.) | common cattle grub | Diptera | Oestridae |
| Hypoderma tarandi (L.) | caribou warble fly | Diptera | Oestridae |
| Hypogastrura nivicola (Fitch) | snow flea | Collembola | Hypogastruridae |
| Hypoprepia fucosa Hbn. | painted lichen moth | Lepidoptera | Arctiidae |
| Hypoprepia miniata (Kby.) | scarletwinged lichen | Lepidoptera | Arctiidae |
| | moth | | |
| Hyppa xylinoides (Gn.) | cranberry cutworm | Lepidoptera | Noctuidae |
| Incisalia augustinus (Westw.) | brown elfin | Lepidoptera | Lycaenidae |
| Incisalia henrici (G. & R.) | Henry elfin | Lepidoptera | Lycaenidae |
| Incisalia irus (Godt.) | frosted elfin | Lepidoptera | Lycaenidae |
| Incisalia lanoraieensis Shep. | bog elfin | Lepidoptera | Lycaenidae |
| Incisalia niphon clarki Free. | pine elfin | Lepidoptera | Lycaenidae |
| Incisalia polia C. & W. | hoary elfin | Lepidoptera | Lycaenidae |
| Ipimorpha pleonectusa Grt. | blackcheeked aspen | Lepidoptera | Noctuidae |
| | caterpillar | | |
| Ips borealis Swaine | northern engraver | Coleoptera | Scolytidae |
| Ips calligraphus (Germ.) | coarsewriting | Coleoptera | Scolytidae |
| | engraver | | |
| Ips grandicollis (Eichh.) | southern pine | Coleoptera | Scolytidae |
| | engraver | | |
| Ips perturbatus (Eichh.) | northern spruce | Coleoptera | Scolytidae |
| | engraver | | |
| Ips pini (Say) | pine engraver | Coleoptera | Scolytidae |
| Isochnus rufipes (LeC.) | willow flea weevil | Coleoptera | Curculionidae |
| Itame loricaria (Evers.) | false bruce spanworm | Lepidoptera | Geometridae |
| Itame pustularia (Gn.) | lesser maple | Lepidoptera | Geometridae |
| | spanworm | | |
| Itame ribearia (Fitch) | currant spanworm | Lepidoptera | Geometridae |
| Ithycerus noveboracensis (Forst.) | New York weevil | Coleoptera | Ithyceridae |
| Ixodes pacificus Cooley & Kohls | western blacklegged | Acari | Ixodidae |
| | tick | | |
| Janus abbreviatus (Say) | willow shoot sawfly | Hymenoptera | Cephidae |
| Janus integer (Nort.) | currant stem girdler | Hymenoptera | Cephidae |
| Junonia coenia (Hbn.) | buckeye | Lepidoptera | Nymphalidae |
| Kaliofenusa ulmi (Sund.) | elm leafminer | Hymenoptera | Tenthredinidae |
| Kaltenbachiella ulmifusa (W. & | elm pouchgall aphid | Homoptera | Aphididae |
| R.) | | | |
| Kaltenbachiola canadensis (Felt) | spruce cone gall | Diptera | Cecidomyiidae |
| | midge | | |
| Kaltenbachiola rachiphaga (Tripp) | spruce cone axis | Diptera | Cecidomyiidae |
| | midge | | |
| Keiferia lycopersicella (Wlsm.) | tomato pinworm | Lepidoptera | Gelechiidae |
| Kleidocerys resedae geminatus Say | birch catkin bug | Heteroptera | Lygaeidae |
| Labidomera clivicollis (Kby.) | milkweed leaf beetle | Coleoptera | Chrysomelidae |
| Labops hesperius Uhl. | black grass bug | Heteroptera | Miridae |
| Lacinipolia meditata (Grt.) | pinkbacked cutworm | Lepidoptera | Noctuidae |
| Lacinipolia renigera (Steph.) | bristly cutworm | Lepidoptera | Noctuidae |
| Lambdina f. fiscellaria (Gn.) | hemlock looper | Lepidoptera | Geometridae |
| Lambdina fiscellaria lugubrosa | western hemlock | Lepidoptera | Geometridae |
| (Hulst) | looper | | |
| Lambdina liscellaria somniaria | western oak looper | Lepidoptera | Geometridae |
| (Hulst) | | | |
| Lampronia rubiella (Bjerk.) | raspberry bud moth | Lepidoptera | Incurvariidae |
| Laothoe juglandis (J. E. Smith) | walnut sphinx | Lepidoptera | Sphingidae |
| Lapara bombycoides Wlk. | pine tree sphinx | Lepidoptera | Sphingidae |
| Lasioderma serricorne (F.) | cigarette beetle | Coleoptera | Anobiidae |
| Latheticus oryzae Waterh. | longheaded flour | Coleoptera | Tenebrionidae |
| | beetle | | |
| Lathridius minutus (L.) | squarenosed fungus | Coleoptera | Lathridiidae |
| | beetle | | |
| Latrodectus variolus Walck. | northern widow | Araneae | Theridiidae |
| | spider | | |
| Lema t. trilinea White | threelined potato | Coleoptera | Chrysomelidae |
| | beetle | | |
| Lepidosaphes ulmi (L.) | oystershell scale | Homoptera | Diaspididae |
| Lepisma saccharina L. | silverfish | Thysanura | Lepismatidae |
| Leptinotarsa decemlineata (Say) | Colorado potato | Coleoptera | Chrysomelidae |
| | beetle | | |
| Leptoglossus occidentalis Heid. | western conifer-seed | Heteroptera | Coreidae |
| | bug | | |
| Leptopterna dolabrata (L.) | meadow plant bug | Heteroptera | Miridae |
| Lepyrus nordenskioeldi canadensis | poplar-willow leaf | Coleoptera | Curculionidae |
| Casey | weevil | | |
| Lethocerus americanus (Leidy) | giant water bug | Heteroptera | Belostomatidae |
| Leucoma salicis (L.) | satin moth | Lepidoptera | Lymantriidae |
| Ligyrus gibbosus (DeG.) | carrot beetle | Coleoptera | Scarabaeidae |
| Lilioceris lilii (Scop.) | lily leaf beetle | Coleoptera | Chrysomelidae |
| Limenitis a. arthemis (Drury) | white admiral | Lepidoptera | Nymphalidae |
| Limenitis archippus (Cram.) | viceroy | Lepidoptera | Nymphalidae |
| Limenitis arthemis astyanax (F.) | redspotted purple | Lepidoptera | Nymphalidae |
| Limonius agonus (Say) | eastern field | Coleoptera | Elateridae |
| | wireworm | | |
| Limonius californicus (Man.) | sugarbeet wireworm | Coleoptera | Elateridae |
| Limonius canus LeC. | Pacific Coast | Coleoptera | Elateridae |
| | wireworm | | |
| Limonius infuscatus Mots. | western field | Coleoptera | Elateridae |
| | wireworm | | |
| Limothrips denticornis Hal. | barley thrips | Thysanoptera | Thripidae |
| Linognathus ovillus (Nm.) | sheep sucking louse | Anoplura | Linognathidae |
| Linognathus pedalis (Osb.) | sheep foot louse | Anoplura | Linognathidae |
| Linognathus setosus (Olf.) | dog sucking louse | Anoplura | Linognathidae |
| Linognathus stenopsis (Burm.) | goat sucking louse | Anoplura | Linognathidae |
| Linognathus vituli (L.) | longnosed cattle louse | Anoplura | Linognathidae |
| Linsleya sphaericollis (Say) | ash blister beetle | Coleoptera | Meloidae |
| Lipaphis erysimi (Kltb.) | turnip aphid | Homoptera | Aphididae |
| Lipeurus caponis (L.) | wing louse | Mallophaga | Philopteridae |
| Liriomyza sativae Blanch. | vegetable leafminer | Diptera | Agromyzidae |
| Listronotus oregonensis (LeC.) | carrot weevil | Coleoptera | Curculionidae |
| Lithophane antennata (Wlk.) | green fruitworm | Lepidoptera | Noctuidae |
| Lixus concavus Say | rhubarb curcuilo | Coleoptera | Curculionidae |
| Lobophora nivigerata Wlk. | twolined aspen looper | Lepidoptera | Geometridae |
| Lochmaeus bilineata (Pack.) | elm prominent | Lepidoptera | Notodontidae |
| Lochmaeus manteo Dbly. | variable oakleaf | Lepidoptera | Notodontidae |
| | caterpillar | | |
| Lomographa semiclarata (Wlk.) | wild cherry looper | Lepidoptera | Geometridae |
| Lophocampa caryae Harr. | hickory tussock moth | Lepidoptera | Arctiidae |
| Lophocampa maculata Harr. | spotted tussock moth | Lepidoptera | Arctiidae |
| Loxostege cereralis (Zell.) | alfalfa webworm | Lepidoptera | Pyralidae |
| Loxostege sticticalis (L.) | beet webworm | Lepidoptera | Pyralidae |
| Lucilia sericata (Meig.) | sheep blow fly | Diptera | Calliphoridae |
| Lycaeides idas (L.) | northern blue | Lepidoptera | Lycaenidae |
| Lycaena dorcas (Kby.) | dorcas copper | Lepidoptera | Lycaenidae |
| Lycaena epixanthe (Bdv. & LeC.) | bog copper | Lepidoptera | Lycaenidae |
| Lycaena phlaeas americana Harr. | American copper | Lepidoptera | Lycaenidae |
| Lycia ursaria (Wlk.) | stout spanworm | Lepidoptera | Geometridae |
| Lyctus linearis (Goeze) | cosmopolitan | Coleoptera | Lyctidae |
| | powderpost beetle | | |
| Lyctus planicollis LeC. | southern lyctus beetle | Coleoptera | Lyctidae |
| Lygidea mendax Reut. | apple red bug | Heteroptera | Miridae |
| Lygocoris caryae (Knight) | hickory plant bug | Heteroptera | Miridae |
| Lygocoris communis (Knight) | green apple bug | Heteroptera | Miridae |
| Lygocoris communis (Knight) | pear plant bug | Heteroptera | Miridae |
| Lygocoris quercalbae (Knight) | oak plant bug | Heteroptera | Miridae |
| Lygus elisus Van D. | lucerne plant bug | Heteroptera | Miridae |
| Lygus elisus Van D. | pale legume bug | Heteroptera | Miridae |
| Lygus hesperus Knight | western tarnished | Heteroptera | Miridae |
| | plant bug | | |
| Lygus lineolaris (P. de B.) | tarnished plant bug | Heteroptera | Miridae |
| Lymantria dispar (L.) | gypsy moth | Lepidoptera | Lymantriidae |
| Lytta nuttalli Say | Nuttall blister beetle | Coleoptera | Meloidae |
| Macrodactylus subspinosus (F.) | rose chafer | Coleoptera | Scarabaeidae |
| Macronoctua onusta Grt. | iris borer | Lepidoptera | Noctuidae |
| Macropsis trimaculata (Fitch) | plum leafhopper | Homoptera | Cicadellidae |
| Macrosiphoniella sanborni (Gill.) | chrysanthemum aphid | Homoptera | Aphididae |
| Macrosiphum euphorbiae (Thos.) | potato aphid | Homoptera | Aphididae |
| Macrosiphum rosae (L.) | rose aphid | Homoptera | Aphididae |
| Macrosteles quadrilineatus Fbs. | aster leafhopper | Homoptera | Cicadellidae |
| Magdalis armicollis (Say) | red elm bark weevil | Coleoptera | Curculionidae |
| Magdalis barbita (Say) | black elm bark weevil | Coleoptera | Curculionidae |
| Magicicada septendecim (L.) | periodical cicada | Homoptera | Cicadidae |
| Malacosoma americanum (F.) | eastern tent caterpillar | Lepidoptera | Lasiocampidae |
| Malacosoma californicum | prairie tent caterpillar | Lepidoptera | Lasiocampidae |
| lutescens (N. & D.) | | | |
| Malacosoma californicum pluviale | northern tent | Lepidoptera | Lasiocampidae |
| (Dyar) | caterpillar | | |
| Malacosoma disstria Hbn. | forest tent caterpillar | Lepidoptera | Lasiocampidae |
| Mamestra configurata Wlk. | bertha armyworm | Lepidoptera | Noctuidae |
| Manduca quinquemaculata (Haw.) | tomato hornworm | Lepidoptera | Sphingidae |
| Manduca sexta (L.) | tobacco hornworm | Lepidoptera | Sphingidae |
| Mantis religiosa L. | praying mantis | Mantodea | Mantidae |
| Mantis religiosa L. | European mantid | Mantodea | Mantidae |
| Marmara elotella (Bsk.) | apple barkminer | Lepidoptera | Gracillariidae |
| Marmara fasciella (Cham.) | white pine barkminer | Lepidoptera | Gracillariidae |
| Marmara pomonella Bsk. | apple fruitminer | Lepidoptera | Gracillariidae |
| Matsucoccus macrocicatrices | white pine fungus | Homoptera | Margarodidae |
| Rich. | scale | | |
| Matsucoccus resinosae B. & God. | red pine scale | Homoptera | Margarodidae |
| Mayetiola carpophaga (Tripp) | spruce seed midge | Diptera | Cecidomyiidae |
| Mayetiola destructor (Say) | Hessian fly | Diptera | Cecidomyiidae |
| Mayetiola piceae (Felt) | spruce gall midge | Diptera | Cecidomyiidae |
| Mayetiola thujae (Hed.) | western red cedar | Diptera | Cecidomyiidae |
| | cone midge | | |
| Mecas confusaC. & L. | poplar gall borer* | Coleoptera | Cerambycidae |
| Megachile rotundata (F.) | alfalfa leafcutting bee | Hymenoptera | Megachilidae |
| Megacyllene robiniae (Forst.) | locust borer | Coleoptera | Cerambycidae |
| Megastigmus atedius Wlk. | spruce seed chalcid | Hymenoptera | Torymidae |
| Megastigmus laricis Marc. | larch seed chalcid | Hymenoptera | Torymidae |
| Megastigmus pinus Parf. | fir seed chalcid | Hymenoptera | Torymidae |
| Megastigmus specularis Walley | balsam fir seed | Hymenoptera | Torymidae |
| | chalcid | | |
| Megastigmus spermotrophus | Douglas-fir seed | Hymenoptera | Torymidae |
| Wachtl | chalcid | | |
| Megisto cymela (Cram.) | little wood satyr | Lepidoptera | Satyridae |
| Melanchra picta (Harr.) | zebra caterpillar | Lepidoptera | Noctuidae |
| Melanolophia canadaria (Gn.) | variable redmarked | Lepidoptera | Geometridae |
| | looper | | |
| Melanolophia imitata (Wlk.) | greenstriped forest | Lepidoptera | Geometridae |
| | looper | | |
| Melanophila acuminata (DeG.) | black fire beetle | Coleoptera | Buprestidae |
| Melanoplus bivittatus (Say) | twostriped | Orthoptera | Acrididae |
| | grasshopper | | |
| Melanoplus borealis (Fieb.) | northern grasshopper | Orthoptera | Acrididae |
| Melanoplus femurrubrum (DeG.) | redlegged | Orthoptera | Acrididae |
| | grasshopper | | |
| Melanoplus packardii Scudd. | Packard grasshopper | Orthoptera | Acrididae |
| Melanoplus sanguinipes (F.) | migratory | Orthoptera | Acrididae |
| | grasshopper | | |
| Melanoplus spretus (Walsh) | Rocky Mountain | Orthoptera | Acrididae |
| | grasshopper | | |
| Melittia cucurbitae (Harr.) | squash vine borer | Lepidoptera | Sesiidae |
| Meloe americanus Leach | buttercup oil beetle | Coleoptera | Meloidae |
| Melophagus ovinus (L.) | sheep ked | Diptera | Hippoboscidae |
| Menacanthus stramineus (Nitz.) | chicken body louse | Mallophaga | Menoponidae |
| Menopon gallinae (L.) | shaft louse | Mallophaga | Menoponidae |
| Merhynchites bicolor (F.) | rose curculio | Coleoptera | Rhynchitidae |
| Merodon equestris (F.) | narcissus bulb fly | Diptera | Syrphidae |
| Meromyza americana Fitch | wheat stem maggot | Diptera | Chloropidae |
| Meroptera pravella (Grt.) | lesser aspen | Lepidoptera | Pyralidae |
| | webworm | | |
| Mesolecanium nigrofasciatum | terrapin scale | Homoptera | Coccidae |
| (Perg.) | | | |
| Messa nana (Klug) | early birch leaf | Hymenoptera | Tenthredinidae |
| | edgeminer | | |
| Messa populifoliella (Towns.) | poplar leafmining | Hymenoptera | Tenthredinidae |
| | sawfly | | |
| Metopolophium dirhodum (Wlk.) | rose-grass aphid | Homoptera | Aphididae |
| Micrurapteryx salicifoliella | willow leafminer | Coleoptera | Cerambycidae |
| (Cham.) | | | |
| Mindarus abietinus Koch | balsam twig aphid | Homoptera | Aphididae |
| Monochamus marmorator Kby. | balsam fir sawyer | Coleoptera | Cerambycidae |
| Monochamus mutator LeC. | spotted pine sawyer | Coleoptera | Cerambycidae |
| Monochamus notatus (Drury) | northeastern sawyer | Coleoptera | Cerambycidae |
| Monochamus s. scutellatus (Say) | whitespotted sawyer | Coleoptera | Cerambycidae |
| Monochamus scutellatus | Oregon fir sawyer | Coleoptera | Cerambycidae |
| oregonensis (LeC.) | | | |
| Monochroa fragariae (Bsk.) | strawberry | Lepidoptera | Gelechiidae |
| | crownminer | | |
| Monoctenus fulvus (Nort.) | cedar sawfly | Hymenoptera | Diprionidae |
| Monoctenus suffusus (Cress.) | arborvitae sawfly | Hymenoptera | Diprionidae |
| Monomorium minimum (Buckl.) | little black ant | Hymenoptera | Formicidae |
| Monomorium pharaonis (L.) | pharaoh ant | Hymenoptera | Formicidae |
| Mononychus vulpeculus (F.) | iris weevil | Coleoptera | Curculionidae |
| Monophadnoides geniculatus | raspberry sawfly | Hymenoptera | Tenthredinidae |
| (Htg.) | | | |
| Mordwilkoja vagabunda (Walsh) | poplar vagabond | Homoptera | Aphididae |
| | aphid | | |
| Mulsantina picta (Rand.) | pine lady beetle | Coleoptera | Coccinellidae |
| Murgantia histrionica (Hahn) | harlequin bug | Heteroptera | Pentatomidae |
| Musca autumnalis DeG. | face fly | Diptera | Muscidae |
| Musca domestica L. | house fly | Diptera | Muscidae |
| Muscina stabulans (Fall.) | false stable fly | Diptera | Muscidae |
| Mycetophagus quadriguttatus | spotted hairy fungus | Coleoptera | Mycetophagidae |
| Mull. | beetle | | |
| Myzus ascalonicus Doncaster | shallot aphid | Homoptera | Aphididae |
| Myzus cerasi (F.) | black cherry aphid | Homoptera | Aphididae |
| Myzus persicae (Sulz.) | green peach aphid | Homoptera | Aphididae |
| Nacerdes melanura (L.) | wharf borer | Coleoptera | Oedemeridae |
| Nacophora quernaria (J. E. Smith) | oak beauty | Lepidoptera | Geometridae |
| Nadata gibbosa (J. E. Smith) | yellowlined | Lepidoptera | Notodontidae |
| | caterpillar | | |
| Nearctaphis bakeri (Cowen) | clover aphid | Homoptera | Aphididae |
| Necrobia ruficollis (F.) | redshouldered ham | Coleoptera | Cleridae |
| | beetle | | |
| Necrobia rufipes (DeG.) | redlegged ham beetle | Coleoptera | Cleridae |
| Nemapogon granella (L.) | European grain moth | Lepidoptera | Tineidae |
| Nematocampa resistaria (H.-S.) | filament bearer | Lepidoptera | Geometridae |
| Nematus ribesii (Scop.) | imported | Hymenoptera | Tenthredinidae |
| | currantworm | | |
| Nemocestes incomptus (Horn) | woods weevil | Coleoptera | Curculionidae |
| Nemoria mimosaria (Gn.) | flanged looper | Lepidoptera | Geometridae |
| Neochlamisus cribripennis (LeC.) | blueberry case beetle | Coleoptera | Chrysomelidae |
| Neoclytus acuminatus (F.) | redheaded ash borer | Coleoptera | Cerambycidae |
| Neoclytus caprea (Say) | banded ash borer | Coleoptera | Cerambycidae |
| Neodiprion abietis (Harr.) | balsam fir sawfly | Hymenoptera | Diprionidae |
| Neodiprion burkei Midd. | lodgepole sawfly | Hymenoptera | Diprionidae |
| Neodiprion lecontei (Fitch) | redheaded pine | Hymenoptera | Diprionidae |
| | sawfly | | |
| Neodiprion n. nanulus Schedl | red pine sawfly | Hymenoptera | Diprionidae |
| Neodiprion pinetum (Nort.) | white pine sawfly | Hymenoptera | Diprionidae |
| Neodiprion pratti banksianae Roh. | jack pine sawfly | Hymenoptera | Diprionidae |
| Neodiprion rugifrons Midd. | redheaded jack pine | Hymenoptera | Diprionidae |
| | sawfly | | |
| Neodiprion sertifer (Geoff.) | European pine sawfly | Hymenoptera | Diprionidae |
| Neodiprion swainei Midd. | Swaine jack pine | Hymenoptera | Diprionidae |
| | sawfly | | |
| Neodiprion tsugae Midd. | hemlock sawfly | Hymenoptera | Diprionidae |
| Neohydatothrips tiliae (Hood) | basswood thrips | Thysanoptera | Thripidae |
| Neophasia menapia (C. & R.F.) | pine white | Lepidoptera | Pieridae |
| Nephelodes minians Gn. | bronzed cutworm | Lepidoptera | Noctuidae |
| Nephopterix subcaesiella (Clem.) | locust leafroller | Lepidoptera | Pyralidae |
| Nephopterix subfuscella (Rag.) | striped sumac | Lepidoptera | Pyralidae |
| | leafroller | | |
| Nepytia canosaria (Wlk.) | false hemlock looper | Lepidoptera | Geometridae |
| Nepytia freemani Mun. | western false hemlock | Lepidoptera | Geometridae |
| | looper | | |
| Nepytia phantasmaria (Stkr.) | phantom hemlock | Lepidoptera | Geometridae |
| | looper | | |
| Neurotoma inconspicua (Nort.) | plum webspinning | Hymenoptera | Pamphiliidae |
| | sawfly | | |
| Niptus hololeucus (Fald.) | golden spider beetle | Coleoptera | Ptinidae |
| Nites betulella (Bsk.) | blackdotted birch | Lepidoptera | Oecophoridae |
| | leaftier | | |
| Nites grotella (Rob.) | hazel leaftier | Lepidoptera | Oecophoridae |
| Nodonota puncticollis (Say) | rose leaf beetle | Coleoptera | Chrysomelidae |
| Nomia melanderi Ckll. | alkali bee | Hymenoptera | Halictidae |
| Nomius pygmaeus (Dej.) | stink beetle | Coleoptera | Carabidae |
| Nomophila nearctica Mun. | celery stalkworm | Lepidoptera | Pyralidae |
| Nosopsyllus fasciatus (Bosc) | northern rat flea | Siphonaptera | Ceratophyllidae |
| Nymphalis antiopa (L.) | mourningcloak | Lepidoptera | Nymphalidae |
| | butterfly | | |
| Nymphalis antiopa (L.) | spiny elm caterpillar | Lepidoptera | Nymphalidae |
| Nymphalis californica (Bdv.) | California | Lepidoptera | Nymphalidae |
| | tortoiseshell | | |
| Nymphalis vau-album (D. & S.) | Compton tortoiseshell | Lepidoptera | Nymphalidae |
| Nysius niger Baker | northern false chinch | Heteroptera | Lygaeidae |
| | bug | | |
| Oberea bimaculata (Oliv.) | raspberry cane borer | Coleoptera | Cerambycidae |
| Oberea schaumii LeC. | poplar branch borer | Coleoptera | Cerambycidae |
| Obolodiplosis robiniae (Hald.) | locust gall midge | Diptera | Cecidomyiidae |
| Obrussa ochrefasciella (Cham.) | hard maple budminer | Lepidoptera | Nepticulidae |
| Odontopus calceatus (Say) | tuliptree leafminer | Coleoptera | Curculionidae |
| Odontota dorsalis (Thunb.) | locust leafminer | Coleoptera | Chrysomelidae |
| Oecanthus fultoni T. J. Wlk. | snowy tree cricket | Grylloptera | Gryllidae |
| Oecanthus nigricornis Wlk. | blackhorned tree | Grylloptera | Gryllidae |
| | cricket | | |
| Oecanthus quadripunctatus Beut. | fourspotted tree | Grylloptera | Gryllidae |
| | cricket | | |
| Oeciacus vicarius Horv. | swallow bug | Heteroptera | Cimicidae |
| Oeneis chryxus (Dbly. & Hew.) | chryxus arctic | Lepidoptera | Satyridae |
| Oeneis jutta (Hbn.) | jutta arctic | Lepidoptera | Satyridae |
| Oeneis macounii (Edw.) | Macoun arctic | Lepidoptera | Satyridae |
| Oeneis polixenes (F.) | polixenes arctic | Lepidoptera | Satyridae |
| Oeneis taygete Gey. | whiteveined arctic | Lepidoptera | Satyridae |
| Oenensis melissa (F.) | melissa arctic | Lepidoptera | Satyridae |
| Oestrus ovis L. | sheep bot fly | Diptera | Oestridae |
| Olethreutes permundana (Clem.) | raspberry leafroller | Lepidoptera | Tortricidae |
| Oligocentria lignicolor (Wlk.) | lacecapped caterpillar | Lepidoptera | Notodontidae |
| Oligonychus pratensis (Banks) | Banks grass mite | Acari | Tetranychidae |
| Oligonychus ununguis (Jac.) | spruce spider mite | Acari | Tetranychidae |
| Omanodus floralis (L.) | narrownecked grain | Coleoptera | Anthicidae |
| | beetle | | |
| Omias saccatus (LeC.) | sagebrush weevil | Coleoptera | Curculionidae |
| Oncideres cingulata (Say) | twig girdler | Coleoptera | Cerambycidae |
| Oncopeltus fasciatus (Dall.) | large milkweed bug | Heteroptera | Lygaeidae |
| Operophtera bruceata (Hulst) | Bruce spanworm | Lepidoptera | Geometridae |
| Operophtera brumata (L.) | winter moth | Lepidoptera | Geometridae |
| Orgyia antiqua (L.) | rusty tussock moth | Lepidoptera | Lymantriidae |
| Orgyia leucostigma (J. E. Smith) | whitemarked tussock | Lepidoptera | Lymantriidae |
| | moth | | |
| Orgyia pseudotsugata (McD.) | Douglas-fir tussock | Lepidoptera | Lymantriidae |
| | moth | | |
| Ornithonyssus bacoti (Hirst) | tropical rat mite | Acari | Macronyssidae |
| Ornithonyssus sylviarum (C. & F.) | northern fowl mite | Acari | Macronyssidae |
| Ortholepis pasadamia (Dyar) | striped birch pyralid | Lepidoptera | Pyralidae |
| Orthosia hibisci (Gn.) | speckled green | Lepidoptera | Noctuidae |
| | fruitworm | | |
| Orthosia revicta (Morr.) | rusty whitesided | Lepidoptera | Noctuidae |
| | caterpillar | | |
| Oryzaephilus mercator (Fauvel) | merchant grain beetle | Coleoptera | Cucujidae |
| Oryzaephilus surinamensis (L.) | sawtoothed grain | Coleoptera | Cucujidae |
| | beetle | | |
| Oscinella frit (L.) | frit fly | Diptera | Chloropidae |
| Ostrinia nubilalis (Hbn.) | European corn borer | Lepidoptera | Pyralidae |
| Ostrinia obumbratalis (Led.) | smartweed borer | Lepidoptera | Pyralidae |
| Otiorhynchus ligustici (L.) | alfalfa snout beetle | Coleoptera | Curculionidae |
| Otiorhynchus ovatus (L.) | strawberry root | Coleoptera | Curculionidae |
| | weevil | | |
| Otiorhynchus rugosostriatus | rough strawberry | Coleoptera | Curculionidae |
| (Goeze) | weevil | | |
| Otiorhynchus sulcatus (F.) | black vine weevil | Coleoptera | Curculionidae |
| Otobius megnini (Duges) | ear tick | Acari | Argasidae |
| Otodectes cynotis (Her.) | ear mite | Acari | Psoroptidae |
| Oulema melanopus (L.) | cereal leaf beetle | Coleoptera | Chrysomelidae |
| Pachypsylla celtidismamma | hackberry nipplegall | Homoptera | Psyllidae |
| (Fletcher) | maker | | |
| Pachyrhinus ferrugineus (Casey) | rusty pineneedle | Coleoptera | Curculionidae |
| | weevil | | |
| Pachysphinx modesta (Harr.) | big poplar sphinx | Lepidoptera | Sphingidae |
| Paleacrita vernata (Peck) | spring cankerworm | Lepidoptera | Geometridae |
| Palorus ratzeburgii (Wissm.) | smalleyed flour beetle | Coleoptera | Tenebrionidae |
| Palorus subdepressus (Woll.) | depressed flour beetle | Coleoptera | Tenebrionidae |
| Palpita magniferalis (Wlk.) | ash leafroller | Lepidoptera | Pyralidae |
| Palthis angulalis (Hbn.) | spruce harlequin | Lepidoptera | Noctuidae |
| Pamphilius ochreipes (Cress.) | viburnum | Hymenoptera | Pamphiliidae |
| | webspinning sawfly | | |
| Pandemis canadana Kft. | green aspen leaftier | Lepidoptera | Tortricidae |
| Pandemis limitata (Rob.) | threelined leafroller | Lepidoptera | Tortricidae |
| Panonychus ulmi (Koch) | European red mite | Acari | Tetranychidae |
| Panthea acronyctoides (Wlk.) | tufted spruce | Lepidoptera | Noctuidae |
| | caterpillar | | |
| Panthea furcilla (Pack.) | tufted white pine | Lepidoptera | Noctuidae |
| | caterpillar | | |
| Paonias excaecatus (J. E. Smith) | blindeyed sphinx | Lepidoptera | Sphingidae |
| Paonias myops (J. E. Smith) | smalleyed sphinx | Lepidoptera | Sphingidae |
| Papaipema cataphracta (Grt.) | burdock borer | Lepidoptera | Noctuidae |
| Papaipema nebris (Gn.) | stalk borer | Lepidoptera | Noctuidae |
| Papilio brevicauda Saund. | shorttailed | Lepidoptera | Papilionidae |
| | swallowtail | | |
| Papilio canadensis (R. & J.) | Canadian tiger | Lepidoptera | Papilionidae |
| | swallowtail | | |
| Papilio cresphontes Cram. | giant swallowtail | Lepidoptera | Papilionidae |
| Papilio cresphontes Cram. | orangedog | Lepidoptera | Papilionidae |
| Papilio glaucus L. | tiger swallowtail | Lepidoptera | Papilionidae |
| Papilio polyxenes asterias Stoll | parsleyworm | Lepidoptera | Papilionidae |
| Papilio polyxenes asterias Stoll | celeryworm | Lepidoptera | Papilionidae |
| Papilio polyxenes asterias Stoll | black swallowtail | Lepidoptera | Papilionidae |
| Papilio troilus L. | spicebush swallowtail | Lepidoptera | Papilionidae |
| Paraclemensia acerifoliella (Fitch) | maple leafcutter | Lepidoptera | Incurvariidae |
| Paradiplosis tumifex Gagn, | balsam gall midge | Diptera | Cecidomyiidae |
| Paraleucoptera albella (Cham.) | cottonwood leafminer | Lepidoptera | Lyonetiidae |
| Parandra brunnea brunnea (F.) | pole borer | Coleoptera | Cerambycidae |
| Paraphytomyza populicola (Wlk.) | Lombardy leafminer | Diptera | Agromyzidae |
| Paraprociphilus tessellatus (Fitch) | woolly alder aphid | Homoptera | Aphididae |
| Paratrioza cockerelli (Sulc) | tomato psyllid | Homoptera | Psyllidae |
| Paratrioza cockerelli (Sulc) | potato psyllid | Homoptera | Psyllidae |
| Parcoblatta pennsylvanica (DeG.) | Pennsylvania wood | Blattodea | Blattellidae |
| | cockroach | | |
| Parectopa robiniella Clem. | locust digitate | Lepidoptera | Gracillariidae |
| | leafminer | | |
| Paria fragariae Wilcox | strawberry rootworm | Coleoptera | Chrysomelidae |
| Parornix geminatella Pack. | unspotted tentiform | Lepidoptera | Gracillariidae |
| | leafminer | | |
| Parthenolecanium corni (Bouch.) | European fruit | Homoptera | Coccidae |
| | lecanium | | |
| Parthenolecanium persicae (F.) | European peach scale | Homoptera | Coccidae |
| Parthenolecanium quercifex | oak lecanium | Homoptera | Coccidae |
| (Fitch) | | | |
| Pediculus humanus capitis DeG. | head louse | Anoplura | Pediculidae |
| Pediculus humanus humanus L. | body louse | Anoplura | Pediculidae |
| Pegomya hyoscyami (Panz.) | spinach leafminer | Diptera | Anthomyiidae |
| Pegomya rubivora (Coq.) | raspberry cane | Diptera | Anthomyiidae |
| | maggot | | |
| Pegomya spp. | beet leafminer | Diptera | Anthomyiidae |
| Pemphigus bursarius (L.) | lettuce aphid | Homoptera | Aphididae |
| Pemphigus populitransversus Riley | poplar petiolegall | Homoptera | Aphididae |
| | aphid | | |
| Pemphigus populivenae Fitch | sugarbeet root aphid | Homoptera | Aphididae |
| Pennisetia marginata (Harr.) | raspberry crown borer | Lepidoptera | Sesiidae |
| Peranabrus scabricollis (Thos.) | coulee cricket | Grylloptera | Tettigoniidae |
| Peridroma saucia (Hbn.) | variegated cutworm | Lepidoptera | Noctuidae |
| Perillus bioculatus (F.) | twospotted stink bug | Heteroptera | Pentatomidae |
| Periphyllus lyropictus (Kess.) | Norway maple aphid | Homoptera | Aphididae |
| Periphyllus negundinis (Thos.) | boxelder aphid | Homoptera | Aphididae |
| Periplaneta americana (L.) | American cockroach | Blattodea | Blattidae |
| Periplaneta australasiae (F.) | Australian cockroach | Blattodea | Blattidae |
| Periplaneta brunnea Burm. | brown cockroach | Blattodea | Blattidae |
| Petrobia latens (Mull.) | brown wheat mite | Acari | Tetranychidae |
| Petrova albicapitana (Bsk.) | northern pitch twig | Lepidoptera | Tortricidae |
| | moth | | |
| Petrova comstockiana (Fern.) | pitch twig moth | Lepidoptera | Tortricidae |
| Phenacoccus aceris (Sign.) | apple mealybug | Homoptera | Pseudococcidae |
| Phenacoccus gossypii T. & C. | Mexican mealybug | Homoptera | Pseudococcidae |
| Pheosia rimosa Pack. | false hornworm | Lepidoptera | Notodontidae |
| Phigalia titea (Cram.) | spiny looper | Lepidoptera | Geometridae |
| Philaenus spumarius (L.) | meadow spittlebug | Homoptera | Cercopidae |
| Phloeosinus canadensis Swaine | northern cedar bark | Coleoptera | Scolytidae |
| | beetle | | |
| Phloeosinus punctatus LeC. | western cedar bark | Coleoptera | Scolytidae |
| | beetle | | |
| Phloeotribus liminaris (Harr.) | peach bark beetle | Coleoptera | Scolytidae |
| Phobetron pithecium (J. E. Smith) | hag moth | Lepidoptera | Limacodidae |
| Pholisora catullus (F.) | common sooty wing | Lepidoptera | Hesperiidae |
| Phormia regina (Meig.) | black blow fly | Diptera | Calliphoridae |
| Phorodon humuli (Schr.) | hop aphid | Homoptera | Aphididae |
| Phragmatobia assimilans Wlk. | dusky red tiger moth | Lepidoptera | Arctiidae |
| Phragmatobia fuliginosa rubricosa | ruby tiger moth | Lepidoptera | Arctiidae |
| (Harr.) | | | |
| Phratora p. purpurea Brown | aspen skeletonizer | Coleoptera | Chrysomelidae |
| Phthorimaea operculella (Zell.) | potato tuberworm | Lepidoptera | Gelechiidae |
| Phyciodes batesii (Reak.) | tawny crescent | Lepidoptera | Nymphalidae |
| Phyciodes selenis (Kby.) | northern pearl | Lepidoptera | Nymphalidae |
| | crescent | | |
| Phyllobius intrusus Kono | arborvitae weevil | Coleoptera | Curculionidae |
| Phyllobius oblongus (L.) | European snout beetle | Coleoptera | Curculionidae |
| Phyllocnistis populiella Cham. | aspen serpentine | Lepidoptera | Lyonetiidae |
| | leafminer | | |
| Phyllocolpa bozemani (Cooley) | poplar leaffolding | Hymenoptera | Tenthredinidae |
| | sawfly | | |
| Phyllocolpa popuella (Ross) | poplar edgefolding | Hymenoptera | Tenthredinidae |
| | sawfly | | |
| Phyllodesma americana (Harr.) | lappet moth | Lepidoptera | Lasiocampidae |
| Phyllonorycter apparella (H.-S.) | aspen leafblotch | Lepidoptera | Gracillariidae |
| | miner | | |
| Phyllonorycter blancardella (F.) | spotted tentiform | Lepidoptera | Gracillariidae |
| | leafminer | | |
| Phyllonorycter crataegella (Clem.) | apple blotch | Lepidoptera | Gracillariidae |
| | leafminer | | |
| Phyllonorycter lucetiella (Clem.) | basswood | Lepidoptera | Gracillariidae |
| | squareblotch miner | | |
| Phyllonorycter lucidicostella | lesser maple | Lepidoptera | Gracillariidae |
| (Clem.) | leafblotch miner | | |
| Phyllonorycter nipigon (Free.) | balsam poplar | Lepidoptera | Gracillariidae |
| | leafblotch miner | | |
| Phyllonorycter populiella (Cham.) | poplar leafminer | Lepidoptera | Gracillariidae |
| Phyllonorycter propinquinella | cherry blotchminer | Lepidoptera | Gracillariidae |
| (Braun) | | | |
| Phyllonorycter salicifoliella | willow leafblotch | Lepidoptera | Gracillariidae |
| (Cham.) | miner | | |
| Phyllonorycter tiliacella (Cham.) | basswood | Lepidoptera | Gracillariidae |
| | roundblotch miner | | |
| Phyllonorycter tremuloidiella | aspen blotchminer | Lepidoptera | Gracillariidae |
| (Braun) | | | |
| Phyllophaga fusca (Fro.) | northern June beetle | Coleoptera | Scarabaeidae |
| Phyllophaga futilis (LeC.) | lesser June beetle | Coleoptera | Scarabaeidae |
| Phyllophaga rugosa (Melsh.) | rugose June beetle | Coleoptera | Scarabaeidae |
| Phyllotreta albionica (LeC.) | cabbage flea beetle | Coleoptera | Chrysomelidae |
| Phyllotreta armoraciae (Koch) | horseradish flea | Coleoptera | Chrysomelidae |
| | beetle | | |
| Phyllotreta cruciferae (Goeze) | crucifer flea beetle | Coleoptera | Chrysomelidae |
| Phyllotreta pusilla Horn | western black flea | Coleoptera | Chrysomelidae |
| | beetle | | |
| Phyllotreta robusta LeC. | garden flea beetle | Coleoptera | Chrysomelidae |
| Phyllotreta striolata (F.) | striped flea beetle | Coleoptera | Chrysomelidae |
| Physokermes piceae (Schr.) | spruce bud scale | Homoptera | Coccidae |
| Phytobia amelanchieris (Greene) | amelanchier twig | Diptera | Agromyzidae |
| | borer | | |
| Phytobia betulivora Spencer | birch cambium miner | Diptera | Agromyzidae |
| Phytobia setosa (Loew) | red maple cambium | Diptera | Agromyzidae |
| | borer | | |
| Phytomyza ilicis Curt. | holly leafminer | Diptera | Agromyzidae |
| Phytonemus pallidus (Banks) | cyclamen mite | Acari | Tarsonemidae |
| Pieris napi (L.) | mustard white | Lepidoptera | Pieridae |
| Pieris rapae (L.) | cabbage butterfly | Lepidoptera | Pieridae |
| Pieris rapae (L.) | imported | Lepidoptera | Pieridae |
| | cabbageworm | | |
| Pieris virginiensis (Edw.) | West Virginia white | Lepidoptera | Pieridae |
| Pikonema alaskensis (Roh.) | yellowheaded spruce | Hymenoptera | Tenthredinidae |
| | sawfly | | |
| Pikonema dimmockii (Cress.) | greenheaded spruce | Hymenoptera | Tenthredinidae |
| | sawfly | | |
| Pineus floccus (Patch) | red spruce adelgid | Homoptera | Adelgidae |
| Pineus pinifoliae (Fitch) | pine leaf adelgid | Homoptera | Adelgidae |
| Pineus similis (Gill.) | ragged spruce gall | Homoptera | Adelgidae |
| | adelgid | | |
| Pineus strobi (Htg.) | pine bark adelgid | Homoptera | Adelgidae |
| Piophila casei (L.) | cheese skipper | Diptera | Piophilidae |
| Pissodes nemorensis Germ. | northern pine weevil | Coleoptera | Curculionidae |
| Pissodes rotundatus LeC. | small spruce weevil | Coleoptera | Curculionidae |
| Pissodes striatulus (F.) | balsam bark weevil | Coleoptera | Curculionidae |
| Pissodes strobi (Peck) | white pine weevil | Coleoptera | Curculionidae |
| Pissodes terminalis Hopping | lodgepole terminal | Coleoptera | Curculionidae |
| | weevil | | |
| Pityokteines sparsus (LeC.) | balsam fir bark beetle | Coleoptera | Scolytidae |
| Plagiodera versicolora (Laich.) | imported willow leaf | Coleoptera | Chrysomelidae |
| | beetle | | |
| Plagiognathus obscurus Uhl. | obscure plant bug | Heteroptera | Miridae |
| Planococcus citri (Risso) | citrus mealybug | Homoptera | Pseudococcidae |
| Platycotis vittata (F.) | oak treehopper | Homoptera | Membracidae |
| Plebejus saepiolus (Bdv.) | greenish blue | Lepidoptera | Lycaenidae |
| Pleroneura brunneicornis Roh. | balsam shootboring | Hymenoptera | Xyelidae |
| | sawfly | | |
| Plodia interpunctella (Hbn.) | Indianmeal moth | Lepidoptera | Pyralidae |
| Plutella xylostella (L.) | diamondback moth | Lepidoptera | Plutellidae |
| Pnyxia scabiei (Hopk.) | potato scab gnat | Diptera | Sciaridae |
| Poanes hobomok (Harr.) | Hobomok skipper | Lepidoptera | Hesperiidae |
| Poanes viator (Edw.) | broadwinged skipper | Lepidoptera | Hesperiidae |
| Pococera aplastella (Hulst) | aspen webworm | Lepidoptera | Pyralidae |
| Pococera asperatella (Clem.) | maple webworm | Lepidoptera | Pyralidae |
| Pococera expandens (Wlk.) | striped oak webworm | Lepidoptera | Pyralidae |
| Pococera militella (Zell.) | sycamore webworm | Lepidoptera | Pyralidae |
| Pococera robustella (Zell.) | pine webworm | Lepidoptera | Pyralidae |
| Podapion gallicola Riley | pine gall weevil | Coleoptera | Apionidae |
| Podisus maculiventris (Say) | spined soldier bug | Heteroptera | Pentatomidae |
| Podosesia syringae (Harr.) | lilac borer | Lepidoptera | Sesiidae |
| Podosesia syringae (Harr.) | ash borer | Lepidoptera | Sesiidae |
| Poecilocapsus lineatus (F.) | fourlined plant bug | Heteroptera | Miridae |
| Pogonomyrmex occidentalis | western harvester ant | Hymenoptera | Formicidae |
| (Cress.) | | | |
| Polites mystic (Edw.) | long dash | Lepidoptera | Hesperiidae |
| Polites peckius (Kby.) | Peck skipper | Lepidoptera | Hesperiidae |
| Polites themistocles (Latr.) | tawnyedged skipper | Lepidoptera | Hesperiidae |
| Pollenia rudis (F.) | cluster fly | Diptera | Calliphoridae |
| Polychrysia moneta (F.) | delphinium cutworm | Lepidoptera | Noctuidae |
| Polydrusus impressifrons (Gyll.) | pale green weevil | Coleoptera | Curculionidae |
| Polygonia comma (Harr.) | hop merchant | Lepidoptera | Nymphalidae |
| Polygonia faunus (Edw.) | green comma | Lepidoptera | Nymphalidae |
| Polygonia gracilis (G. & R.) | hoary comma | Lepidoptera | Nymphalidae |
| Polygonia interrogationis (F.) | question mark | Lepidoptera | Nymphalidae |
| Polygonia progne (Cram.) | gray comma | Lepidoptera | Nymphalidae |
| Polygonia satyrus (Edw.) | satyr anglewing | Lepidoptera | Nymphalidae |
| Polygraphus rufipennis (Kby.) | foureyed spruce bark | Coleoptera | Scolytidae |
| | beetle | | |
| Polyphylla decemlineata (Say) | tenlined June beetle | Coleoptera | Scarabaeidae |
| Pontania proxima (Lep.) | willow redgall sawfly | Hymenoptera | Tenthredinidae |
| Pontania s-pomum (Walsh) | willow applegall | Hymenoptera | Tenthredinidae |
| | sawfly | | |
| Pontia occidentalis (Reak.) | checkered white | Lepidoptera | Pieridae |
| | cabbageworm | | |
| Pontia occidentalis (Reak.) | western checkered | Lepidoptera | Pieridae |
| | white | | |
| Pontia protodice (Bdv. & LeC.) | checkered white | Lepidoptera | Pieridae |
| Popillia japonica Newm. | Japanese beetle | Coleoptera | Scarabaeidae |
| Prionoxystus macmurtrei (Guer.) | little carpenterworm | Lepidoptera | Cossidae |
| Prionoxystus robiniae (Peck) | carpenterworm | Lepidoptera | Cossidae |
| Prionus laticollis (Drury) | broadnecked root | Coleoptera | Cerambycidae |
| | borer | | |
| Pristiphora erichsonii (Htg.) | larch sawfly | Hymenoptera | Tenthredinidae |
| Pristiphora geniculata (Htg.) | mountain-ash sawfly | Hymenoptera | Tenthredinidae |
| Pristiphora lena Kinc. | little spruce sawfly | Hymenoptera | Tenthredinidae |
| Probole amicaria (H.-S.) | redcheeked looper | Lepidoptera | Geometridae |
| Prochoerodes transversata | large maple | Lepidoptera | Geometridae |
| (Drury) | spanworm | | |
| Prodiplosis morrisi Gagn, | leafcurl midge | Diptera | Cecidomyiidae |
| Profenusa canadensis (Marl.) | hawthorn leafmining | Hymenoptera | Tenthredinidae |
| | sawfly | | |
| Profenusa lucifex (Ross) | oak leafmining sawfly | Hymenoptera | Tenthredinidae |
| Profenusa thomsoni (Konow) | ambermarked birch | Hymenoptera | Tenthredinidae |
| | leafminer | | |
| Proserpinus flavofasciata (Wlk.) | yellowbanded day | Lepidoptera | Sphingidae |
| | sphinx | | |
| Proteoteras aesculana Riley | maple twig borer | Lepidoptera | Tortricidae |
| Proteoteras moffatiana Fern. | maple shoot borer | Lepidoptera | Tortricidae |
| Proteoteras willingana (Kft.) | boxelder twig borer | Lepidoptera | Tortricidae |
| Protoboarmia porcelaria | dashlined looper | Lepidoptera | Geometridae |
| indicataria (Wlk.) | | | |
| Protophormia terraenovae (Rob.- | northern blow fly | Diptera | Calliphoridae |
| Desv.) | | | |
| Pseudaletia unipuncta (Haw.) | armyworm | Lepidoptera | Noctuidae |
| Pseudexentera cressoniana | oak olethreutid | Lepidoptera | Tortricidae |
| (Clem.) | leafroller | | |
| Pseudexentera mali Free. | pale apple leafroller | Lepidoptera | Tortricidae |
| Pseudococcus comstocki (Kuw.) | Comstock mealybug | Homoptera | Pseudococcidae |
| Pseudococcus longispinus (Targ.) | longtailed mealybug | Homoptera | Pseudococcidae |
| Pseudococcus maritimus (Ehrh.) | grape mealybug | Homoptera | Pseudococcidae |
| Pseudopityophthorus minutissimus | oak bark beetle | Coleoptera | Scolytidae |
| (Zimm.) | | | |
| Pseudopityophthorus pubipennis | western oak bark | Coleoptera | Scolytidae |
| (LeC.) | beetle | | |
| Pseudosciaphila duplex (Wlsm.) | poplar leafroller | Lepidoptera | Tortricidae |
| Psila rosae (F.) | carrot rust fly | Diptera | Psilidae |
| Psilocorsis cryptolechiella | twoleaf tier | Lepidoptera | Oecophoridae |
| (Cham.) | | | |
| Psilocorsis quercicella Clem. | oak leaftier | Lepidoptera | Oecophoridae |
| Psilocorsis reflexella Clem. | flat leaftier | Lepidoptera | Oecophoridae |
| Psinidia f. fenestralis (Aud.-Serv.) | longhorned | Orthoptera | Acrididae |
| | grasshopper | | |
| Psoroptes equi (Rasp.) | scab mite | Acari | Psoroptidae |
| Psoroptes ovis (Her.) | sheep scab mite | Acari | Psoroptidae |
| Psorosina hammondi (Riley) | appleleaf skeletonizer | Lepidoptera | Pyralidae |
| Psylla striata Patch | birch psyllid | Homoptera | Psyllidae |
| Psylliodes punctulata Melsh. | hop flea beetle | Coleoptera | Chrysomelidae |
| Pterocomma smithiae (Monell) | black willow aphid | Homoptera | Aphididae |
| Pthirus pubis (L.) | crab louse | Anoplura | Pediculidae |
| Ptinus clavipes Panz. | brown spider beetle | Coleoptera | Ptinidae |
| Ptinus fur (L.) | whitemarked spider | Coleoptera | Ptinidae |
| | beetle | | |
| Ptinus ocellus Brown | Australian spider | Coleoptera | Ptinidae |
| | beetle | | |
| Ptinus raptor Sturm | eastern spider beetle | Coleoptera | Ptinidae |
| Ptinus villiger (Reitter) | hairy spider beetle | Coleoptera | Ptinidae |
| Ptycholoma peritana (Clem.) | garden tortrix | Lepidoptera | Tortricidae |
| Pulex irritans (L.) | human flea | Siphonaptera | Pulicidae |
| Pulvinaria amygdali Ckll. | cottony peach scale | Homoptera | Coccidae |
| Pulvinaria innumerabilis (Rathv.) | cottony maple scale | Homoptera | Coccidae |
| Puto cupressi (Colm.) | fir mealybug | Homoptera | Pseudococcidae |
| Puto sandini Wash. | spruce mealybug | Homoptera | Pseudococcidae |
| Pyemotes tritici (L.-F. & M.) | straw itch mite | Acari | Pyemotidae |
| Pyralis farinalis L. | meal moth | Lepidoptera | Pyralidae |
| Pyrgus centaureae (Rambur) | grizzled skipper | Lepidoptera | Hesperiidae |
| Pyrrharctia isabella (J. E. Smith) | banded woollybear | Lepidoptera | Arctiidae |
| Pyrrhia umbra (Hufn.) | rose budworm | Lepidoptera | Noctuidae |
| Quadraspidiotus juglandsregiae | walnut scale | Homoptera | Diaspididae |
| (Comst.) | | | |
| Quadraspidiotus ostreaeformis | European fruit scale | Homoptera | Diaspididae |
| (Curt.) | | | |
| Quadraspidiotus perniciosus | San Jose scale | Homoptera | Diaspididae |
| (Comst.) | | | |
| Rabdophaga rigidae (O.S.) | willow beakedgall | Diptera | Cecidomyiidae |
| | midge | | |
| Rabdophaga salicisbatatas (O.S.) | willow potatogall | Diptera | Cecidomyiidae |
| | midge | | |
| Rabdophaga salicisbrassicoides | willow cabbagegall | Diptera | Cecidomyiidae |
| (Pack.) | midge | | |
| Rabdophaga strobiloides (O.S.) | willow pinecone gall | Diptera | Cecidomyiidae |
| | midge | | |
| Raphia frater Grt. | yellowmarked | Lepidoptera | Noctuidae |
| | caterpillar | | |
| Recurvaria nanella (D. & S.) | lesser bud moth | Lepidoptera | Gelechiidae |
| Reduvius personatus (L.) | masked hunter | Heteroptera | Reduviidae |
| Reticulitermes flavipes (Koll.) | eastern subterranean | Isoptera | Rhinotermitidae |
| | termite | | |
| Reticulitermes hesperus Banks | western subterranean | Isoptera | Rhinotermitidae |
| | termite | | |
| Rhabdopterus picipes (Oliv.) | cranberry rootworm | Coleoptera | Chrysomelidae |
| Rhagoletis cingulata (Loew) | cherry fruit fly | Diptera | Tephritidae |
| Rhagoletis cingulata (Loew) | cherry maggot | Diptera | Tephritidae |
| Rhagoletis completa Cress. | husk maggot | Diptera | Tephritidae |
| Rhagoletis completa Cress. | walnut husk fly | Diptera | Tephritidae |
| Rhagoletis fausta (O.S.) | black cherry fruit fly | Diptera | Tephritidae |
| Rhagoletis indifferens Curran | western cherry fruit | Diptera | Tephritidae |
| | fly | | |
| Rhagoletis mendax Curran | blueberry maggot | Diptera | Tephritidae |
| Rhagoletis pomonella (Walsh) | apple maggot | Diptera | Tephritidae |
| Rhaxonycha carolina (F.) | Carolina cantharid | Coleoptera | Cantharidae |
| Rheumaptera hastata (L.) | spearmarked black | Lepidoptera | Geometridae |
| | moth | | |
| Rhipicephalus sanguineus (Latr.) | brown dog tick | Acari | Ixodidae |
| Rhizoglyphus echinopus (F. & R.) | bulb mite | Acari | Acaridae |
| Rhopalomyia chrysanthemi (Ahlb.) | chrysanthemum gall | Diptera | Cecidomyiidae |
| | midge | | |
| Rhopalosiphum fitchii (Sand.) | apple grain aphid | Homoptera | Aphididae |
| Rhopalosiphum maidis (Fitch) | corn leaf aphid | Homoptera | Aphididae |
| Rhopalosiphum padi (L.) | oat-birdcherry aphid | Homoptera | Aphididae |
| Rhopobota naevana (Hbn.) | blackheaded | Lepidoptera | Tortricidae |
| | fireworm | | |
| Rhyacionia buoliana (D. & S.) | European pine shoot | Lepidoptera | Tortricidae |
| | moth | | |
| Rhyacionia busckana Heinr. | red pine shoot borer | Lepidoptera | Tortricidae |
| Rhyacionia frustrana (Comst.) | Nantucket pine tip | Lepidoptera | Tortricidae |
| | moth | | |
| Rhyacionia granti Miller | jack pine shoot borer | Lepidoptera | Tortricidae |
| Rhyacionia rigidana (Fern.) | pitch pine tip moth | Lepidoptera | Tortricidae |
| Rhyacionia sonia Miller | yellow jack pine | Lepidoptera | Tortricidae |
| | shoot borer | | |
| Rhynchaenus pallicornis (Say) | apple flea weevil | Coleoptera | Curculionidae |
| Rhynchaenus testaceus (Mull.) | birch and alder flea | Coleoptera | Curculionidae |
| | weevil | | |
| Rhyzopertha dominica (F.) | lesser grain borer | Coleoptera | Bostrichidae |
| Ribautiana tenerrima (H.-S.) | bramble leafhopper | Homoptera | Cicadellidae |
| Saissetia coffeae (Wlk.) | hemispherical scale | Homoptera | Coccidae |
| Saperda calcarata Say | poplar borer | Coleoptera | Cerambycidae |
| Saperda candida F. | Saskatoon borer | Coleoptera | Cerambycidae |
| Saperda candida F. | roundheaded | Coleoptera | Cerambycidae |
| | appletree borer | | |
| Saperda tridentata Oliv. | elm borer | Coleoptera | Cerambycidae |
| Saperda vestita Say | linden borer | Coleoptera | Cerambycidae |
| Sarcophaga aldrichi Park. | large flesh fly | Diptera | Sarcophagidae |
| Sarcoptes scabiei (DeG.) | itch mite | Acari | Sarcoptidae |
| Satyrium acadicum (Edw.) | Acadian hairstreak | Lepidoptera | Lycaenidae |
| Satyrium calanus (Hbn.) | banded hairstreak | Lepidoptera | Lycaenidae |
| Satyrium caryaevorum (McD.) | hickory hairstreak | Lepidoptera | Lycaenidae |
| Satyrium edwardsii (G. & R.) | Edwards hairstreak | Lepidoptera | Lycaenidae |
| Satyrium liparops (LeC.) | striped hairstreak | Lepidoptera | Lycaenidae |
| Satyrodes eurydice (Johan.) | eyed brown | Lepidoptera | Satyridae |
| Schinia florida (Gn.) | primrose moth | Lepidoptera | Noctuidae |
| Schizaphis graminum (Rond.) | greenbug | Homoptera | Aphididae |
| Schizolachnus piniradiatae (Dav.) | woolly pineneedle | Homoptera | Aphididae |
| | aphid | | |
| Schizura concinna (J. E. Smith) | redhumped caterpillar | Lepidoptera | Notodontidae |
| Schizura ipomoeae Dbly. | oak-maple humped | Lepidoptera | Notodontidae |
| | caterpillar | | |
| Schizura unicornis (J. E. Smith) | unicorn caterpillar | Lepidoptera | Notodontidae |
| Sciopithes obscurus Horn | obscure root weevil | Coleoptera | Curculionidae |
| Scoliopteryx libatrix (L.) | herald moth | Lepidoptera | Noctuidae |
| Scolytus mali (Bech.) | larger shothole borer | Coleoptera | Scolytidae |
| Scolytus multistriatus (Marsh.) | European elm bark | Coleoptera | Scolytidae |
| | beetle | | |
| Scolytus quadrispinosus Say | hickory bark beetle | Coleoptera | Scolytidae |
| Scolytus rugulosus (Mull.) | shothole borer | Coleoptera | Scolytidae |
| Scolytus tsugae (Swaine) | hemlock engraver | Coleoptera | Scolytidae |
| Scolytus unispinosus LeC. | Douglas-fir engraver | Coleoptera | Scolytidae |
| Scolytus ventralis LeC. | fir engraver | Coleoptera | Scolytidae |
| Scudderia furcata B. von W. | forktailed bush | Grylloptera | Tettigoniidae |
| | katydid | | |
| Scutigerella immaculata (Newp.) | garden symphylan | Symphyla | Scutigerellidae |
| Semanotus ligneus (F.) | cedartree borer | Coleoptera | Cerambycidae |
| Semanotus litigiosus (Casey) | firtree borer | Coleoptera | Cerambycidae |
| Semiothisa granitata (Gn.) | green spruce looper | Lepidoptera | Geometridae |
| Semiothisa ocellinata (Gn.) | locust looper | Lepidoptera | Geometridae |
| Semiothisa sexmaculata (Pack.) | green larch looper | Lepidoptera | Geometridae |
| Semiothisa signaria dispuncta | spruce-fir looper | Lepidoptera | Geometridae |
| (Wlk.) | | | |
| Sesia tibialis (Harr.) | cottonwood crown | Lepidoptera | Sesiidae |
| | borer | | |
| Setoptus jonesi (Keif.) | red pine needle mite | Acari | Phytoptidae |
| Sicya macularia (Harr.) | twopronged looper | Lepidoptera | Geometridae |
| Simulium arcticum Malloch | northern black fly | Diptera | Simuliidae |
| Simulium venustum Say | whitestockinged | Diptera | Simuliidae |
| | black fly | | |
| Simulium vittatum Zett. | striped black fly | Diptera | Simuliidae |
| Sinea diadema (F.) | spined assassin bug | Heteroptera | Reduviidae |
| Sirex cyaneus F. | blue horntail | Hymenoptera | Siricidae |
| Sirex juvencus juvencus (L.) | European blue | Hymenoptera | Siricidae |
| | horntail | | |
| Sitobion avenae (F.) | English grain aphid | Homoptera | Aphididae |
| Sitodiplosis mosellana (Gehin) | wheat midge | Diptera | Cecidomyiidae |
| Sitona cylindricollis (Fahr.) | sweetclover weevil | Coleoptera | Curculionidae |
| Sitona hispidulus (F.) | clover root curculio | Coleoptera | Curculionidae |
| Sitona lineatus (L.) | pea leaf weevil | Coleoptera | Curculionidae |
| Sitophilus granarius (L.) | granary weevil | Coleoptera | Curculionidae |
| Sitophilus oryzae (L.) | rice weevil | Coleoptera | Curculionidae |
| Sitotroga cerealella (Oliv.) | Angoumois grain | Lepidoptera | Gelechiidae |
| | moth | | |
| Smerinthus cerisyi Kby. | willow sphinx | Lepidoptera | Sphingidae |
| Smerinthus jamaicensis (Drury) | twinspot sphinx | Lepidoptera | Sphingidae |
| Solenopsis molesta (Say) | thief ant | Hymenoptera | Formicidae |
| Solenoptes capillatus End. | little blue cattle louse | Anoplura | Linognathidae |
| Spaelotis clandestina (Harr.) | w-marked cutworm | Lepidoptera | Noctuidae |
| Spaelotis havilae (Grt.) | western w-marked | Lepidoptera | Noctuidae |
| | cutworm | | |
| Sparganothis acerivorana MacK. | maple leafroller | Lepidoptera | Tortricidae |
| Sparganothis directana (Wlk.) | chokecherry leafroller | Lepidoptera | Tortricidae |
| Sparganothis pettitana (Rob.) | maple-basswood | Lepidoptera | Tortricidae |
| | leafroller | | |
| Speyeria aphrodite (F.) | aphrodite fritillary | Lepidoptera | Nymphalidae |
| Speyeria atlantis (Edw.) | Atlantis fritillary | Lepidoptera | Nymphalidae |
| Speyeria cybele (F.) | great spangled | Lepidoptera | Nymphalidae |
| | fritillary | | |
| Sphaerolecanium prunastri | globose scale | Homoptera | Coccidae |
| (Fonsc.) | | | |
| Spharagemon collare (Scudd.) | mottled sand | Orthoptera | Acrididae |
| | grasshopper | | |
| Sphinx canadensis Bdv. | northern ash sphinx | Lepidoptera | Sphingidae |
| Sphinx chersis (Hbn.) | great ash sphinx | Lepidoptera | Sphingidae |
| Sphinx drupiferarum J. E. Smith | wild cherry sphinx | Lepidoptera | Sphingidae |
| Sphinx drupiferarum J. E. Smith | plum sphinx | Lepidoptera | Sphingidae |
| Sphinx eremitus (Hbn.) | hermit sphinx | Lepidoptera | Sphingidae |
| Sphinx gordius Cram. | apple sphinx | Lepidoptera | Sphingidae |
| Sphinx kalmiae J. E. Smith | laurel sphinx | Lepidoptera | Sphingidae |
| Sphinx luscitiosa Clem. | poplar-and-willow | Lepidoptera | Sphingidae |
| | sphinx | | |
| Sphinx vashti Stkr. | snowberry sphinx | Lepidoptera | Sphingidae |
| Spilonota ocellana (D. & S.) | eyespotted bud moth | Lepidoptera | Tortricidae |
| Spilosoma virginica (F.) | yellow woollybear | Lepidoptera | Arctiidae |
| Spodoptera exigua (Hbn.) | beet armyworm | Lepidoptera | Noctuidae |
| Spodoptera frugiperda (J. E. Smith) | fall armyworm | Lepidoptera | Noctuidae |
| Spodoptera ornithogalli (Gn.) | yellowstriped | Lepidoptera | Noctuidae |
| | armyworm | | |
| Spodoptera praefica (Grt.) | western yellowstriped | Lepidoptera | Noctuidae |
| | armyworm | | |
| Stegobium paniceum (L.) | drugstore beetle | Coleoptera | Anobiidae |
| Stenolophus lecontei (Chaud.) | seedcorn beetle | Coleoptera | Carabidae |
| Steremnius carinatus (Boh.) | conifer seedling | Coleoptera | Curculionidae |
| | weevil | | |
| Stethophyma lineatum (Scudd.) | striped sedge | Orthoptera | Acrididae |
| | grasshopper | | |
| Sthenopis argenteomaculatus | alder root borer | Lepidoptera | Hepialidae |
| (Harr.) | | | |
| Stictocephala bisonia K. & Y. | buffalo treehopper | Homoptera | Membracidae |
| Stictoleptura canadensis Oliv. | redshouldered pine | Coleoptera | Cerambycidae |
| | borer | | |
| Stilbosis ostryaeella (Cham.) | ironwood leafminer | Lepidoptera | Cosmopterigidae |
| Stomoxys calcitrans (L.) | stable fly | Diptera | Muscidae |
| Strauzia longipennis (Wied.) | sunflower maggot | Diptera | Tephritidae |
| Strobilomyia appalachensis | black spruce cone | Diptera | Anthomyiidae |
| Michelsen | maggot | | |
| Strobilomyia laricis Michelsen | larch cone maggot | Diptera | Anthomyiidae |
| Strobilomyia neanthracina | white spruce cone | Diptera | Anthomyiidae |
| Michelsen | maggot | | |
| Strobilomyia varia (Huckett) | tamarack cone | Diptera | Anthomyiidae |
| | maggot | | |
| Strymon melinus Hbn. | gray hairstreak | Lepidoptera | Lycaenidae |
| Supella longipalpa (F.) | brownbanded | Blattodea | Blattellidae |
| | cockroach | | |
| Symmerista albifrons (J. E. Smith) | orangehumped | Lepidoptera | Notodontidae |
| | oakworm | | |
| Symmerista canicosta Franc. | redhumped oakworm | Lepidoptera | Notodontidae |
| Symmerista leucitys Franc. | orangehumped | Lepidoptera | Notodontidae |
| | mapleworm | | |
| Symydobius americanus Baker | dark birch aphid | Homoptera | Aphididae |
| Synanthedon acerni (Clem.) | maple callus borer | Lepidoptera | Sesiidae |
| Synanthedon albicornis (Hy.Edw.) | willow stem borer | Lepidoptera | Sesiidae |
| Synanthedon bibionipennis (Bdv.) | strawberry crown | Lepidoptera | Sesiidae |
| | moth | | |
| Synanthedon decipiens (Hy.Edw.) | oak gall borer | Lepidoptera | Sesiidae |
| Synanthedon exitiosa (Say) | peachtree borer | Lepidoptera | Sesiidae |
| Synanthedon pictipes (G. & R.) | lesser peachtree borer | Lepidoptera | Sesiidae |
| Synanthedon pini (Kell.) | pitch mass borer | Lepidoptera | Sesiidae |
| Synanthedon pyri (Harr.) | apple bark borer | Lepidoptera | Sesiidae |
| Synanthedon scitula (Harr.) | dogwood borer | Lepidoptera | Sesiidae |
| Synanthedon sequoiae (Hy.Edw.) | sequoia pitch moth | Lepidoptera | Sesiidae |
| Synanthedon tipuliformis (Cl.) | currant borer | Lepidoptera | Sesiidae |
| Syneta ferruginea (Germ.) | rusty leaf beetle | Coleoptera | Chrysomelidae |
| Syngrapha alias (Ottol.) | spruce climbing | Lepidoptera | Noctuidae |
| | cutworm | | |
| Syngrapha rectangula (Kby.) | angulated cutworm | Lepidoptera | Noctuidae |
| Syngrapha selecta (Wlk.) | spruce false looper | Lepidoptera | Noctuidae |
| Systena blanda (Melsh.) | palestriped flea beetle | Coleoptera | Chrysomelidae |
| Systena frontalis (F.) | redheaded flea beetle | Coleoptera | Chrysomelidae |
| Tabanus lineola F. | striped horse fly | Diptera | Tabanidae |
| Tachycines asynamorus Adel. | greenhouse stone | Grylloptera | Gryllacrididae |
| | cricket | | |
| Taeniothrips inconsequens (Uzel) | pear thrips | Thysanoptera | Thripidae |
| Tapinoma sessile (Say) | odorous house ant | Hymenoptera | Formicidae |
| Tarsonemus granarius Lindquist | glossy grain mite | Acari | Tarsonemidae |
| Telamona tremulata Ball | aspen treehopper | Homoptera | Membracidae |
| Tenebrio molitor L. | yellow mealworm | Coleoptera | Tenebrionidae |
| Tenebrio obscurus F. | dark mealworm | Coleoptera | Tenebrionidae |
| Tenebroides mauritanicus (L.) | cadelle | Coleoptera | Trogositidae |
| Tenodera aridifolia sinensis Sauss. | Chinese mantid | Mantodea | Mantidae |
| Tetanops myopaeformis (Roder) | sugarbeet root maggot | Diptera | Otitidae |
| Tethida cordigera (Beauv.) | blackheaded ash | Hymenoptera | Tenthredinidae |
| | sawfly | | |
| Tetramesa hordei (Harr.) | barley jointworm | Hymenoptera | Eurytomidae |
| Tetramesa secale (Fitch) | rye jointworm | Hymenoptera | Eurytomidae |
| Tetramesa tritici (Fitch) | wheat jointworm | Hymenoptera | Eurytomidae |
| Tetranychus canadensis (McG.) | fourspotted spider | Acari | Tetranychidae |
| | mite | | |
| Tetranychus mcdanieli McG. | McDaniel spider mite | Acari | Tetranychidae |
| Tetranychus urticae Koch | twospotted spider | Acari | Tetranychidae |
| | mite | | |
| Tetraopes tetrophthalmus (Forst.) | red milkweed beetle | Coleoptera | Cerambycidae |
| Tetropium cinnamopterum Kby. | eastern larch borer | Coleoptera | Cerambycidae |
| Tetropium parvulum Casey | northern spruce borer | Coleoptera | Cerambycidae |
| Tetropium velutinum LeC. | western larch borer | Coleoptera | Cerambycidae |
| Tetyra bipunctata (H.-S.) | shieldbacked pine | Heteroptera | Pentatomidae |
| | seed bug | | |
| Thecodiplosis piniresinosae | red pine needle midge | Diptera | Cecidomyiidae |
| Kearby | | | |
| Therioaphis riehmi (Borner) | sweetclover aphid | Homoptera | Aphididae |
| Thermobia domestica (Pack.) | firebrat | Thysanura | Lepismatidae |
| Thorybes pylades (Scudd.) | northern cloudy wing | Lepidoptera | Hesperiidae |
| Thrips nigropilosus Uzel | chrysanthemum thrips | Thysanoptera | Thripidae |
| Thrips simplex (Mor.) | gladiolus thrips | Thysanoptera | Thripidae |
| Thrips tabaci Lind. | onion thrips | Thysanoptera | Thripidae |
| Thylodrias contractus Mots. | odd beetle | Coleoptera | Dermestidae |
| Thymelicus lineola (Ochs.) | European skipper | Lepidoptera | Hesperiidae |
| Thyridopteryx ephemeraeformis | bagworm | Lepidoptera | Psychidae |
| (Haw.) | | | |
| Tibicen pruinosa (Say) | dogday cicada | Homoptera | Cicadidae |
| Tinea pellionella L. | casemaking clothes | Lepidoptera | Tineidae |
| | moth | | |
| Tineola bisselliella (Hum.) | webbing clothes moth | Lepidoptera | Tineidae |
| Tipula paludosa Meig. | European crane fly | Diptera | Tipulidae |
| Tischeria malifoliella Clem. | appleleaf trumpet | Lepidoptera | Tischeriidae |
| | miner | | |
| Tischeria quercitella Clem. | oak blotchminer | Lepidoptera | Tischeriidae |
| Tolype laricis (Fitch) | larch lappet moth | Lepidoptera | Lasiocampidae |
| Tolype velleda (Stoll) | velleda lappet moth | Lepidoptera | Lasiocampidae |
| Tomostethus multicinctus (Roh.) | brownheaded ash | Hymenoptera | Tenthredinidae |
| | sawfly | | |
| Torymus varians (Wlk.) | apple seed chalcid | Hymenoptera | Torymidae |
| Toumeyella liriodendri (Gmel.) | tuliptree scale | Homoptera | Coccidae |
| Toumeyella parvicornis (Ckll.) | pine tortoise scale | Homoptera | Coccidae |
| Trachykele blondeli Marseul | western cedar borer | Coleoptera | Buprestidae |
| Tremex columba (L.) | pigeon tremex | Hymenoptera | Siricidae |
| Trialeurodes vaporariorum | greenhouse whitefly | Homoptera | Aleyrodidae |
| (Westw.) | | | |
| Tribolium audax Halst. | American black flour | Coleoptera | Tenebrionidae |
| | beetle | | |
| Tribolium castaneum (Hbst.) | red flour beetle | Coleoptera | Tenebrionidae |
| Tribolium confusum Duv. | confused flour beetle | Coleoptera | Tenebrionidae |
| Tribolium destructor Uytt. | large flour beetle | Coleoptera | Tenebrionidae |
| Tribolium madens (Charp.) | European black flour | Coleoptera | Tenebrionidae |
| | beetle | | |
| Trichiocampus simplicicornis | hairy willow sawfly | Hymenoptera | Tenthredinidae |
| (Nort.) | | | |
| Trichiocampus viminalis (Fall.) | hairy poplar sawfly | Hymenoptera | Tenthredinidae |
| Trichiosoma triangulum Kby. | giant birch sawfly | Hymenoptera | Cimbicidae |
| Trichobaris trinotata (Say) | potato stalk borer | Coleoptera | Curculionidae |
| Trichodectes canis (DeG.) | dog biting louse | Mallophaga | Trichodectidae |
| Trichogramma minutum Riley | minute egg parasite | Hymenoptera | Trichogrammatid |
| Tricholochmaea d. decora (Say) | gray willow leaf | Coleoptera | Chrysomelidae |
| | beetle | | |
| Tricholochmaea decora carbo | Pacific willow leaf | Coleoptera | Chrysomelidae |
| (LeC.) | beetle | | |
| Tricholochmaea vaccinii (Fall) | blueberry leaf beetle | Coleoptera | Chrysomelidae |
| Trichophaga tapetzella (L.) | carpet moth | Lepidoptera | Tineidae |
| Trichoplusia ni (Hbn.) | cabbage looper | Lepidoptera | Noctuidae |
| Trichordestra legitima (Grt.) | striped garden | Lepidoptera | Noctuidae |
| | caterpillar | | |
| Trigonogenius globulus Sol. | globular spider beetle | Coleoptera | Ptinidae |
| Trisetacus ehmanni Keif. | pine needle mite | Acari | Phytoptidae |
| Trisetacus grosmanni Keif. | spruce bud mite | Acari | Phytoptidae |
| Trisetacus grosmanni Keif. | fir bud mite | Acari | Phytoptidae |
| Trogium pulsatorium (L.) | larger pale booklouse | Psocoptera | Trogiidae |
| Trogium pulsatorium (L.) | deathwatch | Psocoptera | Trogiidae |
| Trogoderma granarium Everts | Khapra beetle | Coleoptera | Dermestidae |
| Trogoderma inclusum LeC. | larger cabinet beetle | Coleoptera | Dermestidae |
| Trogoderma variabile Ballion | warehouse beetle | Coleoptera | Dermestidae |
| Tropidosteptes amoenus Reut. | ash plant bug | Heteroptera | Miridae |
| Trypodendron betulae Swaine | birch ambrosia beetle | Coleoptera | Scolytidae |
| Trypodendron lineatum (Oliv.) | striped ambrosia | Coleoptera | Scolytidae |
| | beetle | | |
| Trypodendron retusum (LeC.) | poplar ambrosia | Coleoptera | Scolytidae |
| | beetle | | |
| Tuberolachnus salignus (Gmel.) | giant willow aphid | Homoptera | Aphididae |
| Tychius picirostris (F.) | clover seed weevil | Coleoptera | Curculionidae |
| Tychius stephensi Schonh. | red clover seed | Coleoptera | Curculionidae |
| | weevil | | |
| Typhaea stercorea (L.) | hairy fungus beetle | Coleoptera | Mycetophagidae |
| Typhlocyba froggatti Baker | yellow apple | Homoptera | Cicadellidae |
| | leafhopper | | |
| Typhlocyba pomaria McA. | white apple | Homoptera | Cicadellidae |
| | leafhopper | | |
| Tyria jacobaeae (L.) | cinnabar moth | Lepidoptera | Arctiidae |
| Tyrolichus casei Oud. | cheese mite | Acari | Acaridae |
| Tyrophagus putrescentiae (Schr.) | mold mite | Acari | Acaridae |
| Udea rubigalis (Gn.) | celery leaftier | Lepidoptera | Pyralidae |
| Udea rubigalis (Gn.) | greenhouse leaftier | Lepidoptera | Pyralidae |
| Unaspis euonymi (Comst.) | euonymus scale | Homoptera | Diaspididae |
| Upis ceramboides (L.) | roughened darkling | Coleoptera | Tenebrionidae |
| | beetle | | |
| Urocerus albicornis (F.) | black horntail | Hymenoptera | Siricidae |
| Urocerus cressoni Nort. | black and red horntail | Hymenoptera | Siricidae |
| Urocerus gigas flavicornis (F.) | banded horntail | Hymenoptera | Siricidae |
| Utetheisa bella (L.) | bella moth | Lepidoptera | Arctiidae |
| Vanessa atalanta (L.) | red admiral | Lepidoptera | Nymphalidae |
| Vanessa cardui (L.) | painted lady | Lepidoptera | Nymphalidae |
| Vanessa virginiensis (Drury) | American painted | Lepidoptera | Nymphalidae |
| | lady | | |
| Vasates quadripedes Shimer | maple bladdergall | Acari | Eriophyidae |
| | mite | | |
| Vespa crabro germana Christ | European hornet | Hymenoptera | Vespidae |
| Vespa crabro germana Christ | giant hornet | Hymenoptera | Vespidae |
| Vespula germanica (F.) | German yellowjacket | Hymenoptera | Vespidae |
| Vespula maculifrons (Buys.) | eastern yellowjacket | Hymenoptera | Vespidae |
| Vespula pensylvanica (Sauss.) | western yellowjacket | Hymenoptera | Vespidae |
| Wohlfahrtia vigil (Wlk.) | myiasis fly | Diptera | Sarcophagidae |
| Wyeomyia smithii (Coq.) | pitcherplant mosquito | Diptera | Culicidae |
| Xanthia togata (Esp.) | pinkbarred sallow | Lepidoptera | Noctuidae |
| Xanthogaleruca luteola (Mull.) | elm leaf beetle | Coleoptera | Chrysomelidae |
| Xanthonia decemnotata (Say) | tenspotted leaf beetle | Coleoptera | Chrysomelidae |
| Xanthoteras quercusforticorne | oak figgall wasp | Hymenoptera | Cynipidae |
| (Walsh) | | | |
| Xanthotype sospeta (Drury) | crocus geometer | Lepidoptera | Geometridae |
| Xenopsylla cheopis (Roths.) | oriental rat flea | Siphonaptera | Pulicidae |
| Xestia perquiritata (Morr.) | gray spruce cutworm | Lepidoptera | Noctuidae |
| Xestia spp. | spotted cutworm | Lepidoptera | Noctuidae |
| Xestobium rufovillosum (DeG.) | deathwatch beetle* | Coleoptera | Anobiidae |
| Xestobium rufovillosum (DeG.) | knock beetle* | Coleoptera | Anobiidae |
| Xyela minor Nort. | pine flower sawfly | Hymenoptera | Xyelidae |
| Xylotrechus aceris Fisher | gallmaking maple | Coleoptera | Cerambycidae |
| | borer | | |
| Xylotrechus colonus (F.) | rustic borer | Coleoptera | Cerambycidae |
| Xylotrechus obliteratus LeC. | poplar butt borer* | Coleoptera | Cerambycidae |
| Xylotrechus undulatus (Say) | spruce zebra beetle | Coleoptera | Cerambycidae |
| Yponomeuta cognatella Hbn. | euonymus webworm | Lepidoptera | Yponomeutidae |
| Yponomeuta malinella Zell. | apple ermine moth | Lepidoptera | Yponomeutidae |
| Ypsolopha dentella (F.) | European | Lepidoptera | Plutellidae |
| | honeysuckle leafroller | | |
| Zale helata (Sm.) | white pine false | Lepidoptera | Noctuidae |
| | looper | | |
| Zale lunifera (Hbn.) | pine false looper | Lepidoptera | Noctuidae |
| Zale metatoides McD. | jack pine false looper | Lepidoptera | Noctuidae |
| Zale minerea (Gn.) | large false looper | Lepidoptera | Noctuidae |
| Zale undularis (Drury) | locust false looper | Lepidoptera | Noctuidae |
| Zaraea inflata Nort. | honeysuckle sawfly | Hymenoptera | Cimbicidae |
| Zeiraphera canadensis Mut. & | spruce bud moth | Lepidoptera | Tortricidae |
| Free. | | | |
| Zeiraphera fortunana (Kft.) | yellow spruce | Lepidoptera | Tortricidae |
| | budworm | | |
| Zeiraphera improbana (Wlk.) | larch needleworm | Lepidoptera | Tortricidae |
| Zeiraphera unfortunana Powell | purplestriped | Lepidoptera | Tortricidae |
| | shootworm | | |
| Zelleria haimbachi Bsk. | pine needle | Lepidoptera | Yponomeutidae |
| | sheathminer | | |
| Zeugophora scutellaris Suffr. | cottonwood | Coleoptera | Chrysomelidae |
| | leafmining beetle | | |
| Zeuzera pyrina (L.) | leopard moth | Lepidoptera | Cossidae |
| Zonosemata electa (Say) | pepper maggot | Diptera | Tephritidae |
| Zootermopsis angusticollis | Pacific dampwood | Isoptera | Termopsidae |
| (Hagen) | termite | | |
| Zophodia grossulariella (Hbn.) | gooseberry fruitworm | Lepidoptera | Pyralidae |
| Zygogramma exclamationis (F.) | sunflower beetle | Coleoptera | Chrysomelidae |

For purposes of simplicity, the term “insect” shall be used through out this application; however, it should be understood that the term “insect” refers, not only to insects, but also to arachnids, larvae, and like invertebrates. Also for purposes of this application, the term “insect control” shall refer to having a repellant effect, a pesticidal effect, or both.

“Target pest” refers to the organism that is the subject of the insect control effort.

“Repellant effect” is an effect wherein more insects are repelled away from a host or area that has been treated with the composition than a control host or area that has not been treated with the composition. In some embodiments, repellant effect is an effect wherein at least about 75% of insects are repelled away from a host or area that has been treated with the composition. In some embodiments, repellant effect is an effect wherein at least about 90% of insects are repelled away from a host or area that has been treated with the composition.

“Pesticidal effect” is an effect wherein treatment with a composition causes at least about 1% of the insects to die. In this regard, an LC₁ to LC₁₀₀ (lethal concentration) or an LD₁ to LD₁₀₀ (lethal dose) of a composition will cause a pesticidal effect. In some embodiments, the pesticidal effect is an effect wherein treatment with a composition causes at least about 5% of the exposed insects to die. In some embodiments, the pesticidal effect is an effect wherein treatment with a composition causes at least about 10% of the exposed insects to die. In some embodiments, the pesticidal effect is an effect wherein treatment with a composition causes at least about 25% of the insects to die. In some embodiments the pesticidal effect is an effect wherein treatment with a composition causes at least about 50% of the exposed insects to die. In some embodiments the pesticidal effect is an effect wherein treatment with a composition causes at least about 75% of the exposed insects to die. In some embodiments the pesticidal effect is an effect wherein treatment with a composition causes at least about 90% of the exposed insects to die.

“Disablement” is an effect wherein insects are mobility-impaired such that their mobility is reduced as compared to insects that have not been exposed to the composition. In some embodiments, disablement is an effect wherein at least about 75% of insects are mobility-impaired such that their mobility is reduced as compared to insects that have not been exposed to the composition. In some embodiments, disablement is an effect wherein at least about 90% of insects are mobility-impaired such that their mobility is reduced as compared to insects that have not been exposed to the composition. In some embodiments, disablement can be caused by a disabling effect at the cellular or whole-organism level.

Embodiments of the invention can be used to control parasites. As used herein, the term “parasite” includes parasites, such as but not limited to, protozoa, including intestinal protozoa, tissue protozoa, and blood protozoa. Examples of intestinal protozoa include, but are not limited to: Entamoeba hystolytica, Giardia lamblia, Cryptosporidium muris, and Cryptosporidium parvum. Examples of tissue protozoa include, but are not limited to: Trypanosomatida gambiense, Trypanosomatida rhodesiense, Trypanosomatida crusi, Leishmania mexicana, Leishmania braziliensis, Leishmania tropica, Leishmania donovani, Toxoplasma gondii, and Trichomonas vaginalis. Examples of blood protozoa include, but are not limited to Plasmodium vivax, Plasmodium ovale, Plasmodium malariae, and Plasmodium falciparum. Histomonas meleagridis is yet another example of a protozoan parasite.

As used herein, the term “parasite” further includes, but is not limited to: helminthes or parasitic worms, including nematodes (round worms) and platyhelminthes (flat worms). Examples of nematodes include, but are not limited to: animal and plant nematodes of the adenophorea class, such as the intestinal nematode Trichuris trichiura (whipworm) and the plant nematode Trichodorus obtusus (stubby-root nematode); intestinal nematodes of the secementea class, such as Ascaris lumbricoides, Enterobius vermicularis (pinworm), Ancylostoma duodenale (hookworm), Necator americanus (hookworm), and Strongyloides stercoralis; and tissue nematodes of the secementea class, such as Wuchereria bancrofti (Filaria bancrofti) and Dracunculus medinensis (Guinea worm). Examples of plathyeminthes include, but are not limited to: Trematodes (flukes), including blood flukes, such as Schistosoma mansoni (intestinal Schistosomiasis), Schistosoma haematobium, and Schistosoma japonicum; liver flukes, such as Fasciola hepatica, and Fasciola gigantica; intestinal flukes, such as Heterophyes heterophyes; and lung flukes such as Paragonimus westermani. Examples of platheminthes further include, but are not limited to: Cestodes (tapeworms), including Taenia solium, Taenia saginata, Hymenolepis nana, and Echinococcus granulosus.

Furthermore, the term “parasite” further includes, but is not limited to those organisms and classes of organisms listed in the following table:

TABLE 6
PARASITES SUBJECT TO CONTROL BY EMBODIMENTS OF THE
INVENTION

| | | |
|---|---|---|
| Parasite (Genus) | (Species) | Context |

Protozoa (sub-groups: rhizopods, flagellates, ciliate, sporozoans)

| | | |
|---|---|---|
| Entamoeba | coli | Example of gut rhizopod that can switch from |
| | dispar | commensal to parasite depending on circumstances. |
| | histolytica | Several species are found in humans. E. histolytica |
| | gingivalis | is the pathogen responsible for amoebiasis (which |
| | | includes amoebic dysentery and amoebic liver |
| | | abscesses). |
| Balantidium | coli | Example of parasitic ciliate and zoonosis |
| Giardia | intenstinalis | Example of water-borne flagellate and zoonosis |
| | lamblia | |
| Trichomonas | vaginalis | Example of gut flagellate in birds. Venereally |
| | | transmitted flagellate causing abortion & infertility |
| Histomonas | meleagridis | Example of a parasite transmitted by another parasite - |
| | | Heterakis |
| Trypanosoma | avium | Example of a venerally transmitted flagellate |
| | brucei | |
| | cruzi | |
| | equiperdum | |
| | evansi | |
| | vivax | |
| Eimeria | acervulina | A picomplexan parasite responsible for the poultry |
| | brunetti | disease coccidiosis. Used to illustrate the basic |
| | jemezi | characteristics of the coccidian direct lifecycle. |
| | maxima | Ovine, bovine & rabbit coccidiosis mentioned but |
| | nextrix | not by species. |
| | tenella | |
| | stiedae | |
| | meleagridis | |
| Isospora | belli | Mentioned as the dog/cat/pig equivalent of Eimeria |
| | felis | |
| | canis | |
| Cyclospora | cayetanensis | Traveler's Diarrhea. |
| Cryptosporidium | parvum | Of the Phylum Apicomplexa and causes a diarrheal |
| | hominis | illness called cryptosporidiosis. Example of an |
| | canis | important water borne zoonosis. |
| | felis | |
| | hominis | |
| | meleagridis | |
| | muris | |
| Sarcocystis | cruzi | Used to illustrate the basic characteristics of the |
| | hominis | coccidian indirect lifecycle. Can happen when |
| | muris | undercooked meat is ingested. Symptoms include |
| | | diarrhea, which may be mild and transient or severe |
| | | and life threatening. |
| Toxoplasma | gondii | The definitive host is the cat, but the parasite can be |
| | | carried by the vast majority of warm-blooded |
| | | animals, including humans. The causative agent of |
| | | toxoplasmosis. |
| Neospora | caninum | Important pathogen in cattle and dogs. Highly |
| | | transmissible with some herds having up to 90% |
| | | prevalence. Causes abortions. |
| Babesia | major | Example of tick-borne protozoa, responsible for |
| | microti | causing Texas Fever. |
| | divergens | |
| | duncani | |
| | gibsoni | |
| Plasmodium | falciparum | Example of an endemic insect borne protozoan. |
| | vivax | Causative agent of malaria. |
| | ovale | |
| | malariae | |
| | knowlesi | |
| | gigliolii | |
| Leishmania | aethiopica | Example of insect borne protozoan that lives inside |
| | donovani | host macrophages |
| | major | |
| | mexicana | |
| | tropica | |
| | braziliensis | |

Trematodes

| | | |
|---|---|---|
| Fasciola | hepatica | Also known as the common liver fluke it is a |
| | magna | parasitic flatworm of phylum Platyhelminthes that |
| | gigantica | infects liver of a various mammals, including man. |
| | jacksoni | The disease caused by the fluke is called fascioliasis |
| | | (also known as fasciolosis). F. hepatica is world- |
| | | wide distributed and causes great economic losses in |
| | | sheep and cattle. |
| Dicrocoelium | dendriticum | The Lancet liver fluke is a parasite fluke that tends |
| | | to live in cattle or other grazing mammals. |
| Schistosoma | mansoni | Commonly known as blood-flukes and bilharzia, |
| | japonicum | cause the most significant infection of humans by |
| | mekongi | flatworms. Considered by the World Health |
| | intercalatum | Organization as second in importance only to |
| | haematobium | malaria. |

Cestodes

| | | |
|---|---|---|
| Taenia | crassiceps | Example of tapeworms with humans as natural |
| | pisiformis | definite hosts but with implications for zoonoses and |
| | saginata | meat inspection |
| | solium | |
| Dipylidium | caninum | Also called the cucumber tapeworm or the double- |
| | | pore tapeworm, it infects organisms afflicted with |
| | | fleas, including canids, felids, and pet-owners, |
| | | especially children. |
| Echinococcus | granulosus | Includes six species of cyclophyllid tapeworms. |
| | multilocularis | Infection with Echinococcus results in hydatid |
| | shiquicus | disease, also known as echinococcosis. |

Nematodes

| | | |
|---|---|---|
| Aphelenchoides | fragariae | Foliar nematodes are plant parasitic roundworms |
| | ritzemabosi | which are a widespread problem for the ornamental |
| | besseyi. | and nursery industries. |
| Heterodera | | Soybean cyst nematode. |
| Globodera | solanacearum | Potato cyst nematode. |
| | virginiae | |
| | tabacum | |
| Nacobbus | dorsalis | False Root-knot. |
| Pratylenchus | brachurus | Brown root rot. |
| | penetrans | |
| Ditylenchus | dipsaci | Plant pathogenic nematode which infects the bud |
| | | and stem. |
| Xiphinema | americanum | American dagger nematode; plant pathogen. |
| Longidorus | sylphus | Attacks mint. |
| Paratrichodorus | minor | Christie's stubby root nematode. |
| Dioctophyma | renale | Giant kidney worm; common parasital worm |
| | | found in carnivorous animals. |
| Meloidogyne | hapla | Root-knot nematodes infect plant roots and are |
| | incognita | one of the three most economically damaging |
| | javanica | genera of nematodes on horticultural and field |
| | | crops. |
| Trichostrongylus | tenius | Used as a basic nematode lifecycle |
| Ostertagia | | Highlights impact of larval development in |
| or Teladorsagia | | abomasum wall, differences between type I & II, |
| | | example of seasonally-induced hypobiosis |
| Nematodirus | | Example of nematode developing in the gut lumen, |
| | | example of nematode with critical hatching |
| | | conditions |
| Haemonchus | | Example of blood-feeding nematode |
| Cooperia | | Distinctive coiled nematode of ruminants |
| Trichuris | | Distinctive whip-like nematode of ruminants |
| Ascaris | | Example of hepato-trachael migratory nematode |
| Parascaris | | Important equine nematode |
| Oxyuris | | Distinctive pin-worm of equines |
| Toxascaris | | Example of non-migratory ascarid of dogs & cats |
| | | referred forward to the migratory Toxocara sp |
| Toxocara | | Example of complex migratory nematode with |
| | | hypobiotic larval stages, complex biochemical |
| | | interactions between host & parasite, congenital |
| | | infections, vertical transmission, zoonosis, |
| | | reproductive-related hypobiosis, Comparison with |
| | | T. catti, refs back to non-migratory Toxascaris |
| Trichinella | | Example of hypobiotic larvae, no external stages, |
| | | zoonosis |
| Oesophagostomum | | Example of strongyle of ruminants with extensive |
| | | cuticular ornamentation and nodule formation on |
| | | gut wall |
| Chabertia | | Example of strongyle of ruminants with large |
| | | buccal capsule as adaptation to tissue feeding |
| Cyathostomes | | Horse colic. |
| or Trichonemes | | |
| Strongylus | vulgaris | Blood worm; common horse parasite. |
| Bunostomum | | Example of hookworm of ruminants |
| Uncinaria | | Example of canine/feline “northern” hookworm |
| Ancylostoma | | Example of potential emerging hookworm related |
| | | to climate change/behaviour |
| Dictyocaulus | | Basic lungworm direct lifecycle, vaccination using |
| | | irradiated larvae |
| Metastrongylus | | Lungworm with indirect lifecycle, used to |
| | | reinforce concepts of transport, paratenic & |
| | | intermediate host using earthworm as example |
| Parafilaria | | Example of filarial worm, example of insect-borne |
| | | parasite that does not involve a blood-feeding |
| | | vector |
| Dirofialria | | Example of filarial worm transmitted by blood- |
| | | feeding vector, distribution limited by that of |
| | | vector, potential impact of climate change on |
| | | distribution |

Fungi

| | | |
|---|---|---|
| Cercospora | zeae-maydis | Etiological agent of grey leaf spot in cereal plants. |
| Ustilago | maydis | Etiological agent of corn smut disease of maize. |
| Magnaporthe | grisea | Most significant disease affecting rice cultivation; |
| | | rice blast. |
| Bipolaris | oryzae | Brown spot can infect both seedlings and mature |
| | | plants. |

| | |
|---|---|
| Parasite | Context |

Acarina - Mites and Ticks

| | |
|---|---|
| Psoroptic mites - | Sheep scab aetiology and control. Topology of infestation in relation to |
| Psoroptes ovis, | skin histology. |
| Chorioptes | |
| Sarcoptic mites - | Causation of mange, hypersensitivity and pruritus. Topology of |
| Sarcoptes, | infestation in relation to skin histology. |
| Knemidocoptes | |
| Demodectic mites - | Causation of demodecosis. Topology of infestation in relation to |
| Demodex, | histology of skin. Aesthetic and zoonotic problems with Cheyletiella. |
| Trombicula, | |
| Cheyletiella | |
| Dermanyssid mites - | Nature of infestation as micro-predator. Importance to poultry industry. |
| Dermanyssus, | Control by hygiene and pesticides. |
| Ornithonyssus | |
| Ixodes ricinus | Vector of agents of babesiosis, tick borne fever, louping ill and Lyme |
| | disease. |

Lice and Fleas

| | |
|---|---|
| Linognathus and | Example of sessile ectoparasites with incomplete metamorphosis causing |
| Haematopinus sp. | stress and hide damage. Example of blood feeding anopluran lice. |
| Trichodectes and | Lice problems in small companion animals caused by chewing lice. Role |
| Felicola | as intermediate host of Dipylidium tapeworm. |
| Lipeurus, | Two families of chewing lice on birds. All bird lice are chewing lice |
| Cuclotogaster, | causing irritation and production losses. |
| Menopon | |
| Ctenocephalides felis | Cat/Dog flea; one of the most abundant and widespead fleas in the world. |
| and C. canis | |
| Ceratophyllus and | Parasitizes mainly rodents and birds. |
| Echidnophaga | |

Flies

| | |
|---|---|
| Muscid flies | Importance of flies with sponging mouthparts a nuisance leading to |
| | production losses in dairy cattle and as mechanical vectors of pathogens |
| | such as Moraxella bacteria. |
| Haematobia and | Horn fly; H. irritans is a bloodsucking fly dangerous to livestock. |
| Stomoxys | |
| Tabanid flies | Examples of biting stress caused by flies with complex slashing and |
| | sponging blood feeding mouthparts. Example of life cycle of flies with |
| | complete metamorphosis. |
| Melophagus ovinus | Louse flies or keds; obligate parasite of mammals and birds - can serve |
| | as the vector of pigeon malaria. |
| Culicoides midges | Example of how flies act as vectors. |
| Mosquitoes | Vectors of viral, protozoal and nematode pathogens. |
| Phlebotomus sand | Vector of Leishmania protozoa. |
| flies | |
| Lucilia cuprina | Example of facultative myiasis - blowfly strike. |
| blowfly | |
| Hypoderma bovis | Example of obligate myiasis - warble fly. Example of low reproduction/ |
| | high survival system. |
| Gasterophilus and | Illustration of these forms of myiasis. |
| Oestrus bots | |

Embodiments of the invention can be used to prevent or treat the following parasite hosts:

TABLE 7
PARASITE HOSTS
Fungal Diseases afflicting Canola (Brassica rapa)

| | |
|---|---|
| Alternaria black spot = | Alternaria brassicae, Alternaria brassicicola |
| Dark pod spot (UK) | Alternaria japonica = Alternaria raphani |
| Anthracnose | Colletotrichum gloeosporioides, Glomerella cingulata |
| | [teleomorph] |
| | Colletotrichum higginsianum |
| Black leg = stem canker (UK) | Leptosphaeria maculans |
| | Phoma lingam [anamorph] |
| Black mold rot | Rhizopus stolonifer |
| Black root | Aphanomyces raphani |
| Brown girdling root rot | Rhizoctonia solani |
| | Thanatephorus cucumeris [teleomorph] |
| Cercospora leaf spot | Cercospora brassicicola |
| Clubroot | Plasmodiophora brassicae |
| Downy mildew | Peronospora parasitica |
| Fusarium wilt | Fusarium oxysporum f. sp. conglutinans |
| Gray mold | Botrytis cinerea |
| | Botryotinia fuckeliana [teleomorph] |
| Head rot | Rhizoctonia solani |
| | Thanatephorus cucumeris [teleomorph] |
| Leaf spot | Alternaria alternata |
| | Ascochyta spp. |
| Light leaf spot | Pyrenopeziza brassicae |
| | Cylindrosporium concentricum [anamorph] |
| Pod rot | Alternaria alternata |
| | Cladosporium spp. |
| Powdery mildew | Erysiphe polygoni |
| | Erysiphe cruciferarum |
| Ring spot | Mycosphaerella brassicicola |
| | Asteromella brassicae [anamorph] |
| Root rot | Alternaria alternata |
| | Fusarium spp. |
| | Macrophomina phaseolina |
| | Phymatotrichopsis omnivora |
| | Phytophthora megasperma |
| | Pythium debaryanum |
| | Pythium irregulare |
| | Rhizoctonia solani |
| | Thanatephorus cucumeris [teleomorph] |
| | Sclerotium rolfsii |
| | Athelia rolfsii [teleomorph] |
| Sclerotinia stem rot | Sclerotinia sclerotiorum |
| Seed rot, damping-off | Alternaria spp. |
| | Fusarium spp. |
| | Gliocladium roseum |
| | Nectria ochroleuca [teleomorph] |
| | Pythium spp. |
| | Rhizoctonia solani |
| | Thanatephorus cucumeris [teleomorph] |
| | Rhizopus stolonifer |
| | Sclerotium rolfsii |
| Root gall smut | Urocystis brassicae |
| Southern blight (leaf, root | Sclerotium rolfsii |
| and seed rot) | |
| Verticillium wilt | Verticillium longisporum |
| White blight | Rhizoctonia solani |
| | Thanatephorus cucumeris [teleomorph] |
| White leaf spot = grey stem | Pseudocercosporella capsellae = |
| (Canada) | Cercosporella brassicae |
| | Mycosphaerella capsellae [teleomorph] |
| White rust = staghead | Albugo candida = |
| | Albugo cruciferarum |
| | (Peronospora sp. commonly present in staghead phase) |
| Yellows | Fusarium oxysporum |

Cat (Felis catus)

### Apicomplexa:

Besnoitia sp. (oocysts)
Isospora felis
Isospora rivolta
Sarcocystis gigantea (sporocysts)
Sarcocystis hirsuta (sporocysts)
Sarcocystis medusijormis (sporocysts)
Sarcocystis muris (sporocysts)
Sarcocystis sp. (sporocysts)
Toxoplasma gondii (cysts)
Toxoplasma gondii (oocysts

### Sarcomastigophora:

Giardia intestinalis
Dog (Canis familiaris)

### Apicomplexa:

Hammondia heydorni (oocysts)
Isospora canis
Isospora ohioensis
Neospora caninum
Sarcocystis arieticanis (sporocysts)
Sarcocystis capracanis (sporocysts)
Sarcocystis cruzi (sporocysts)
Sarcocystis tenella (sporocysts)
Sarcocystis sp. (sporocysts)
Toxoplasma gondii (cysts)

### Sarcomastigophora:

Giardia intestinalis
Goat (Capra hircus)

### Apicomplexa:

### Cvptosporidiurn sp.

Eimeria alijevi
Eimeria apsheronica
Eimeria arloingi
Eimeria capralis
Eimeria caprina
Eimeria caprovina
Eimeria charlestoni
Eimeria christenseni
Eimeria hirci
Eimeria jolchejevi
Eimeria masseyensis
Eimeria ninakohlyakimovae
Eimeria punctata
Eimeria tunisiensis
Sarcocystis capracanis (cysts)
Toxoplasma gondii (cysts)

### Sarcomastigophora:

### Giardia sp.

Horse (Equus caballus)

### Apicomplexa:

Eimeria leuckarti
Klossiella equi
Sarcocystis sp. (cysts)
Man (Homo sapiens)

### Apicomplexa:

### Ciyptosporidium sp.

Isospora hominis*

### Plasmodium sp.*

Toxoplasma gondii (cysts)

### Sarcomastigophora:

Chilomastix mesnili
Dientamoeba fragilis
Endolimax nana
Entamoeba coli
Entamoeba hartmanni
Entamoeba histolytica
Giardia intestinalis
Iodamoeba buetschlii
Leishmania donovani*
Trichomonas hominis
Trichomonas vaginalis

Fungal diseases afflicting Maize (Zea mays)

| | |
|---|---|
| Anthracnose leaf blight | Colletotrichum graminicola |
| Anthracnose stalk rot | Glomerella graminicola |
| | Glomerella tucumanensis |
| | Glomerella falcatum |
| Aspergillus ear and kernel rot | Aspergillus flavus |
| Banded leaf and sheath spot | Rhizoctonia solani = Rhizoctonia microsclerotia |
| | Thanatephorus cucumeris |
| Black bundle disease | Acremonium strictum = Cephalosporium |
| | acremonium |
| Black kernel rot | Lasiodiplodia theobromae = Botryodiplodia |
| | theobromae |
| Borde blanco | Marasmiellus sp. |
| Brown spot | Physoderma maydis |
| Black spot | |
| Stalk rot | |
| Cephalosporium kernel rot | Acremonium strictum = Cephalosporium |
| | acremonium |
| Charcoal rot | Macrophomina phaseolina |
| Corticium ear rot | Thanatephorus cucumeris = Corticium sasakii |
| Curvularia leaf spot | Curvularia clavata |
| | C. eragrostidis = C. maculans |
| | Cochliobolus eragrostidis |
| | Curvularia inaequalis |
| | C. intermedia |
| | Cochliobolus intermedius |
| | Curvularia lunata |
| | Cochliobolus lunatus |
| | Curvularia pallescens Cochliobolus pallescens |
| | Curvularia senegalensis |
| | C. tuberculata |
| | Cochliobolus tuberculatus |
| Didymella leaf spot | Didymella exitalis |
| Diplodia ear rot and stalk rot | Diplodia frumenti |
| | Botryosphaeria festucae |
| Diplodia ear rot | Diplodia maydis |
| Stalk rot | |
| Seed rot | |
| Seedling blight | |
| Diplodia leaf spot or leaf streak | Stenocarpella macrospora = Diplodia |
| | macrospora |

Downy mildews afflicting Maize (Zea mays)

| | |
|---|---|
| Brown stripe downy mildew | Sclerophthora rayssiae |
| Crazy top downy mildew | Sclerophthora macrospora = Sclerospora |
| | macrospora |
| Green ear downy mildew | Sclerospora graminicola |
| Graminicola downy mildew | |
| Java downy mildew | Peronosclerospora maydis = Sclerospora |
| | maydis |
| Philippine downy mildew | Peronosclerospora philippinensis = |
| | Sclerospora philippinensis |
| Sorghum downy mildew | Peronosclerospora sorghi = Sclerospora sorghi |
| Spontaneum downy mildew | Peronosclerospora spontanea = Sclerospora |
| | spontanea |
| Sugarcane downy mildew | Peronosclerospora sacchari = Sclerospora |
| | sacchari |
| Dry ear rot | Nigrospora oryzae |
| Cob, kernel and stalk rot | Khuskia oryzae |
| Ear rots, minor | Alternaria alternata = A. tenuis |
| | Aspergillus glaucus |
| | A. niger |
| | Aspergillus spp. |
| | Botrytis cinerea |
| | Botryotinia fuckeliana |
| | Cunninghamella sp. |
| | Curvularia pallescens |
| | Doratomyces stemonitis = Cephalotrichum |
| | stemonitis |
| | Fusarium culmorum |
| | Gonatobotrys simplex |
| | Pithomyces maydicus |
| | Rhizopus microsporus |
| | R. stolonifer = R. nigricans |
| | Scopulariopsis brumptii |
| Ergot | Claviceps gigantea |
| Horse's tooth | Sphacelia sp. |
| Eyespot | Aureobasidium zeae = Kabatiella zeae |
| Fusarium ear and stalk rot | Fusarium subglutinans = F. moniliforme |
| Fusarium kernel, root and stalk rot, seed rot and | Fusarium moniliforme |
| seedling blight | Gibberella fujikuroi |
| Fusarium stalk rot | Fusarium avenaceum |
| Seedling root rot | Gibberella avenacea |
| Gibberella ear and stalk rot | Gibberella zeae |
| | Fusarium graminearum |
| Gray ear rot | Botryosphaeria zeae = Physalospora zeae |
| | Macrophoma zeae |
| Gray leaf spot | Cercospora sorghi = C. sorghi |
| Cercospora leaf spot | C. zeae-maydis |
| Helminthosporium root rot | Exserohilum pedicellatum = Helminthosporium |
| | pedicellatum |
| | Setosphaeria pedicellata |
| Hormodendrum ear rot | Cladosporium cladosporioides = |
| Cladosporium rot | Hormodendrum cladosporioides |
| | C. herbarum |
| | Mycosphaerella tassiana |
| Hyalothyridium leaf spot | Hyalothyridium maydis |
| Late wilt | Cephalosporium maydis |
| Leaf spots, minor | Alternaria alternata |
| | [[[Ascochyta maydis]] |
| | A. tritici |
| | A. zeicola |
| | Bipolaris victoriae = Helminthosporium |
| | victoriae |
| | Cochliobolus victoriae |
| | C. sativus |
| | Bipolaris sorokiniana = H. sorokinianum = H. sativum |
| | Epicoccum nigrum |
| | Exserohilum prolatum = Drechslera prolata |
| | Setosphaeria prolata |
| | Graphium penicillioides |
| | Leptosphaeria maydis |
| | Leptothyrium zeae |
| | Ophiosphaerella herpotricha |
| | Scolecosporiella sp. |
| | Paraphaeosphaeria michotii |
| | Phoma sp. |
| | Septoria zeae |
| | S. zeicola |
| | S. zeina |
| Northern corn leaf blight | Setosphaeria turcica |
| White blast | Exserohilum turcicum = Helminthosporium |
| Crown stalk rot | turcicum |
| Stripe | |
| Northern corn leaf spot | Cochliobolus carbonum |
| Helminthosporium ear rot (race 1) | Bipolaris zeicola = Helminthosporium |
| | carbonum |
| Penicillium ear rot | Penicillium spp. |
| Blue eye | P. chrysogenum |
| Blue mold | P. expansum |
| | P. oxalicum |
| Phaeocytostroma stalk rot and root rot | Phaeocytostroma ambiguum = |
| | Phaeocytosporella zeae |
| Phaeosphaeria leaf spot | Phaeosphaeria maydis = Sphaerulina maydis |
| Physalospora ear rot | Botryosphaeria festucae = Physalospora zeicola |
| Botryosphaeria ear rot | Diplodia frumenti |
| Purple leaf sheath | Hemiparasitic bacteria and fungi |
| Pyrenochaeta stalk rot and root rot | Phoma terrestris = Pyrenochaeta terrestris |
| Pythium root rot | Pythium spp. |
| | P. arrhenomanes |
| | P. graminicola |
| Pythium stalk rot | Pythium aphanidermatum = P. butleri |
| Red kernel disease | Epicoccum nigrum |
| Ear mold, leaf and seed rot | |
| Rhizoctonia ear rot | Rhizoctonia zeae |
| Sclerotial rot | Waitea circinata |
| Rhizoctonia root rot and stalk rot | Rhizoctonia solani |
| | R. zeae |
| Root rots, minor | Alternaria alternata |
| | Cercospora sorghi |
| | Dictochaeta fertilis |
| | Fusarium acuminatum Gibberella acuminata |
| | F. equiseti |
| | G. intricans |
| | F. oxysporum |
| | F. pallidoroseum |
| | F. poae |
| | F. roseum |
| | G. cyanogena |
| | F. sulphureum |
| | Microdochium bolleyi |
| | Mucor sp. |
| | Periconia circinata |
| | Phytophthora cactorum |
| | P. drechsleri |
| | P. nicotianae |
| | Rhizopus arrhizus |
| Rostratum leaf spot | Setosphaeria rostrata = Helminthosporium |
| Helminthosporium leaf disease, ear and stalk | rostratum |
| rot | |
| Rust, common corn | Puccinia sorghi |
| Rust, southern corn | Puccinia polysora |
| Rust, tropical corn | Physopella pallescens |
| | P. zeae = Angiopsora zeae |
| Sclerotium ear rot | Sclerotium rolfsii |
| Southern blight | Athelia rolfsii |
| Seed rot-seedling blight | Bipolaris sorokiniana |
| | B. zeicola = Helminthosporium carbonum |
| | Diplodia maydis |
| | Exserohilum pedicillatum |
| | Exserohilum turcicum = Helminthosporium |
| | turcicum |
| | Fusarium avenaceum |
| | \|F. culmorum |
| | F. moniliforme |
| | Gibberella zeae |
| | F. graminearum |
| | Macrophomina phaseolina |
| | Penicillium spp. |
| | Phomopsis spp. |
| | Pythium spp. |
| | Rhizoctonia solani |
| | [[Rhizoctonia zeae\|R. zeae |
| | Sclerotium rolfsii |
| | Spicaria spp. |
| Selenophoma leaf spot | Selenophoma sp. |
| Sheath rot | Gaeumannomyces graminis |
| Shuck rot | Myrothecium gramineum |
| Silage mold | Monascus purpureus |
| | M. ruber |
| Smut, common | Ustilago zeae = U. maydis |
| Smut, false | Ustilaginoidea virens |
| Smut, head | Sphacelotheca reiliana = Sporisorium holci- |
| | sorghi |
| Southern corn leaf blight and stalk rot | Cochliobolus heterostrophus |
| | Bipolaris maydis = Helminthosporium maydis |
| Southern leaf spot | Stenocarpella macrospora = Diplodia |
| | macrospora |
| Stalk rots, minor | Cercospora sorghi |
| | Fusarium episphaeria |
| | F. merismoides |
| | F. oxysporum |
| | F. poae |
| | F. roseum |
| | F. solani |
| | Nectria haematococca |
| | F. tricinctum |
| | Mariannaea elegans |
| | Mucor spp. |
| | Rhopographus zeae |
| | Spicaria spp. |
| Storage rots | Aspergillus spp. |
| | Penicillium spp. and other fungi |
| Tar spot | Phyllachora maydis |
| Trichoderma ear rot and root rot | Trichoderma viride = T. lignorum |
| | Hypocrea sp. |
| White ear rot, root and stalk rot | Stenocarpella maydis = Diplodia zeae |
| Yellow leaf blight | Ascochyta ischaemi |
| | Phyllosticta maydis |
| | Mycosphaerella zeae-maydis |
| Zonate leaf spot | Gloeocercospora sorghi |

Nematodes afflicting Maize (Zea mays)

| | |
|---|---|
| Awl | Dolichodorus spp., D. heterocephalus |
| Bulb and | Ditylenchus dipsaci |
| stem | |
| Burrowing | Radopholus similis |
| Cyst | Heterodera avenae |
| | H. zeae |
| | Punctodera chalcoensis |
| Dagger | Xiphinema spp. |
| | X. americanum X. mediterraneum |
| False root- | Nacobbus dorsalis |
| knot | |
| Lance, | Hoplolaimus columbus |
| Columbia | |
| Lance | Hoplolaimus spp. |
| | H. galeatus |
| Lesion | Pratylenchus spp., P. brachyurus, P. crenatus, P. hexincisus, P. neglectus |
| | P. penetrans, P. scribneri, P. thornei, P. zeae |
| Needle | Longidorus spp. |
| | L. breviannulatus |
| Ring | Criconemella spp. |
| | C. ornata |
| Root-knot | Meloidogyne spp. |
| | M. chitwoodi |
| | M. incognita |
| | M. javanica |
| Spiral | Helicotylenchus spp. |
| Sting | Belonolaimus spp. |
| | B. longicaudatus |
| Stubby-root | Paratrichodorus spp. |
| | P. christiei |
| | P. minor |
| | Quinisulcius acutus |
| | Trichodorus spp. |
| Stunt | Tylenchorhynchus dubius |

Mouse (Mus musculus)

### Apicomplexa:

Hepatozoon musculi
Sarcocystis muris (cysts)

### Sarcomastigophora:

Giardia intestinalis
Giardia muris

### Ox

(Bos tarus)

### Apicomplexa:

### Ctyptosporidium sp.

Eimeria alabamensis
Eimeria auburnensis
Eimeria bovis
Eimeria brasiliensis
Eimeria bukidnonensis
Eimeria canadensis
Eimeria cylindrica
Eimeria ellipsoidalis
Eimeria subspherica
Eimeria wyomingensis
Eimeria zurnii

### Isospora sp.

Neospora caninum
Sarcocystis cruzi (cysts)
Sarcocystis hirsuta (cysts)
Theileria orientalis

### Sarcomastigophora:

Tritrichomonas foetus

### Ciliophora:

Balantidium coli
Pig (Sus scrofa)

### Apicomplexa:

### Ctyptosporidium sp.

Eimeria cerdonis
Eimeria debliecki
Eimeria neodebliecki
Eimeria porci
Eimeria scabs
Eimeria suis
Isospora suis
Sarcocystis sp. (cysts)
Toxoplasma gondii (cysts)

### Ciliophora:

Balantidium coli
Poultry (Gallus gallus)

### Endoparasites:

### Protozoa:

Histomonas meleagridis
Hexamita meleagridis

### Eimeria spp.

### Helminths:

Ascaridia galli
Ascaridia dissimilis
Ascardidia columbae
Capillaria contorta
Capillaria obsingata
Capillaria caudinflata
Heterakis gallinarum
Heterakis isolonche
Syngamus trachea

### Ectoparasites:

### Mites:

Cnemidocoptes mutans
Cnemidocoptes gallinae
Dermanyssus gallinae
Lamiosioptes cysticola
Ornithonyssus slyvarium

### Fleas:

Ceratophyllus gallinae
Echindnophaga gallinacea

### Lice:

Menacanthus stramineus
Rabbit (Otyctolagus cuniculus)

### Apicomplexa:

Eimeria jlavescens
Eimeria irresidua
Eimeria media
Eimeria petforans
Eimeria pyriformis
Eimeria stiedae
Hepatozoon cuniculi
Sarcocystis sp. (cysts)
Toxoplasma gondii (cysts)
Rice (Oryza sativa)

Fungal diseases afflicting Rice

| | |
|---|---|
| Aggregate sheath spot | Ceratobasidium oryzae-sativae |
| | Rhizoctonia oryzae-sativae |
| Black kernel | Curvularia lunata |
| | Cochliobolus lunatus |
| Blast (leaf, neck [rotten neck], | Pyricularia grisea = |
| nodal and collar) | Pyricularia oryzae |
| | Magnaporthe grisea |
| Brown spot | Cochliobolus miyabeanus |
| | Bipolaris oryzae |
| Crown sheath rot | Gaeumannomyces graminis |
| Downy mildew | Sclerophthora macrospora |
| Eyespot | Drechslera gigantea |
| False smut | Ustilaginoidea virens |
| Kernel smut | Tilletia barclayana = |
| | Neovossia horrida |
| Leaf smut | Entyloma oryzae |
| Leaf scald | Microdochium oryzae = |
| | Rhynchosporium oryzae |
| Narrow brown leaf spot | Cercospora janseana = |
| | Cercospora oryzae |
| | Sphaerulina oryzina |
| Pecky rice (kernel spotting) | Damage by many fungi including |
| | Cochliobolus miyabeanus |
| | Curvularia spp. |
| | Fusarium spp. |
| | Microdochium oryzae |
| | Sarocladium oryzae |
| | and other fungi. |
| Root rots | Fusarium spp. |
| | Pythium spp. |
| | Pythium dissotocum |
| | Pythium spinosum |
| Seedling blight | Cochliobolus miyabeanus |
| | Curvularia spp. |
| | Fusarium spp. |
| | Rhizoctonia solani |
| | Sclerotium rolfsii |
| | Athelia rolfsii |
| Sheath blight | Thanatephorus cucumeris |
| | Rhizoctonia solani |
| Sheath rot | Sarocladium oryzae = |
| | Acrocylindrium oryzae |
| Sheath spot | Rhizoctonia oryzae |
| Stackburn (Alternaria leaf spot) | Alternaria padwickii |
| Stem rot | Magnaporthe salvinii |
| | Sclerotium oryzae |
| Water-mold (seed-rot and | Achlya conspicua |
| seedling disease) | Achlya klebsiana |
| | Fusarium spp. |
| | Pythium spp. |
| | Pythium dissotocum |
| | Pythium spinosum |

Nematodes, parasitic

| | |
|---|---|
| Crimp nematode, | Aphelenchoides besseyi |
| summer | |
| Root-knot | Meloidogyne spp. |
| Root nematode, | Hirschmanniella oryzae |
| rice | |
| Stem nematode, | Ditylenchus angustus |
| rice | |

Sheep (Ovis aries)

### Apicomplexa:

### Ctyptosporidium sp.

Eimeria ahsata
Eimeria crandallis
Eimeria faurei
Eimeria granulosa
Eimeria intricate
Eimeria ovinoidalis
Eimeria ovis
Eimeria pallida
Eimeria pama
Eimeria punctata
Eimeria weybridgensis
Sarcocystis arieticanis (cysts)
Sarcocystis gigantea (cysts)
Sarcocystis medusiformis (cysts)
Sarcocystis tenella (cysts) Toxoplasma gondii (cysts)
Soybean (Glycine max)

Fungal diseases afflicting Soybeans

| | |
|---|---|
| Alternaria leaf spot | Alternaria spp. |
| Anthracnose | Colletotrichum truncatum |
| | Colletotrichum dematium f. truncatum |
| | Glomerella glycines |
| | Colletotrichum destructivum |
| Black leaf blight | Arkoola nigra |
| Black root rot | Thielaviopsis basicola |
| | Chalara elegans [synanamorph] |
| Brown spot | Septoria glycines |
| | Mycosphaerella usoenskajae |
| Brown stem rot | Phialophora gregata = |
| | Cephalosporium gregatum |
| Charcoal rot | Macrophomina phaseolina |
| Choanephora leaf blight | Choanephora infundibulifera |
| | Choanephora trispora |
| Damping-off | Rhizoctonia solani |
| | Thanatephorus cucumeris |
| | Pythium aphanidermatum |
| | Pythium debaryanum |
| | Pythium irregulare |
| | Pythium myriotylum |
| | Pythium ultimum |
| Downy mildew | Peronospora manshurica |
| Drechslera blight | Drechslera glycines |
| Frogeye leaf spot | Cercospora sojina |
| Fusarium root rot | Fusarium spp. |
| Leptosphaerulina leaf spot | Leptosphaerulina trifolii |
| Mycoleptodiscus root rot | Mycoleptodiscus terrestris |
| Neocosmospora stem rot | Neocosmospora vasinfecta |
| | Acremonium spp. |
| Phomopsis seed decay | Phomopsis spp. |
| Phytophthora root and stem rot | Phytophthora sojae |
| Phyllosticta leaf spot | Phyllosticta sojaecola |
| Phymatotrichum root rot = | Phymatotrichopsis omnivora = |
| cotton root rot | Phymatotrichum omnivorum |
| Pod and stem blight | Diaporthe phaseolorum |
| | Phomopsis sojae |
| Powdery mildew | Microsphaera diffusa |
| Purple seed stain | Cercospora kikuchii |
| Pyrenochaeta leaf spot | Pyrenochaeta glycines |
| Pythium rot | Pythium aphanidermatum |
| | Pythium debaryanum |
| | Pythium irregulare |
| | Pythium myriotylum |
| | Pythium ultimum |
| Red crown rot | Cylindrocladium crotalariae |
| | Calonectria crotalariae |
| Red leaf blotch = Dactuliophora | Dactuliochaeta glycines = |
| leaf spot | Pyrenochaeta glycines |
| | Dactuliophora glycines [synanamorph] |
| Rhizoctonia aerial blight | Rhizoctonia solani |
| | Thanatephorus cucumeris |
| Rhizoctonia root and stem rot | Rhizoctonia solani |
| Rust | Phakopsora pachyrhizi |
| Scab | Spaceloma glycines |
| Sclerotinia stem rot | Sclerotinia sclerotiorum |
| Southern blight (damping-off | Sclerotium rolfsii |
| and stem rot) = | |
| Sclerotium blight | Athelia rolfsii |
| Stem canker | Diaporthe phaseolorum |
| | Diaporthe phaseolorum var. |
| | caulivora Phomopsis phaseoli |
| Stemphylium leaf blight | Stemphylium botryosum |
| | Pleospora tarda |
| Sudden death syndrome | Fusarium solani f.sp. glycines |
| Target spot | Corynespora cassiicola |
| Yeast spot | Nematospora coryli |

Nematodes, parasitic

| | |
|---|---|
| Lance nematode | Hoplolaimus columbus |
| | Hoplolaimus galeatus |
| | Hoplolaimus magnistylus |
| Lesion nematode | Pratylenchus spp. |
| Pin nematode | Paratylenchus projectus |
| | Paratylenchus tenuicaudatus |
| Reniform | Rotylenchulus reniformis |
| nematode | |
| Ring nematode | Criconemella ornata |
| Root-knot | Meloidogyne arenaria |
| nematode | Meloidogyne hapla |
| | Meloidogyne incognita |
| | Meloidogyne javanica |
| Sheath nematode | Hemicycliophora spp. |
| Soybean cyst | Heterodera glycines |
| nematode | |
| Spiral nematode | Helicotylenchus spp. |
| Sting nematode | Belonolainus gracilis |
| | Belonolainus longicaudatus |
| Stubby root | Paratrichodorus minor |
| nematode | |
| Stunt nematode | Quinisulcius acutus |
| | Tylenchorhynchus spp. |

Tobacco (Nicotiana tabacum)

Fungal diseases afflicting Tobacco

| | |
|---|---|
| Anthracnose | Colletotrichum destructivum |
| | Glomerella glycines |
| Barn spot | Cercospora nicotianae |
| Barn rot | Several fungi and bacteria |
| Black root rot | Thielaviopsis basicola |
| Black shank | Phytophthora nicotianae |
| Blue mold (downy | Peronospora tabacina = |
| mildew) | Peronospora hyoscyami f.sp. tabacina |
| Brown spot | Alternaria alternata |
| Charcoal rot | Macrophomina phaseolina |
| Collar rot | Sclerotinia sclerotiorum |
| Damping-off, | Pythium spp. |
| Pythium | Pythium aphanidermatum |
| | Pythium ultimum |
| Frogeye leaf spot | Cercospora nicotianae |
| Fusarium wilt | Fusarium oxysporum |
| Gray mold | Botrytis cinerea |
| | Botryotinia fuckeliana |
| Mycosphaerella leaf | Mycosphaerella nicotianae |
| spot | |
| Olpidium seedling | Olpidium brassicae |
| blight | |
| Phyllosticta leaf spot | Phyllosticta nicotiana |
| Powdery mildew | Erysiphe cichoracearum |
| Ragged leaf spot | Phoma exigua var. exigua = |
| | Ascochyta phaseolorum |
| Scab | Hymenula affinis = |
| | Fusarium affine |
| Sore shin and | Rhizoctonia solani |
| damping-off | Thanatephorus cucumeris |
| Southern stem rot | Sclerotium rolfsii |
| Southern blight | Athelia rolfsii |
| Stem rot of | Pythium spp. |
| tranplants | |
| Target spot | Rhizoctonia solani |
| Verticillium wilt | Verticillium albo-atrum |
| | Verticillium dahliae |

Nematodes, parasitic

| | |
|---|---|
| Bulb and stem (stem | Ditylenchus dipsaci |
| break) | |
| Cyst | Globodera solanacearum = |
| | Globodera virginiae |
| | Globodera tabacum |
| Dagger, American | Xiphinema americanum |
| Foliar | Aphelenchoides ritzemabosi |
| Lesion | Pratylenchus brachyurus |
| | Pratylenchus penetrans |
| | Pratylenchus spp. |
| Reniform | Rotylenchulus reniformis |
| Root-knot | Meloidogyne arenaria, Meloidogyne hapla, |
| | Meloidogyne incognita, Meloidogyne javanica |
| Spiral | Helicotylenchus spp. |
| Stubby-root | Paratrichodorus spp. |
| | Trichodorus spp. |
| Stunt | Merlinius spp. |
| | Tylenchorhynchus spp. |

### Wheat (Triticum spp.)

Fungal diseases afflicting Wheat

| | |
|---|---|
| Alternaria leaf blight | Alternaria triticina |
| Anthracnose | Colletotrichum graminicola |
| | Glomerella graminicola |
| Ascochyta leaf spot | Ascochyta tritici |
| Aureobasidium decay | Microdochium bolleyi = |
| | Aureobasidium bolleyi |
| Black head molds = sooty molds | Alternaria spp. |
| | Cladosporium spp. |
| | Epicoccum spp. |
| | Sporobolomyces spp. |
| | Stemphylium spp. and other genera |
| Cephalosporium stripe | Hymenula cerealis = |
| | Cephalosporium gramineum |
| Common bunt = stinking smut | Tilletia tritici = |
| | Tilletia caries |
| | Tilletia laevis = |
| | Tilletia foetida |
| Common root rot | Cochliobolus sativus |
| | Bipolaris sorokiniana = |
| | Helminthosporium sativum |
| Cottony snow mold | Coprinus psychromorbidus |
| Crown rot = foot rot, seedling | Fusarium spp. |
| blight, dryland root rot | Fusarium pseudograminearum |
| | Gibberella zeae |
| | Fusarium graminearum Group II |
| | Gibberella avenacea |
| | Fusarium avenaceum |
| | Fusarium culmorum |
| Dilophospora leaf spot = twist | Dilophospora alopecuri |
| Downy mildew = crazy top | Sclerophthora macrospora |
| Dwarf bunt | Tilletia controversa |
| Ergot | Claviceps purpurea |
| | Sphacelia segetum |
| Eyespot = foot rot, strawbreaker | Tapesia yallundae |
| | Ramulispora herpotrichoides = |
| | Pseudocercosporella herpotrichoides |
| | W-pathotype |
| | T. acuformis |
| | Ramulispora acuformis = |
| | Pseudocercosporella herpotrichoides |
| | var. acuformis R-pathoytpe |
| False eyespot | Gibellina cerealis |
| Flag smut | Urocystis agropyri |
| Foot rot = dryland foot rot | Fusarium spp. |
| Halo spot | Pseudoseptoria donacis = |
| | Selenophoma donacis |
| Karnal bunt = partial bunt | Tilletia indica = |
| | Neovossia indica |
| Leaf rust = brown rust | Puccinia triticina = |
| | Puccinia recondita f.sp. tritici |
| | Puccinia tritici-duri |
| Leptosphaeria leaf spot | Phaeosphaeria herpotrichoides = |
| | Leptosphaeria herpotrichoides |
| | Stagonospora sp. |
| Loose smut | Ustilago tritici = |
| | Ustilago segetum var. tritici |
| | Ustilago segetum var. nuda |
| | Ustilago segetum var. avenae |
| Microscopica leaf spot | Phaeosphaeria microscopica = |
| | Leptosphaeria microscopica |
| Phoma spot | Phoma spp. |
| | Phoma glomerata |
| | Phoma sorghina = |
| | Phoma insidiosa |
| Pink snow mold = Fusarium | Microdochium nivale = |
| patch | Fusarium nivale |
| | Monographella nivalis |
| Platyspora leaf spot | Clathrospora pentamera = |
| | Platyspora pentamera |
| Powdery mildew | Erysiphe graminis f.sp. tritici |
| | Blumeria graminis = |
| | Erysiphe graminis |
| | Oidium monilioides |
| Pythium root rot | Pythium aphanidermatum |
| | Pythium arrhenomanes |
| | Pythium graminicola |
| | Pythium myriotylum |
| | Pythium volutum |
| Rhizoctonia root rot | Rhizoctonia solani |
| | Thanatephorus cucumeris |
| Ring spot = Wirrega blotch | Pyrenophora seminiperda = |
| | Drechslera campanulata |
| | Drechslera wirreganensis |
| Scab = head blight | Fusarium spp. |
| | Gibberella zeae |
| | Fusarium graminearum Group II |
| | Gibberella avenacea |
| | Fusarium avenaceum |
| | Fusarium culmorum |
| | Microdochium nivale = |
| | Fusarium nivale |
| | Monographella nivalis |
| Sclerotinia snow mold = snow | Myriosclerotinia borealis = |
| scald | Sclerotinia borealis |
| Sclerotium wilt (see Southern | Sclerotium rolfsii |
| blight) | Athelia rolfsii |
| Septoria blotch | Septoria tritici |
| | Mycosphaerella graminicola |
| Sharp eyespot | Rhizoctonia cerealis |
| | Ceratobasidium cereale |
| Snow rot | Pythium spp. |
| | Pythium aristosporum |
| | Pythium iwayamae |
| | Pythium okanoganense |
| Southern blight = Sclerotium | Sclerotium rolfsii |
| base rot | Athelia rolfsii |
| Speckled snow mold = gray | Typhula idahoensis |
| snow mold or Typhula blight | Typhula incarnata |
| | Typhula ishikariensis |
| | Typhula ishikariensis var. canadensis |
| Spot blotch | Cochliobolus sativus |
| | Bipolaris sorokiniana = |
| | Helminthosporium sativum |
| Stagonospora blotch | Phaeosphaeria avenaria f.sp. triticae |
| | Stagonospora avenae f.sp. triticae = |
| | Septoria avenae f.sp. triticea |
| | Phaeosphaeria nodorum |
| | Stagonospora nodorum = |
| | Septoria nodorum |
| Stem rust = black rust | Puccinia graminis = |
| | Puccinia graminis f.sp. tritici |
| Storage molds | Aspergillus spp. |
| | Penicillium spp. |
| | and others |
| Stripe rust = yellow rust | Puccinia striiformis |
| | Uredo glumarum |
| Take-all | Gaeumannomyces graminis var. tritici |
| | Gaeumannomyces graminis var. avenae |
| Tan spot = yellow leaf spot, red | Pyrenophora tritici-repentis |
| smudge | Drechslera tritici-repentis |
| Tar spot | Phyllachora graminis |
| | Linochora graminis |
| Wheat Blast | Magnaporthe grisea |
| Zoosporic root rot | Lagena radicicola |
| | Ligniera pilorum |
| | Olpidium brassicae |
| | Rhizophydium graminis |

Embodiments of the invention can be used to treat crops in order to limit or prevent insect infestation. The types of crops that can be treated can include, for example, any of the following, or the like:

TABLE 8
CROPS SUITABLE FOR TREATMENT WITH COMPOSITIONS AND
METHODS OF THE INVENTION

| Crop name | Botanical name |
|---|---|
| Abaca (Manila hemp) | Musa textilis |
| Alfalfa for fodder | Medicago sativa |
| Alfalfa for seed | Medicago sativa |
| Almond | Prunus dulcis |
| Anise seeds | Pimpinella animus |
| Apple | Malus sylvestris |
| Apricot | Prunus armeniaca |
| Areca (betel nut) | Areca catechu |
| Arracha | Arracacia xanthorrhiza |
| Arrowroot | Maranta arundinacea |
| Artichoke | Cynara scolymus |
| Asparagus | Asparagus officinalis |
| Avocado | Persea americana |
| Bajra (Pearl millet) | Pennisetum americanum |
| Bambara groundnut | Vigna subterranea |
| Banana | Musa paradisiaca |
| Barley | Hordeum vulgare |
| Beans, dry, edible, for grains | Phaseolus vulgaris |
| Beans, harvested green | Phaseolus and Vigna spp. |
| Beet, fodder (mangel) | Beta vulgaris |
| Beet, red | Beta vulgaris |
| Beet, sugar | Beta vulgaris |
| Beet, sugar for fodder | Beta vulgaris |
| Beet, sugar for seeds | Beta vulgaris |
| Bergamot | Citrus bergamia |
| Betel nut | Areca catechu |
| Black pepper | Piper nigrum |
| Black wattle | Acacia mearnsii |
| Blackberries of various | Rubus spp. |
| species | |
| Blueberry | Vaccinium spp. |
| Brazil nut | Bertholletia excelsa |
| Breadfruit | Artocarpus altilis |
| Broad bean, dry | Vicia faba |
| Broad bean, harvested green | Vicia faba |
| Broccoli | Brassica oleracea var. botrytis |
| Broom millet | Sorghum bicolor |
| Broom sorghum | Sorghum bicolor |
| Brussels sprouts | Brassica oleracea var. gemmifera |
| Buckwheat | Fagopyrum esculentum |
| Cabbage (red, white, Savoy) | Brassica oleracea var. capitata |
| Cabbage, Chinese | Brassica chinensis |
| Cabbage, for fodder | Brassica spp. |
| Cacao (cocoa) | Theobroma cacao |
| Cantaloupe | Cucumis melo |
| Caraway seeds | Carum carvi |
| Cardamom | Elettaria cardamomum |
| Cardoon | Cynara cardunculus |
| Carob | Ceratonia siliqua |
| Carrot, edible | Daucus carota ssp. sativa |
| Carrot, for fodder | Daucus carota ssp. sativa |
| Cashew nuts | Anacardium occidentale |
| Cassava (manioc) | Manihot esculenta |
| Castor bean | Ricinus communis |
| Cauliflower | Brassica oleracea var. botrytis |
| Celeriac | Apium graveolens var. rapaceum |
| Celery | Apium graveolens |
| Chayote | Sechium edule |
| Cherry (all varieties) | Prunus spp. |
| Chestnut | Castanea sativa |
| Chickpea (gram pea) | Cicer arietinum |
| Chicory | Cichorium intybus |
| Chicory for greens | Cichorium intybus |
| Chili, dry (all varieties) | Capsicum spp. (annuum) |
| Chili, fresh (all varieties) | Capsicum spp. (annuum) |
| Cinnamon | Cinnamomum verum |
| Citron | Citrus medica |
| Citronella | Cymbopogon citrates/Cymbopogon nar |
| Clementine | Citrus reticulata |
| Clove | Eugenia aromatica (Syzygium aromaticu |
| Clover for fodder | Trifolium spp. |
| (all varieties) | |
| Clover for seed (all varieties) | Trifolium spp. |
| Cocoa (cacao) | Theobroma cacao |
| Coconut | Cocos nucifera |
| Cocoyam | Colocasia esculenta |
| Coffee | Coffea spp. |
| Cola nut (all varieties) | Cola acuminata |
| Colza (rapeseed) | Brassica napus |
| Corn (maize), for cereals | Zea mays |
| Corn (maize), for silage | Zea mays |
| Corn (sweet), for vegetable | Zea mays |
| Corn for salad | Valerianella locusta |
| Cotton (all varieties) | Gossypium spp. |
| Cottonseed (all varieties) | Gossypium spp. |
| Cowpea, for grain | Vigna unguiculata |
| Cowpea, harvested green | Vigna unguiculata |
| Cranberry | Vaccinium spp. |
| Cress | Lepidium sativum |
| Cucumber | Cucumis sativus |
| Currants (all varieties) | Ribes spp. |
| Custard apple | Annona reticulate |
| Dasheen | Colocasia esculenta |
| Dates | Phoenix dactylifera |
| Drumstick tree | Moringa oleifera |
| Durra (sorghum) | Sorghum bicolour |
| Durum wheat | Triticum durum |
| Earth pea | Vigna subterranea |
| Edo (eddoe) | Xanthosoma spp.; Colocasia spp. |
| Eggplant | Solanum melongena |
| Endive | Cichorium endivia |
| Fennel | Foeniculum vulgare |
| Fenugreek | Trigonella foenum-graecum |
| Fig | Ficus carica |
| Filbert (Hazelnut) | Corylus avellana |
| Fique | Furcraea macrophylla |
| Flax for fibre | Linum usitatissimum |
| Flax for oil seed (linseed) | Linum usitatissimum |
| Formio (New Zealand flax) | Phormium tenax |
| Garlic, dry | Alium sativum |
| Garlic, green | Alium sativum |
| Geranium | Pelargonium spp.; Geranium spp. |
| Ginger | Zingiber officinale |
| Gooseberry (all varieties) | Ribes spp. |
| Gourd | Lagenaria spp; Cucurbita spp. |
| Gram pea (chickpea) | Cicer arietinum |
| Grape | Vitis vinifera |
| Grapefruit | Citrus paradisi |
| Grapes for raisins | Vitis vinifera |
| Grapes for table use | Vitis vinifera |
| Grapes for wine | Vitis vinifera |
| Grass esparto | Lygeum spartum |
| Grass, orchard | Dactylis glomerata |
| Grass, Sudan | Sorghum bicolor var. sudanense |
| Groundnut (peanut) | Arachis hypogaea |
| Guava | Psidium guajava |
| Guinea corn (sorghum) | Sorghum bicolor |
| Hazelnut (filbert) | Corylus avellana |
| Hemp fibre | Cannabis sativa ssp. indica |
| Hemp, Manila (abaca) | Musa textilis |
| Hemp, sun | Crotalaria juncea |
| Hempseed | Cannabis sativa (marijuana) |
| Henequen | Agave fourcroydes |
| Henna | Lawsonia inermis |
| Hop | Humulus lupulus |
| Horse bean | Vicia faba |
| Horseradish | Armoracia rusticana |
| Hybrid maize | Zea mays |
| Indigo | Indigofera tinctoria |
| Jasmine | Jasminum spp. |
| Jerusalem artichoke | Helianthus tuberosus |
| Jowar (sorghum) | Sorghum bicolor |
| Jute | Corchorus spp. (over 30 sp.) |
| Kale | Brassica oleracea var. acephala |
| Kapok | Ceiba pentandra |
| Kenaf | Hibiscus cannabinus |
| Kohlrabi | Brassica oleracea var. gongylodes |
| Lavender | Lavandula spp. (over 15 sp.) |
| Leek | Alium ampeloprasum; Alium porrum |
| Lemon | Citrus limon |
| Lemon grass | Cymbopogon citratus |
| Lentil | Lens culinaris |
| Lespedeza (all varieties) | Lespedeza spp. |
| Lettuce | Lactuca sativa var. capitata |
| Lime, sour | Citrus aurantifolia |
| Lime, sweet | Citrus limetta |
| Linseed (flax for oil seed) | Linum usitatissimum |
| Liquorice | Glycyrrhiza glabra |
| Litchi | Litchi chinensis |
| Loquat | Eriobotrya japonica |
| Lupine (all varieties) | Lupinus spp. |
| Macadamia (Queensland nut) | Macadamia spp. ternifolia |
| Mace | Myristica fragrans |
| Maguey | Agave atrovirens |
| Maize (corn) | Zea mays |
| Maize (corn) for silage | Zea mays |
| Maize (hybrid) | Zea mays |
| Maize, ordinary | Zea mays |
| Mandarin | Citrus reticulata |
| Mangel (fodder beet) | Beta vulgaris |
| Mango | Mangifera indica |
| Manioc (cassava) | Manihot esculenta |
| Maslin (mixed cereals) | Mixture of Triticum spp.; Secale cereale |
| Medlar | Mespilus germanica |
| Melon (except watermelon) | Cucumis melo |
| Millet broom | Sorghum bicolor |
| Millet, bajra | Pennisetum americanum |
| Millet, bulrush | Pennisetum americanum |
| Millet, finger | Eleusine coracana |
| Millet, foxtail | Setaria italica |
| Millet, Japanese | Echinochloa esculenta |
| Millet, pearl (bajra, bulrush) | Pennisetum americanum |
| Millet, proso | Panicum miliaceum |
| Mint (all varieties) | Mentha spp. |
| Mulberry for fruit | Morus spp. |
| (all varieties) | |
| Mulberry for silkworms | Morus alba |
| Mushrooms | Agaricus spp.; Pleurotus spp.; Volvariela |
| Mustard | Brassica nigra; Sinapis alba |
| Nectarine | Prunus persica var. nectarina |
| New Zealand flax (formio) | Phormium tenax |
| Niger seed | Guizotia abyssinica |
| Nutmeg | Myristica fragrans |
| Oats, for fodder | Avena spp. (about 30 sp.) |
| Oats, for grain | Avena spp. (about 30 sp.) |
| Oil palm | Elaeis guineensis |
| Okra | Abelmoschus esculentus |
| Olive | Olea europaea |
| Onion seed | Alium cepa |
| Onion, dry | Alium cepa |
| Onion, green | Alium cepa |
| Opium | Papaver somniferum |
| Orange | Citrus sinensis |
| Orange, bitter | Citrus aurantium |
| Ornamental plants | Various |
| Palm palmyra | Borassus flabellifer |
| Palm, kernel oil | Elaeis guineensis |
| Palm, oil | Elaeis guineensis |
| Palm, sago | Metroxylon sagu |
| Papaya (pawpaw) | Carica papaya |
| Parsnip | Pastinaca sativa |
| Pea, edible dry, for grain | Pisum sativum |
| Pea, harvested green | Pisum sativum |
| Peach | Prunus persica |
| Peanut (groundnut) | Arachis hypogaea |
| Pear | Pyrus communis |
| Pecan nut | Carya ilinoensis |
| Pepper, black | Piper nigrum |
| Pepper, dry | Capsicum spp. (over 30 sp.) |
| Persimmon | Diospyros kaki; Diospyros virginiana |
| Pigeon pea | Cajanus cajan |
| Pineapple | Ananas comosus |
| Pistachio nut | Pistacia vera |
| Plantain | Musa sapientum |
| Plum | Prunus domestica |
| Pomegranate | Punica granatum |
| Pomelo | Citrus grandis |
| Poppy seed | Papaver somniferum |
| Potato | Solamum tuberosum |
| Potato, sweet | Ipomoea batatas |
| Prune | Prunus domestica |
| Pumpkin, edible | Cucurbita spp. (over 25 sp.) |
| Pumpkin, for fodder | Cucurbita spp. (over 25 sp.) |
| Pyrethum | Chrysanthemum cinerariaefolium |
| Quebracho | Aspidosperma spp. (more than 3 sp.) |
| Queensland nut | See Macadamia |
| Quince | Cydonia oblonga |
| Quinine | Cinchona spp. (more than 6 sp.) |
| Quinoa | Chenopodium quinoa |
| Radish | Raphanus sativus (inc. Cochlearia |
| | armoracia) |
| Ramie | Boehmeria nivea |
| Rapeseed (colza) | Brassica napus |
| Raspberry (all varieties) | Rubus spp. (over 360 sp.) |
| Red beet | Beta vulgaris |
| Redtop | Agrostis spp. |
| Rhea | Boehmeria nivea |
| Rhubarb | Rheum spp. |
| Rice | Oryza sativa; Oryza glaberrima |
| Rose | Rose spp. |
| Rubber | Hevea brasiliensis |
| Rutabaga (swede) | Brassica napus var. napobrassica |
| Rye | Secale cereale |
| Ryegrass seed | Lolium spp. (about 20 sp.) |
| Safflower | Carthamus tinctorius |
| Sainfoin | Onobrychis vicifolia |
| Salsify | Tragopogon porrifolius |
| Sapodilla | Achras sapota |
| Satsuma (mandarin/tangerine) | Citrus reticulata |
| Scorzonera - black salsify | Scorzonera hispanica |
| Sesame | Sesamum indicum |
| Shea butter (nut) | Vitelaria paradoxa |
| Sisal | Agave sisalana |
| Sorghum | Sorghum bicolor |
| Sorghum, broom | Sorghum bicolor |
| Sorghum, durra | Sorghum bicolor |
| Sorghum, Guinea corn | Sorghum bicolor |
| Sorghum, jowar | Sorghum bicolor |
| Sorghum, sweet | Sorghum bicolor |
| Soybean | Glycine max |
| Soybean hay | Glycine max |
| Spelt wheat | Triticum spelta |
| Spinach | Spinacia oleracea |
| Squash | Cucurbita spp. (over 25 sp.) |
| Strawberry | Fragaria spp. (over 30 sp.) |
| Sugar beet | Beta vulgaris |
| Sugar beet for fodder | Beta vulgaris |
| Sugar beet for seed | Beta vulgaris |
| Sugarcane for fodder | Saccharum officinarum |
| Sugarcane for sugar or alcohol | Saccharum officinarum |
| Sugarcane for thatching | Saccharum officinarum |
| Sunflower for fodder | Helianthus annuus |
| Sunflower for oil seed | Helianthus annuus |
| Sunhemp | Crotalaria juncea |
| Swede | Brassica napus var. napobrassica |
| Swede for fodder | Brassica napus var. napobrassica |
| Sweet corn | Zea mays |
| Sweet lime | Citrus limetta |
| Sweet pepper | Capsicum annuum |
| Sweet potato | Lopmoea batatas |
| Sweet sorghum | Sorghum bicolor |
| Tangerine | Citrus reticulata |
| Tannia | Xanthosoma sagittifolium |
| Tapioca (cassava) | Manihot esculenta |
| Taro | Colocasia esculenta |
| Tea | Camelia sinensis |
| Tef | Eragrostis abyssinica |
| Timothy | Phleum pratense |
| Tobacco | Nicotiana tabacum |
| Tomato | Lycopersicon esculentum |
| Trefoil | Lotus spp. (about 100 sp.) |
| Triticale for fodder | Hybrid of Triticum aestivum and Secale |
| | cereale |
| Tung tree | Aleurites spp.; Fordii |
| Turnip, edible | Brassica rapa |
| Turnip, for fodder | Brassica rapa |
| Urena (Congo jute) | Urena lobata |
| Vanilla | Vanilla planifolia |
| Vetch for grain | Vicia sativa |
| Walnut | Juglans spp. (over 20 sp.), ep. regia |
| Watermelon | Citrulus lanatus |
| Wheat | Triticum aestivum |
| Yam | Dioscorea spp. (over 120 sp.) |
| Yerba mate | Ilex paraguariensis |

In certain embodiments of the invention, an area can be treated with a composition of the present invention, for example, by using a spray formulation, such as an aerosol or a pump spray, or a burning formulation, such as a candle or a piece of incense containing the composition, or the like. In certain embodiments of the invention, an area can be treated, for example, via aerial delivery, by truck-mounted equipment, or the like. Of course, various treatment methods can be used without departing from the spirit and scope of the present invention. For example, compositions can be comprised in household products, for example, hard surface cleaners, and the like.

An exemplary dispenser of a system of the present invention can deliver an pest control composition to the atmosphere in a continuous manner over a period of time. The exemplary dispenser can include a reservoir for holding a pest control composition, and a wick for drawing the composition from the reservoir and releasing the insect control composition into the atmosphere. The reservoir can be constructed from a material that is impermeable to the pest control composition, for example, appropriate glass, ceramic, or polymeric materials can be used. The reservoir can include an aperture, which can be sealed or unsealed, as desired. When the exemplary system of the present invention is not in use, the aperture can be sealed to prevent the release of the pest control composition into the atmosphere. It may be desirable, for example, to seal the aperture when the exemplary system is being stored or transported. When the system is in use, the aperture is unsealed, such that the wick can draw the pest control composition from the reservoir, and release the control composition through the aperture into the atmosphere.

In certain embodiments of the invention, the rate of release of the composition can be controlled, for example, by making adjustments to the wick of the dispenser. For example, the surface area of the wick that is exposed to the atmosphere can be altered. Generally, the greater the exposed surface area, the greater the rate of release of the pest control composition. In this regard, in certain embodiments, the dispenser can include multiple wicks and the reservoir can include multiple apertures through which the insect control composition can be released into the atmosphere. As another example, the wick can be constructed from a particular material that draws the pest control composition from the reservoir and releases it into the environment at a desired rate, such as, for example, a wick made of wood, a wick made of a synthetic fiber, or the like.

Another exemplary dispenser of a system of the present invention can deliver an insect control composition to a desired area. The dispenser can include a sealed pouch that can be constructed from a material that is impermeable to the insect control composition, for example, a metallic foil, a polymeric material, or the like. The pouch can define a volume for holding the insect control composition. The composition can be provided in a material disposed within the volume of the pouch, for example, a sponge, a cloth saturated with the material, or the like. When it becomes desirable to place the exemplary system into use, the pouch can be unsealed, exposing the composition for release into the atmosphere or for application to a desired area.

In certain embodiments the insect control composition is provided in a saturated cloth within the pouch, which can be used to apply the control composition a desired area. For example, a desired area can be an animal, such as a human, a domestic animal, surfaces within a dwelling, an outdoor living area, or the like.

In certain embodiments, the dispenser can further include a hook, allowing the pouch and exposed control composition to be hung in a desired location, such as in a closet or a pantry.

In certain embodiments, a method of the present invention can deliver insect an control composition to a desired area. In certain embodiments, a dispenser used with the method can be constructed from a substantially planar, integral piece of material, having a first side that is coated with control composition, and a second side that is not coated with control composition. The integral piece of material can be folded and sealed such that the side coated with the control composition is contained within the volume defined by the sealed pouch. When the pouch is unsealed, the side that is coated with control composition is exposed. The substantially planar piece of material can be placed in a desired location to deliver control composition to the atmosphere, or to crawling insects that walk across the material.

Another exemplary dispenser of a system of the present invention can deliver an insect control composition to a desired area. The control composition can be incorporated into an appropriate material. In certain embodiments, the composition-containing material can be a material that is capable of controlling the release rate of the control composition, i.e., controlled-release material, allowing the control composition to be released into the atmosphere at a desired rate that can be adjusted by providing controlled-release material having appropriate specifications. The controlled-release material can be constructed from an appropriate polymer. In other embodiments the composition-containing material does not allow the control composition to be released into the atmosphere, but rather retains the control composition. An optional casing that is impermeable to the insect control composition can be provided to hold the composition-containing material until the system is ready for use. When the system is ready for use, the casing can be peeled away, exposing the composition-containing material. The composition-containing material can be placed in a desired location to deliver control composition to crawling insects that walk across the material, or to deliver the control composition to the atmosphere when a controlled-release material is used, e.g., control flying insects.

In certain embodiments, the composition-containing material can have a substantially planar design, appropriate for positioning adjacent a mattress for controlling bed bugs, e.g., Cimex lectularius. A substantially planar design can also be used, for example, as or with a picnic table cloth. In certain embodiments, the composition-containing material can be used as ground cover for a garden bed or adjacent crop plants to control weeds. In certain embodiments, the composition-containing material can take the shape of a bag, and could be used for trash collection, while controlling insect commonly attracted to household garbage or other trash.

Another exemplary dispenser of a system of the present invention can be a substantially dry sheet containing the control composition, which control composition can be applied to a desired location upon exposing the cloth to water or an aqueous liquid, e.g., perspiration. In certain embodiments, the dry sheet containing the control composition can dissolve into a cream or gel when exposed to water or an aqueous liquid, which can then be applied to a desired area. For example, a desired area can be an animal, such as a human, a domestic animal, or another animal.

The following references are incorporated herein by this reference: U.S. Pat. No. 6,610,254 to Furner et al., issued Aug. 26, 2003, entitled “Dual Function Dispenser,” U.S. Pat. No. 6,360,477 to Flashinski et al., issued Mar. 26, 2002, entitled “Insect Control Pouch,” U.S. Pat. No. 5,980,931 to Fowler et al., issued Nov. 9, 1999, entitled “Cleansing Products Having a Substantially Dry Substrate,” U.S. Pat. No. 4,320,113 to Kydonieus, issued Mar. 16, 1982, entitled “Process for Controlling Cockroaches and Other Crawling Insects,” U.S. Pat. No. 4,943,435 to Baker et al., issued Jul. 24, 1990, entitled “Prolonged Activity Nicotine Patch,” United States Patent Publication No. 2004/0185080 to Hojo, et al, entitled “Sustained Release Dispenser Comprising Two or More Sex Pheromone Substances and a Pest Control Method,” PCT Publication No. WO/2006/061803 to Firmenich, et al, entitled “A Device for Dispensing a Volatile Liquid and Method for its Activation,” and PCT Publication No. WO/2004/006968 to Firmenich, et al., entitled “A Device for Dispensing Active Volatile Liquid.”

Treatment can include, for example, use of a oil-based formulation, a water-based formulation, a residual formulation, and the like. In some embodiments, combinations of formulations can be employed to achieve the benefits of different formulation types.

Embodiments of the invention can result in agricultural improvements, such as, for example, increased crop yield, reduced frequency of application of pest control product, reduced phytotoxicity associated with the pesticide, reduced cost or increased value associated with at least one environmental factor, and the like.

In embodiments of the invention that can reduce the cost of, or increase the value associated with at least one environmental factor, the environmental factor can include, for example, air quality, water quality, soil quality, detectable pesticide residue, safety or comfort of workers, collateral effect on a non-target organism, and the like.

Embodiments of the present invention can be used to control pests by either treating a host directly, or treating an area where the host will be located. For purposes of this application, host is defined as a plant, human or other animal. The host can be treated, for example, directly by using a cream or spray formulation, that can be applied externally or topically, when appropriate in light of the specific composition being used, e.g., to the skin of a human. A composition can be applied to the host, for example, in the case of a human, using formulations of a variety of personal products or cosmetics for use on the skin or hair. For example, any of the following can be used, when appropriate in light of the specific composition being used: fragrances, colorants, pigments, dyes, colognes, skin creams, skin lotions, deodorants, talcs, bath oils, soaps, shampoos, hair conditioners and styling agents.

The present invention is further illustrated by the following examples.

### EXAMPLES

Test compositions are provided, including: a pest control chemical (selected, for example from Table 1), an insect control product (selected, for example, from Table 3), and a blend selected from Table 9 (below).

TABLE 9
BLENDS OF COMPOUNDS

| | | CAS | | |
|---|---|---|---|---|
| | | Registry | | |
| | Compounds | Number | Vol/Vol | Wt/Wt |
| Blend 1 | LFO (LFO), (IFF) | | 4.0% | 4% |
| | D-Limonene | 5989-27-5 | 83.0% | 82% |
| | (Millennium) | | | |
| | Thyme Oil White | 8007-46-3 | 3.0% | 3% |
| | (Ungerer) | | | |
| | Lime Oil 410 | | 10.0% | 10% |
| Blend 2 | Tetrahydrolinalool | 78-69-3 | 0.80% | 0.78% |
| | FCC | | | |
| | Isopropyl Myristate | 110-27-0 | 0.80% | 0.80% |
| | Piperonal (aldehyde) | 120-57-0 | 0.80% | 0.80% |
| | Triethyl Citrate | 77-93-0 | 0.60% | 0.80% |
| | Linalool Coeur | 78-70-6 | 0.56% | 0.57% |
| | Geraniol 60 | 106-24-1 | 0.40% | 0.41% |
| | Vanillin | 121-33-5 | 0.04% | 0.05% |
| | D-Limonene | 5989-27-5 | 83.0% | 85.5% |
| | (Millennium) | | | |
| | Lime Oil 410 Minus | | 10.0% | 10.0% |
| | Thyme Oil White | 8007-46-3 | 3.0% | 3.3% |
| | (Ungerer) | | | |
| Blend 3 | Isopropyl myristate | 110-27-0 | 24.0% | 23.5% |
| | Tetrahydrolinalool | 78-69-3 | 20.0% | 19.0% |
| | FCC | | | |
| | Linalool Coeur | 78-70-6 | 16.0% | 15.9% |
| | Geraniol Fine FCC | 106-24-1 | 10.4% | 10.5% |
| | Piperonal (aldehyde) | 120-57-0 | 8.0% | 7.8% |
| | Vanillin | 121-33-5 | 1.6% | 1.8% |
| | BSO | 8014-13-9 | 20.0% | 21.5% |
| Blend 4 | Isopropyl myristate | 110-27-0 | 10.8% | 9.6% |
| | Tetrahydrolinalool | 78-69-3 | 9.0% | 7.8% |
| | FCC | | | |
| | Linalool Synthetic | 78-70-6 | 7.2% | 6.5% |
| | Geraniol Fine FCC | 106-24-1 | 4.7% | 4.3% |
| | Piperonal (aldehyde) | 120-57-0 | 3.6% | 3.2% |
| | Vanillin | 121-33-5 | 0.7% | 0.8% |
| | BSO | 8014-13-9 | 27.0% | 26.3% |
| | Methyl Salicylate 98% | 119-36-8 | 27.0% | 33.0% |
| | Nat | | | |
| | D-Limonene | 5989-27-5 | 10.0% | 8.8% |
| | (Millennium) | | | |
| Blend 5 | Thyme Oil White | 8007-46-3 | 22.0% | 20.6% |
| | (Ungerer) | | | |
| | Wintergreen Oil | 68-917-75-9 | 38.0% | 45.0% |
| | Isopropyl Myristate | 110-27-0 | 39.0% | 33.4% |
| | Vanillin | 121-33-5 | 1.0% | 1.1% |
| Blend 6 | D-Limonene | 5989-27-5 | 62.5% | 56.3% |
| | (Millennium) | | | |
| | Thyme Oil White | 8007-46-3 | 12.5% | 12.4% |
| | (Ungerer) | | | |
| | Wintergreen Oil | 68-917-75-9 | 25.0% | 31.3% |
| Blend 7 | LFO (IFF) | | 12.0% | 12.94% |
| | D-Limonene | 5989-27-5 | 9.0% | 8.72% |
| | (Millennium) | | | |
| | Thyme Oil White | 8007-46-3 | 9.0% | 9.58% |
| | (Ungerer) | | | |
| | Lime Oil 410 | | 70.0% | 68.76% |
| Blend 8 | Tetrahydrolinalool | 78-69-3 | 2.40% | 2.29% |
| | FCC | | | |
| | Isopropyl Myristate | 110-27-0 | 2.40% | 2.35% |
| | Piperonal (aldehyde) | 120-57-0 | 2.40% | 2.35% |
| | Triethyl Citrate | 77-93-0 | 1.80% | 2.35% |
| | Linalool Coeur | 78-70-6 | 1.68% | 1.66% |
| | Geraniol 60 | 106-24-1 | 1.20% | 1.21% |
| | Vanillin | 121-33-5 | 0.12% | 0.15% |
| | Lime Oil 410 | | 70.0% | 69.4% |
| | D-Limonene | 5989-27-5 | 10.0% | 9.70% |
| | (Millennium) | | | |
| | Thyme Oil White | 8007-46-3 | 8.0% | 8.54% |
| | (Ungerer) | | | |
| Blend 9 | LFO (IFF) | | 80.0% | 80.09% |
| | BSO | 8014-13-9 | 20.0% | 19.91% |
| Blend 10 | LFO (IFF) | | 50.0% | 50.13% |
| | BSO | 8014-13-9 | 50.0% | 49.87% |
| Blend 11 | Thyme Oil White | 8007-46-3 | 5.0% | 4.60% |
| | Wintergreen Oil | 68-917-75-9 | 50.0% | 57.80% |
| | Isopropyl Myristate | 110-27-0 | 45.0% | 37.60% |
| Blend 12 | d-Limonene | 5989-27-5 | 35.0% | 28.24% |
| | Thyme Oil White | 8007-46-3 | 5.0% | 4.44% |
| | Wintergreen Oil | 68-917-75-9 | 60.0% | 67.33% |
| Blend 13 | d-Limonene | 5989-27-5 | 10.0% | 9.90% |
| | Linalool Coeur | 78-70-6 | 14.0% | 14.14% |
| | Geraniol 60 | 106-24-1 | 10.0% | 10.30% |
| | Tetrahydrolinalool | 78-69-3 | 25.0% | 24.29% |
| | Isopropyl Myristate | 110-27-0 | 29.0% | 28.92% |
| | Piperonal | 120-57-0 | 10.0% | 9.97% |
| | Vanillin | 121-33-5 | 2.0% | 2.48% |
| Blend 14 | Methyl Salicylate 98% | 119-36-8 | 9.0% | 11.73% |
| | Nat | | | |
| | Linalool Coeur | 78-70-6 | 10.0% | 9.49% |
| | Geraniol Fine | 106-24-1 | 6.5% | 6.29% |
| | Tetrahydrolinalool | 78-69-3 | 12.5% | 11.40% |
| | Isopropyl Myristate | 110-27-0 | 15.0% | 14.04% |
| | Piperonal (aldehyde) | 120-57-0 | 5.0% | 4.68% |
| | Vanillin | 121-33-5 | 1.0% | 1.16% |
| | BSO | 8014-13-9 | 31.0% | 31.92% |
| | d-Limonene | 5989-27-5 | 10.0% | 9.30% |
| Blend 15 | Isopropyl myristate | 110-27-0 | 15.0% | 14.54% |
| | Tetrahydrolinalool | 78-69-3 | 12.5% | 11.81% |
| | FCC | | | |
| | Linalool Coeur | 78-70-6 | 10.0% | 9.82% |
| | Geraniol Fine FCC | 106-24-1 | 6.5% | 6.51% |
| | Piperonal (aldehyde) | 120-57-0 | 5.0% | 4.85% |
| | Vanillin | 121-33-5 | 1.0% | 1.20% |
| | Mineral Oil | 8042-47-5 | 15.0% | 14.97% |
| | BSO | 8014-13-9 | 25.0% | 26.66% |
| | d-Limonene | 5989-27-5 | 10.0% | 9.63% |
| Blend 16 | Isopropyl myristate | 110-27-0 | 15.0% | 14.26% |
| | Tetrahydrolinalool | 78-69-3 | 12.5% | 11.57% |
| | FCC | | | |
| | Linalool Synthetic | 78-70-6 | 10.0% | 9.63% |
| | Geraniol Fine FCC | 106-24-1 | 6.5% | 6.38% |
| | Piperonal (aldehyde) | 120-57-0 | 5.0% | 4.75% |
| | Vanillin | 121-33-5 | 1.0% | 1.12% |
| | BSO | 8014-13-9 | 50.0% | 52.28% |
| Blend 17 | Thyme Oil White | 110-27-0 | 39.0% | 38.21% |
| | Wintergreen Oil | 78-69-3 | 20.0% | 24.79% |
| | Vanillin | 121-33-5 | 1.0% | 1.11% |
| | Isopropyl Myristate | 8014-13-9 | 40.0% | 35.89% |
| Blend 18 | Thyme Oil White | 110-27-0 | 40.0% | 39.24% |
| | Wintergreen Oil | 78-69-3 | 20.0% | 24.82% |
| | Isopropyl Myristate | 8014-13-9 | 40.0% | 35.94% |
| Blend 19 | Linalool Coeur | 78-70-6 | 5.0% | 4.7% |
| | Thymol (crystal) | 89-83-8 | 39.0% | 40.8% |
| | Alpha-Pinene, 98% | 80-56-8 | 2.0% | 1.9% |
| | Para-Cymene | 99-87-6 | 37.0% | 34.5% |
| | trans-Anethole | 4180-23-8 | 17.0% | 18.2% |
| Blend 20 | Thyme Oil White | 8007-46-3 | | 22% |
| | (Ungerer) | | | |
| | Methyl Salicylate Nat | 68917-75-9 | | 38% |
| | Wintergreen extract | | | |
| | Isopropyl Myristate | 110-27-0 | | 39% |
| | Vanillin | 121-33-5 | | 1.0% |
| Blend 21 | D-Limonene | 5989-27-5 | | 62.5% |
| | (Millennium) | | | |
| | Thyme Oil White | 8007-46-3 | | 12.5% |
| | (Ungerer) | | | |
| | Methyl Salicylate Nat | 68917-75-9 | | 25.0% |
| | Wintergreen extract | | | |
| Blend 22 | Methyl Salicylate | 119-36-8 | | 39% |
| | Thymol (crystal) | 89-83-8 | | 20% |
| | Geraniol 60 | 106-24-1 | | 20% |
| | Isopropyl Myristate | 110-27-0 | | 20% |
| | Vanillin | 121-33-5 | | 1% |
| Blend 23 | LFO | 5989-27-5 | | 42.6% |
| | D-Limonene | 5989-27-5 | | 27.35% |
| | (Millennium) | | | |
| | Thyme Oil White | 8007-46-3 | | 30.08% |
| | (Ungerer) | | | |
| Blend 24 | D-Limonene | 5989-27-5 | | 82.52% |
| | Thyme Oil White | 8007-46-3 | | 3.28% |
| | Linalool Coeur | 78-70-6 | | 0.57% |
| | Tetrahydrolinalool | 78-69-3 | | 0.78% |
| | Vanillin | 121-33-5 | | 0.05% |
| | Isopropyl myristate | 110-27-0 | | 0.80% |
| | Piperonal (aldehyde) | 120-57-0 | | 0.80% |
| | Lime Oil Minus | | | 9.99% |
| | Geraniol 60 | 106-24-1 | | 0.41% |
| | Triethyl Citrate | 77-93-0 | | 0.80% |
| Blend 25 | Thyme Oil White | 8007-46-3 | | 12.38% |
| | Wintergreen Oil | | | 31.32% |
| | Technical | | | |
| | D-Limonene | 5989-27-5 | | 56.30% |
| Blend 26 | Fenchol Alpha | 512-13-0 | | 0.01% |
| | Nonanal | 124-19-6 | | 0.02% |
| | Tocopherol Gamma | 54-28-4 | | 0.02% |
| | Tenox | | | |
| | Octanal | 124-13-0 | | 0.04% |
| | Terpinene 4 OL | 562-74-3 | | 0.08% |
| | Camphor Dextro | 464-49-3 | | 0.09% |
| | Dodecanal | 112-54-9 | | 0.10% |
| | Decanal | 112-31-2 | | 0.12% |
| | Geranyl Acetate | 105-87-3 | | 0.12% |
| | 2-Methyl 1,3- | 30640-46-1, | | 0.26% |
| | cyclohexadiene | 1888-90-0 | | |
| | Isoborneol | 124-76-5 | | 0.28% |
| | Camphene | 79-92-5 | | 0.37% |
| | Myrcene | 123-35-3 | | 0.78% |
| | Linalool Coeur | 78-70-6 | | 0.84% |
| | Borneol L | 507-70-0 | | 0.89% |
| | Para-Cymene | 99-87-6 | | 1.11% |
| | Alpha-Pinene, 98% | 80-56-8 | | 1.33% |
| | Linalyl Acetate | 115-95-7 | | 1.79% |
| | Beta Pinene | 127-91-3 | | 1.93% |
| | Alpha Terpinene | 99-86-5 | | 1.93% |
| | Terpinolene | 586-62-9 | | 4.33% |
| | alpha-Terpineol | 98-55-5 | | 4.68% |
| | Citral | 5392-40-5 | | 7.02% |
| | gamma-terpinene | 99-85-4 | | 7.23% |
| | Thyme Oil White | 8007-46-3 | | 9.58% |
| | LFO | | | 12.94% |
| | D-Limonene | 5989-27-5 | | 42.12% |
| Blend 27 | Wintergreen Oil | | | 24.82% |
| | Technical | | | |
| | Isopropyl myristate | 110-27-0 | | 35.94% |
| | Thyme Oil White | 8007-46-3 | | 39.24% |
| Blend 28 | Vanillin | 121-33-5 | | 0.2% |
| | Piperonyl Alcohol | 495-76-1 | | 1.4% |
| | Linalool Coeur | 78-70-6 | | 2.9% |
| | Isopropyl myristate | 110-27-0 | | 3.4% |
| | Tetrahydrolinalool | 78-69-3 | | 3.5% |
| | Piperonal (aldehyde) | 120-57-0 | | 3.6% |
| | D-Limonene | 5989-27-5 | | 14.8% |
| | Lime Oil Minus | | | 70.2% |
| Blend 29 | Vanillin | 121-33-5 | | 0.2% |
| | Piperonyl Alcohol | 495-76-1 | | 1.4% |
| | Linalool Coeur | 78-70-6 | | 2.9% |
| | Isopropyl myristate | 110-27-0 | | 3.4% |
| | Tetrahydrolinalool | 78-69-3 | | 3.5% |
| | Piperonal (aldehyde) | 120-57-0 | | 3.6% |
| | Lime Oil Minus | | | 15.2% |
| | D-Limonene | 5989-27-5 | | 69.8% |
| Blend 30 | Vanillin | 121-33-5 | | 0.4% |
| | Piperonyl Alcohol | 495-76-1 | | 2.9% |
| | Linalool Coeur | 78-70-6 | | 5.7% |
| | Isopropyl myristate | 110-27-0 | | 6.8% |
| | Tetrahydrolinalool | 78-69-3 | | 6.9% |
| | Piperonal (aldehyde) | 120-57-0 | | 7.1% |
| | Lime Oil Minus | | | 70.2% |
| Blend 31 | D-Limonene | 5989-27-5 | | 27.35% |
| | Thyme Oil White | 8007-46-3 | | 30.08% |
| | LFO3 | | | 42.57% |
| Blend 32 | Vanillin | 121-33-5 | | 0.5% |
| | Geraniol 60 | 106-24-1 | | 4.2% |
| | Linalool Coeur | 78-70-6 | | 5.7% |
| | Tetrahydrolinalool | 78-69-3 | | 7.9% |
| | Isopropyl myristate | 110-27-0 | | 8.1% |
| | Piperonal (aldehyde) | 120-57-0 | | 8.1% |
| | Triethyl Citrate | 77-93-0 | | 8.1% |
| | D-Limonene | 5989-27-5 | | 27.4% |
| | Thyme Oil White | 8007-46-3 | | 30.1% |
| Blend 33 | D-Limonene | 5989-27-5 | | 27.35% |
| | Thyme Oil White | 8007-46-3 | | 30.08% |
| | LFO | | | 42.6% |
| Blend 34 | Stock 10% SLS | | | 3.18% |
| | Solution | | | |
| | D-Limonene | 5989-27-5 | | 4.03% |
| | Thyme Oil White | 8007-46-3 | | 4.43% |
| | LFO3 | | | 6.27% |
| | Benzyl Alcohol | 100-51-6 | | 16.61% |
| | Isopar M | 64742-47-8 | | 20.95% |
| | Water | 7732-18-5 | | 44.53% |
| Blend 35 | Vanillin | 121-33-5 | | 0.07% |
| | Geraniol 60 | 106-24-1 | | 0.62% |
| | Linalool Coeur | 78-70-6 | | 0.84% |
| | Tetrahydrolinalool | 78-69-3 | | 1.16% |
| | Isopropyl myristate | 110-27-0 | | 1.19% |
| | Piperonal (aldehyde) | 120-57-0 | | 1.19% |
| | Triethyl Citrate | 77-93-0 | | 1.19% |
| | Stock 10% SLS | | | 3.18% |
| | Solution | | | |
| | D-Limonene | 5989-27-5 | | 4.03% |
| | Thyme Oil White | 8007-46-3 | | 4.43% |
| | Benzyl Alcohol | 100-51-6 | | 16.61% |
| | Isopar M | 64742-47-8 | | 20.95% |
| | Water | 7732-18-5 | | 44.53% |
| Blend 36 | D-Limonene | 5989-27-5 | | 27.35% |
| | Thyme Oil White | 8007-46-3 | | 30.08% |
| | LFO3 | | | 42.57% |
| Blend 37 | Vanillin | 121-33-5 | | 0.50% |
| | Geraniol 60 | 106-24-1 | | 4.18% |
| | Linalool Coeur | 78-70-6 | | 5.73% |
| | Tetrahydrolinalool | 78-69-3 | | 7.88% |
| | Isopropyl myristate | 110-27-0 | | 8.08% |
| | Piperonal (aldehyde) | 120-57-0 | | 8.09% |
| | Triethyl Citrate | 77-93-0 | | 8.11% |
| | D-Limonene | 5989-27-5 | | 27.35% |
| | Thyme Oil White | 8007-46-3 | | 30.08% |
| Blend 38 | Thyme Oil White | 8007-46-3 | | 3.3% |
| | LFO | | | 4.4% |
| | Lime Oil Minus | | | 10.0% |
| | D-Limonene | 5989-27-5 | | 82.3% |
| Blend 39 | D-Limonene | 5989-27-5 | | 8.72% |
| | Thyme Oil White | 8007-46-3 | | 9.58% |
| | LFO | | | 12.94% |
| | Lime Oil Minus | | | 68.76% |
| Blend 40 | Vanillin | 121-33-5 | | 0.1% |
| | Geraniol 60 | 106-24-1 | | 1.2% |
| | Linalool Coeur | 78-70-6 | | 1.7% |
| | Tetrahydrolinalool | 78-69-3 | | 2.3% |
| | Piperonal (aldehyde) | 120-57-0 | | 2.4% |
| | Triethyl Citrate | 77-93-0 | | 2.4% |
| | Thyme Oil White | 8007-46-3 | | 8.6% |
| | D-Limonene | 5989-27-5 | | 9.8% |
| | Lime Oil Minus | | | 69.3% |
| Blend 41 | Thyme Oil White | 8007-46-3 | | 20.6% |
| | Isopropyl myristate | 110-27-0 | | 34.3% |
| | Wintergreen Oil | 68917-75-9 | | 45.1% |
| Blend 42 | Vanillin | 121-33-5 | | 1.9% |
| | Piperonal (aldehyde) | 120-57-0 | | 7.8% |
| | Geraniol Fine FCC | 106-24-1 | | 10.5% |
| | Linalool Coeur | 78-70-6 | | 15.8% |
| | Tetrahydrolinalool | 78-69-3 | | 19.0% |
| | BSO | 977017-84-7 | | 21.5% |
| | Isopropyl myristate | 110-27-0 | | 23.4% |
| Blend 43 | Alpha-Pinene, 98% | 80-56-8 | | 3.78% |
| | Linalool Coeur | 78-70-6 | | 6.63% |
| | Soy Bean Oil | 8016-70-4 | | 24.03% |
| | Para-Cymene | 99-87-6 | | 28.39% |
| | Thymol (crystal) | 89-83-8 | | 37.17% |
| Blend 44 | Alpha-Pinene, 98% | 80-56-8 | | 4.97% |
| | Linalool Coeur | 78-70-6 | | 8.73% |
| | Para-Cymene | 99-87-6 | | 37.37% |
| | Thymol (crystal) | 89-83-8 | | 48.93% |
| Blend 45 | Vanillin | 121-33-5 | | 0.32% |
| | Piperonal (aldehyde) | 120-57-0 | | 1.29% |
| | Geraniol Fine FCC | 106-24-1 | | 1.73% |
| | Linalool Coeur | 78-70-6 | | 2.61% |
| | Tetrahydrolinalool | 78-69-3 | | 3.13% |
| | Isopropyl myristate | 110-27-0 | | 3.86% |
| | D-Limonene | 5989-27-5 | | 8.72% |
| | Thyme Oil White | 8007-46-3 | | 9.58% |
| | Lime Oil 410 | | | 68.76% |
| Blend 46 | Thyme Oil White | 8007-46-3 | | 4.44% |
| | D-Limonene | 5989-27-5 | | 28.24% |
| | Methyl Salicylate | | | 67.32% |
| | Synth | | | |
| Blend 47 | Thyme Oil White | 8007-46-3 | | 20.6% |
| | Isopropyl myristate | 110-27-0 | | 34.3% |
| | Wintergreen Oil | | | 45.1% |
| | Technical | | | |
| Blend 48 | CIK Formula | | | 22.44% |
| | Lemon Grass Oil- | | | 22.93% |
| | India | | | |
| | Castor Oil | | | 54.63% |
| | hydrogenated-PEO40 | | | |
| Blend 49 | BSO | 977017-84-7 | | 4.83% |
| | Thyme Oil White | 8007-46-3 | | 11.18% |
| | LFO | | | 16.18% |
| | D-Limonene | 5989-27-5 | | 67.81% |
| Blend 50 | BSO | 977017-84-7 | | 5.31% |
| | Thyme Oil White | 8007-46-3 | | 11.59% |
| | LFO | | | 16.01% |
| | D-Limonene | 5989-27-5 | | 67.09% |
| Blend 51 | Vanillin | 121-33-5 | | 0.15% |
| | Geraniol 60 | 106-24-1 | | 1.23% |
| | Linalool Coeur | 78-70-6 | | 1.68% |
| | Tetrahydrolinalool | 78-69-3 | | 2.31% |
| | Isopropyl myristate | 110-27-0 | | 2.37% |
| | Piperonal (aldehyde) | 120-57-0 | | 2.37% |
| | Triethyl Citrate | 77-93-0 | | 2.38% |
| | D-Limonene | 5989-27-5 | | 8.83% |
| | Thyme Oil White | 8007-46-3 | | 9.71% |
| | Isopar M | 64742-47-8 | | 13.80% |
| | Lime Oil 410 | | | 55.17% |
| Blend 52 | Vanillin | 121-33-5 | | 0.15% |
| | Geraniol 60 | 106-24-1 | | 1.21% |
| | Linalool Coeur | 78-70-6 | | 1.66% |
| | Tetrahydrolinalool | 78-69-3 | | 2.28% |
| | Isopropyl myristate | 110-27-0 | | 2.34% |
| | Piperonal (aldehyde) | 120-57-0 | | 2.34% |
| | Triethyl Citrate | 77-93-0 | | 2.35% |
| | D-Limonene | 5989-27-5 | | 8.72% |
| | Thyme Oil White | 8007-46-3 | | 9.59% |
| | Lime Oil 410 | | | 69.35% |
| Blend 53 | Thyme Oil White | 8007-46-3 | | 5.37% |
| | Lime Oil 410 | | | 9.98% |
| | LFO | | | 16.31% |
| | D-Limonene | 5989-27-5 | | 68.34% |
| Blend 54 | Alpha-Pinene, 98% | 80-56-8 | | 3.8% |
| | Linalool Coeur | 78-70-6 | | 6.6% |
| | Soy Bean Oil | 8016-70-4 | | 24.0% |
| | Para-Cymene | 99-87-6 | | 28.39% |
| | Thymol (crystal) | 89-83-8 | | 37.2% |
| Blend 55 | Para-Cymene | 99-87-6 | | 1.90% |
| | Alpha-Pinene, 98% | 80-56-8 | | 4.70% |
| | Trans-Anethole | 4180-23-8 | | 18.20% |
| | Thymol (crystal) | 89-83-8 | | 34.40% |
| | Linalool Coeur | 78-70-6 | | 40.80% |
| Blend 56 | Alpha-Pinene, 98% | 80-56-8 | | 9.46% |
| | Linalool Coeur | 78-70-6 | | 9.49% |
| | Para-Cymene | 99-87-6 | | 33.18% |
| | Thymol (crystal) | 89-83-8 | | 47.87% |
| Blend 57 | Vanillin | 121-33-5 | | 2.47% |
| | Piperonal (aldehyde) | 120-57-0 | | 9.95% |
| | Geraniol Fine FCC | 106-24-1 | | 13.36% |
| | Linalool Coeur | 78-70-6 | | 20.15% |
| | Tetrahydrolinalool | 78-69-3 | | 24.23% |
| | Isopropyl myristate | 110-27-0 | | 29.84% |
| Blend 58 | Vanillin | 121-33-5 | | 1.17% |
| | Hercolyn D | 8050-15-5 | | 4.44% |
| | Hedione | 24851-98-7 | | 6.67% |
| | Piperonal (aldehyde) | 120-57-0 | | 7.55% |
| | Dipropylene glycol | 246-770-3 | | 9.09% |
| | (DPG) | | | |
| | Triethyl Citrate | 77-93-0 | | 10.10% |
| | Isopropyl myristate | 110-27-0 | | 15.10% |
| | Ethyl Linalool | 10339-55-6 | | 22.91% |
| | Tetrahydrolinalool | 78-69-3 | | 22.98% |
| Blend 59 | Vanillin | 121-33-5 | | 1.2% |
| | Geraniol 60 | 106-24-1 | | 9.8% |
| | Linalool Coeur | 78-70-6 | | 13.5% |
| | Tetrahydrolinalool | 78-69-3 | | 18.5% |
| | Isopropyl myristate | 110-27-0 | | 19.0% |
| | Piperonal (aldehyde) | 120-57-0 | | 19.0% |
| | Triethyl Citrate | 77-93-0 | | 19.1% |
| Blend 60 | Vanillin | 121-33-5 | | 1.2% |
| | Piperonyl Alcohol | 495-76-1 | | 9.6% |
| | Linalool Coeur | 78-70-6 | | 19.2% |
| | Isopropyl myristate | 110-27-0 | | 22.9% |
| | Tetrahydrolinalool | 78-69-3 | | 23.2% |
| | Piperonal (aldehyde) | 120-57-0 | | 23.8% |
| Blend 61 | Fenchol Alpha | 512-13-0 | | 0.01% |
| | Nonanal | 124-19-6 | | 0.03% |
| | Tocopherol Gamma | 54-28-4 | | 0.03% |
| | Tenox | | | |
| | Octanal | 124-13-0 | | 0.06% |
| | Terpinene 4 OL | 562-74-3 | | 0.11% |
| | Camphor Dextro | 464-49-3 | | 0.13% |
| | Dodecanal | 112-54-9 | | 0.14% |
| | Decanal | 112-31-2 | | 0.17% |
| | Geranyl Acetate | 105-87-3 | | 0.18% |
| | 2-Methyl 1,3- | 30640-46-1, | | 0.38% |
| | cyclohexadiene | 1888-90-0 | | |
| | Isoborneol | 124-76-5 | | 0.41% |
| | Camphene | 79-92-5 | | 0.54% |
| | Myrcene | 123-35-3 | | 1.14% |
| | Linalool Coeur | 78-70-6 | | 1.22% |
| | Borneol L | 507-70-0 | | 1.30% |
| | Para-Cymene | 99-87-6 | | 1.61% |
| | Alpha-Pinene, 98% | 80-56-8 | | 1.94% |
| | Linalyl Acetate | 115-95-7 | | 2.60% |
| | Beta Pinene | 127-91-3 | | 2.80% |
| | Alpha Terpinene | 99-86-5 | | 2.80% |
| | Terpinolene | 586-62-9 | | 6.30% |
| | alpha-Terpineol | 98-55-5 | | 6.80% |
| | Citral | 5392-40-5 | | 10.21% |
| | gamma-terpinene | 99-85-4 | | 10.51% |
| | D-Limonene | 5989-27-5 | | 48.58% |
| Blend 62 | Fenchol Alpha | 512-13-0 | | 0.01% |
| | Nonanal | 124-19-6 | | 0.04% |
| | Tocopherol Gamma | 54-28-4 | | 0.04% |
| | Tenox | | | |
| | Octanal | 124-13-0 | | 0.07% |
| | Terpinene 4 OL | 562-74-3 | | 0.13% |
| | Camphor Dextro | 464-49-3 | | 0.16% |
| | Dodecanal | 112-54-9 | | 0.17% |
| | Decanal | 112-31-2 | | 0.20% |
| | Geranyl Acetate | 105-87-3 | | 0.22% |
| | 2-Methyl 1,3- | 30640-46-1, | | 0.46% |
| | cyclohexadiene | 1888-90-0 | | |
| | Isoborneol | 124-76-5 | | 0.49% |
| | Camphene | 79-92-5 | | 0.65% |
| | Myrcene | 123-35-3 | | 1.37% |
| | Linalool Coeur | 78-70-6 | | 1.47% |
| | Borneol L | 507-70-0 | | 1.57% |
| | Para-Cymene | 99-87-6 | | 1.94% |
| | Alpha-Pinene, 98% | 80-56-8 | | 2.34% |
| | Linalyl Acetate | 115-95-7 | | 3.13% |
| | Beta Pinene | 127-91-3 | | 3.37% |
| | Alpha Terpinene | 99-86-5 | | 3.37% |
| | Terpinolene | 586-62-9 | | 7.59% |
| | gamma-terpinene | 99-85-4 | | 12.66% |
| | D-Limonene | 5989-27-5 | | 58.54% |
| Blend 63 | Alpha Terpinene | 99-86-5 | | 4.88% |
| | Alpha-Pinene, 98% | 80-56-8 | | 5.01% |
| | Beta Pinene | 127-91-3 | | 5.02% |
| | Linalyl Acetate | 115-95-7 | | 5.30% |
| | Camphene | 79-92-5 | | 5.84% |
| | Myrcene | 123-35-3 | | 9.26% |
| | Para-Cymene | 99-87-6 | | 10.04% |
| | Linalool Coeur | 78-70-6 | | 10.05% |
| | Terpinolene | 586-62-9 | | 10.10% |
| | D-Limonene | 5989-27-5 | | 34.50% |
| Blend 64 | Stock 10% SLS | | | 10% |
| | Solution | | | |
| | 25B-4A for | | | 90% |
| | Institutions | | | |
| Blend 65 | Lecithin | 8002-43-5 | | 0.20% |
| | Polyglycerol-4-oleate | 9007-48-1 | | 0.90% |
| | Water | 7732-18-5 | | 9.8% |
| | 25B-4A for | | | 89.1% |
| | Institutions | | | |
| Blend 66 | Xanthan Gum | 11138-66-2 | | 0.28% |
| | Potassium Sorbate | 590-00-1 or | | 1.00% |
| | | 24634-61-5 | | |
| | Cationic Formulation | | | 16.90% |
| | Water | 7732-18-5 | | 81.82% |
| Blend 67 | Lecithin | 8002-43-5 | | 0.034% |
| | Potassium Sorbate | 590-00-1 or | | 0.11% |
| | | 24634-61-5 | | |
| | Polyglycerol-4-oleate | 9007-48-1 | | 0.15% |
| | Xanthan Gum | 11138-66-2 | | 0.28% |
| | 25B-4A for | | | 15% |
| | Institutions | | | |
| | Water | 7732-18-5 | | 84.4% |
| Blend 68 | Lecithin | 8002-43-5 | | 0.03% |
| | Potassium Sorbate | 590-00-1 or | | 0.11% |
| | | 24634-61-5 | | |
| | Polyglycerol-4-oleate | 9007-48-1 | | 0.15% |
| | Xanthan Gum | 11138-66-2 | | 0.28% |
| | Thyme Oil White | 8007-46-3 | | 3.09% |
| | Isopropyl myristate | 110-27-0 | | 5.15% |
| | Wintergreen Oil | 68917-75-9 | | 6.77% |
| | Water | 7732-18-5 | | 84.41% |
| Blend 69 | Lecithin | 8002-43-5 | | 0.20% |
| | Polyglycerol-4-oleate | 9007-48-1 | | 0.90% |
| | Water | 7732-18-5 | | 9.8% |
| | 25B-4A-formula 1a | | | 89.10% |
| Blend 70 | Stock 2.5% Xanthan- | | | 12.7% |
| | 1% Ksorbate | | | |
| | Cationic Formulation | | | 84.2% |
| | Water | 7732-18-5 | | 3.1% |
| Blend 71 | Potassium Sorbate | 590-00-1 or | | 0.13% |
| | | 24634-61-5 | | |
| | Lecithin | 8002-43-5 | | 0.17% |
| | Xanthan Gum | 11138-66-2 | | 0.32% |
| | Polyglycerol-4-oleate | 9007-48-1 | | 0.76% |
| | Thyme Oil White | 8007-46-3 | | 15.5% |
| | Water | 7732-18-5 | | 23.6% |
| | Isopropyl myristate | 110-27-0 | | 25.7% |
| | Wintergreen Oil | 68917-75-9 | | 33.8% |
| Blend 72 | Water | 7732-18-5 | | 9.2% |
| | Stock 2.5% Xanthan- | | | 11.90% |
| | 1% Ksorbate | | | |
| | Cationic Formulation | | | 78.87% |
| Blend 73 | Potassium Sorbate | 590-00-1 or | | 0.13% |
| | | 24634-61-5 | | |
| | Lecithin | 8002-43-5 | | 0.17% |
| | Xanthan Gum | 11138-66-2 | | 0.32% |
| | Polyglycerol-4-oleate | 9007-48-1 | | 0.76% |
| | Water | 7732-18-5 | | 28.6% |
| | 25B-4A for | | | 70% |
| | Institutions | | | |
| Blend 74 | Water | 7732-18-5 | | 3.1% |
| | Stock 2.5% Xanthan- | | | 12.7% |
| | 1% Ksorbate | | | |
| | Cationic Formulation- | | | 84.2% |
| | Hi Residual | | | |
| Blend 75 | Xanthan Gum | 11138-66-2 | | 0.28% |
| | Potassium Sorbate | 590-00-1 or | | 1% |
| | | 24634-61-5 | | |
| | Cationic Formulation- | | | 16.90% |
| | Hi Residual | | | |
| | Water | 7732-18-5 | | 81.8% |
| Blend 76 | CIK Formula | | | 2.50% |
| Blend 77 | Lecithin | 8002-43-5 | | 0.20% |
| | Polyglycerol-4-oleate | 9007-48-1 | | 0.90% |
| | Water | 7732-18-5 | | 9.8% |
| | 25B-4A for | | | 89.10% |
| | Institutions w Methyl | | | |
| | Sal | | | |
| Blend 78 | Xanthan Gum | 11138-66-2 | | 0.28% |
| | Potassium Sorbate | 590-00-1 or | | 1.00% |
| | | 24634-61-5 | | |
| | Cationic Formulation | | | 16.90% |
| | w MS | | | |
| | Water | 7732-18-5 | | 81.82% |
| Blend 79 | Vitamin E Acetate | [58-95-7] | | 0.02% |
| | Propyl Paraben | [94-13-3] | | 0.05% |
| | Disodium EDTA | [139-33-3] | | 0.05% |
| | BHT | 128-37-0 | | 0.10% |
| | Methyl Paraben | [99-76-3] | | 0.15% |
| | Triethanolamine | [102-71-6] | | 0.15% |
| | Citronella Oil | 106-22-9 | | 0.20% |
| | Carbopol 940 | [9003-01-4] | | 0.20% |
| | Sodium | [7681-57-4] | | 0.25% |
| | Metabisulphate | | | |
| | Propylene Glycol | [57-55-6] | | 2.00% |
| | Light Liquid Paraffin | 8012-95-1 | | 4.00% |
| | CIK Formula | | | 5.00% |
| | Cresmer RH40 | [61791-12-6] | | 5.00% |
| | hydrogenated castor | | | |
| | oil | | | |
| | White Soft Paraffin | [8009-03-8] | | 9.00% |
| | Emulsifying Wax | 67762-27-0, | | 14.00% |
| | | 9005-67-8 | | |
| | Water | 7732-18-5 | | 59.83% |
| Blend 80 | Span 80 | | | 0.05% |
| | Sodium Benzoate | | | 0.20% |
| | Isopropyl alcohol | 67-63-0 | | 1.50% |
| | 25B-4b blend | | | 12.50% |
| | A46 Propellent | | | 14.50% |
| | Isopar M | 64742-47-8 | | 29% |
| | Water | 7732-18-5 | | 42.25% |
| Blend 81 | Isopropyl alcohol | 67-63-0 | | 3.0% |
| | TT-7 | | | 6.0% |
| | A46 Propellent | | | 40.0% |
| | Isopar M | 64742-47-8 | | 51.0% |
| Blend 82 | Isopropyl alcohol | 67-63-0 | | 3.0% |
| | TT-7 | | | 6.0% |
| | A46 Propellent | | | 40.0% |
| | Isopar M | 64742-47-8 | | 51.0% |
| Blend 83 | HL1 | | | 6.0% |
| | A46 Propellent | | | 40.0% |
| | Isopar M | 64742-47-8 | | 54.0% |
| | Bifenthrin | 83657-04-3 | | 0.05% |
| Blend 84 | Lecithin | 8002-43-5 | | 0.03% |
| | Potassium Sorbate | 590-00-1 or | | 0.11% |
| | | 24634-61-5 | | |
| | Polyglycerol-4-oleate | 9007-48-1 | | 0.15% |
| | Xanthan Gum | 11138-66-2 | | 0.28% |
| | Thyme Oil White | 8007-46-3 | | 2.06% |
| | Isopropyl myristate | 110-27-0 | | 3.43% |
| | Wintergreen Oil | 68917-75-9 | | 4.51% |
| | Water | 7732-18-5 | | 89.42% |
| Blend 85 | Lecithin | 8002-43-5 | | 0.03% |
| | Potassium Sorbate | 590-00-1 or | | 0.11% |
| | | 24634-61-5 | | |
| | Polyglycerol-4-oleate | 9007-48-1 | | 0.15% |
| | Xanthan Gum | 11138-66-2 | | 0.28% |
| | Thyme Oil White | 8007-46-3 | | 1.03% |
| | Isopropyl myristate | 110-27-0 | | 1.72% |
| | Wintergreen Oil | 68917-75-9 | | 2.26% |
| | Water | 7732-18-5 | | 94.43% |
| Blend 86 | Lecithin, Soya | 8030-76-0 | | 0.20% |
| | Polyglycerol-4-oleate | 9007-48-1 | | 0.90% |
| | Water | 7732-18-5 | | 9.80% |
| | 25B-4A-formula 1a | | | 89.10% |
| Blend 87 | Lecithin, Soya | 8030-76-0 | | 0.20% |
| | Polyglycerol-4-oleate | 9007-48-1 | | 0.90% |
| | Water | 7732-18-5 | | 9.80% |
| | Wintergreen Oil | | | 22.1% |
| | Technical | | | |
| | Isopropyl myristate | 110-27-0 | | 32.0% |
| | Thyme Oil White | 8007-46-3 | | 35.0% |
| Blend 88 | Lecithin, Soya | 8030-76-0 | | 0.10% |
| | Polyglycerol-4-oleate | 9007-48-1 | | 0.90% |
| | Water | 7732-18-5 | | 9.90% |
| | 25B-4A w vanillin | | | 89.1% |
| Blend 89 | Lecithin, Soya | 8030-76-0 | | 0.10% |
| | Polyglycerol-4-oleate | 9007-48-1 | | 0.90% |
| | Water | 7732-18-5 | | 9.90% |
| | Isopropyl myristate | 110-27-0 | | 29.76% |
| | Thyme Oil White | 8007-46-3 | | 18.27% |
| | Wintergreen Oil | 68917-75-9 | | 40.10% |
| | Vanillin | 121-33-5 | | 0.98% |
| Blend 90 | Polyglycerol-4-oleate | 9007-48-1 | | 1.90% |
| | Water | 7732-18-5 | | 9.00% |
| | 25B-4A-formula 1a | | | 89.10% |
| Blend 91 | Polyglycerol-4-oleate | 9007-48-1 | | 1.90% |
| | Water | 7732-18-5 | | 9.00% |
| | Wintergreen Oil | | | 22.1% |
| | Technical | | | |
| | Isopropyl myristate | 110-27-0 | | 32.0% |
| | Thyme Oil White | 8007-46-3 | | 35.0% |
| Blend 92 | Potassium Sorbate | 590-00-1 or | | 0.11% |
| | | 24634-61-5 | | |
| | Xanthan Gum | 11138-66-2 | | 0.275% |
| | Polyglycerol-4-oleate | 9007-48-1 | | 1.90% |
| | Anionic Dispersible | | | 11.30% |
| | Concentrate | | | |
| | Water | 7732-18-5 | | 86.410% |
| Blend 93 | Lecithin, Soya | 8030-76-0 | | 0.011% |
| | Potassium Sorbate | 590-00-1 or | | 0.11% |
| | | 24634-61-5 | | |
| | Xanthan Gum | 11138-66-2 | | 0.275% |
| | Thyme Oil White | 8007-46-3 | | 1.25% |
| | Polyglycerol-4-oleate | 9007-48-1 | | 2.002% |
| | Wintergreen Oil | | | 3.15% |
| | Technical | | | |
| | D-Limonene | 5989-27-5 | | 5.67% |
| | Water | 7732-18-5 | | 87.529% |
| Blend 94 | Potassium Sorbate | 590-00-1 or | | 0.11% |
| | | 24634-61-5 | | |
| | Xanthan Gum | 11138-66-2 | | 0.275% |
| | Cationic Dispersible | | | 11.30% |
| | Concentrate | | | |
| | Water | 7732-18-5 | | 88.315% |
| Blend 95 | Lecithin, Soya | 8030-76-0 | | 0.023% |
| | Polyglycerol-4-oleate | 9007-48-1 | | 0.102% |
| | Potassium Sorbate | 590-00-1 or | | 0.11% |
| | | 24634-61-5 | | |
| | Xanthan Gum | 11138-66-2 | | 0.275% |
| | Wintergreen Oil | | | 2.50% |
| | Technical | | | |
| | Isopropyl myristate | 110-27-0 | | 3.62% |
| | Thyme Oil White | 8007-46-3 | | 3.95% |
| | Water | 7732-18-5 | | 89.422% |
| Blend 96 | Potassium Sorbate | 590-00-1 or | | 0.11% |
| | | 24634-61-5 | | |
| | Xanthan Gum | 11138-66-2 | | 0.275% |
| | Nonionic Dispersible | | | 11.30% |
| | Concentrate | | | |
| | Water | 7732-18-5 | | 88.315% |
| Blend 97 | Potassium Sorbate | 590-00-1 or | | 0.11% |
| | | 24634-61-5 | | |
| | Polyglycerol-4-oleate | 9007-48-1 | | 0.21% |
| | Xanthan Gum | 11138-66-2 | | 0.275% |
| | Wintergreen Oil | 68917-75-9 | | 2.50% |
| | Isopropyl myristate | 110-27-0 | | 3.62% |
| | Thyme Oil White | 8007-46-3 | | 3.95% |
| | Water | 7732-18-5 | | 89.332% |
| Blend 98 | Potassium Sorbate | 590-00-1 or | | 1.00% |
| | | 24634-61-5 | | |
| | Xanthan Gum | 11138-66-2 | | 2.500% |
| | Water | 7732-18-5 | | 96.500% |
| Blend 99 | Sodium Benzoate | | | 2% |
| | Water | 7732-18-5 | | 98% |
| Blend 100 | Span 80 | | | 1.20% |
| | Tween 80 | | | 1.65% |
| | 25B-4b blend | | | 2.84% |
| | 2% Sodium Benzoate | | | 11.36% |
| | Isopar M | 64742-47-8 | | 14.20% |
| | Water | 7732-18-5 | | 68.75% |
| Blend 101 | Span 80 | | | 1.20% |
| | Tween 80 | | | 1.65% |
| | Isopar M | 64742-47-8 | | 14.20% |
| | Water | 7732-18-5 | | 79.88% |
| | Sodium Benzoate | | | 0.23% |
| | Wintergreen Oil | 68917-75-9 | | 0.89% |
| | Thyme Oil White | 8007-46-3 | | 0.35% |
| | D-Limonene | 5989-27-5 | | 1.60% |
| Blend 102 | Propellent A70 | | | 22% |
| | 8A Intermediate | | | 78% |
| Blend 103 | Propellent A70 | | | 22.0% |
| | Span 80 | | | 0.94% |
| | Tween 80 | | | 1.29% |
| | Isopar M | 64742-47-8 | | 11.08% |
| | Water | 7732-18-5 | | 62.31% |
| | Sodium Benzoate | | | 0.18% |
| | Wintergreen Oil | 68917-75-9 | | 0.69% |
| | Thyme Oil White | 8007-46-3 | | 0.27% |
| | D-Limonene | 5989-27-5 | | 1.25% |
| Blend 104 | Potassium Sorbate | 590-00-1 or | | 1% |
| | | 24634-61-5 | | |
| | Xanthan Gum | 11138-66-2 | | 2.50% |
| | Water | 7732-18-5 | | 96.50% |
| Blend 105 | Sodium Lauryl Sulfate | 151-21-3 | | 10% |
| | Water | 7732-18-5 | | 90.00% |
| Blend 106 | Water | 7732-18-5 | | 83.5% |
| | Potassium Sorbate | 590-00-1 or | | 1.0% |
| | | 24634-61-5 | | |
| | Xanthan Gum | 11138-66-2 | | 0.28% |
| | Polyglycerol-4-oleate | 9007-48-1 | | 0.15% |
| | Lecithin | 8002-43-5 | | 0.034% |
| | 25B-4A for | | | 15.1% |
| | Institutions | | | |
| Blend 107 | Water | 7732-18-5 | | 33.40% |
| | 15% B-5028 RTU in | | | 66.60% |
| | BLF | | | |
| Blend 108 | Stock 10% SLS | | | 3.18% |
| | Solution | | | |
| | D-Limonene | 5989-27-5 | | 4.03% |
| | Thyme Oil White | 8007-46-3 | | 4.43% |
| | LFO3 | | | 6.27% |
| | Benzyl Alcohol | 100-51-6 | | 16.61% |
| | Isopar M | 64742-47-8 | | 20.95% |
| | Water | 7732-18-5 | | 44.53% |
| Blend 109 | Bifenthrin | 83657-04-3 | | 0.05% |
| | Stock 10% SLS | | | 3.178% |
| | Solution | | | |
| | D-Limonene | 5989-27-5 | | 4.028% |
| | Thyme Oil White | 8007-46-3 | | 4.428% |
| | LFO3 | | | 6.267% |
| | Benzyl Alcohol | 100-51-6 | | 16.60% |
| | Isopar M | 64742-47-8 | | 20.94% |
| | Water | 7732-18-5 | | 44.51% |
| Blend 110 | Bifenthrin | 83657-04-3 | | 0.05% |
| | Span 80 | | | 0.50% |
| | Isopar M | 64742-47-8 | | 15% |
| | Water | 7732-18-5 | | 74.45% |
| | Thyme Oil White | 8007-46-3 | | 2.06% |
| | Wintergreen Oil | 68917-75-9 | | 4.51% |
| | Isopropyl myristate | 110-27-0 | | 3.43% |
| Blend 111 | Sodium Lauryl Sulfate | 151-21-3 | | 0.02% |
| | Water | 7732-18-5 | | 97.98% |
| | Thyme Oil White | 8007-46-3 | | 0.41% |
| | Wintergreen Oil | 68917-75-9 | | 0.90% |
| | Isopropyl myristate | 110-27-0 | | 0.69% |
| Blend 112 | AgSorb | | | 95.00% |
| | Thyme Oil White | 8007-46-3 | | 1.03% |
| | Wintergreen Oil | 68917-75-9 | | 2.26% |
| | Isopropyl myristate | 110-27-0 | | 1.71% |
| Blend 113 | DG Light | | | 95.0% |
| | Thyme Oil White | 8007-46-3 | | 1.03% |
| | Wintergreen Oil | 68917-75-9 | | 2.26% |
| | Isopropyl myristate | 110-27-0 | | 1.71% |
| Blend 114 | Sodium Lauryl Sulfate | 151-21-3 | | 0.02% |
| | Thyme Oil White | 8007-46-3 | | 0.41% |
| | Isopropyl myristate | 110-27-0 | | 0.69% |
| | Wintergreen Oil | 68917-75-9 | | 0.90% |
| | Water | 7732-18-5 | | 97.98% |
| Blend 115 | Vanillin | 121-33-5 | | 0.02% |
| | Geraniol 60 | 106-24-1 | | 0.12% |
| | Linalool Coeur | 78-70-6 | | 0.17% |
| | Tetrahydrolinalool | 78-69-3 | | 0.23% |
| | Isopropyl myristate | 110-27-0 | | 0.24% |
| | Piperonal (aldehyde) | 120-57-0 | | 0.24% |
| | Triethyl Citrate | 77-93-0 | | 0.24% |
| | Thyme Oil White | 8007-46-3 | | 0.98% |
| | Lime Oil Minus | | | 3.00% |
| | Stock 10% SLS | | | 3% |
| | Solution | | | |
| | D-Limonene | 5989-27-5 | | 24.76% |
| | Water | 7732-18-5 | | 67% |
| Blend 116 | Xanthan Gum | 11138-66-2 | | 0.28% |
| | Potassium Sorbate | 590-00-1 or | | 1% |
| | | 24634-61-5 | | |
| | Cationic Formulation | | | 16.90% |
| | Thyme Oil White | 8007-46-3 | | 20.6% |
| | Isopropyl myristate | 110-27-0 | | 34.3% |
| | Wintergreen Oil | 68917-75-9 | | 45.1% |
| | Water | 7732-18-5 | | 81.82% |
| Blend 117 | 25B-4A for | | | 5% |
| | Institutions | | | |
| | Miracle Gro (Sterile) | | | 95% |
| Blend 118 | Bifenthrin | 83657-04-3 | | 0.05% |
| | Span 80 | | | 0.50% |
| | Thyme Oil White | 8007-46-3 | | 0.51% |
| | Isopropyl myristate | 110-27-0 | | 0.86% |
| | Wintergreen Oil | 68917-75-9 | | 1.13% |
| | Isopar M | 64742-47-8 | | 15% |
| | Water | 7732-18-5 | | 81.95% |

### Example 1

### Pesticidal Effect on Culex quinquefasciatus

The effect of compositions, and their individual ingredients, on the mortality of insects is tested. Multiple plexiglass chambers are used. A treatment chamber is provided for each composition and ingredient that is tested, and the chambers are sprayed (aerosol spray) evenly on all surfaces with the composition or ingredient being tested. A control chamber is provided that is not treated.

Southern house mosquitoes, Culex quinquefasciatus, are obtained as test organisms. Multiple laboratory-cultured, sucrose-fed female mosquitoes aged about 2-5 days are released into the glass chambers prior to the spraying of aerosol. The discharge rate (gm/second) of each can of aerosol to be tested is predetermined. Based on the dosage required, an estimated time of spray of aerosol is discharged into the glass chamber.

Knockdown of mosquitoes is observed at indicated intervals up to about 20 minutes. After about 20 minutes, all mosquitoes are collected and placed in cylindrical polyethylene containers with 10% sucrose pads. Mortality is observed 4 hours post-treatment. The mortality value is based on a combination of dead and moriband mosquitoes over the total number of mosquitoes initially released.

The data from an exemplary study is shown in Table 10. The study tested: (1) a composition comprising Pyrethrum and Blend 9; (2) Pyrethrum; (3) BSO; and (4) LFO (IFF Inc., Hazlet, N.J.). The percent mortality of the mosquitoes treated with the composition was 100%, compared to 60% for BSO alone, 80% for LFO alone, 90% for Pyrethrum alone, and 0% for the non-treated control.

TABLE 10

| | Mosquitoes | | |
|---|---|---|---|
| | # Added to | # Dead after 4 | % |
| | Chamber | hours | Mortality |
| Control | 50 | 0 | 0% |
| BSO | 50 | 30 | 60% |
| LFO | 50 | 40 | 80% |
| Pyrethrum | 50 | 45 | 90% |
| Composition (Pyrethrum and | 50 | 50 | 100% |
| Blend 9) | | | |

### Example 2

### Repellency Effect Against Culex quinquefasciatus

The repellency of exemplary compositions of the present invention are compared to the repellency of their individual ingredients, and to a non-treated control. Southern house mosquitoes, Culex quinquefasciatus, are obtained as test organisms. Multiple human evaluators test each treatment in a replicated experiment. Experimentation is conducted in a laboratory using multiple-chambered, plexiglass modules, each chamber stocked with about 2-10 day-old colony-reared female mosquitoes. The modules are equipped with sliding doors to expose the mosquitoes to the legs of three volunteers. Treatments are applied at about 28.6 μl to 12 cm² rectangular sections of skin located directly beneath the chamber openings. Each volunteer conducts 2-minute biting counts for each treatment at five time intervals: 0, 1, 2, 4 & 6 hours post-treatment. New mosquitoes are stocked into the chamber for each time interval. Ambient temperature and humidity data is recorded with a HOBO datalogger. Percent repellency is determined according to the following formula: Control−Treatment/Control X 100.

The data from an exemplary study is shown in Table 11. The study tested: (1) a composition comprising 5% DEET and 95% Blend 9; (2) BSO; and (3) LFO (IFF Inc., Hazlet, N.J.). The percent repellency for the composition was 100%, as compared to the individual ingredients, that exhibited lower initial percent repellency, and no repellency after about 6 hours.

TABLE 11
PERCENT REPELLENCY

| | 0 | 1 Hour | 2 Hours | 4 Hours | 6 Hours |
|---|---|---|---|---|---|
| Control | 0 | 0 | 0 | 0 | 0 |
| BSO | 20 | 10 | 5 | 2 | 0 |
| LFO | 30 | 15 | 8 | 3 | 0 |
| 5% DEET | 40 | 20 | 10 | 5 | 0 |
| Composition | 100.0 | 100.0 | 100.0 | 100.0 | 100.0 |
| (5% DEET and 95% | | | | | |
| Blend 9) | | | | | |

As indicated by the data above, the composition has a synergistic effect as compared to the individual ingredients of the composition. A coefficient of synergy can be calculated for the blend, relative to each individual ingredient, i.e., comparison composition. Such synergy coefficients for the composition including Pyrethrum, BSO, and LFO are set forth in Table 12. Such synergy coefficients for the composition including DEET, BSO, and LFO are set forth in Table 13.

TABLE 12

| | | | Concentration | | |
|---|---|---|---|---|---|
| | | | of Comparison | | |
| | | | Composition in | Concentration | |
| Comparison | Mortality | | Blend | Adjustment | Synergy |
| Composition | (%) | Activity Ratio | (%, by wt) | Factor | Coefficient |
| BSO | 60 | (1.00)/(0.60) = | 19.91(0.95) = | (1.00)/(0.1891) = | 8.83 |
| | | 1.67 | 18.91 | 5.29 | |
| LFO | 80 | (1.00)/(0.80) = | 80.09(0.95) = | (1.00)/(0.7609) = | 1.64 |
| | | 1.25 | 76.09 | 1.31 | |
| Pyrethrum | 90 | (1.00)/(0.90) = | 5 | (1.00)/(0.05) = | 22.2 |
| | | 1.11 | | 20 | |
| Control | 00.0 | — | — | — | — |
| Composition | 100 | (1.00)/(1.00) = | 100 | (1.00)/(1.00) = | 1.00 |
| | | 1.00 | | 1.00 | |

TABLE 13

| | | | Concentration | | |
|---|---|---|---|---|---|
| | | | of Comparison | | |
| | Repelency | | Composition in | Concentration | |
| Comparison | (%), | | Blend | Adjustment | Synergy |
| Composition | at 1 Hour | Activity Ratio | (%, by wt) | Factor | Coefficient |
| BSO | 10 | (1.00)/(0.10) = | 19.91(0.95) = | (1.00)/(0.1891) = | 52.9 |
| | | 10 | 18.91 | 5.29 | |
| LFO | 15 | (1.00)/(0.15) = | 80.09(0.95) = | (1.00)/(0.7609) = | 8.78 |
| | | 6.7 | 76.09 | 1.31 | |
| DEET | 20 | (1.00)/(0.20) = | 5 | (1.00)/(0.05) = | 100 |
| | | 5.0 | | 20 | |
| Control | 00.0 | — | — | — | — |
| Composition | 100 | (1.00)/(1.00) = | 100 | (1.00)/(1.00) = | 1.00 |
| | | 1.00 | | 1.00 | |

The synergy coefficients and other data presented in Tables 12 and 13 are calculated as follows. An activity ratio (A) can be calculated by dividing the effect of the blend (E_{B}) by the effect of the comparison composition (E_{C}), as follows:

A=E_{B}/E_{c} Formula 1

A concentration adjustment factor (F) can be calculated based on the concentration (X) of the comparison composition in the blend, as follows:

F=1/X Formula 2

The synergy coefficient (S) can then be calculated by multiplying the activity ratio (A) and the concentration adjustment factor (F), as follows:

S=(A)(F) Formula 3

As such, the synergy coefficient (S) can also by calculated, as follows:

S=[E_{B}/E_{C}]/X Formula 4

For example, with reference to Table 12, the activity ratio for BSO is 1.67 because the effect of the composition is a cure rate of 100%, while the effect of BSO alone is 60% [(1.00)/(0.60)=1.67]. The concentration adjustment factor for BSO is 5.29 because the blend contains 95% of a blend that includes 19.91% BSO [19.91 (0.95)=18.91], as compared to the 100% p-cymene tested alone [(1.00)/(0.1891)=5.29]. The synergy coefficient of the blend, relative to BSO(S_{BSO}) is therefore 8.83. With further reference to Table 12, the synergy coefficients for the blend are as follows: S_{pyrethrum}=22.2; S_{LFO}=1.64; S_{BSO}=8.83.

In some embodiments, synergy or synergistic effect associated with a composition can be determined using calculations similar to those described in Colby, S. R., “Calculating synergistic and antagonistic responses of herbicide combinations,” Weeds (1967) 15:1, pp. 20-22, which is incorporated herein by this reference. In this regard, the following formula can be used to express an expected percent effect (E) of a composition including two compounds, Compound X and Compound Y:

E=X+Y−(X*Y/100) Formula 5

In Formula 5, X is the measured actual percent effect of Compound X in the composition, and Y is the measured actual percent effect of Compound Y of the composition. The expected percent effect (E) of the composition is then compared to a measured actual percent effect (A) of the composition. If the actual percent effect (A) that is measured differs from the expected percent effect (E) as calculated by the formula, then the difference is due to an interaction of the compounds. Thus, the composition has synergy (a positive interaction of the compounds) when A>E. Further, there is a negative interaction (antagonism) when A<E.

Formula 5 can be extended to account for any number of compounds in a composition; however it becomes more complex as it is expanded, as is illustrated by the following formula for a composition including three compounds, Compound X, Compound Y, and Compound Z:

E=X+Y+Z−((XY+XZ+YZ)/100)+(X*Y*Z/10000) Formula 6

An easy-to-use formula that accommodates compositions with any number of compounds can be provided by modifying Formulas 5 and 6. Such a modification of the formula will now be described. When using Formulas 5 and 6, an untreated control value (untreated with composition or compound) is set at 100%, e.g., if the effect being measured is the amount of target insects killed, the control value would be set at 100% survival of target insect. In this regard, if treatment with Compound A results in 80% killing of a target insect, then the treatment with Compound A can be said to result in a 20% survival, or 20% of the control value. The relationship between values expressed as a percent effect and values expressed as a percent-of-control are set forth in the following formulas, where E′ is the expected percent of control of the composition, Xₙ is the measured actual percent effect of an individual compound (Compound Xₙ₋) of the composition, Xₙ′ is the percent of control of an individual compound of the composition, and A′ is the actual measured percent of control of the of the composition.

E=100−E′ Formula 7

Xₙ=100=Xₙ′ Formula 8

A=100−A′ Formula 9

By substituting the percent-of-control values for the percent effect values of Formulas 5 and 6, and making modifications to accommodate any number (n) of compounds, the following formula is provided for calculating the expected percent of control (E′) of the composition:

$${E}^{’} = ( {\prod }_{i = 1}^{n} {X}_{i}^{’} ) \div {100}^{n - 1} \qquad Formula 10$$

According to Formula 10, the expected percent of control (E′) for the composition is calculated by dividing the product of the measured actual percent of control values (Xₙ′) for each compound of the composition by 100ⁿ⁻¹. The expected percent of control (E′) of the composition is then compared to the measured actual percent of control (A′) of the composition. If the actual percent of control (A′) that is measured differs from the expected percent of control (E′) as calculated by the Formula 10, then the difference is due to an interaction of the compounds. Thus, the composition has synergy (a positive interaction of the compounds) when A′<E′. Further, there is a negative interaction (antagonism) when A′>E′.

### Example 3

### Synergistic Compositions as Indicated by TyR Binding Inhibition

When the chemical(s) and compound(s) are combined to provide the compositions of the present invention, there is a synergistic effect. The efficacy for insect control and the synergistic effect of compositions can be predicted and demonstrated in a variety of manners, for example, a competition binding assay can be used. With reference to Table 14, the percent TyrR binding inhibition affected by the following agents was determined using a competition binding assay: the natural ligand, Tyramine(TA); Blend 5; Blend 12; DM; Pyrethrum; 90:1 Blend 5+DM; 9:1 Blend 5+Pyrethrum; 90:1 Blend 12+DM; and 9:1 Blend 12+Pyrethrum.

TABLE 14

| Agent | % TyrR Binding Inhibition |
|---|---|
| Tyramine (TA) | 75 |
| Blend 5 | 30 |
| Blend 12 | 60 |
| DM | 10 |
| Pyrethrum | 5 |
| 90:1 Blend 5 + DM | 50 |
| 9:1 Blend 5 + Pyrethrum | 60 |
| 90:1 Blend 12 + DM | 60 |
| 9:1 Blend 12 + Pyrethrum | 60 |

One example of an synergistic effect shown by this study is as follows: the insect control chemical, Pyrethrum, only has a 5% TyrR binding inhibition, and Blend 5 only has a 30% TyrR binding inhibition; however, when Pyrethrum and Blend 5 are combined, the TyrR binding inhibition increases to 60%, approaching that of the natural ligand.

### Example 4

### Pesticidal Effect Against Blattella germanica

With reference to Table 15, the pesticidal effect against Blattella germanica (German cockroaches) was determined for DM, Blend 12, and the composition including DM and Blend 12. Treatment with DM alone resulted in an average knock down (KD) of the insects in 120 sec, and 100% killing of the insects in 15 minutes. Treatment with Blend 12 alone resulted in an average KD of the insects in 20 sec, and 100% killing of the insects in 5 minutes. A synergistic effect was shown for the combination treatment that resulted in an average KD of the insects in 5 sec, and 100% killing of the insects in 55 seconds. The composition including Blend 12 and DM was shown to be effective and was shown to have a synergistic effect. Additionally, the above-described methods, including competition receptor binding assays, assessments of changes in cAMP, and assessments of changes in Ca²⁺, are confirmed to be effective at predicting and demonstrating the synergistic effect of and the efficacy of the composition.

TABLE 15
Efficacy of DM and Blend 12 against German cockroaches

Bioactivity

| Chemicals | KD | | 100% Kill | |
|---|---|---|---|---|
| DM (0.037 mg/cm²) | 120 | sec | 15 | min |
| (17 μl of 16.99% formulated DM) | | | | |
| Blend 12 | 20 | sec | 5 | min |
| (1.9 mg/cm²) | | | | |
| Composition (1.9 mg/cm²) | 5 | sec | 55 | sec |
| (1 part DM: 9 parts Blend 12 (v/v)) | | | | |

### Example 5

### Pesticidal Effect Against Aedes aegypti

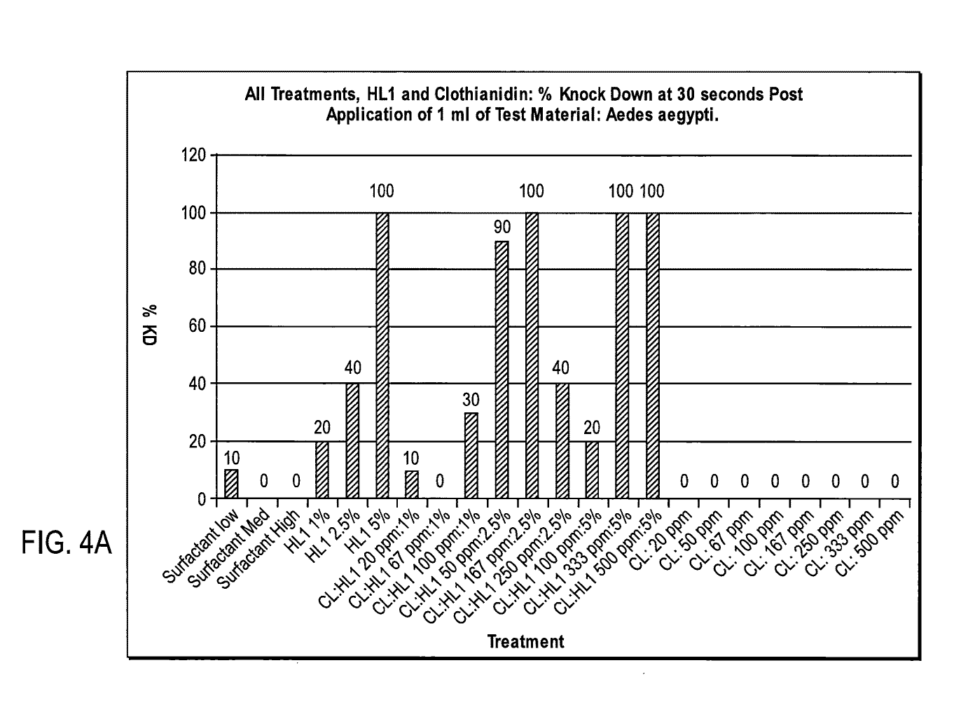

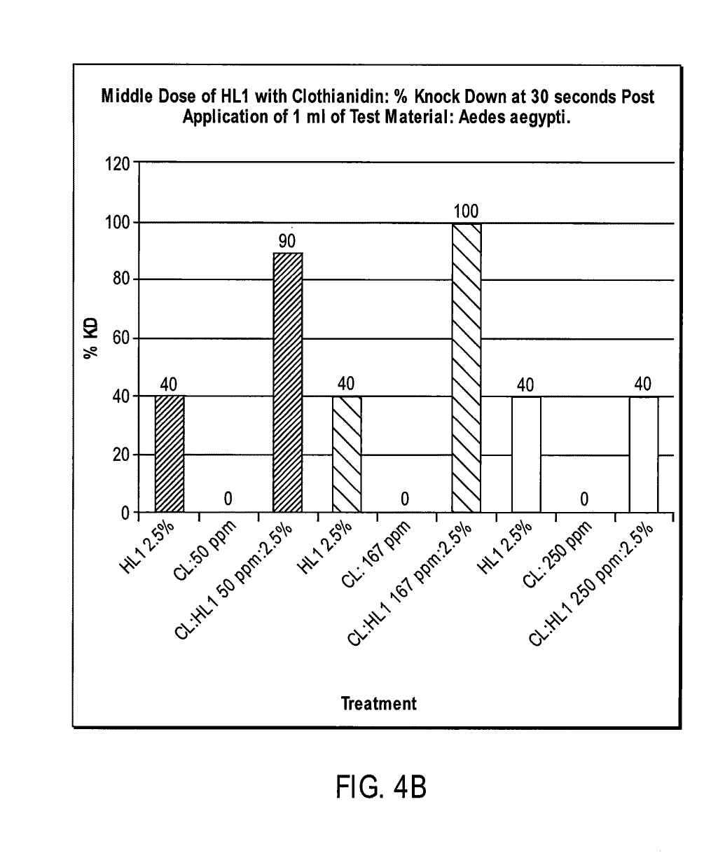

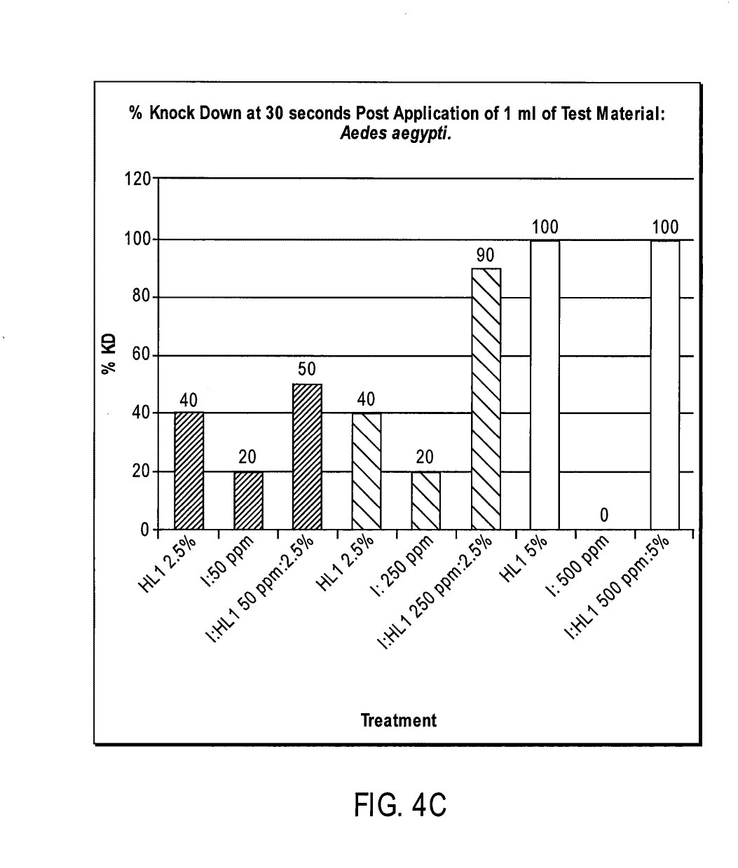

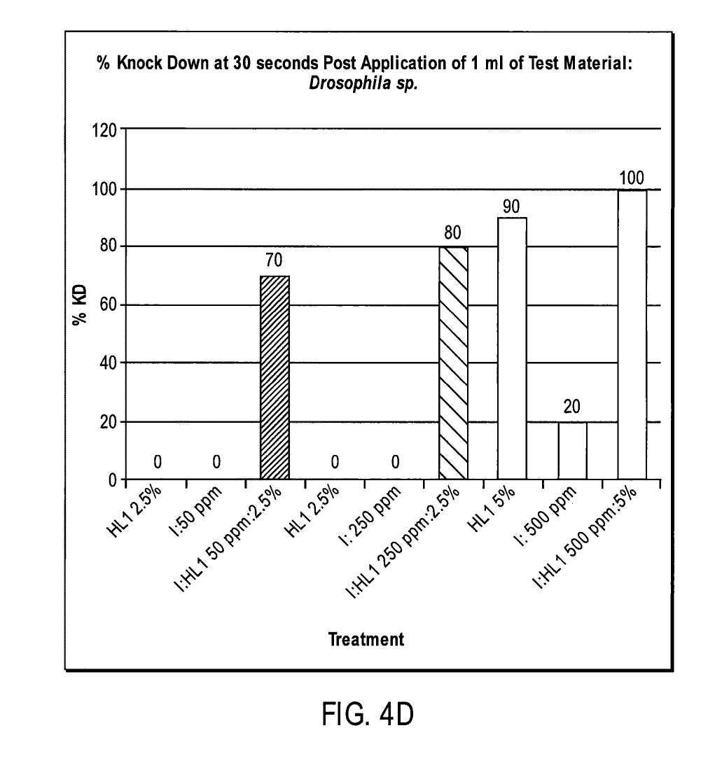

With reference to FIG. 4A, the pesticidal effect against Aedes aegypti was determined for Blend 23 (labeled “HL1”) and the composition including CL and Blend 23. Treatment with CL alone at 500 ppm resulted in no KD of the target insect, however treatment with CL at 167 ppm combined with 2.5% Blend 23 resulted in 100% KD. The composition including Blend 23 and CL was shown to be effective and was shown to have a synergistic effect.

Similarly, with reference to FIG. 4B, the pesticidal effect against Aedes aegypti was determined for Blend 23 (labeled “HL1”) and the composition including CL and Blend 23. Treatment with CL alone at 250 ppm resulted in no KD of the target insect, however treatment with CL at 167 ppm combined with 2.5% Blend 23 resulted in 100% KD. The composition including Blend 23 and CL was shown to be effective and was shown to have a synergistic effect.

Similarly, with reference to FIG. 4C, the pesticidal effect against Aedes aegypti was determined for Blend 23 (labeled “HL1”) and the composition including Imidacloprid and Blend 23. Treatment with Imidacloprid alone at 250 ppm resulted in 20% KD of the target insect at 30 seconds post-treatment, while treatment with 2.5% Blend 23 alone resulted in 40% KD of the target insect at 30 seconds post-treatment. However treatment with Imidacloprid at 250 ppm combined with 2.5% Blend 23 resulted in 90% KD at 30 seconds post-treatment. The composition including Blend 23 and CL was shown to be effective and was shown to have a synergistic effect.

Similarly, with reference to FIG. 4D, the pesticidal effect against Drosophila sp. was determined for Blend 23 (labeled “HL1”) and the composition including Imidacloprid and Blend 23. Treatment with Imidacloprid alone at 50 ppm resulted in 0% KD of the target insect at 30 seconds post-treatment, while treatment with 2.5% Blend 23 alone also resulted in 0% KD of the target insect at 30 seconds post-treatment. However treatment with Imidacloprid at 50 ppm combined with 2.5% Blend 23 resulted in 70% KD at 30 seconds post-treatment. The composition including Blend 23 and CL was shown to be effective and was shown to have a synergistic effect.

### Example 6

### Pesticidal Effect Against Aedes aegypti

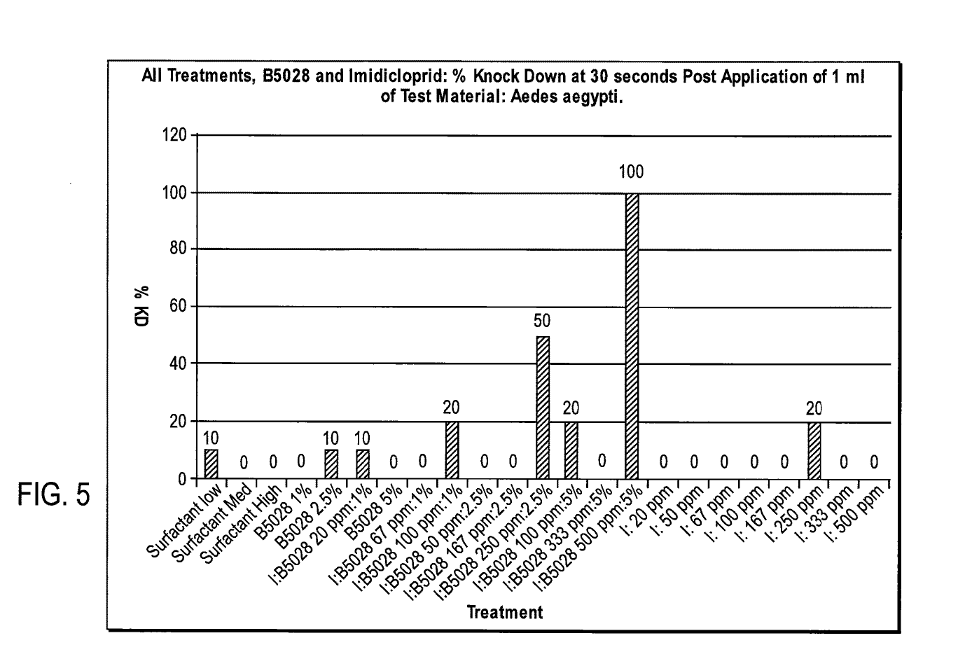

With reference to FIG. 5, the pesticidal effect against Aedes aegypti was determined for Blend 5 (labeled “B5028”) and the composition including Imidacloprid and B5028. Treatment with Imidacloprid alone at 500 ppm resulted in no KD of the target insect, and treatment with B5028 at 5% showed 10% KD of the target. However treatment with Imidacloprid at 500 ppm combined with B5028 at 5% resulted in 100% KD. The composition including B5028 and CL was shown to be effective and was shown to have a synergistic effect.

### Example 6

### Comparison of Pesticidal Effects

Similarly, with reference to Table 16, the pesticidal effect against German cockroaches was determined for DM, Blend 5, and the composition including DM and Blend 5. Treatment with DM alone resulted in an average KD of the insects in 140 sec, and 100% killing of the insects in 12 minutes. Treatment with Blend 5 alone resulted in an average KD of the insects in 10 sec, and 100% killing of the insects in 45 seconds. A synergistic effect was shown for the combination treatment that results in an average KD of the insects in 5 sec, and 100% killing of the insects in 17 seconds. The composition including Blend 5 and DM was shown to be effective and was shown to have a synergistic effect. The above-described methods, including competition receptor binding assays, assessments of changes in cAMP, and assessments of changes in Ca²⁺, were confirmed to be effective at predicting and demonstrating the synergistic effect of and the efficacy of the composition.

TABLE 16
Efficacy of DM and Blend 5 against German cockroaches

Bioactivity

| Chemicals | KD | | 100% Kill | |
|---|---|---|---|---|
| DM (0.037 mg/cm²) | 140 | sec | 12 | min |
| (17 μl of 16.99% formulated DM) | | | | |
| Blend 5 | 10 | sec | 45 | sec |
| (3.8 mg/cm²) | | | | |
| Composition (3.8 mg/cm²) | 5 | sec | 17 | sec |
| (1 part DM: 99 parts Blend 5 (v/v)) | | | | |

### Example 7

### Comparison of Pesticidal Effects

With reference to Table 17, the pesticidal effect against Darkling Beetles was determined for Pyrethrum, Blend 12, and the composition including Pyrethrum and Blend 12.

TABLE 17
Efficacy of Pyrethrum and Blend 12 against Darkling Beetles

| | % Mortality after Application by direct | | | |
|---|---|---|---|---|
| | spray to Darkling Beetle | | | |
| Test Material | Day 1 | Day 4 | Day 8 | Day 12 |
| Vehicle Control | 0 ± 0% | 0 ± 0% | 5 ± 7% | 5 ± 7% |
| (Water) | | | | |
| 4% Blend 12 | 15 ± 5% | 40 ± 13% | 55 ± 10% | 80 ± 0% |
| 4% Pyrethrum | 0 ± 0% | 10 ± 10% | 20 ± 19% | 30 ± 28% |
| 2% Blend 12 and | 25 ± 13% | 45 ± 17% | 80 ± 14% | 100 ± 0%** |
| 2% Pyrethrum | | | | |

Values displayed are the mean plus or minus the standard deviation for 4 replicates of 10 insects each, except vehicle control-(2 replicates of 10 insects each).
**Significantly greater than all other values for mortality (P < 0.001, 2 tail student t Test)

The synergistic effect can be altered by changing the specific combinations of ingredients or changing the specific ratios of ingredients.

### Example 8

### Pesticidal Effect Against Periplaneta americana

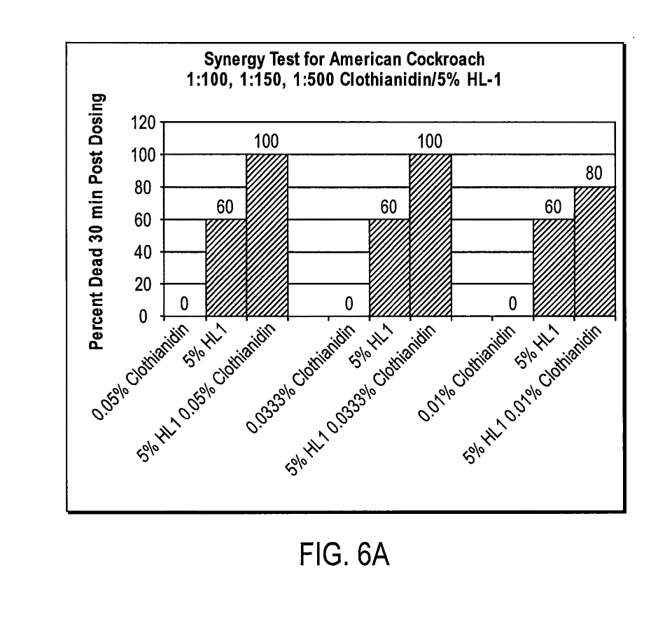

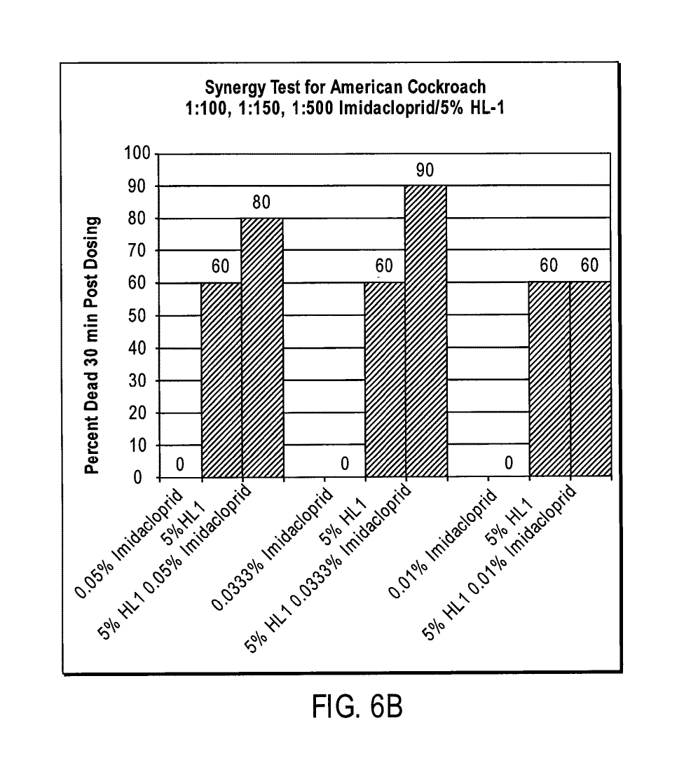

With reference to FIG. 6A, the pesticidal effect against Periplaneta americana was determined for Blend 23 (labeled “HL1”) and the composition including CL and Blend 23. Treatment with CL alone at 0.05% resulted in no mortality of the target insect at 30 minutes post-treatment, while treatment with Blend 23 at 5% resulted in 60% target mortality 30 minutes post-treatment. However treatment with CL at 0.05% combined with 5% Blend 23 resulted in 100% mortality 30 minutes post-treatment. The composition including Blend 23 and CL was shown to be effective and was shown to have a synergistic effect.

With reference to FIG. 6B, the pesticidal effect against Periplaneta americana was determined for Blend 23 (labeled “HL1”) and the composition including Imidacloprid and Blend 23. Treatment with Imidacloprid alone (at 0.05%, 0.033%, and 0.01%) resulted in no mortality of the target insect at 30 minutes post-treatment, while treatment with Blend 23 at 5% resulted in 60% target mortality 30 minutes post-treatment. However treatment with Imidacloprid at 0.033% combined with 5% Blend 23 resulted in 90% mortality 30 minutes post-treatment. The composition including Blend 23 and Imidacloprid was shown to be effective and was shown to have a synergistic effect.

### Example 9

### Pesticidal Effect Against Bed Bugs

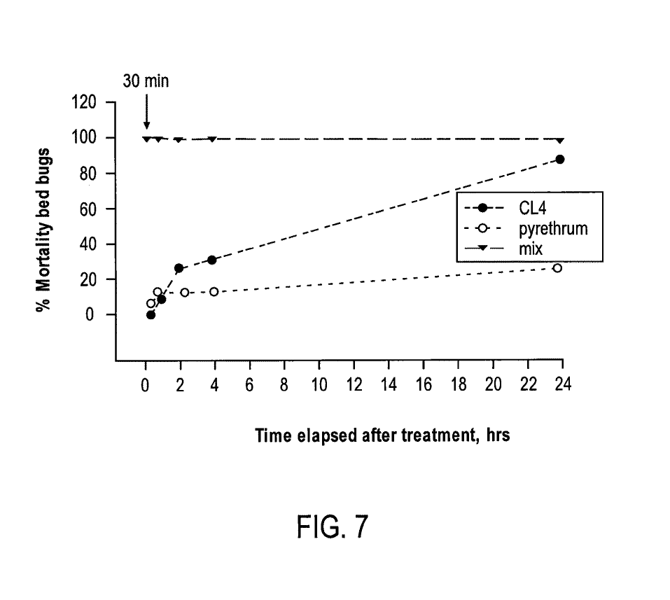

Turning now to FIG. 7 showing the pesticidal effect against bed bugs expressed as percent mortality as a function of time, the 1:1 ratio composition was shown to have a synergistic effect, when compared to the pesticidal effect of Blend 12 (labeled as “CL-4”) or Pyrethrum alone. The pyrethrum alone did not achieve higher than about 30% mortality, and Blend 12 alone did not achieve higher than about 80% mortality. However, the 1:1 ratio composition including Blend 12 and Pyrethrum resulted in 100% mortality, as early as about 30 minutes after treatment, and had a residual effect lasting up to about 24 hours after treatment.

### Example 10

### Synergistic Combination of Active Ingredients with DM and Imidacloprid

With reference to Table 18, the pesticidal effect against several insects was determined for Imidacloprid (a commercial pesticide rated as “moderately toxic” by the EPA, and requiring a “Warning” or “Caution” label), DM, Blend 2, Blend 5, and the composition including DM and Blend 2. Treatment with DM alone resulted in an average KD of the insects in 120 sec, and 100% killing of the insects in 15 minutes. The composition including Blend 2 and DM was shown to be effective and was shown to have a synergistic effect.

TABLE 18
Interim Field Plot Ratings, South Georgia, August 1-6, 2007 (Insect counts)

| | | Blend 2 | | | Blend 5 | | | | | |
|---|---|---|---|---|---|---|---|---|---|---|
| | Un- | percentage | | | percentage | | | DM + | | |
| Pest | treated | 0.75 | 1.5 | 3.0 | 0.75 | 1.5 | 3.0 | Blend 2 | DM | Imidacloprid |
| Whitefly (on | | | | | | | | | | |
| zucchini) | | | | | | | | | | |
| Adult | 20 | 27 | 30 | 21 | 20 | 21 | 14 | 17 | 18 | 16 |
| Nymph | 282 | 207 | 171 | 162 | 122 | 107 | 74 | 28 | 142 | 5 |
| aphids (on | | | | | | | | | | |
| cotton) | | | | | | | | | | |
| Adults | 61 | 50 | 25 | 18 | 37 | 23 | 16 | 7 | 15 | 0.3 |
| Nymph | 204 | 138 | 105 | 86 | 108 | 78 | 53 | 16 | 26 | 1.6 |
| Thrips (on | 22 | 24 | 18 | 12 | 20 | 13 | 9 | 6 | 13 | 9 |
| cotton) | | | | | | | | | | |
| Flower | 3.4 | 3.3 | 2.7 | 2.2 | 2.6 | 2.5 | 1.6 | 1.9 | 2.2 | 2.0 |
| damage (1-5 | | | | | | | | | | |
| rating scale; | | | | | | | | | | |
| 1 = no | | | | | | | | | | |
| damage) | | | | | | | | | | |

Ratings 1 wk after treatment.
No phyto on cotton; dose related phyto on zucchini

### Example 11

### Repellency of Target Insects

Adult insects are randomly selected for testing the repellent effect of test compositions. 5 insects per replicate are used. 3 replicates are used for each treatment. Untreated control tests are included with only solvent application to an equal-sized population/replications, held under identical conditions. Filter paper (about 80 cm²) is treated with the test composition (about 100 mg in 300 ml acetone). After about 3 minutes of air drying, the filter paper is placed in a dish and insect repellency is evaluated. Insects are released to the dish, one insect at a time at the far end of the dish. Using one or more stopwatches, the time spent on either the filter paper or the untreated surface of the dish is recorded up to about 300 seconds. Repellency ratio (RR) is calculated as follows: RR=[(time on control surface−time on treated surface)/total time of test]. If RR>0 the composition is considered to have a repellant effect, that is to say, an effect, wherein more insects are repelled away from treated surface than the control surface; if RR<0 the composition is considered to not have a repellant effect.

### Example 12

### Repellent Effect Against Aedes aegypti

Approximately 250 female Aedes aegypti mosquitoes are introduced into a chamber containing 5 wells, each covered by a Baudruche membrane. Wells are filled with bovine blood, containing sodium citrate (to prevent clotting) and ATP (72 mg ATP disodium salt per 26 ml of blood), and heated to 37 C. A volume of 25 ul of isopropyl alcohol, containing test compositions is applied to each membrane.

After 5 min, 4 day-old female mosquitoes are added to the chamber. The number of mosquitoes probing the membranes for each treatment is recorded at 2 min intervals over 20 min.

### Example 13

### Pesticidal Effect Against Coptotermes formosanus

Filter paper having a diameter of 80 mm is placed in a cylindrical cup made of acrylic resin having a diameter of 80 mm and a height of 60 mm (i.e. a cup having a hole with a diameter of 10 mm formed in the bottom and having hard plaster (Dental Stone) set at the bottom in a thickness of 10 mm), and 1 ml of a test composition containing a sample compound in a predetermined concentration, is dropped thereon. Nine Coptotermes formosanus (termite) workers and one termite soldier are released thereon. The cup is placed in a container having wet cotton laid over the bottom, and the container is maintained at room temperature of 25 C for 7 days, whereupon the mortality of termites in the cup is examined.

### Example 14

### Pesticidal Effect Against Coptotermes formosanus

A solution containing a test compound in a predetermined concentration is coated by a paint brush in an amount of 110 mg+/−10 mg on a rectangular wood block of Japanese red pine (20 mm×10 mm×10 mm). The treated wood block is naturally dried in a dark room of 25 C for 14 days. The treated wood block and a non-treated wood block are dried at a temperature of 60 C for 72 hours, their weights (W.sub.1) are measured, and they are used as test specimens. A test specimen is put into a cylindrical cup made of acrylic resin (i.e. a cup having a hole with a diameter of 10 mm formed in the bottom and having hard plaster (Dental Stone) set at the bottom in a thickness of 10 mm), and 150 termite workers and 10 termite soldiers (Reticulitermes speratus) are released thereon. The cup is placed in a container having wet cotton laid over the bottom, and the container is maintained at room temperature of 25 C for 24 days, whereupon the mortality of termites in the cup is examined. Further, the test specimen is taken out from the cup, and the deposited substance is removed from the surface of the test specimen. After drying at a temperature of 60 C for 72 hours, it is weighed (W.sub.2), whereupon the mean weight loss is calculated.

### Example 15

### Pesticidal Effect Against Drosophila

Two acetonic solutions (about 1% and 10%) of a test composition are prepared. Test concentrations in acetone are then added to the inside of glass vials (about 5 ml) that are marked to about 3 cm above the bottom. The vials are rotated such that the inner surfaces of the vials, except the area between the marks to the neck, are left with a film of test composition. All vials are aerated for about 10 seconds to ensure complete evaporation of acetone before introducing Drosophila to the treated vials. After complete evaporation of acetone, about 10 adult sex mixed flies are added to each vial and the vials are stoppered with cotton plugs. Mortality is observed about 24 hours after exposure.

### Example 16

### Pesticidal Effect Against Ants

1 g of powdered skim milk is treated with 1 ml of test composition at a predetermined concentration. Then, this composition is put into a cup together with wet cotton, and 15 ants (Lasius japonicus) are released. 4 days later, the mortality is examined.

### Example 17

### Pesticidal Effect Against Ants

The repellent effect of various test compositions is tested by treating a filter paper with the test oils. After five minutes at room temperature, the paper is placed in a dish and ants are introduced one at a time. The repellency is determined as described above. Oils are tested alone and are mixed with pesticidal compounds or products to form compositions that are then tested.

### Example 18

### Repellent Effect of Test Compositions Vs. DEET

For purposes of comparing the repellent effect of various test compositions, the repellency of the commercial repellent 29% DEET, that can be purchased under the name, REPEL® (Wisconsin Pharmacal Company, Inc, Jackson, Wyo.), is measured against Carpenter ants by treating a filter paper with the 29% DEET. After five minutes at room temperature, the paper is placed in a dish and ants are introduced one at a time. The repellency is determined as described above.

### Example 19

### Pesticidal Effect Against Pediculus Humanus Capitus

Live adult Pediculus humanus capitus (head lice) are collected from female and male children between the age of about 4 and 11. The insects are collected using fine-toothed louse detector comb and pooled together. The collected lice are kept in dishes and used in the studies within about 30 minutes of their collection.

Various concentrations of the compositions being tested are prepared in water. To allow the pesticidal effect of these compositions to be compared to that of a commercially available lice-killing agent, ivermectin, is dissolved in water. About 1 ml of each concentration of the compositions is applied to a dish, about 1 ml of the ivermectin solution is applied to a dish, and about 1 ml of water is applied to a control dish. 10 adult head lice are introduced to each dish.

Treated and control dishes are kept under continuous observation and LT₁₀₀ is observed. LT refers to the time required to kill a given percentage of insects; thus, LT₁₀₀ refers to the time required to kill 100% of the lice. Head lice is considered dead if no response to a hard object is found.

### Example 20

### Pesticidal Effect Against Mosquito Larvae

Four small ponds are used for test locations and floating boom dividers are used to further subdivide the ponds into five test areas. An initial survey of the test areas is conducted for both aquatic insects and vegetation. Insects are sampled using dip nets within two meters of the shore within the emergent vegetation, which produces ideal mosquito habitat. 96% of the mosquito larvae were present within one meter of the shore. Plots are sampled and large numbers of larvae are observed.

Test plots are treated with compositions comprising the blends listed in Table 7 and commercial pesticide products. After 24 hours the plots are sampled again.

### Example 21

### Repellent Effect Against Aedes aegypti

0.7 grams of each test composition is applied to the forearms of three male subjects. The subjects then insert their forearms into 25 cm×25 cm×40 cm cheesecloth-covered wire cages containing approximately 500 seven-to-ten-day-old mixed sex Aedes aegypti mosquitoes. Assessments are conducted for three minutes per arm commencing immediately after the application of the formulation thereto, and every hour thereafter until a confirmed bite is recorded. A confirmed bite is defined as more than one bite in a given exposure period or one bite in each of two consecutive exposure periods. A 15 second pre-treatment exposure of an untreated forearm is conducted for each subject at the beginning of each day of testing.

The data are analyzed using two-way analysis of variance with treatment means separated using least significant difference techniques.

### Example 22

### Repellent Effect Against Western Black-Legged Ticks

To determine the efficacy of test compounds as a tick repellent, a test subject's hands are treated with a test composition while the fingers of the hand are left untreated. As a positive control, Ultrathon™ (3M, Minneapolis, Minn.) is applied to the hand and the fingers are left untreated. An untreated hand is used as a negative control. Unfed nymphal Western Black-legged ticks are placed on the fingers of the hands and observed as they climbed toward the treated or untreated skin of the hand. Ticks crossing onto the treated skin are scored as “crossing.” Those not crossing were scored as “repelled.” Ticks are removed after a single score is recorded. Repellency is calculated as the proportion of all trials in which a tick is repelled. For example, 8 repels in 10 trials provides a repellency of 80%. In this study, each subject tests a tick at 15 minute intervals for 2 hours and 15 minutes.

### Example 23

### Repellent Effect Against Aedes aegypti

To determine if test compositions would enhance the mosquito repelling effect of DEET, the repellent activity of test compositions alone and compositions comprising test compositions and DEET were compared to a positive control, Ultrathon™ (3M, Minneapolis, Minn., approximately 31% DEET).

In the first study, three subjects receive applications of test compositions, to one subject is applied Ultrathon™, and two subjects serve as negative controls. Composition applications are evenly divided among leg and arm surfaces. The total area of treated surfaces are calculated for each subject in advance of the application.

Test subjects count and record bites in a series of 10 minute periods. Counts are recorded on data sheets. In this test, the testing period was two hours, with 12 consecutive 10 minute recording periods.

Ambient biting rates are measured throughout the study by the subjects with untreated control limbs. Total bites are recorded.

### Example 23

### Repellent Effect Against Ceratopogonid Biting Flies

To determine the efficacy of test compositions as biting insect repellents, eight human subjects take part in an experiment wherein three subjects are treated with a test composition. Three other subjects serve as negative controls (untreated skin), while two positive control subjects are treated with two commercially available insect repellents, Ultrathon™, a DEET-based repellent, and Treo™, a plant-based repellent. Testing is conducted at various sites.

The test materials are applied either to the lower arm or lower leg skin of the study subjects. The areas of treated skin surfaces are calculated for each subject in advance of the application. Applications of the test materials are made at various concentrations. Positive control subjects are treated with Ultrathon™ and Treo™ at the recommended concentrations.

Each test subject records the number of bites received by ceratopogonid biting flies on treated or control surfaces during sequential sampling periods that begin every 10 minutes, with the overall test duration being approximately 1 hour.

### Example 24

### Repellent Effect Against Aedes vexans

Tests are conducted in the outdoors in an area where the predominant species of mosquito is Aedes vexans, an aggressive biting insect. Tests are performed in the summer months in the early afternoon (1430-1630 hours, Test 1) and in the late afternoon/early evening (1515-1915 hours, Test 2). In two separate tests, four subjects in total apply a test composition to one lower arm. The other lower arm of each subject is untreated and serves as a control. Total mosquito bites are counted and the resulting data is analyzed.

### Example 25

### Repellent Effect Against Musca domestica L. (Diptera:Muscidae)

A study is conducted to evaluate the efficacy of candles (designated as “A”, “B” and “C”) containing test compositions in repelling house flies.

Candle “A” contains 95% Paraffin Wax and 5% of a test composition.

Candle “B” contains 90% Paraffin Wax and 10% of a test composition.

Candle “C” contains only Paraffin Wax.

The evaluation is conducted in a 28.3 cubic meter chamber with airing ports. A screened cage measuring 15 cm×15 cm×47.5 cm is attached inside an upper airing port, and a screened repellency observation cage measuring 15 cm×15 cm×32.5 cm is attached outside the upper airing port. The two cages are held together by a Masonite plate that fits firmly in the airing port. A 4 cm hole located in the center of each Masonite plate provides an escape for the test insects. A barrier is used to close the hole.

A caged mouse is used as an attractant and is placed inside the chamber in the larger section of the repellency cage. Musca domestica L. (adult house flies) are used as test insects.

The candles are allowed to burn for 20 minutes and the number of house flies and mosquitoes repelled is recorded for the next 60 minutes with the following equipment and procedure.

For each replicate, 75 to 100 adult house flies are removed from the rearing cage by means of a vacuum aspirator, and transferred by carbon dioxide anesthesia to the inner cage containing the mouse. The assembled cage is placed in one of the upper ventilation ports of the chamber. For each experimental situation the test insects are transferred to a clean cage containing the mouse. A house fly candle is placed centrally on the chamber floor and burned for 20 minutes before initiating the repellency counts. The maximum period for the repellency counts is 60 minutes. The first repellency count is made at 10 minutes after the burning ends, and subsequent counts are taken at 5-minute intervals thereafter. The number of house flies repelled are those escaping to the outside cage. For the control, counts are made in a similar manner, but no candle is burned.

The same three candles are used for all four replicates. Between replicates the chamber is exhausted, the Kraft paper flooring for the chamber is replaced, and the two screened repellency cages are submerged in hot detergent water, rinsed and dried.

### Example 26

### Metamorphosis Inhibition Effect Against Nilaparvata lugens

Test compositions are provided at appropriate concentrations. Compositions are sprayed onto rice plants cultivated in polyethylene cups at a rate of 20 ml per every 2 pots on a turning table. After air-drying, the plants are infested with about ten 3rd instar nymphs of Nilaparvata lugens (brown rice planthopper). After 10 days, the number of normal adults is counted to obtain an emergence inhibitory rate.

### Example 27

### Reproduction Inhibition Effect Against Nephotettix cincticeps

Test compositions are provided at appropriate concentrations. Compositions are sprayed onto rice plants (about 20 cm in height) cultivated in plastic pots at a rate of 40 ml per every 2 pots on a turning table. After air-drying, the pots are covered with wire cages, and 10 male and 10 female adults of Nephotettix cincticeps (green rice leafhopper) are released in each of the cages. After 3 weeks, the number of nymphs is counted to obtain a reproduction inhibitory rate.

### Example 28

### Reproduction Inhibition Effect Against Nilaparvata lugens

Test compositions are provided at appropriate concentrations. Compositions are sprayed onto rice plants (about 20 cm in height) cultivated in plastic pots at a rate of 40 ml per every 2 pots on a turning table. After air-drying, the pots are covered with wire cages, and each 5 female and male adults of brown rice planthopper (Nilaparvata lugens) are released in each of the cages. After 3 weeks, the number of nymphae are counted to obtain a reproduction inhibitory rate.

### Example 29

### Repellent Effect Against Mosquitos

The tendency of mosquitoes to rest upon cloth surfaces when not feeding is used to evaluate the insect repellency of test compounds. Lab-bred mosquito pupae are transferred to test chambers prepared from cardboard boxes (45 cm×30 cm×30 cm). To permit observation and allow for ventilation, the top of box is removed and covered with mosquito netting. Access to the interior of the chamber is provided by two holes (10 cm diameter) cut into the front face of the box and covered with mosquito netting. The inner surface of the chambers is lined with muslin cloth that serves as the resting surface for the mosquitos.

To measure the repellency of the test compounds and mixture thereof, two opposing walls of the experimental chambers are treated with solvent and the remaining two walls are treated with test compounds or DEET, either alone or as a mixture. The test compounds are applied uniformly over the cardboard surface. After drying for four hours, 100 mosquitoes are introduced into the test chamber. An observer notes at appropriate times the location of the resting mosquitoes. Repellent effect is defined as the length of time before mosquitoes began resting on the repellent treated surface (i.e., days of 100% repellency).

### Example 30

### Repellent Effect Against Flies

To measure the efficacy of the test compositions as fly repellents, vinyl floor tiles (25 cm²) are treated uniformly with either 2 ml solvent or 2 ml test composition or mixtures of MNDA or DEET dissolved in isopropyl alcohol to yield a final concentration of 2%. The tiles are placed onto a glass plate located inside test chambers identical to those used to measure mosquito repellency. A food source in a small dish is placed on top of each tile. The experiment is initiated by introducing 100 flies into the test chamber. An observer notes at appropriate times the feeding location of the flies. Repellent effect is defined as the length of time the flies stay away from the tile treated with the repellent compound(s).

### Example 31

### Pesticidal Effect Against Spodoptera littoralis, Dysdercus Fasciatus and Heliothis virescens

Cotton plants are sprayed with appropriate concentrations of a test compound. After drying of the coating, larvae of the species Spodoptera littoralis (L3 stage), Dysdercus fasciatus (L4) and Heliothis virescens (L3), respectively, are settled on the plants. Two plants are used for each test compound and for each test species, and an assessment of the destruction of larvae is made 2, 4, 24 and 48 hours after commencement of the test. The tests are carried out at 24 C with 60% relative humidity. Total insect mortality is recorded.

### Example 32

### Pesticidal Effect Against Myzus Persicae

Plants (Vicia fabae) grown in water are each infested, before the commencement of the test, with about 200 individuals of the species Myzus persicae. Three days later, the plants treated in this manner are sprayed from a distance of 30 cm until dripping wet with a solution containing 10 and 1 ppm, respectively, of the compound to be tested. Two plants are used for each test compound and for each concentration, and an evaluation of the attained degree of destruction of the insects is made after a further 24 hours.

### Example 33

### Pesticidal Effect Against Aphis craccivora

Rooted bean plants are transplanted into pots containing 600 cc of soil, and subsequently 50 ml of a solution of the test composition at an appropriate concentration is poured directly onto the soil. After 24 hours, lice of the species Aphis craccivora are settled onto the parts of the plants above the soil, and a plastic cylinder is placed over each plant in order to protect the lice from a possible contact or gas effect of the test composition. Evaluation of the lice viability is made 24 and 48 hours after commencement of the test. Two plants, each in a separate pot, are used for each concentration dose of test composition. The test is carried out at 25 C with 70% relative humidity.

### Example 34

### Pesticidal Effect Against Aulocara elliotti

Grasshoppers (Aulocara elliotti (Thomas)) are collected as nymphs and as young adults at a wild population site and divided into groups with three pairs of nymphs maintained per cage until they become adults. The adults are separated, one pair to a cage and are maintained under hot temperatures that fluctuate diurnally from 24 C-29.5 C. The growing host plant, western wheatgrass, is transplanted from a field site onto tables in a greenhouse where it is maintained under hot temperatures that alternate diurnally from 24 C-29.5 C.

Twice each week grasshopper pairs are fed the greenhouse grass that is freshly cut on the morning of the feeding day and then treated with a test composition prepared according to the present invention. The feedings are continued until all grasshoppers are dead. The number of eggs laid and the number of viable eggs are recorded throughout the lifetime of each female grasshopper.

The freshly cut greenhouse grass is treated with the test composition by dipping the grass leaves in the composition and then letting the cut ends stand in the same solution for about 4 hours. Individual feeding vials are assembled by wrapping cut grass with a urethane foam strip about one inch in diameter and then fitting the bundle of cut grass into a plastic pill vial. The cut grass is then watered with the test composition, and as this composition evaporates or is taken up by the grass, the vial is rewatered with distilled water. These conditions are maintained throughout the lifetime of each female grasshopper.

### Example 35

### Aerial Application of Insect Control Compositions

Aerial application platforms (helicopters and fixed wing) are used to apply appropriate concentrations of insect control compositions. Applications are made uniformly over the entire crop, ensuring that the aircraft is utilizing the optimum swath width. Areas that cannot be effectively treated by aircraft are not planted. The optimum application height for the composition is determined by methods known in the art and then utilized; turbine aircraft are generally operated with the spray boom 10-12 feet above the crop canopy. Other release heights may reduce pattern uniformity and increase drift potential.

Spraying during the heat of the day is avoided if possible; as more radiant energy is absorbed into the crop canopy, it becomes more difficult to pass the smaller droplets through the strong micro-inversion layer that forms at the top of the crop.

Appropriate spray nozzles are determined by methods known in the art and then utilized; nozzles that make as few droplets as possible below 200μ (microns) are often preferred. Droplet spectrums should be targeted in the 285-335 VMD (volumetric median diameter—where ½ of the spray volume is that size or larger and ½ of the spray volume is that size or smaller) range. Droplet spectrum is an important aspect of these applications and should be carefully adjusted with nozzle selection, operating pressure and mounting configuration. Software models are available to help determine the expected droplet spectrum.

Almost all applications can be enhanced with wind, particularly application crosswinds, to help mix the material down into the lower portions of the canopy. Turbine powered, faster aircraft, generally have more uniform patterns, though it may be more difficult for faster aircraft to work around some obstructions. Total spray volume per acre will be somewhat dependent on crop canopy structure. The use of adjuvants and surfactants may be beneficial as spreaders and stickers. Care should be taken to avoid major droplet spectrum changes when these products are being utilized. If multiple applications are made, utilize different travel lanes or go in the opposite direction to move droplets into the canopy at different angles.

### Example 36

### Composition Effect on Insect Mortality

A formulation containing 0.75% of Blend 24 (also designated B-5001) and 1.4 ounces of Deltamethrin per gallon (7 ounces of Deltamethrin per planted acre) is prepared (“Combined Formulation A”). Cotton plants of variety DPL555RRBR are planted in an outdoor field in a location suitable for cotton cultivation. The formulation is applied to the plants by spraying, using a backpack system employing TSX-8 cones at a nozzle pressure of 60 psi. Three applications of the formulation are made, at 9, 16, and 23 days post-planting. The temperature during these applications is between 80 and 100 degrees Fahrenheit. 5 gallons of the formulation are applied per acre. For comparison purposes, three other formulations are applied in a similar manner to cotton plants of the same variety planted at the same location and under the same conditions. The first formulation contains, as its active ingredient, only 0.75% of Blend 24 (“Blend 24 Formulation A”), the second formulation contains only 1.4 ounces of Deltamethrin per gallon (i.e., 7 ounces of Deltamethrin per acre) (“Deltamethrin Formulation A”), and the third formulation contains 1.24 ounces per gallon of the commercial insecticide Provado® (i.e., 6.2 ounces of Provado® per acre) (“Provado® Formulation A;” active ingredient: imidacloprid, 1-[(6-Chloro-3-pyridinyl)methyl]-N-nitro-2-imidazolidinimine) available from Bayer CropScience (Research Triangle Park, N.C.). Furthermore, no formulation is applied to control plants.

The presence of Western flower thrip (Frankliniella occidentis) adults and nymphs on the plant leaves is assessed at, for example, 10 days and 17 days post-planting. Feeding damage is assessed at 10 days post-planting. Tobacco thrips, if also present, are not segregated.

At any of these points, or after one, two, or three applications of each formulation, plants to which Combined Formulation A was applied exhibit an F. occidentis adult or nymph count that is significantly lower than that of plants treated with Blend 24 Formulation A, Deltamethrin Formulation A, or Provado® Formulation A. The feeding damage observed at 10 days after planting is also lower for the plants treated with Combined Formulation A than for those treated with Blend 24 Formulation A, Deltamethrin Formulation A, or Provado® Formulation A.

Furthermore, the presence of cotton aphid (Aphis gossypii) adults or nymphs on the plant leaves is assessed at, for example, 17 days and 24 days post-planting.

At either of these points, or after one, two, or three applications of each formulation, the plants treated with Combined Formulation A exhibit an A. gossypii adult or nymph count that is significantly lower than that of plants treated with Blend 24 Formulation A, Deltamethrin Formulation A, or Provado® Formulation A.

### Example 37

### Composition Effect on Insect Mortality

Combined Formulation A, Blend 24 Formulation A, Deltamethrin Formulation A, and Provado® Formulation A are prepared as described above. Cotton plants of variety DPL555RRBR are planted in an outdoor field in a location suitable for cotton cultivation. The formulations are applied to the plants by spraying, using a backpack system employing TSX-8 cones at a nozzle pressure of 60 psi. Two applications of the formulation are made, at 76 and 84 days post-planting. The temperature during these applications is within a range of 80-100 degrees Fahrenheit. 5 gallons of the formulations are applied per acre.

The presence of cotton aphids (Aphis gossypii) adults and nymphs on the plant leaves is assessed at 84, 91, and 98 days post-planting. At any of these points, or after one or two or more applications of each formulation, plants to which Combined Formulation A was applied exhibit an A. gossypii adult or nymph count that is significantly lower than that of plants treated with Blend 24 Formulation A, Deltamethrin Formulation A, or Provado® Formulation A.

Furthermore, the presence of whitefly (Bemisia tabaci) adults and nymphs on the plant leaves is assessed at 91 days and 98 days post-planting. At any of these points, or after one or two or more applications of each formulation, plants to which Combined Formulation A was applied exhibit an B. tabaci adult or nymph count that is significantly lower than that of plants treated with Blend 24 Formulation A, Deltamethrin Formulation A, or Provado® Formulation A.

### Example 38

### Composition Effect on Insect Mortality

A formulation containing 0.75% of Blend 24 (also designated B-5001) and 0.35 ounces of Deltamethrin per gallon (7 ounces of Deltamethrin per planted acre) is prepared (“Combined Formulation B”). Zucchini plants, variety “Yellow Crook Neck,” are planted in an outdoor field in a location suitable for zucchini cultivation. Four replications are undertaken. The formulation is applied to the plants by spraying, using a backpack system employing XR8002 nozzles at a nozzle pressure of 42 psi. Three applications of the formulation are made, at 17, 24, and 31 days post-planting. The temperature during these applications is within a range of 80-100 degrees Fahrenheit. 20 gallons of the formulation are applied per acre. For comparison purposes, three other formulations are applied in a similar manner to zucchini plants of the same variety planted at the same location and under the same conditions. The first formulation contains, as its active ingredient, only 0.75% of Blend 24 (“Blend 24 Formulation B”), the second formulation contains only 0.35 ounces of Deltamethrin per gallon (i.e., 7 ounces of Deltamethrin per acre) (“Deltamethrin Formulation B”), and the third formulation contains 0.31 ounces per gallon of the commercial insecticide Provado® (i.e., 6.2 ounces of Provado® per acre) (“Provado® Formulation B;” active ingredient: imidacloprid, 1-[(6-Chloro-3-pyridinyl)methyl]-N-nitro-2-imidazolidinimine) available from Bayer CropScience (Research Triangle Park, N.C.). Furthermore, no formulation is applied to control plants.

None of the formulations show significant phytotoxicity at 24 or 33 days after planting, although formulations containing higher concentrations of either Blend 24 or Blend 5 (1.5% and 3.0%) do show phytotoxicity at these points.

Damage to the plants from leaf miners (Liriomyza sp.) is assessed at 24 days and 32 days post-planting. At either of these points, or after one or two or more applications of each formulation, plants treated with Combined Formulation B exhibit significantly less damage from leaf miners than plants treated with Blend 24 Formulation B, Deltamethrin Formulation B, or Provado® Formulation B.

The severity of powdery mildew (Erysiphe sp.) in the treated plants is assessed at, for example, 24 days after planting. At this point, or after one or two or more applications of each formulation, the severity is significantly lower in the plants treated with Combined Formulation B than in plants treated with Blend 24 Formulation B, Deltamethrin Formulation B, or Provado® Formulation B.

The presence of whitefly (Bemisia tabaci) adults and nymphs on the plant leaves is assessed at 24 days and 32 days post-planting. At either of these points, or after one or two or more applications of each formulation, the plants treated with Combined Formulation B exhibit a B. tabaci adult or nymph count that is significantly lower than that in the plants treated with Blend 24 Formulation B, Deltamethrin Formulation B, or Provado® Formulation B.

### Example 39

### Composition Effect on Insect Mortality

A formulation containing 0.75% of Blend 24 (also designated B-5001) and 0.093 ounces of Deltamethrin per gallon (7 ounces of Deltamethrin per planted acre) is prepared (“Combined Formulation C”). Tomato plants, variety FL-47, are planted in an outdoor field in a location suitable for tomato cultivation. 4 replications are undertaken. The formulation is applied to the plants by spraying, using a backpack system employing a disk cone at a nozzle pressure of 42 psi. Five applications of the formulation are made, at 2 days pre-planting, and 8, 14, 21, and 28 days post-planting. The temperature during these applications is within a range of 80-100 degrees Fahrenheit. 75 gallons of the formulation are applied per acre. For comparison purposes, three other formulations are applied in a similar manner to tomato plants of the same variety planted at the same location and under the same conditions. The first formulation contains, as its active ingredient, only 0.75% of Blend 24 (“Blend 24 Formulation C”), the second contains only 0.093 ounces of Deltamethrin per gallon (i.e., 7 ounces of Deltamethrin per acre) (“Deltamethrin Formulation C”), and the third contains 0.0826 ounces per gallon of the commercial insecticide Provado® (i.e., 6.2 ounces of Provado® per acre) (“Provado® Formulation C;” active ingredient: imidacloprid, 1-[(6-Chloro-3-pyridinyl)methyl]-N-nitro-2-imidazolidinimine) available from Bayer CropScience (Research Triangle Park, N.C.). Furthermore, no formulation is applied to control plants.

The presence of Western flower thrip (Frankliniella occidentis) adults and nymphs on the plant leaves is assessed at 28 days and 35 days post-planting. At either of these points, or after one or two or more applications of each formulation, the F. occidentis adult or nymph counts are significantly lower in the plants treated with Combined Formulation C than in plants treated with Blend 24 Formulation C, Deltamethrin Formulation C, or Provado® Formulation C.

Furthermore, the presence of sweet potato whitefly (Bemisia inconspicua) adults and nymphs on the plant leaves is assessed at 8, 14, 21, 28, and 35 days post-planting. At one or more of these points, or after one or two or more applications of each formulation, the B. inconspicua adult or nymph counts are significantly lower in the plants treated with Combined Formulation C than in plants treated with Blend 24 Formulation C, Deltamethrin Formulation C, or Provado® Formulation C.

### Example 40

### Composition Effect on Insect Mortality

Combined Formulation B, Blend 24 Formulation B, Deltamethrin Formulation B, and Provado® Formulation B are prepared as described above. Soybean plants, variety “Pritchard,” are planted in an outdoor field in a location suitable for soybean cultivation. 4 replications are conducted. Each formulation is applied to the plants by spraying, using a backpack system employing XR8002 nozzles at a nozzle pressure of 42 psi. Four applications of the formulations are made, at 83, 90, 97, and 111 days post-planting. The temperature during these applications is between 80 and 100 degrees Fahrenheit. 20 gallons of the formulation are applied per acre. The presence of cotton aphids (Aphis gossypii) adults and nymphs on the plant leaves is assessed at 90, 97, 111, 118, and 125 days post-planting. At one or more of these points, or after one or two or more applications of each formulation, the A. gossypii adult or nymph counts are significantly lower in the plants treated with Combined Formulation B than in plants treated with Blend 24 Formulation B, Deltamethrin Formulation B, or Provado® Formulation B.

### Example 41

### Composition Effect on Insect Mortality

A granular formulation containing 1% of Blend 41 (also designated B-5028) and a standard amount of the commercial insecticide Aloft™ (active ingredients: bifenthrin and clothinanidin, available from Arysta LifeScience, Cary N.C.) is prepared (“Combined Formulation D”). Field tests are conducted on turf growing in an outdoor field. The formulation is applied to the turf either by hand sprinkling or by using a disk cone at 131 gpa and a pressure of 25 psi. Irrigation equivalent to one-half inch rain is immediately incorporated after sprinkling One application of the formulation is made, at a temperature of 94 degrees Fahrenheit, at 50% relative humidity, and at a soil temperature of 88 degrees Fahrenheit. For comparison purposes, three other formulations are applied in a similar manner to turf of the same variety under the same conditions. The first formulation contains, as its active ingredient, only 1% granular Blend 41 (“Blend 41 Formulation D”), the second contains only the standard amount of Aloft™ (“Aloft™ Formulation D”), and the third contains 21b/acre of the commercial insecticide Merit® (“Merit® formulation D;” active ingredient: 0.5% imidacloprid, 1-[(6-Chloro-3-pyridinyl)methyl]-N-nitro-2-imidazolidinimine) available from Bayer CropScience (Research Triangle Park, N.C.). Furthermore, no formulation is applied to control turf.

The presence of Japanese beetles (Popalli japonica) is assessed at 51 days after application of the formulations. At one or more of these points, or after one or two or more applications of each formulation, turf treated with Combined Formulation D exhibits a P. japonica count that is significantly lower than the count obtained from turf treated with Blend 41 Formulation D, Aloft™ Formulation D, or Merit® Formulation D.

Additionally, single active ingredients such as essential oils may be combined with pest control chemicals such as those listed above to produce synergistic or additive effects, as in the following examples.

### Example 42

### Preparation of Stably Transfected Schneider Cell Lines with Tyramine Receptor (TyrR)

A. PCR Amplification and Subcloning Drosophila melanogaster Tyramine Receptor.

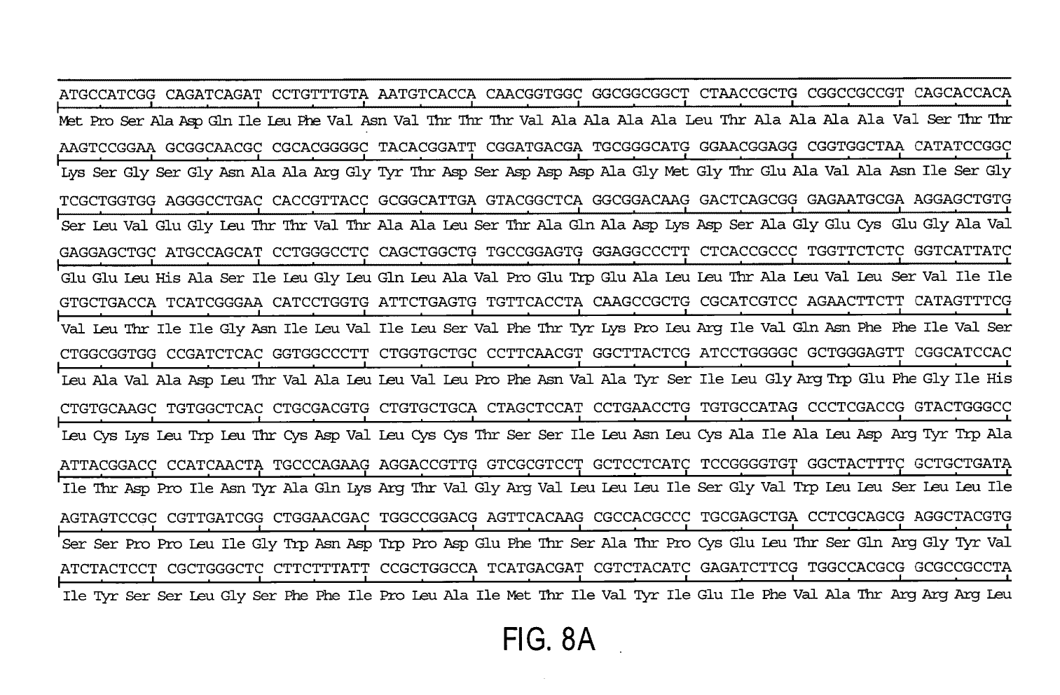

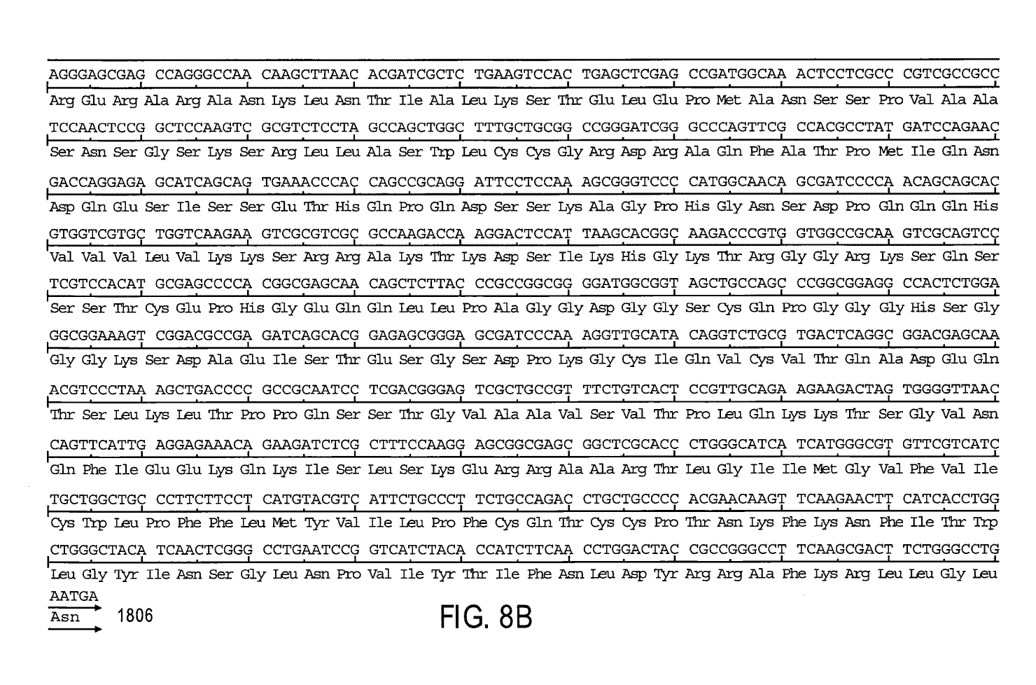

Tyramine receptor is amplified from Drosophila melanogaster head cDNA phage library GH that is obtained through the Berkeley Drosophila Genome Project (Baumann, A., 1999, Drosophila melanogaster mRNA for octopamine receptor, splice variant 1B NCBI direct submission, Accession AJ007617). The nucleic acid sequence and the peptide sequence of TyrR are set forth in FIGS. 8A and 8B. Phage DNA is purified from this library using a liquid culture lysate. (Baxter, et al., 1999, Insect Biochem Mol Biol 29, 461-467). Briefly, oligonucleotides that are used to amplify the open reading frame of the Drosophila tyramine receptor (TyrR) (Han, et al., 1998, J Neurosci 18, 3650-3658; von Nickisch-Rosenegk, et al., 1996. Insect Biochem Mol Biol 26, 817-827) consist of the 5′ oligonucleotide: 5′ gccgaattcgccaccATGCCATCGGCAGATCAGATCCTG 3′ and 3′ oligonucleotide: 5′ taatctagaTCAATTCAGGCCCAGAAGTCGCTTG 3′. Capitalized letters match the tyramine receptor sequence. An added Kozak sequence (Grosmaitre, X., Jacquin-Joly, E., 2001 Mamestra brassicae putative octopamine receptor (OAR) mRNA, complete cds. NCBI direct submission, Accession AF43878) is indicated by underlined nucleotides. The 5′ oligonucleotide also contains an EcoR I site and the 3′ oligonucleotide a Xba I site. The PCR is performed using Vent polymerase (New England Biolabs) with the following conditions: about 95° C., about 5 min for about 1 cycle; about 95° C., about 30 sec; and about 70° C., about 90 sec for about 40 cycles and about 70° C., about 10 min for about 1 cycle.

The PCR product is digested with EcoR I and Xba I, subcloned into pcDNA 3 (Invitrogen) and sequenced on both strands by automated DNA sequencing (Vanderbilt Cancer Center). When this open reading frame is translated to protein, it is found to correctly match the published tyramine receptor sequence (Saudou, et al., The EMBO Journal vol 9 no 1, 6-617). For expression in Drosophila Schneider cells, the TyrR ORF is excised from pcDNA3 and inserted into pAC5.1/V5-His(B) [pAc5(B)] using the Eco RI and Xba I restriction sites.

For transfection, Drosophila Schneider cells are stably transfected with pAc5(B)-TyrR ORF using the calcium phosphate-DNA coprecipitation protocol as described by Invitrogen Drosophila Expression System (DES) manual. The precipitation protocol is the same for either transient or stable transfection except for the use of an antibiotic resistant plasmid for stable transfection. At least about ten clones of stably transfected cells are selected and separately propagated. Stable clones expressing the receptors are selected by whole cell binding/uptake using ³H-tyramine. For this assay, cells are washed and collected in insect saline (170 mM NaCl, 6 mM KCl, 2 mM NaHCO₃, 17 mM glucose, 6 mM NaH₂PO₄, 2 mM CaCl₂, and 4 mM MgCl₂). About 3 million cells in about 1 mL insect saline are incubated with about 4 nM ³H-tyramine at about 23° C. for about 5 minutes. Cells are centrifuged for about 30 seconds and the binding solution is aspirated. The cell pellets are washed with about 5004 insect saline and the cells are resuspended and transferred to scintillation fluid. Nonspecific binding is determined by including about 50 μM unlabeled-tyramine in the reaction. Binding is quantified counting radioactivity using a using a Liquid Scintillation β-counter (Beckman, Model LS1801).

B. Selection of Clones Having the Highest Level of Functionally Active Tyramine Receptor Protein.

Tyramine receptor binding/uptake is performed to determine which of the transfected clones have the highest levels of functionally active tyramine receptor protein. There are about 10 clonal lines for tyramine receptor and about 2 pAc(B) for control. ³H-tyramine (about 4 nM/reaction) is used as a tracer, with and without about 50 μM unlabeled tyramine as a specific competitor. For this assay, cells are grown in plates and are collected in about 3 ml of medium for cell counting and the number of cells is adjusted to about 3×10⁶ cells/ml. About two pAcB clones are used in parallel as controls. About 1 ml cell suspension is used per reaction. Based on specific binding, about 3 clones express a high level of active tyramine receptor protein. The clone having the highest specific tyramine receptor binding (about 90%), is selected for further studies. The selected clone is propagated and stored in liquid nitrogen. Aliquot of the selected clone are grown for whole cell binding and for plasma membrane preparation for kinetic and screening studies. The control pAcB does not demonstrate any specific binding for the tyramine receptor.

C. Efficacy of Schneider Cells Transfected with Tyramine Receptor for Screening Compositions for Tyramine Receptor Interaction.

Cells transfected with the tyramine receptor (about 1×10⁶ cells/ml) are cultured in each well of a multi-well plate. About 24 hours after plating the cells, the medium is withdrawn and replaced with about 1 ml insect saline (about 23 C). Different concentrations of ³H-tyramine (about 0.1-10 nM) are added with and without about 10 μM unlabeled tyramine and incubated at room temperature (RT). After about a 20 minute incubation, the reaction is stopped by rapid aspiration of the saline and at least one wash with about 2 ml insect saline (about 23 C). Cells are solubilized in about 300 μl 0.3M NaOH for about 20 min at RT. Solubilized cells are transferred into about 4 ml Liquid Scintillation Solution (LSS) and vigorously vortexed for about 30 sec before counting the radioactivity using a Liquid Scintillation β-counter (Beckman, Model LS1801) (LSC).

Receptor specific binding data is expressed as fmol specific binding per 1×10⁶ cells and measured as a function of ³H-tyramine concentration. Specific binding values are calculated as the difference between values in the absence of and values in the presence of about 10 μM unlabeled tyramine. The maximum specific binding occurs at about 5 nM ³H-tyramine. Untransfected cells do not respond to tyramine at concentrations as high as about 100 μM.

To study the kinetics of the tyramine receptor in stably transfected cells with pAcB-TyrR, crude membrane fractions are prepared from the transfected cells and used to calculate the equilibrium dissociation constant (K_{d}), Maximum Binding Capacity (Bₘₐₓ), equilibrium inhibitor dissociation constant (Kᵢ) and EC₅₀ (effective concentration at which binding is inhibited by 50%). A preliminary study to determine the optimum concentration of membrane protein for receptor binding activity is performed. In this study, different concentrations of protein (about 10-50 μg/reaction) are incubated in about 1 ml binding buffer (50 mM Tris, pH 7.4, 5 mM MgCl₂ and 2 mM ascorbic acid). The reaction is initiated by the addition of about 5 nM ³H-tyramine with and without about 10 μM unlabeled tyramine. After about 1 hr incubation at room temperature, reactions are terminated by filtration through GF/C filters (VWR), which have been previously soaked in about 0.3% polyethyleneimine (PEI). The filters are washed one time with about 4 ml ice cold Tris buffer and air dried before the retained radioactivity is measured using LSC. Binding data is analyzed by curve fitting (GraphPad software, Prism). The data demonstrates no differences between about 10, 20, 30 and 50 μg protein/reaction in tyramine receptor specific binding. Therefore, about 10 μg protein/reaction is used.

To determine Bₘₐₓ and K_{d} values for tyramine receptor (TyrR) in membranes expressing TyrR, saturation binding experiments are performed. Briefly, about 10 μg protein is incubated with ³H-tyramine at a range of concentrations (about 0.2-20 nM). Binding data is analyzed by curve fitting (GraphPad software, Prism) and the K_{d} for tyramine binding to its receptor is determined.

To determine the affinities of several ligands for TyrR, increasing concentration of several compounds are tested for their ability to inhibit binding of about 2 nM ³H-tyramine. For both saturation and inhibition assays total and non-specific binding is determined in the absence and presence of about 10 μM unlabeled-tyramine, respectively. Receptor binding reactions are incubated for about 1 hour at room temperature (RT) in restricted light. Reactions are terminated by filtration through GF/C filters (VWR), which have been previously soaked in about 0.3% polyethyleneimine (PEI). The filters are washed one time with about 4 ml ice cold Tris buffer and air dried before retained radioactivity is measured using LSC. Binding data is analyzed by curve fitting (GraphPad software, Prism).

In a saturation binding curve of ³H-tyramine (³H-TA) to membranes prepared from Schneider cells expressing tyramine receptor, ³H-tyramine has a high affinity to tyramine receptor in the stably transfected cells with pAcB-TyrR with K_{d} determined to be about 1.257 nM and Bₘₐₓ determined to be about 0.679 pmol/mg protein.

In inhibition binding of ³H-tyramine (³H-TA) to membranes prepared from Schneider cells expressing tyramine receptor in the presence and absence of various concentrations of unlabeled tyramine (TA), the EC₅₀ and the Kᵢ for tyramine against its receptor in Schneider cells expressing tyramine receptor are about 0.331 μM and 0.127 μM, respectively.

In order to determine the pharmacological profile of tyramine receptor (TyrR), the ability of a number of putative Drosophila neurotransmitters to displace ³H-tyramine (³H-TA) binding from membranes expressing tyramine receptor is tested. In inhibition binding of ³H-Tyramine to membranes prepared from Schneider cells expressing tyramine receptor in the presence and absence of different concentrations of unlabeled ligands (including Tyramine (TA), Octopamine (OA), Dopamine (DA), and Serotonin (SE)), tyramine displays the highest affinity (Kᵢ of about 0.127 μM, EC₅₀ of about 0.305 μM) for the Drosophila TyrR. Octopamine, dopamine and serotonin were less efficient than tyramine at displacing ³H-tyramine binding.

With respect to the Kᵢ and EC₅₀ of the ligands, the rank order of potency is as follows: tyramine>octopamine>dopamine>serotonin, showing the likelihood that the stably transfected Schneider cells are expressing a functionally active tyramine receptor.

As such, Schneider cells expressing tyramine receptor are effective as a model for studies and screening for compositions that interact with the tyramine receptor.

### Example 43

### In Vitro Calcium Mobilization Effects of a Combination of Thyme Oil and Imidacloprid

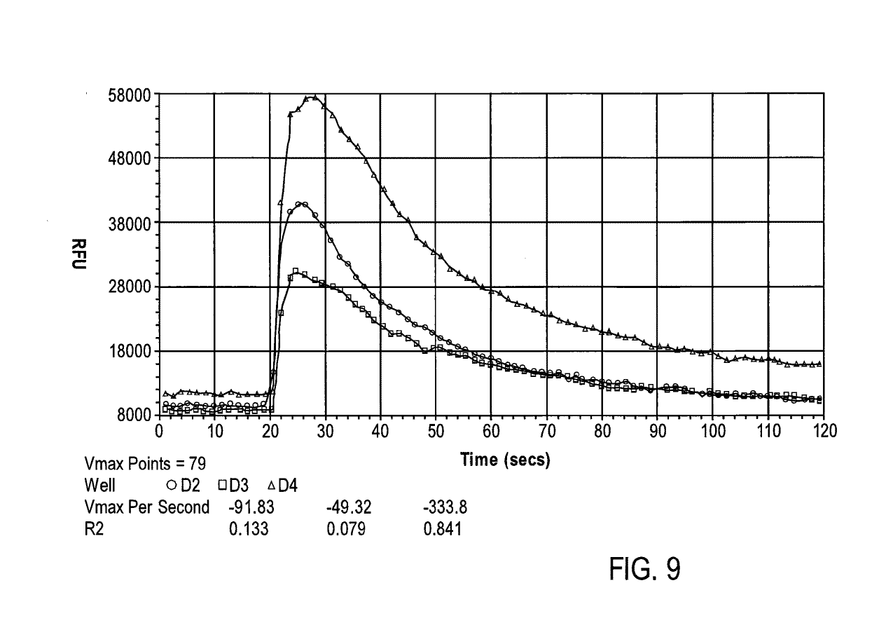

A Schneider cell line was produced that expressed a cell-surface tyramine receptor of Drosophila melanogaster, as described above. Cells of this line were exposed to three different compositions. The first composition contained imidacloprid at 1 mg/ml. The second solution contained thyme oil at 1 mg/ml. The third composition contained an approximately 50/50 mixture of imidacloprid and thyme oil, with the mixture contained at a concentration of 1 mg/ml. The results of this screening procedure are shown in FIG. 9 as fluorescence intensity curves corresponding to intracellular calcium ion concentrations. In FIG. 9, the curve corresponding to the composition containing the mixture of imidacloprid and thyme oil is indicated by triangles, the curve corresponding to the composition containing the thyme oil alone is indicated by circles, and the curve corresponding to the composition containing imidacloprid alone is indicated by squares. These curves may be obtained by the following method.

Intracellular calcium ion concentrations ([Ca²⁺]i) are measured by using the acetoxymethyl (AM) ester of the fluorescent indicator fura-2 (Enan, et al., Biochem. Pharmacol. vol 51, 447-454). Cells expressing the tyramine receptor are grown under standard conditions. A cell suspension is prepared in assay buffer (140 mM NaCl, 10 mM HEPES, 10 mM glucose, 5 mM KCl, 1 mM CaCl₂, 1 mM MgCl2) and the cell number is adjusted to about 2×10⁶ cells per ml. Briefly, about 1.0 ml cell suspension (about 2×10⁶ cells) is incubated with about 5 μM fura 2/AM for about 30 min at about 28° C. After incubation, the cells are pelleted at about 3700 rpm for about 10 sec at room temperature and then resuspended in about 1.5 ml assay buffer. [Ca²⁺]i changes are analyzed in a spectrofluorometer in the presence and absence of test chemicals. Excitation wave lengths are about 340 nm (generated by Ca²⁺-bound fura-2) and about 380 nm (corresponding to Ca²⁺-free fura-2). The fluorescence intensity is monitored at an emission wave length of about 510 nm. No absorbance of fluorescence artifacts are observed with any of the compounds used. The ratio of about 340/380 nm is calculated and plotted as a function of time.

As shown in FIG. 9, the composition containing the mixture of imidacloprid and thyme oil exhibited a much higher peak intensity and Vₘₐₓ per second than the compositions containing either of the ingredients alone. This demonstrates that imidacloprid and thyme oil act synergistically in this cell system to affect intracellular calcium ion concentrations.

This combination of ingredients, when applied to a pest expressing the tyramine receptor, also acts synergistically to control the pest.

### Example 44

### In Vitro Calcium Mobilization Effects of a Combination of Thyme Oil and Fluoxastrobin

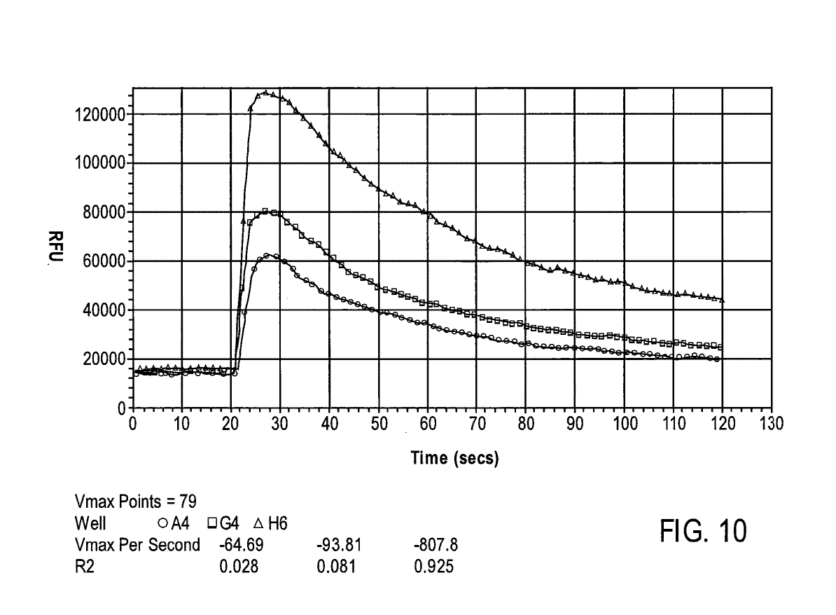

A Schneider cell line was produced that expressed a cell-surface tyramine receptor of Drosophila melanogaster, as described above. Cells of this line were exposed to three different compositions. The first composition contained fluoxastrobin at 1 mg/ml. The second solution contained thyme oil at 1 mg/ml. The third composition contained an approximately 50/50 mixture of fluoxastrobin and thyme oil, with the mixture contained at a concentration of 1 mg/ml. The results of this screening procedure are shown in FIG. 10 as fluorescence intensity curves corresponding to intracellular calcium ion concentrations. In FIG. 10, the curve corresponding to the composition containing the mixture of fluoxastrobin and thyme oil is indicated by triangles, the curve corresponding to the composition containing the thyme oil alone is indicated by squares, and the curve corresponding to the composition containing fluoxastrobin alone is indicated by circles. These curves may be obtained by the method described above.

As shown in FIG. 10, the composition containing the mixture of fluoxastrobin and thyme oil exhibited a much higher peak intensity and Vₘₐₓ per second than the compositions containing either of the ingredients alone. This demonstrates that fluoxastrobin and thyme oil act synergistically in this cell system to affect intracellular calcium ion concentrations.

This combination of ingredients, when applied to a pest expressing the tyramine receptor, also acts synergistically to control the pest.

One of ordinary skill in the art will recognize that modifications and variations are possible without departing from the teachings of the invention. This description, and particularly the specific details of the exemplary embodiments disclosed, is provided primarily for clearness of understanding and no unnecessary limitations are to be understood therefrom, for modifications and other embodiments will become evident to those skilled in the art upon reading this disclosure and can be made without departing from the spirit or scope of the claimed invention.

What is claimed is:

1. A composition for controlling a target pest comprising a pest control product and at least one active agent, wherein:
the active agent is capable of interacting with a receptor in the target pest;
the pest control product has a first activity against the target pest when applied without the active agent and the composition has a second activity against the target pest; and
the second activity is greater than the first activity.

2. The composition of claim 1, wherein the first and second activities are quantified by measuring concentration of the pest control product effective to control the target pest, and a concentration corresponding to the first activity is higher than a concentration corresponding to the second activity.

3. The composition of claim 1, wherein the first and second activities are quantified by measuring disablement effect of the target pest at a standard concentration of pest control product, and the composition exhibits a greater disablement effect than the pest control product applied without the active agent.

4. The composition of claim 1, wherein the first activity persists for a first period, the second activity persists for a second period, and the second period is longer than the first period.

5. The composition of claim 1, wherein the second activity reflects a synergistic interaction of the active agent and the pest control product.

6. The composition of claim 1, wherein the target pest is selected from the group comprising: a fungus, a plant, an animal, a moneran, and a protist.

7. The composition of claim 6, wherein the target pest is an arthropod species.

8. The composition of claim 7, wherein the arthropod is an insect, an arachnid, or an arachnoid.

9. The composition of claim 8, wherein the target pest is a species belonging to an animal order selected from: Acari, Anoplura, Araneae, Blattodea, Coleoptera, Collembola, Diptera, Grylloptera, Heteroptera, Homoptera, Hymenoptera, Isopoda, Isoptera, Lepidoptera, Mantodea, Mallophaga, Neuroptera, Odonata, Orthoptera, Psocoptera, Siphonaptera, Symphyla, Thysanura, and Thysanoptera.

10. The method of claim 1, wherein the pest control product is selected from the group comprising: a chlorphenoxy compound, a carbamate, an organophosphate, an organochlorine, a pyrethroid, a neonicotinoid, a botanical product, a fungicide, a nematicide, and insecticide, an acaracide, a bactericide, an avermectin, an abamectin, a spinosad, a fluxastrobin, and an indoxacarb.

11. The composition of claim 10, wherein the pest control product is selected from the group comprising: 2,4-D Amine, 2,4D IBE, methomyl, carbofuran, carbaryl, BPMC, carbendazim, carbosulfan, captan hydrochloride, cartap, acephate, malathion, diazinon, chlorpyfiros, fenoxycab, edifenphos, febuconazole, chlorphenapyr, magnesium phosphide, metamidophos, fenitrothion, DDT, DDE, heptachlorepoxide, cypermethrin, cynmethylin +2,4-D IBE, lambdacyhalothrin, dazomet, cyfluthrin, betacypermethrin, pendimethlin, permethrin, deltamethrin, bifenethrin, alphacypermethrin, fenvalerate, propanil, esfenvalerate, thiomethoxam, fipronil, clothianidin, imidacloprid, rotenone, nicotine, caffeine, a pyrethrum, an essential oil, and a fixed oil.

12. The composition of claim 1, wherein control comprises a condition selected from the group comprising: killing, knockdown, repellency, interference with reproduction, interference with feeding, and interference with a stage of a life cycle of the target pest.

13. A method of pest control comprising contacting a target pest, or a substrate associated with a target pest, with the composition of claim 1, resulting in control of the pest.

14. The method of claim 13, wherein the substrate is a crop plant or a soil.

15. The method of claim 13, wherein use of the composition permits an improvement of control of the pest as compared with use of the pesticide alone or the active agent alone.

16. The method of claim 15, wherein the improvement is at least one of: increased killing of the target pest; faster knockdown of the target pest; increased repellency of the target pest; increased interference with reproduction by the target pest; increased interference with feeding by the target pest; increased interference with a stage of a life cycle of the target pest;
and prolonged effectiveness of the pest control product.

17. The method of claim 13, wherein use of the composition permits an agricultural improvement selected from the group comprising: increased crop yield; reduced frequency of application of pest control product; reduced phytotoxicity associated with the pesticide; and reduced cost or increased value associated with at least one environmental factor.

18. The method of claim 17, wherein the environmental factor is selected from: air quality, water quality, soil quality, detectable pesticide residue, safety or comfort of workers; and a collateral effect on a non-target organism.

19. A composition for pest control, comprising at least two active ingredients, wherein at least one active ingredient interacts with a G protein-coupled receptor (GPCR) of the pest and wherein at least one active ingredient does not interact with the GPCR, and wherein the at least two active ingredients in combination have a synergistic pest-control activity.

20. A method of pest control, comprising,
providing a composition comprising at a first and a second active ingredient, wherein the first active ingredient interacts with a receptor of a target pest, and wherein the second active ingredient is a pesticide that does not interact with the receptor of the first active ingredient; and
contacting the pest with the composition, wherein the contacting results in synergistic pest control.


SEQUENCE LISTING (12 sequences)

SEQ ID NO: 1 - DNA, 1806 bp, Drosophila melanogaster
atgccatcggcagatcagatcctgtttgtaaatgtcaccacaacggtggcggcggcggctctaaccgctgcggccgccgtcagcaccacaaagtccggaagcggcaacgccgcacggggctacacggattcggatgacgatgcgggcatgggaacggaggcggtggctaacatatccggctcgctggtggagggcctgaccaccgttaccgcggcattgagtacggctcaggcggacaaggactcagcgggagaatgcgaaggagctgtggaggagctgcatgccagcatcctgggcctccagctggctgtgccggagtgggaggcccttctcaccgccctggttctctcggtcattatcgtgctgaccatcatcgggaacatcctggtgattctgagtgtgttcacctacaagccgctgcgcatcgtccagaacttcttcatagtttcgctggcggtggccgatctcacggtggcccttctggtgctgcccttcaacgtggcttactcgatcctggggcgctgggagttcggcatccacctgtgcaagctgtggctcacctgcgacgtgctgtgctgcactagctccatcctgaacctgtgtgccatagccctcgaccggtactgggccattacggaccccatcaactatgcccagaagaggaccgttggtcgcgtcctgctcctcatctccggggtgtggctactttcgctgctgataagtagtccgccgttgatcggctggaacgactggccggacgagttcacaagcgccacgccctgcgagctgacctcgcagcgaggctacgtgatctactcctcgctgggctccttctttattccgctggccatcatgacgatcgtctacatcgagatcttcgtggccacgcggcgccgcctaagggagcgagccagggccaacaagcttaacacgatcgctctgaagtccactgagctcgagccgatggcaaactcctcgcccgtcgccgcctccaactccggctccaagtcgcgtctcctagccagctggctttgctgcggccgggatcgggcccagttcgccacgcctatgatccagaacgaccaggagagcatcagcagtgaaacccaccagccgcaggattcctccaaagcgggtccccatggcaacagcgatccccaacagcagcacgtggtcgtgctggtcaagaagtcgcgtcgcgccaagaccaaggactccattaagcacggcaagacccgtggtggccgcaagtcgcagtcctcgtccacatgcgagccccacggcgagcaacagctcttacccgccggcggggatggcggtagctgccagcccggcggaggccactctggaggcggaaagtcggacgccgagatcagcacggagagcgggagcgatcccaaaggttgcatacaggtctgcgtgactcaggcggacgagcaaacgtccctaaagctgaccccgccgcaatcctcgacgggagtcgctgccgtttctgtcactccgttgcagaagaagactagtggggttaaccagttcattgaggagaaacagaagatctcgctttccaaggagcggcgagcggctcgcaccctgggcatcatcatgggcgtgttcgtcatctgctggctgcccttcttcctcatgtacgtcattctgcccttctgccagacctgctgccccacgaacaagttcaagaacttcatcacctggctgggctacatcaactcgggcctgaatccggtcatctacaccatcttcaacctggactaccgccgggccttcaagcgacttctgggcctgaattga

SEQ ID NO: 2 - protein, 601 aa, Drosophila melanogaster
MPSADQILFVNVTTTVAAAALTAAAAVSTTKSGSGNAARGYTDSDDDAGMGTEAVANISGSLVEGLTTVTAALSTAQADKDSAGECEGAVEELHASILGLQLAVPEWEALLTALVLSVIIVLTIIGNILVILSVFTYKPLRIVQNFFIVSLAVADLTVALLVLPFNVAYSILGRWEFGIHLCKLWLTCDVLCCTSSILNLCAIALDRYWAITDPINYAQKRTVGRVLLLISGVWLLSLLISSPPLIGWNDWPDEFTSATPCELTSQRGYVIYSSLGSFFIPLAIMTIVYIEIFVATRRRLRERARANKLNTIALKSTELEPMANSSPVAASNSGSKSRLLASWLCCGRDRAQFATPMIQNDQESISSETHQPQDSSKAGPHGNSDPQQQHVVVLVKKSRRAKTKDSIKHGKTRGGRKSQSSSTCEPHGEQQLLPAGGDGGSCQPGGGHSGGGKSDAEISTESGSDPKGCIQVCVTQADEQTSLKLTPPQSSTGVAAVSVTPLQKKTSGVNQFIEEKQKISLSKERRAARTLGIIMGVFVICWLPFFLMYVILPFCQTCCPTNKFKNFITWLGYINSGLNPVIYTIFNLDYRRAFKRLLGLN

SEQ ID NO: 3 - DNA, 1128 bp, Drosophila melanogaster
atgacaatcgaggatatcggcctggtgggcatcaacgtgcggatgtggcgacacttggccgtgctgtaccccactccgggctccagctggcgcaagttcgccttcgtactgccggtgactgcgatgaatctgatgcagttcgtctacctgctgcggatgtggggcgacctgcccgccttcattctgaacatgttcttcttctcggccattttcaacgccctgatgcgcacgtggctggtcataatcaagcggcgccagttcgaggagtttctcggccaactggccactctgttccattcgattctcgactccaccgacgagtgggggcgtggcatcctgcggagggcggaacgggaggctcggaacctggccatccttaatttgagtgcctccttcctggacattgtcggtgctctggtatcgccgcttttcagggaggagagagctcatcccttcggcgtagctctaccaggagtgagcatgaccagttcgcctgtctacgaggttatctacttggcccaactgcctacgcccctgctgctgtccatgatgtacatgcctttcgtcagcctttttgccggcctggccatctttgggaaggccatgctgcagatcctggtacacaggctgggccagattggcggagaagagcagtcggaggaggagcgcttccaaaggctggcctcctgcattgcgtaccacacgcaggtgatgcgctatgtgtggcagctcaacaaactggtggccaacattgtggcggtggaagcaattatttttggctcgataatctgctcactgctcttctgtctgaatattataacctcacccacccaggtgatctcgatagtgatgtacattctgaccatgctgtacgttctcttcacctactacaatcgggccaatgaaatatgcctcgagaacaaccgggtggcggaggctgtttacaatgtgccctggtacgaggcaggaactcggtttcgcaaaaccctcctgatcttcttgatgcaaacacaacacccgatggagataagagtcggcaacgtttaccccatgacattggccatgttccagagtctgttgaatgcgtcctactcctactttaccatgctgcgtggcgtcaccggcaaa

SEQ ID NO: 4 - protein, 376 aa, Drosophila melanogaster
MTIEDIGLVGINVRMWRHLAVLYPTPGSSWRKFAFVLPVTAMNLMQFVYLLRMWGDLPAFILNMFFFSAIFNALMRTWLVIIKRRQFEEFLGQLATLFHSILDSTDEWGRGILRRAEREARNLAILNLSASFLDIVGALVSPLFREERAHPFGVALPGVSMTSSPVYEVIYLAQLPTPLLLSMMYMPFVSLFAGLAIFGKAMLQILVHRLGQIGGEEQSEEERFQRLASCIAYHTQVMRYVWQLNKLVANIVAVEAIIFGSIICSLLFCLNIITSPTQVISIVMYILTMLYVLFTYYNRANEICLENNRVAEAVYNVPWYEAGTRFRKTLLIFLMQTQHPMEIRVGNVYPMTLAMFQSLLNASYSYFTMLRGVTGK

SEQ ID NO: 5 - DNA, 1461 bp, Drosophila melanogaster
atgacaacctcgatgcagccgagcaagtacacgggcctggtcgccgacctgatgcccaacatccgggcgatgaagtactccggcctgttcatgcacaacttcacgggcggcagtgccttcatgaagaaggtgtactcctccgtgcacctggtgttcctcctcatgcagttcaccttcatcctggtcaacatggccctgaacgccgaggaggtcaacgagctgtcgggcaacacgatcacgaccctcttcttcacccactgcatcacgaagtttatctacctggctgttaaccagaagaatttctacagaacattgaatatatggaaccaggtgaacacgcatcccttgttcgccgagtcggatgctcgttaccattcgatcgcactggcgaagatgaggaagctgttctttctggtgatgctgaccacagtcgcctcggccaccgcctggaccacgatcaccttctttggcgacagcgtaaaaatggtggtggaccatgagacgaactccagcatcccggtggagataccccggctgccgattaagtccttctacccgtggaacgccagccacggcatgttctacatgatcagctttgcctttcagatctactacgtgctcttctcgatgatccactccaatctatgcgacgtgatgttctgctcttggctgatattcgcctgcgagcagctgcagcacttgaagggcatcatgaagccgctgatggagctgtccgcctcgctggacacctacaggcccaactcggcggccctcttcaggtccctgtcggccaactccaagtcggagctaattcataatgaagaaaaggatcccggcaccgacatggacatgtcgggcatctacagctcgaaagcggattggggcgctcagtttcgagcaccctcgacactgcagtcctttggcgggaacgggggcggaggcaacgggttggtgaacggcgctaatcccaacgggctgaccaaaaagcaggagatgatggtgcgcagtgccatcaagtactgggtcgagcggcacaagcacgtggtgcgactggtggctgccatcggcgatacttacggagccgccctcctcctccacatgctgacctcgaccatcaagctgaccctgctggcataccaggccaccaaaatcaacggagtgaatgtctacgccttcacagtcgtcggatacctaggatacgcgctggcccaggtgttccacttttgcatctttggcaatcgtctgattgaagagagttcatccgtcatggaggccgcctactcgtgccactggtacgatggctccgaggaggccaagaccttcgtccagatcgtgtgccagcagtgccagaaggcgatgagcatatcgggagcgaaattcttcaccgtctccctggatttgtttgcttcggttctgggtgccgtcgtcacctactttatggtgctggtgcagctcaagtaa

SEQ ID NO: 6 - protein, 486 aa, Drosophila melanogaster
MTTSMQPSKYTGLVADLMPNIRAMKYSGLFMHNFTGGSAFMKKVYSSVHLVFLLMQFTFILVNMALNAEEVNELSGNTITTLFFTHCITKFIYLAVNQKNFYRTLNIWNQVNTHPLFAESDARYHSIALAKMRKLFFLVMLTTVASATAWTTITFFGDSVKMVVDHETNSSIPVEIPRLPIKSFYPWNASHGMFYMISFAFQIYYVLFSMIHSNLCDVMFCSWLIFACEQLQHLKGIMKPLMELSASLDTYRPNSAALFRSLSANSKSELIHNEEKDPGTDMDMSGIYSSKADWGAQFRAPSTLQSFGGNGGGGNGLVNGANPNGLTKKQEMMVRSAIKYWVERHKHVVRLVAAIGDTYGAALLLHMLTSTIKLTLLAYQATKINGVNVYAFTVVGYLGYALAQVFHFCIFGNRLIEESSSVMEAAYSCHWYDGSEEAKTFVQIVCQQCQKAMSISGAKFFTVSLDLFASVLGAVVTYFMVLVQLK

SEQ ID NO: 7 - DNA, 39 bp, Drosophila melanogaster
gccgaattcgccaccatgccatcggcagatcagatcctg

SEQ ID NO: 8 - DNA, 34 bp, Drosophila melanogaster
taatctagatcaattcaggcccagaagtcgcttg

SEQ ID NO: 9 - DNA, 34 bp, Drosophila melanogaster
taagcggccgcatgacaacctcgatgcagccgag

SEQ ID NO: 10 - DNA, 34 bp, Drosophila melanogaster
ataccgcggcttgagctgcaccagcaccataaag

SEQ ID NO: 11 - DNA, 36 bp, Drosophila melanogaster
taagcggccgcatgacaatcgaggatatcggcctgg

SEQ ID NO: 12 - DNA, 35 bp, Drosophila melanogaster
ataccgcggtttgccggtgacgccacgcagcatgg